(19) United States
(12) Patent Application Publication
(10) Pub. No.: US 2013/0317839 A1
(43) Pub. Date: Nov. 28, 2013

(54) SYSTEM AND METHOD FOR INCREASING PATIENT ADHERENCE TO MEDICATION TREATMENT REGIMENS

(71) Applicant: DRFIRST.COM, INC., Rockville, MD (US)

(72) Inventors: Christopher John CRESWELL, Potomac, MD (US); Brandon Anthony BRYLAWSKI, Bethesda, MD (US); Yixin HOU, Rockville, MD (US); Andrew Mutch CURTIS, Gaithersburg, MD (US); Weizhen DAI, North Potomac, MD (US); Kamal TAYAL, Gaithersburg, MD (US); Zilong TANG, Rockville, MD (US); Richard AUER, Oakton, VA (US); David FREITAG, South Riding, VA (US); Yu-Fui HUNG, Bethesda, MD (US); Eric REESE, Bethesda, MD (US)

(73) Assignee: DRFIRST.COM, INC., Rockville, MD (US)

(21) Appl. No.: 13/952,349

(22) Filed: Jul. 26, 2013

Related U.S. Application Data
(63) Continuation-in-part of application No. 13/565,164, filed on Aug. 2, 2012.
Application No. 13/565,164 is a continuation-in-part of application No. 13/544,531, filed on Jul. 9, 2012.
Application No. 13/544,531 is a continuation-in-part of application No. 13/462,486, filed on May 2, 2012.
(60) Provisional application No. 61/635,613, filed on Apr. 19, 2012.
(60) Provisional application No. 61/611,942, filed on Mar. 16, 2012.

(51) Int. Cl. G06Q 50/22; G06Q 10/00

(52) U.S. Cl. CPC G06Q 50/22; G06Q 10/00
USPC 705/2

(57) ABSTRACT

A system and method for increasing patient adherence to following medication treatment regimens. An adherence data processing and communication system generates and displays medication adherence data based on historical medication information. The system is linked to other systems involved with electronic ordering and filling of prescriptions, such as electronic prescription and pharmacy systems all connected by suitable wired and/or wireless communication protocols including the Internet. In one embodiment, the adherence data is displayed in the form of an interactive report card which provides a user with adherence metrics in both summary and more detailed formats for prescription medications taken by the patient. A related method executed by the data processing and communication system is disclosed.

### CROSS-REFERENCE TO RELATED APPLICATIONS

The present application is a continuation-in-part of U.S. patent application Ser. No. 13/565,164 filed Aug. 2, 2012, which in turn is a continuation-in-part of U.S. patent application Ser. No. 13/544,531 filed Jul. 9, 2012 which in turn is a continuation-in-part of U.S. patent application Ser. No. 13/462,486, filed May 2, 2012, which in turn claims the benefit of United Stated Provisional Application Ser. No. 61/635,613, filed Apr. 19, 2012, and United Stated Provisional Application Ser. No. 61/611,942, filed Mar. 16, 2012, the entireties of which are incorporated herein by reference.

### FIELD OF THE INVENTION

The present invention generally relates to systems and methods for improving patient adherence to medical treatment regimens, and more particularly to computer processor based systems and methods for electronically enhancing patient adherence to prescription medicine treatment regimens.

### BACKGROUND OF THE INVENTION

Poor patient adherence to taking and complying with treatment regimens is a major concern within the health care industry. After visiting their health care provider and receiving at least one prescription for medication such as a pharmaceutical substance, many patients thereafter fail to maintain a level of compliance with their prescribed treatment regimen and adherence to diligently taking their mediation as prescribed and/or continuing their medication regimen by timely seeking refills on their medication. This practice results in increased costs to all parties involved in the health care industry, including, but not limited to the patient, the health care provider, the pharmacies, the pharmaceutical companies, and the health insurance companies. There are currently some employed with the goal of increasing patient adherence, such as by the distribution of patient educational health materials, discount coupons, and patient reminder services. However, such approaches have generally lacked sufficient coordination and/or timely provision of patient compliance information to the health care provider or other entities to make a significant improvement in the overall care of the patient.

One important element to increasing patient adherence is good health care provider-patient interaction. Because this interaction is most effective when it takes place at the point-of-care while the patient is thinking about their current physical state, this interaction is crucial for facilitating patient health, awareness, and adherence. However, there is currently not a system that allows for a health care provider to be fully informed of whether their patients are adhering to diligently taking their prescriptions contemporaneously while the patients are at the point-of-care. Further, the current methods of increasing patient adherence through educational and financial incentives require the health care provider to not only know whether or not their patient is adhering to taking their prescribed medications, but also requires the health care provider to have the specific education material and discount coupons available for each patient's specific diagnoses and prescribed medications at the point-of-care. This is overly burdensome and practically impossible for a health care provider who has patients with a wide variety of health care needs. Therefore, there is also a need for a system that can more easily and efficiently coordinate and distribute patient educational materials, coupons, and other supplemental programs at the point-of-care.

Additionally, pharmaceutical companies are restricted in the number of coupons and other incentives they may distribute. Currently, the coupons and other incentives are distributed to patients without taking into consideration whether the patient receiving the coupon or other incentive needs will be incentivized by them. Therefore, there also remains a need for a system that can aid pharmaceutical companies in distributing coupons and other incentives to their customers in a more efficient manner.

Improved systems and methods are desired for providing contemporaneous information about patient adherence to following prescription medication regimens and enhancing the effectiveness of the foregoing patient incentives.

### SUMMARY OF THE INVENTION

The systems and methods described herein help to fill the needs and solve the issues described above. These systems and methods may be embodied in the form of computer-implemented processes and apparatuses configured for implementing and practicing those processes, as further described herein.

The present disclosure provides a patient adherence system and compliance dashboard for determining patient behavior and adherence to prescription medication regimens based on patient medication histories, and further providing that adherence information to a user such as a health care provider contemporaneous with the time and at the point of service such as in the doctor's office during a patient visit. Advantageously, this allows the health care provider to make an intervention as needed to get the patient to regularly fill and take their prescribed medications which will benefit the patient's health. Embodiments of the compliance dashboard include an interactive toolbar that allows the health care provider to navigate to and display important medication adherence information made available by the patient adherence system. In one embodiment, the compliance dashboard may conveniently be integrated into the electronic prescription system user interface to provide ready access to the patient medication adherence information, as further described herein.

According to one aspect of the present invention, a computer processor implemented method for navigating and displaying patient medication adherence information in a graphical user interface is provided. The method includes: a processor automatically displaying a toolbar in the graphical user interface, the toolbar comprising a plurality of user selectable content tabs; selecting a first content tab in the toolbar; the processor retrieving a patient medication adherence metric from a database for at least one drug, the patient medication adherence metric being indicative of the patient's compliance with following a medication treatment regimen and having a numeric value; the processor displaying a patient advisor report card comprising an adherence chart having a plurality of individual drug timelines and an adherence metric graphic displaying the patient medication adherence metric in a graphical form, wherein the patient medication adherence metric displayed in the adherence graphic corresponds to one of the drug timelines in the adherence chart.

In another embodiment, a computer processor implemented method for navigating and displaying patient medication adherence information in a graphical user interface includes: a first processor receiving patient medication history data for a patient; the first processor generating patient medication adherence data for at least one drug taken by the patient, the patient medication adherence data having a numeric value indicative of the patient's compliance with following a medication treatment regimen; the first processor storing the patient medication adherence data in a first database; a second processor automatically displaying a toolbar in a graphical user interface of a user terminal, the toolbar comprising a plurality of user selectable content tabs; a user selecting a first content tab in the toolbar: the second processor retrieving the patient medication adherence data from the first database for the at least one drug; the second processor displaying a patient advisor report card comprising an adherence chart having a plurality of individual drug timelines and an adherence graphic displaying the patient medication adherence data in a graphical form, wherein the patient medication adherence data displayed in the adherence graphic corresponds to one of the drug timelines in the adherence chart. In one embodiment, the graphical user interface is an electronic prescription system entry screen.

According to one aspect of the present invention, a non-transitory computer readable storage medium encoded with program instructions of an application is provided. When the program instructions are executed by a processor, the instructions cause the processor to perform steps comprising: processing a request for patient medication adherence data for a patient, the patient medication adherence data being indicative of the patient's compliance with following a medication treatment regimen including one or more prescription drugs and having a numeric value; retrieving the patient medication adherence data from a database for the patient; displaying a report card comprising the patient medication adherence data on a graphical user interface, the report card including: (1) an adherence chart showing the patient medication adherence data in a first graphical form comprising a plurality of individual drug timelines, and (2) an adherence graphic displaying the patient medication adherence data in a second graphical form comprising a bar chart reflecting the numeric value of the patient medication adherence data. The bar chart displayed in the adherence graphic corresponds to one of the drug timelines in the adherence chart.

According to one embodiment, the present invention is directed to a method of provisioning a combined educational coupon, the method comprising: a) receiving, on a computer apparatus, electronic prescription data for a prescribed substance for a patient; b) the computer apparatus determining educational data relating to the prescribed substance and coupon data relating to the prescribed substance; and c) the computer apparatus generating a single data file comprising the educational data relating to the prescribed substance and the coupon data relating to the prescribed substance.

According to another embodiment, the present invention is directed to a non-transitory computer-readable storage medium encoded with instructions which, when executed on a processor, perform a method comprising: a) receiving data relating to an electronic prescription of a prescribed substance for a patient; b) searching one or more databases for educational data relating to the prescribed substance and coupon data relating to the prescribed substance; c) determining educational data relating to the prescribed substance and coupon data relating to the prescribed substance, d) retrieving from the one or more databases the educational data relating to the prescribed substance and the coupon data relating to the prescribed substance; and e) generating a single data file comprising the educational data relating to the prescribed substance and the coupon data relating to the prescribed substance.

According to yet another embodiment, the present invention is directed to a computer system for electronically generating educational coupons for a prescribed substance, the computer system comprising: a processor; a storage device; a network interface; and instructions residing on the storage unit, which when executed by the processor, causes the processor to: a) receive electronic prescription data for a prescribed substance for a patient; b) determine educational data relating to the prescribed substance and coupon data relating to the prescribed substance; and c) generate a single data file comprising the educational data relating to the prescribed substance and the coupon data relating to the prescribed substance.

According to another embodiment, the present invention is directed to a method of supplementing an electronic prescription issued by a health care provider, the method comprising: a) receiving, on a computer apparatus, electronic prescription data generated by a health care provider for a patient for a prescribed substance; b) the computer apparatus determining, from a plurality of available supplemental programs stored on one or more databases, supplemental programs for which the patient is eligible based on the electronic prescription data; c) presenting to the health care provider, in a display device, a list of the eligible supplemental programs, each of the eligible supplemental programs being selectable and de-selectable by the health care provider in the display device; and d) the computer apparatus activating each supplemental program from the plurality of available supplemental programs that have been selected and confirmed by the health care provider in the display device; and wherein one of the activated supplemental programs is a coupon service, and wherein step d) further comprises retrieving coupon data relating to the prescribed substance from the one or more databases, and provisioning a coupon based on the coupon data to the patient; and wherein one of the activated supplemental programs is a prescribed substance education service, and wherein step d) further comprises retrieving education content relating to the prescribed substance from the one or more databases, and transmitting said education content to the patient, said coupon data being integrated into the education content to create a combined educational coupon.

According to another embodiment, the present invention is directed to a method of providing educational materials to a patient, the method comprising: a) receiving, on a computer apparatus, electronic prescription data for a prescribed substance for a patient, said electronic prescription data including a diagnostic code; b) searching one or more databases, using the computer apparatus, to determine: (1) general educational data relating to the prescribed substance and independent of the diagnostic code; and (2) specific educational data relating to the prescribed substance and based on the diagnostic code: and c) presenting to a health care provider, in a display device, a list of the general educational data and the specific educational data determined in step b) for provisioning to the patient.

According to another embodiment, the present invention is directed to a non-transitory computer-readable storage medium encoded with instructions which, when executed on a processor, perform a method comprising: a) receiving electronic prescription data for a prescribed substance for a patient, said electronic prescription data including a diagnostic code; b) searching one or more databases to determine: (1) general educational data relating to the prescribed substance independent of the diagnostic code; and (2) specific educational data relating to the prescribed substance based on the diagnostic code; and c) presenting to a health care provider, in a display device, a list of the general educational data and the specific educational data determined in step b) for provisioning to the patient.

According to yet another embodiment, the present invention is directed to a computer system for electronically generating coupons for a prescribed substance, the computer system comprising: a processor: a storage device; a network interface: and instructions residing on the storage unit, which when executed by the processor, causes the processor to: a) receive electronic prescription data for a prescribed substance for a patient, said electronic prescription data including a diagnostic code; b) search one or more databases to determine: (1) general educational data relating to the prescribed substance independent of the diagnostic code; and (2) specific educational data relating to the prescribed substance based on the diagnostic code: and c) present to a health care provider, in a display device, a list of the general educational data and the specific educational data determined in step b) for provisioning to the patient.

### BRIEF DESCRIPTION OF THE DRAWINGS

The features of the exemplary embodiments of the present invention will be described with reference to the following drawings where like elements are labeled similarly, and in which:

FIG. 1 is a schematic diagram of a system for supplementing patient and provider interactions to increase patient adherence according to one embodiment of the present invention;

FIG. 2 is a schematic diagram of a health care provider system for supplementing patient and provider interactions to increase patient adherence according to one embodiment of the present invention;

FIG. 3 is a schematic diagram of an electronic prescription system for supplementing patient and provider interactions to increase patient adherence according to one embodiment of the present invention;

FIG. 4 is a schematic diagram of a supplemental program system for supplementing patient and provider interactions to increase patient adherence according to one embodiment of the present invention;

FIG. 5 is a schematic diagram of a plurality of third party program vendors for supplementing patient and provider interactions to increase patient adherence according to one embodiment of the present invention;

FIG. 6 is a schematic diagram of a pharmacy system for supplementing patient and provider interactions to increase patient adherence according to one embodiment of the present invention;

FIG. 7 is a schematic diagram of payor system for supplementing patient and provider interactions to increase patient adherence according to one embodiment of the present invention;

FIGS. 8a-8c is a flow chart of a system for supplementing patient and provider interactions to increase patient adherence according to one embodiment of the present invention;

FIG. 9 is an illustration of a combined educational material and coupon document according to one embodiment of the present invention;

FIGS. 10-15 are screen shots of graphical user interfaces used for supplementing patient and provider interactions to increase patient adherence according to one embodiment of the present invention;

FIG. 16 is a flow diagram of a method of acquiring patient medication history data according to an embodiment of the present invention;

FIGS. 17-28 are event diagrams of methods for supplementing patient and provider interactions to increase patient adherence according to embodiments of the present invention;

FIG. 29 is a schematic diagram of a system for increasing patient adherence through the activation of supplemental programs according to one embodiment of the present invention;

FIG. 30 is a flow chart of a method for defining a plurality of cohorts of a program cohort group according to one embodiment of the present invention;

FIG. 31 is a schematic diagram depicting how the SP module defines a plurality of cohorts according to one embodiment of the present invention;

FIG. 32 is a schematic diagram of a method of defining a plurality of different permutations of eligible supplemental programs for a target drug according to one embodiment of the present invention;

FIG. 33 is a schematic diagram of a method of assigning a different permutation of eligible supplemental programs to each cohort out of a plurality of cohorts of a program cohort group according to one embodiment of the present invention;

FIG. 34 is a schematic diagram of a cohort relation table according to one embodiment of the present invention;

FIGS. 35a-35b are a flow chart of a method for receiving data relating to an electronic prescription for the target drug and activating the permutation of supplemental programs associated with the health care provider's cohort for the target drug according to one embodiment of the present invention;

FIG. 36a is a flow chart of a method of retrieving supplemental program data in accordance with an alternate embodiment of the present invention;

FIG. 36b is a flow chart of a method of generating a document list of all eligible supplemental programs that are selected and accepted by a provider for an electronic prescription according to an alternate embodiment of the present invention;

FIG. 36c is a flow chart of a method of retrieving the document associated with supplemental programs that are selected and accepted by a provider for an electronic prescription according to an alternate embodiment of the present invention;

FIGS. 37a-37b are a flow chart of a method of parsing patient adherence data into data grouping based on a plurality of different cohorts according to an embodiment of the present invention;

FIG. 38a is a graphical representation of the effectiveness of different permutations of supplemental programs on patient's first fill compliance according to one embodiment of the present invention;

FIG. 38b is a graphical representation of the effectiveness of different permutations of supplemental programs on patient's medication persistency rate according to one embodiment of the present invention;

FIG. 39 is a schematic diagram of a patient adherence system for tracking and reporting compliance with drug treatment regimens:

FIG. 40 is a flow chart of an exemplary process showing how the patient adherence system of FIG. 39 may process prescription data;

FIG. 41 is a flow chart of an exemplary process showing how the patient adherence system of FIG. 39 may obtain medication history data;

FIGS. 42-45 are exemplary screen shots of a graphical user interface (GUI) including a patient advisor system compliance dashboard with user interactive patient advisor toolbar for navigating the patient adherence system and retrieving patient medication history and adherence data in addition to other useful medication related information;

FIGS. 46-53 are exemplary GUI screen shots showing a patient advisor report card containing patient medication adherence and related data for a plurality of drugs accessed via a Report Card tab in the toolbar:

FIGS. 54-55 are exemplary GUI screen shots showing medication related studies accessed via an Outcome Studies tab in the toolbar;

FIGS. 56-57 are exemplary GUI screen shots showing medication educational materials accessed via an Education tab in the toolbar:

FIGS. 58-59 are exemplary GUI screen shots showing medication discount information and coupons accessed via a Coupon tab in the toolbar:

FIG. 60 is a flow chart of a process for generating and transmitting patient medication adherence data to the patient advisor system compliance dashboard for display to a user such as the health care provider or others;

FIG. 61 is a flow chart of a process for retrieving and displaying the Report Card tab in the patient advisor system toolbar in two different display modes; and

FIG. 62 is an exemplary GUI screen shot showing an alternative display of the patient advisor report card.

All drawings are schematic.

### DETAILED DESCRIPTION OF EMBODIMENTS

The features and benefits of the present disclosure are illustrated and described herein by reference to exemplary embodiments and is in no way intended to limit the invention, its application, or uses. This description of exemplary embodiments is intended to be read in connection with the accompanying drawings, which are to be considered part of the entire written description. Accordingly, the present disclosure expressly should not be limited to such embodiments illustrating some possible non-limiting combination of features that may exist alone or in other combinations of features; the scope of the claimed invention being defined by the claims appended hereto.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally.” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “coupled,” “affixed,” “connected,” “interconnected,” and the like refer to a relationship wherein structures are secured or attached to one another either directly or indirectly through intervening structures, as well as both movable or rigid attachments or relationships, unless expressly described otherwise. The terms “medication,” “drug” and “substance” may be used interchangeably herein unless specifically noted to the contrary to define a medication prescribed by a health care provider having a potential health effect.

Computer-executable instructions/programs (e.g. code) and data described herein may be programmed into and tangibly embodied in non-transitory computer readable medium that is accessible to and retrievable by a respective processor as described herein which configures and directs the processor to perform the desired functions and processes by executing the instructions encoded in the medium. It should be noted that non-transitory “computer readable medium” as described herein may include, without limitation, any suitable volatile or non-volatile memory including random access memory (RAM) and various types thereof, read-only memory (ROM) and various types thereof, USB flash memory, and magnetic or optical data storage devices (e.g. internal/external hard disks, floppy discs, magnetic tape CD-ROM. DVD-ROM, optical disk, ZIP™ drive, Blu-ray disk, and others), which may be written to and/or read by a processor operably connected to the medium.

Aspects of the present invention may be implemented in software, hardware, firmware, or combinations thereof. The computer programs described herein are not limited to any particular embodiment, and may be implemented in an operating system, application program, foreground or background process, driver, or any combination thereof, executing on a single computer or server processor or multiple computer or server processors

Processors described herein may be any computer/server central processing unit (CPU), microprocessor, micro-controller, or computational device or circuit configured for executing computer program instructions (e.g. code).

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, DVDs, hard drives, ZIP™ disks, memory sticks, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits

System Overview

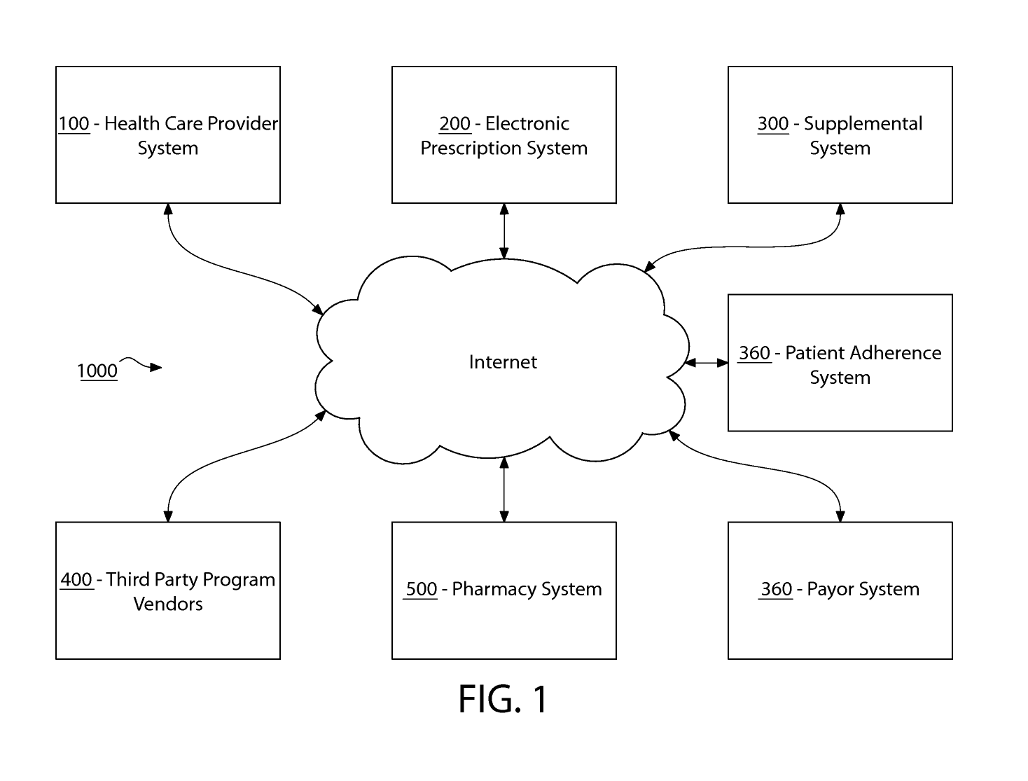

Referring to FIG. 1, a schematic diagram of a system 1000 for supplementing patient and provider interactions to increase patient adherence according to one embodiment of the present invention is illustrated. System 1000 is a networked data processing and communication system. Generally, the system 1000 comprises a health care provider (HCP) system 100, an electronic prescription (EP) system 200, a supplemental program (SP) system 300, at least one third party program vendor 400, a pharmacy system 500, and a payor system 600 all in operable communication with one another to form a wide area network (WAN). In some embodiments, as further described herein, system 1000 may further include a patient adherence system 360.

The individual systems 100-500 and 360 shown in FIG. 1 which comprises system 1000 and other systems which may operably communicate and exchange data with any of these systems through system 1000 shall be broadly construed to be health care systems. As the term is used herein, a health care system shall broadly mean any type of data processing and/or communication system which creates, processes, accesses, uploads, downloads, stores, collects, displays, manipulates, or otherwise utilizes in any manner or degree whatsoever any type of information/data directly or tangentially related to a patient, medication, and health and dental care for a patient (human or animal) and any related activities and services.

As exemplified by FIG. 1, the components of the system 1000 may be in operable communication via the internet. However, the invention is not so limited and other electronic communication means or links may be utilized, such as a satellite network, a cellular network, a common carrier network(s), Wi-Fi, Bluetooth, WiMAX, wired connections, or any combination thereof as some possible but non-limiting examples. Further, it should be noted that operable communication includes any means of electronic communication, such as but not limited to wired and wireless electronic communication, in which data can be transmitted and received between the systems and modules of the system 1000. Moreover, it should also be noted that operable communication includes both direct and indirect communication, as well as bi-directional communication between the systems and modules of the system 1000.

As discussed in more detail below, the system 1000 of the present invention may be configured in other ways. Therefore, it should be noted that the invention is not limited only to those configuration explicitly described herein and, in alternate embodiments the system 1000 may take on other configurations and/or layouts. For instance, any of the systems and/or modules or components of the system 1000 may be connected via a local area network (LAN). For example, according to one embodiment of the present invention, the EP system 200 and the SP system 300 reside on the same LAN, and therefore, may communicate via Ethernet and/or Wi-Fi over a LAN.

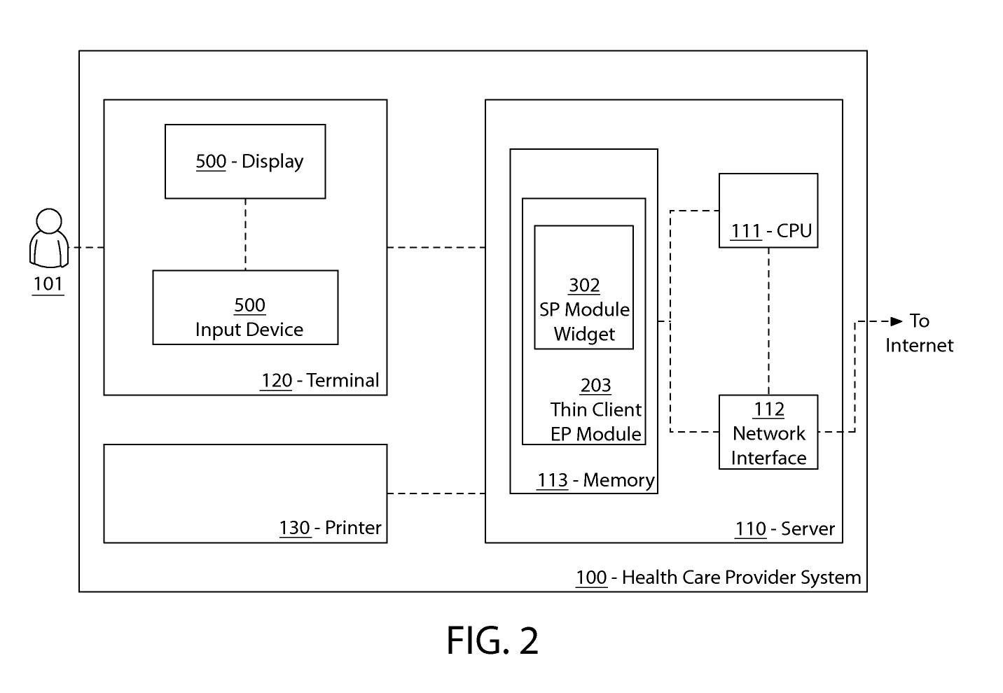

Referring to FIG. 2, a schematic diagram of an HCP system 100 according to one embodiment of the present invention is illustrated. The HCP system (100 comprises a server 110, a terminal 120, and a printer 130 in operable communication. Further, as discussed in more detail below, the HCP system 100 may also be said to comprise at least one health care provider 101. Although exemplified as comprising the above components, the HCP system 200 may comprise any number, more or less, of the components listed above. For example, a particular HCP system 100 may comprises a plurality of providers 101, a plurality of servers 110, a plurality of terminals 120, and/or a plurality of printers 130.

Generally, the HCP system 100 may be associated with an individual, institution or organization that provides general and/or specific health care for those patients in need. For example, an HCP system 100 may be associated with an entire hospital or health care system, a specialized practice group within a larger hospital or health care system, a private general practice, or a private specialized practice. The health care provider 101 may be a medical doctor, a nurse practitioner, or a staff administrator who is authorized to issue prescriptions. As noted above, the HCP system 100 may be associated with any number of providers 101, and a particular provider 101 may be associated with more than one HCP system 100 at any given time.

The server 110 of the HCP system 100 comprises a properly programmed processor (e.g. central processing unit (CPU) or microprocessor) 111 executing computer instructions, a network interface 112, and a memory device or unit 113 (also referred to herein as simply “memory”) all in operable communication via a system bus. In one embodiment, memory 113 may preferably be a non-volatile form of non-transitory computer readable medium which retains data even after power is removed or lost from the system. It should be noted the processor 111 may be considered the processor of the HCP system 100. Further, although exemplified as a single server 110, the invention is not so limited and in alternate embodiments the HCP system 100 may comprise any number of servers 110. Additionally, although not exemplified, it should be understood that the processor 111 can have integrated memory. The network interface 112 connects the server 110 to the over systems and modules of the system 1000 via the internet. The properly programmed processor 111 of the HCP system 100 effectuates the performing of the processes and functions described below, including but not limited to, the storage of data to the memory 113 of the HCP system 100, the performance of the processes and functions of a thin-client version or portion or of an electronic prescription (EP) module 203 and a supplemental program (SP) module widget 302, and the transfer (transmission and receipt) of data from HCP system 100 to the other systems and modules of the system 1000.

Although not specifically enumerated herein, it should be noted that server 110 (and other servers as variously described herein) include all of the usual appurtenances necessary to form a fully functional and interconnected data processing and storage system. Accordingly, server 110 will generally include a bus which operably interconnects the processor (e.g. processor 111), read-only memory (ROM), random access memory (RAM), computer readable medium such as non-volatile memory (e.g. memory 113), and others.

In the exemplified embodiment, the memory 113 comprises the thin-client portion of the EP module 203 and the SP module widget 302, both of which are described in more detail below. Although exemplified schematically as a single memory unit, it should be noted that the memory 113 may comprise any number or types of computer readable medium which may include one or more databases used to store data, modules, or other information. For example, the memory may be used to store provider information, patient information, prescribed substance or medication information, and appropriate software (e.g. computer instructions, program or application) operable to direct operation of processor 111 and to allow the provider 101 to interact with the thin-client portion of the EP module 203 and the SP module widget 302.

Although exemplified as part of the memory 113, in other embodiments the thin-client portion of the EP module 203 may reside elsewhere on the HCP system 100 or on another system altogether accessible to HCP system 100. Further, in the exemplified embodiment, the SP module widget 302 is integrated into the thin-client portion of the EP module 203. However, it should be noted that the invention is not so limited and in alternate embodiments, any portion of the SP module may be integrated into any portion of the HCP system 100. Further, in one embodiment of the present invention, the SP module is not integrated with the EP module, but is rather a completely separate module altogether.

The terminal 120 of the HCP system 100 may be a personal computer (PC) or any mobile processor-based electronic unit, such as without limitation for example a notebook or laptop computer, tablet or pad computer, personal digital assistant, mobile/smart phone, or equivalent which is in operable communication with server HCP 110 by wired or wireless communication protocols such as Wi-Fi, Bluetooth, etc. Each termnninal 120 of the HCP system 100 comprises a properly programmed processor (not shown), a memory device (not shown), a power supply (not shown), a video card (not shown), a display device 121, firmware (not shown), software (not shown), a network interface (not shown) and a user input device 122 (e.g., a keyboard, mouse and/or touch screen). Although not exemplified, it should be understood that the processor of the terminal 120 can have integrated memory. The properly programmed processor of the terminal 120 is configured to effectuate the processes and functions described below, including, but not limited to the effectuation of the graphical user interfaces (GUI) for display on the display device 121 of the terminal 120 for the provider 101 and the transmission of user inputs from the provider 101 via the input device 122 to the other systems and modules of the system 1000.

As discussed in more detail below, after the provider 101 generates a prescription for a substance using the thin-client portion of the EP module 203, the electronic prescription is transmitted by the HCP system 100 to the pharmacy system 500 for processing. Further, as also discussed in more detail below, at any point during the prescription writing processes using the thin-client portion of EP module 203, the SP module widget 302 may receive electronic prescription data relating to the electronic prescription and transmits the electronic prescription data to the to the SP system 300 for further processing.

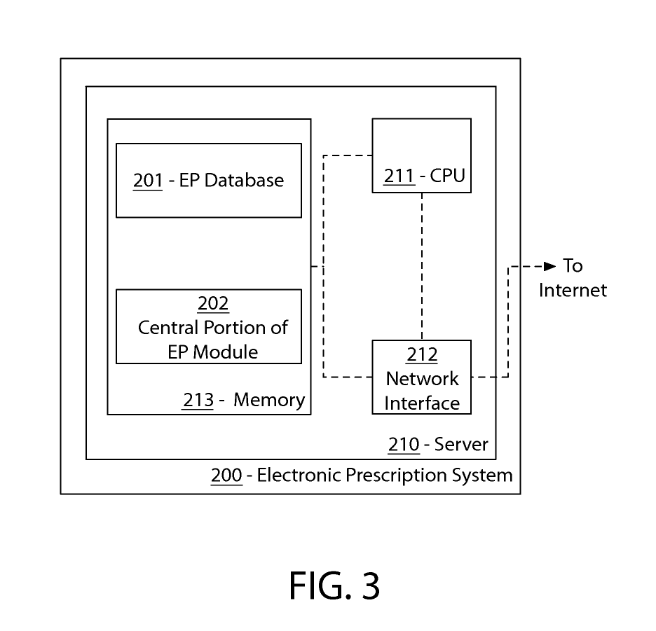

Referring to FIG. 3, a schematic diagram of an EP system 200 according to one embodiment of the present invention is illustrated. Generally, the EP system 200 comprises a server 210 which comprises a properly programmed processor (CPU) 211 executing computer instructions or control logic, a network interface 212, and a non-transitory computer readable medium such as memory unit 213 in operable communication. In one embodiment, memory 213 is non-volatile. It should be noted that the processor 211 may be considered the processor of the EP system 200. Further, although exemplified as a single server 210, the invention is not so limited and in alternate embodiments the EP system 200 may comprise any number of servers 210. Additionally, although not exemplified, it should be understood that the processor 211 can have integrated memory. The network interface 212 connects the server 210 to the over systems and modules of the system 1000 via the internet.

As discussed in more detail below, the processor 211 of the EP system 200 effectuates the performance of the processes and functions described herein, including but not limited to the performance of the processes carried out by the central portion of the EP module 202, the storage of data to the EP database 201, and the transfer of data between the EP system 200 and the other systems and modules of the system 1000.

The memory 213 of the EP system 200 comprises an electronic prescription (EP) database 201 and a central portion of the electronic prescription (EP) module 202. The EP database 201 stores information relating to electronic prescriptions that are generated using and effectuated by the EP module, such as, but not limited to, provider data, patient data, prescribed substance data, payor data, and patient medication history data. Further, although exemplified as a single memory unit, it should be noted that the memory 213 may comprise any number of databases used to store data, modules, or other information.

Generally, the EP module is one or more computer programs configured to allow a provider 101 to generate and transmit electronic prescriptions to the pharmacy system 500. In embodiments where the EP module comprises a central portion 202 and a client portion 203, the central portion 202 is configured to do most of the heavy processing of the EP module. Further, in such embodiments, the client portion 203 is a thin-client portion that does light processing and generates/displays user interfaces for the provider 101 on the display device 121 of their terminal 120.

As used herein, the central portion 202 and the thin-client portion 203 of the EP module may be collectively defined as the “EP module.” Although exemplified as comprising a thin-client portion 203 that resides within the memory 113 of the HCP system 100 and a central portion 202 that resides within the memory 213 of the EP system 200, the EP module is not so limited. In alternate embodiments, the central portion 202 of the EP module may reside elsewhere on the system 1000 or be combined with the thin-client portion 203 of the EP module and reside on any of the systems of the system 1000. In embodiments where the central portion 202 and the thin-client portion 203 are combined, the provider 101 may access the EP module via a web interface (portal) or an applicant user interface using their terminal 120. One non-limiting example of an EP module is Rcopia® by DrFirst®. In other possible embodiments, the central portion 202 and the thin-client portion 203 may be combined and located in the HCP system 100 such as in HCP memory 113 accessible locally to server 110 such that the provider 101 may access the combined EP system without resort to an external communication link such as via the web interface and Internet.

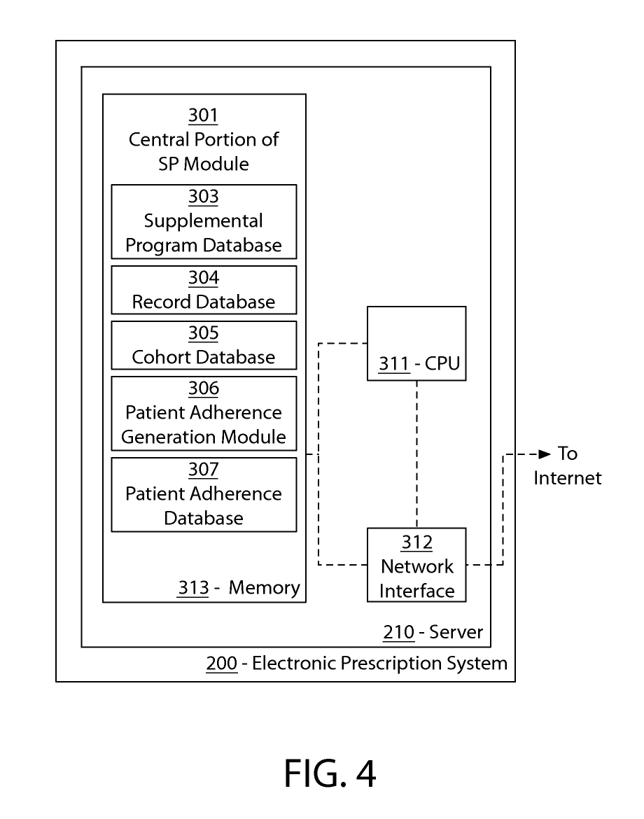

Referring to FIG. 4, a schematic diagram of a SP system 300 according to one embodiment of the present invention is illustrated. Generally, the SP system 300 comprises a server 310 which comprises a properly programmed processor (CPU) 311, a network interface 312, and a non-transitory computer readable medium such as memory unit 313 in operable communication. In one embodiment, memory 313 is non-volatile. It should be noted that the server 310 may be considered the supplemental program server and the processor 311 may be considered the processor of the SP system 300. Further, although exemplified as a single server 310, the invention is not so limited and alternate embodiments the SP system 300 may comprise any number of servers 310. Additionally, although not exemplified, it should be understood that the processor 311 can have integrated memory. The network interface 312 connects the server 310 to the over systems and modules of the system 1000 via the internet.

As discussed in more detail below, the processor 311 of the SP system 300 effectuates the performance of the processes and functions described herein, including but not limited to the performance of the processes carried out by the central portion 301 of a supplemental program (SP) module (e.g., the determination of eligibility performed by the SP module, the transfer of content to a patient or the HCP system 100, the enrollment of a patient into a service, etc.), the storage of data to a supplemental program database 303 and a record database 304, and the transfer of data between the SP system 300 and the other systems and modules of the system 1000.

The memory 313 of the SP system 300 comprises a central portion of the SP module 301, a supplemental program database 303, and a records database 304. Although exemplified as a single memory unit, it should be noted that the memory 113 may comprise any number of databases used to store data, modules, or other information. As used herein, the central portion 301 and the widget 302 of the SP module may be collectively defined as the “SP module.”

Generally, the SP module is one or more computer programs configured to determine, from a plurality of available supplemental programs, specific supplemental programs for which a patient is eligible. Further, as also discussed in more detail below, the SP module is configured to, among other things: (1) receive electronic prescription data generated by a provider 101 for a patient for a prescribed substance from either the HCP system 100, the EP module, or the EP system 200; (2) retrieve patient data, prescribed substance data, provider data, and/or payor data from one or more databases of the system 1000; (3) determine, from a plurality of available supplemental programs, specific supplemental programs for which a patient is eligible; (4) determine delivery modes that are available for each supplemental program in which the patient is eligible; (5) generate graphical user interfaces (GUIs) that are displayed to the provider 101 on the display device 121 of the HCP system 100; (6) receive inputs from the provider 101 via the input device 122 of the HCP system 100; (7) generate an activation signal for each supplemental program that is selected by the provider 101; (8) receive the activation signal from the HCP system 100; (9) activate supplemental programs that are selected and confirmed by the provider 101, (10) tailor content associated with an activated supplemental program for a specific delivery mode; and (11) deliver the content associated with the activated supplemental program to the patient.

As also discussed in more detail below, the central portion 301 of the SP module determines eligible supplemental programs, out of a plurality of available supplemental programs, for a patient based on at least electronic prescription data and the rules of each available supplemental programs. Although not exemplified, the central portion 301 of the SP module comprises a rules engine that determines the eligibility of each of the available supplemental programs for a patient being prescribed a particular substance. Further, the central portion 301 of the SP module also comprises agents that reach out to the third party content providers 400 to retrieve content relating to the plurality of supplemental programs. However, the invention is not so limited and in one embodiment, the central portion 301 of the SP module does not comprise the rules engine, but rather just transmits at least the electronic prescription data to the third party content providers 400, which in turn determines the eligibility of each of the available supplemental programs.

In the exemplified embodiments, the central portion 301 does most of the heavy processing of the SP module, while the SP widget 302 routes data to the central portion 301 and provides an interface for the provider 101 to access the SP module. Although exemplified as comprising a SP module widget 302 that resides within the memory 113 of the HCP system 100 (and more specifically, a SP module widget 302 that is integrated into the EP module) and a central portion 301 that resides within the memory 313 of the SP system 300, the SP module is not so limited. In alternate embodiments of the present invention, the central portion 301 and/or the SP widget 302 may reside elsewhere on the system 1000, or the central portion 301 may be combined with the SP module widget 302 and the combined SP module may reside on any system or module of the system 1000. Further, as described herein, it should be understood that any of the processes or functions performed by either the central portion 301 or the SP widget 302 may be performed partially or wholly by the other portion of the SP module in an alternate embodiment of the present invention.

The supplemental program database 303 stores general supplemental program data, including, but not limited to the names of a plurality of available supplemental programs, general information relating to each of the plurality of available supplemental programs, and the rules of each of the available supplemental program. As discussed in more detail below, according to one embodiment of the present invention, a supplemental program is a document or service that is activated for a patient based on the defined rules of the supplemental program. Further, according to one embodiment of the present invention, each supplemental program is designed to increase the patient's adherence to a prescribed substance.

As also discussed in more detail below, the rules of each supplemental program dictate which patients are eligible for the supplemental program. Generally, each rule may be based on, among other things, a substance currently being prescribed to the patient, the patient's medical history, information relating to the provider, and/or information relating to the patient's payor or health insurance company. According to one embodiment of the present invention, the rules of the supplemental programs are defined by a combination of an administrator of the SP system 300 and one or more pharmaceutical companies. However, the invention is not so limited, and in alternate embodiments the rules may be defined by any combination of the administrator of the SP system 300, the pharmaceutical companies, and/or the third party program vendors 400.

It should be noted that although exemplified as residing entirely in the memory 313 of the SP system 300, in alternate embodiments, the supplemental program database 303 may reside entirely on another system of the system 1000 or be broken up and reside partially on two or more of the systems of the system 1000. Specifically, in one alternate embodiment the supplemental program database 303 resides entirely on the HCP system 100, while in another alternate embodiment the supplemental program database 303 resides entirely on the EP system 200.

Further, as also discussed in more detail below, in one embodiment of the present invention the supplemental program database 303 may comprise the underlying supplemental programs themselves. In such embodiments, the SP module does not have to reach out to the third party content providers 400 to retrieve content relating to a supplemental program or to enroll a patient in a supplemental program.

The record database 304 stores information relating to the parties and the processes involved in supplementing an electronic prescription, such as, but not limited to, patient data, prescribed substance data, provider data, payor data, and patient medication history data. Further, the record database 304 may further store provider preference data and patient preference data. It should be noted that although exemplified as residing entirely on the SP system 300, in alternate embodiments, the record database 304 may reside entirely on another system of the system 1000 or be broken up and reside partially on two or more of the systems of the system 1000. Specifically, in one alternate embodiment the record database 304 resides entirely on the HCP system 100, while in another alternate embodiment the record database 304 resides entirely on the EP system 200.

Finally, according to one embodiment of the present invention, the SP system 300 further comprises an administrator. The administrator is an individual (or group of individuals) who has access to the databases, modules, and engines of the SP system 300, and may configured to databases, modules, and engines as they see fit. For example, in some embodiments of the present invention, the administrator may configure the settings of the SP module (both central portion 301 and SP widget 302), may configure the data stored in the one or more databases of the SP system 300, may configure the rules of the available supplemental programs, and/or may configure the rules engine of the SP module. Therefore, the administrator of the SP system 300 has the ability to access and control the processes and functions of all of the components of the SP system 300.

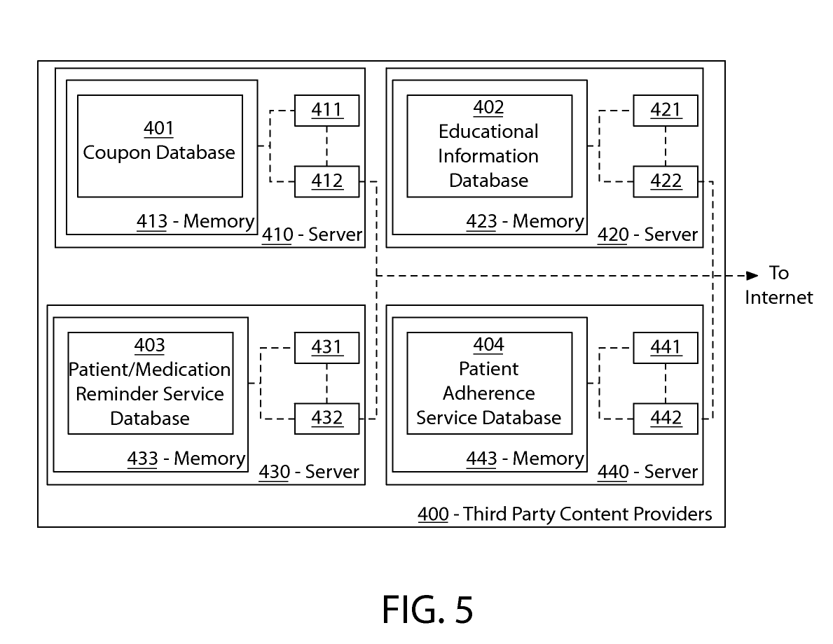

Referring to FIG. 5, a schematic diagram of a plurality of third party content providers 400 according to one embodiment of the present invention is illustrated. Generally, the present invention is not limited to any specific number of third party content providers 400. Therefore, although four third party content providers (410, 420, 430, 440) are illustrated in FIG. 5, the present invention may comprise more or less than four third party content providers 400. For example, in an alternate embodiment of the present invention, one or more of the third party content providers 400 may be combined.

Each third party content provider 400 comprises a server 410, 420, 430, 440 which comprises a properly programmed processor (CPU) 411, 421, 431, 441, a network interface 412, 422, 432, 442, and a non-transitory computer readable medium such as memory unit 413, 423, 433, 443 in operable communication. In one embodiment, memory 413, 423, 433, 443 are non-volatile. Although each third party content provider 400 is exemplified as comprising a single server 410 (or 420, 430, 440), the invention is not so limited and in alternate embodiments any of the third party content provider 400 may comprise any number of servers. Additionally, although not exemplified, it should be understood that the processors 411, 421, 431, 441 can have integrated memory. Finally, the network interfaces 412, 422, 432, 442 connects their respective server 410, 420, 430, 440 to the over systems and modules of the system 1000 via the internet.

As discussed in more detail below, the processors 411, 421, 431, 441 of each third party content providers 400 effectuates the performance of the processes and functions described herein, including but not limited to the storage of data to the databases 401, 402, 403, and 404, the transfer of content to a patient, the enrollment of a patient into a service, and the transfer of data between each third party content providers 400 and the other systems (specifically the SP system 300) of the system 1000.

The memory unit 413 comprises a coupon database 401, the memory unit 423 comprises an educational information database 402, the memory unit 433 comprises a patient/medication reminder service database 403, and the memory unit 443 comprises a patient adherence service database 404. Although exemplified as a single memory unit, it should be noted that any of the memory units 413, 423, 433, 443 may comprise any number of databases used to store data, modules, or other information.

The coupon database 401 stores supplemental program coupon data relating to a plurality of different coupon documents and coupon services for a plurality of substances that may be prescribed to a patient. The supplemental program coupon data may include the amount of a coupon, the rules relating to the eligibility of a coupon or a coupon service, the delivery modes of the coupon or coupon service, and other information relating to a particular coupon or coupon service. Further, it should be noted that a coupon may be, but is not limited to, a discount for prescribed substances, a rebate for prescribed substances, or a voucher for a free trial of prescribed substances.

The educational information database 402 stores supplemental program educational data relating to a plurality of different educational documents for a plurality of different substances and diseases states for which a patient may be prescribed or diagnosed. The supplemental program educational data may include general educational documents relating to a plurality of different substances or disease states, specific educational documents relating to a plurality of different substances or disease states, general educational services that relate to a plurality of different substances or disease states, specific educational services that relate to a plurality of different substances or disease states, and the rules relating to the eligibility of the documents and services listed above.

The patient/medication reminder service database 403 stores supplemental program reminder data relating to a plurality of different patient reminder services and substance (or medication) reminder services. The supplemental program reminder data may include information relating to appointment reminder services for a patient, prescription filling reminder services for a patient, refill reminder services for a patient, and the rules relating to the eligibility of the services listed above.

The patient adherence service database 404 stores supplemental program adherence data relating to a plurality of adherence services for patients. The supplemental program adherence data may include information relating to a variety of different adherence programs and services for patients, including the rules relating to the eligibility of the services.

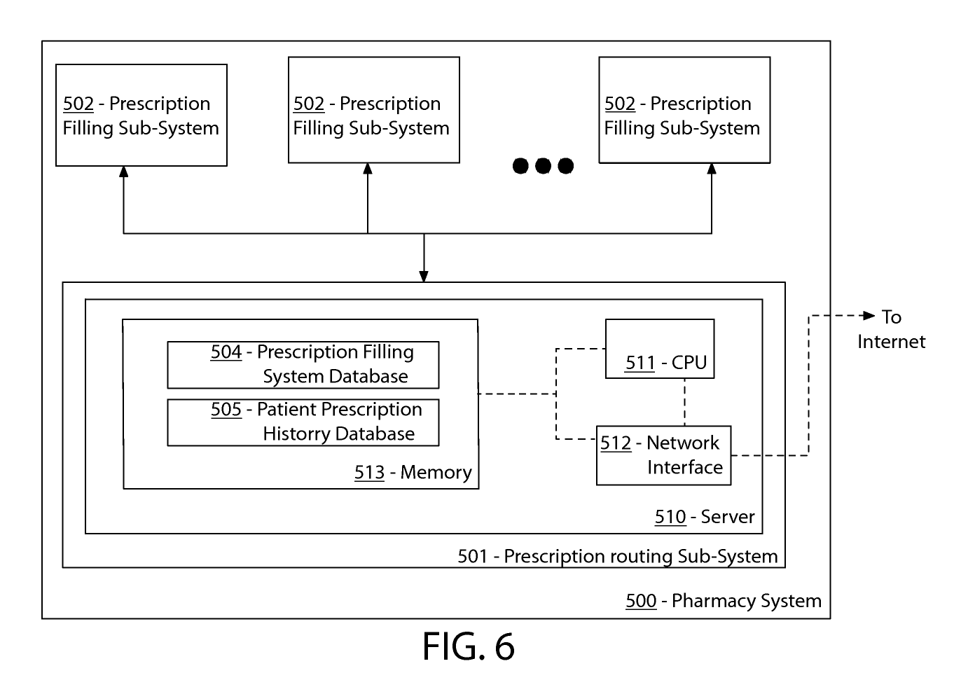

Referring to FIG. 6, a schematic diagram of a pharmacy system 500 according to one embodiment of the present invention is illustrated. In the exemplified embodiment, the pharmacy system 500 comprises a prescription routing sub-system 501 and at least one prescription filling sub-system 502, all in operable communication with one another. Generally, the prescription routing sub-system 501 is configured to electronically receive a prescription for a substance from the HCP system 100 or the EP system 200 and route the prescription to a prescription filling sub-system 502.

The prescription routing sub-system 501 comprises a server 510 that comprises a properly programmed processor 511, a network interface 512, and a non-transitory computer readable medium such as memory device or unit 513 in operable communication. In one embodiment, memory 513 is non-volatile. Although not exemplified, each of the prescription filling sub-systems 502 comprises a properly programmed processor, a network interface, and a memory unit. Although exemplified as a single server 510, the invention is not so limited and in alternate embodiments the prescription routing sub-system 501 may comprise any number of servers 510. Additionally, although not exemplified, it should be understood that the processor 511 can have integrated memory. The network interface 512 connects the server 510 to the over systems and modules of the system 1000 via the internet. The processor 511 of the pharmacy system 500 effectuates the processes and functions described herein, including but not limited to, the reception of prescription data from the EP module, the transfer of prescription history information to the SP module, and the transfer of data between the pharmacy system 500 and the other systems and modules of the system 1000.

In the exemplified embodiment, the memory 513 of the prescription routing sub-system 501 comprises a prescription filling system database 504 and a patient prescription history database 505. The prescription filling system database 504 stores the names, addresses and other information relating to each of the prescription filling sub-system(s) 502. The patient prescription history database 505 stores information relating to previous prescriptions routed by the pharmacy system 500 for patients.

The prescription filling sub-system 502 is a system that fills the prescribed substance for an end user. For example, prescription filling sub-system 502 may be a local pharmacy used by a patient.

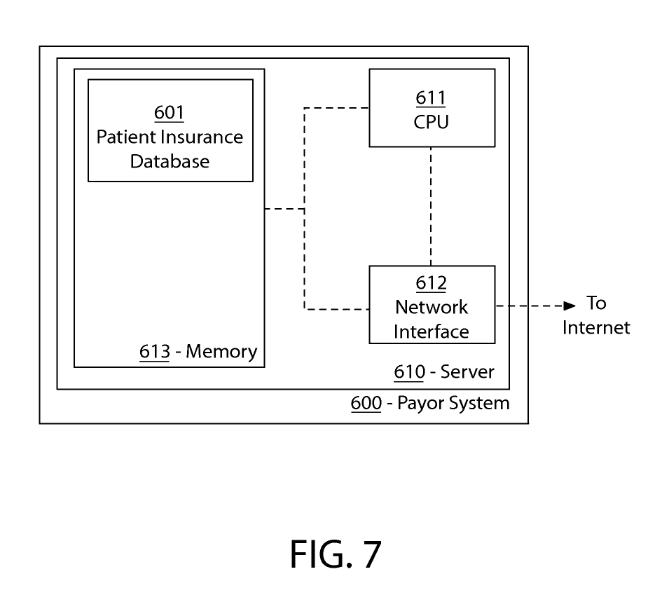

Referring to FIG. 7, a schematic diagram of a payor system 600 according to one embodiment of the present invention is illustrated. Generally, the payor system 600 comprises a server 610 which comprises a properly programmed processor (CPU) 611, a network interface 612, and a non-transitory computer readable medium such as memory unit 613 in operable communication. In one embodiment, memory 613 is non-volatile. It should be noted that the processor 611 may be considered the processor of the payor system 600. Further, although exemplified as a single server 610, the invention is not so limited and in alternate embodiments the payor system 600 may comprise any number of servers 610. Additionally, although not exemplified, it should be understood that the processor 611 can have integrated memory. The network interface 612 connects the server 610 to the over systems and modules of the system 1000 via the internet.

As discussed in more detail below, the processor 611 of the payor system 600 effectuates the performance of the processes and functions described herein, including but not limited to the storage of data to the database 601 of the memory 613 and the transfer of data (e.g., patient insurance information) between the payor system 600 and the other systems and modules of the system 1000.

The memory 613 of the payor system 600 comprises a patient insurance database 601. The patient insurance database 601 stores information relating to the payor of prescriptions for substances of patients, such as, but not limited to, the patient's insurance company, the patient's co-pay amount, and the patient's other deductibles. Further, although exemplified as a single memory unit, it should be noted that the memory 613 may comprise any number of databases used to store data, modules, or other information.

Therefore, it may be said that the system 1000 comprises a plurality of databases or one or more databases. Specifically, as noted above, the system 1000 comprises the EP database 201 on the EP system 200, the supplemental program database 303 and the records database 304 on the SP system 300, the coupon database 401, the educational information database 402, the patient medication/reminder service database 403, and the patient adherence service database 404 of the third party content providers 400, the prescription filling sub-system database 504 and the patient prescription history database 505 of the pharmacy system 500, and the patient insurance database 601 of the payor system 600.

Supplemental Programs

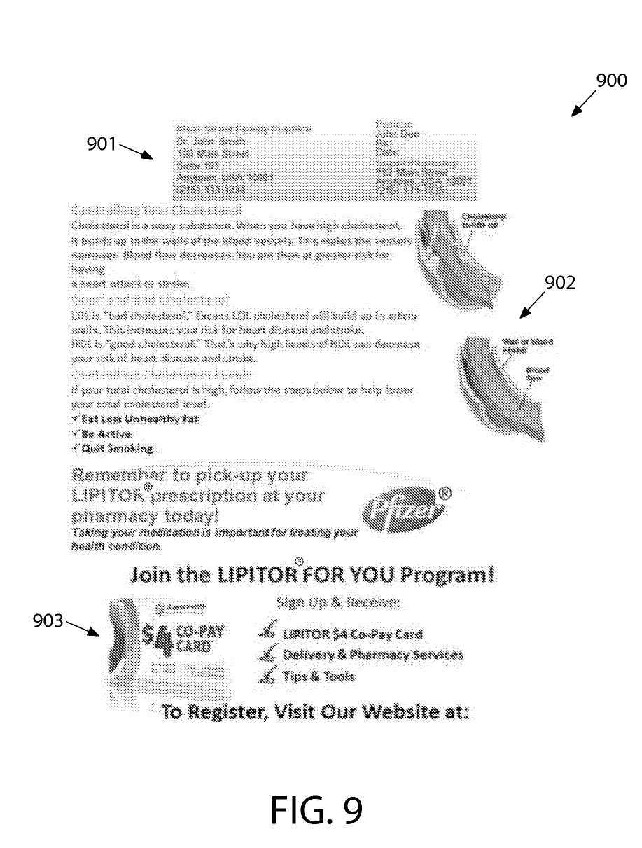

A supplemental program, as used herein, may be any document that is provided to a patient or any service in which a patient is enrolled that is designed for increasing patient adherence to a prescribed substance. Stated another way, a supplemental program may be a document or service designed to help patients understand their medication regimen and comply with it. For example, a supplemental program may be a coupon (or a coupon service) that is provided to a patient for a particular prescribed substance, educational material (either general or specific) that is provided to a patient for a particular prescribed substance or disease state, a combined coupon/educational document (referred to herein as an “EduSAVE™” document, one example of which is exemplified in FIG. 9), a loyalty card, a prescription reminder service, an appointment reminder service, a health care coaching service, or any other patient adherence service or document. In one embodiment, the available supplemental programs are all patient adherence programs. However, the invention is not so limited and in alternate embodiments, some or all of the available supplemental programs may not relate to patient adherence.

As discussed in more detail below, eligibility of a supplemental program is determined by comparing one or more of a plurality of different data elements (such as, but not limited to, a patient's general information, a patient's medical history, a brand name or formula of a substance prescribed to a patient, other information relating to a substance prescribed to a patient, a patient's payor's information (e.g., a patient's health insurance company and/or health insurance plan), a provider's general or specific information) with the rules of each of the available supplemental programs. If the data element(s) meets the rules for a specific supplemental program, then the patient is determined to be “eligible” for that program. For example, a specific program may only be eligible to patients who are being prescribed a particular substance, patients who reside within a particular geographic region, patients who have a specific history with a particular substance, patients who have at least specific co-pay for a particular substance, or patients whose providers meet certain qualifications.

As discussed in detail below, the determination of eligibility is determined by the SP module, and more specifically, by the rules engine of the SP module. Generally, the SP module receives and/or retrieves a plurality of data relating to the patient, the prescribed substance, the provider, and/or the payor, and applies that data to the rules of each of the available supplemental programs to determine supplemental programs in which the patient is eligible.

Method for Supplementing Patient and Provider Interactions

Generally and in accordance with one embodiment of the present invention, a method for supplementing patient and provider interactions to increase patient adherence generally comprises three steps: (1) determining, from a plurality of available supplemental programs, supplemental programs for which a particular patient receiving a prescription for a particular substance is eligible; (2) receiving confirmation/approval from the patient's health care provider that the eligible supplemental program should be activated; and (3) activating the eligible supplemental programs that the provider has confirmed/approved in order to increase patient adherence to the prescribed substance.

1. Determining Eligible Supplemental Programs for a Patient

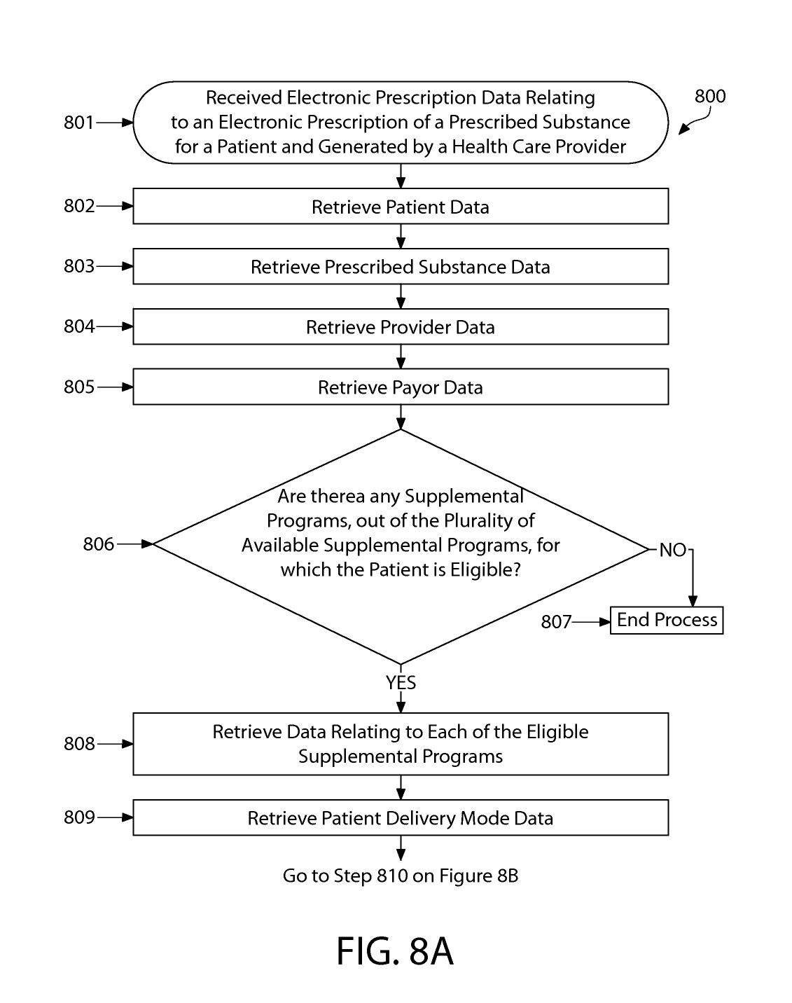

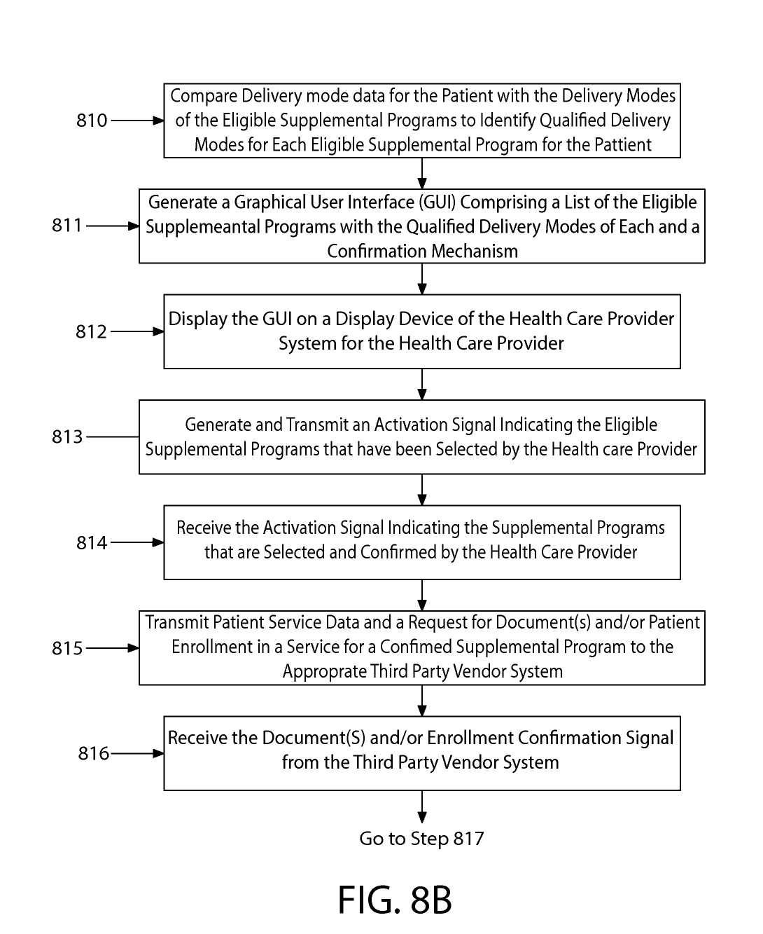

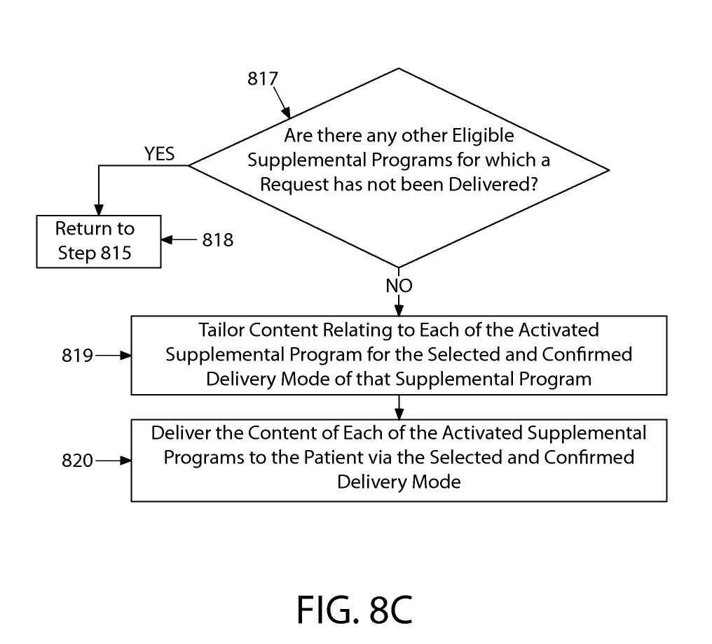

Referring to FIGS. 8a-8c, a flow chart of a system for supplementing patient and provider interactions to increase patient adherence according to one embodiment of the present invention is illustrated.

According to one embodiment of the present invention, the process begins when a patient visits their health care provider 101 seeking health care advice, and the provider 101, after diagnosing the patient, decides to write an electronic prescription for a particular substance for the patient. The electronic prescription is typically generated by the provider 201 using the EP module. Specifically, in one embodiment of the present invention, the provider 101 drafts an electronic prescription using the thin-client portion of the EP module 203, which resides on the HCP system 100.

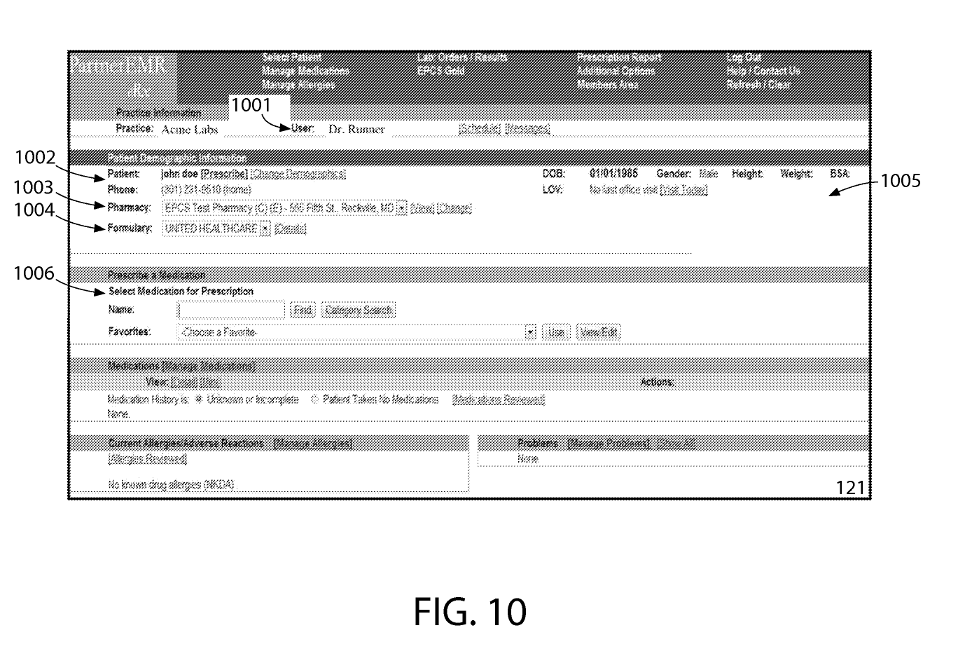

Referring to FIG. 10, a screen shot of a graphical user interface (GUI) generated by the EP module (and specifically the thin-client portion 203 of the EP module) to allow the provider 101 to generate an electronic prescription for a patient according to one embodiment of the present invention is illustrated. As shown in FIG. 10, the GUI comprises information relating to the provider (at least their name) 1001, information relating to the patient 1002, information relating to the pharmacy 1003 where the electronic prescription will be transmitted, information relating to the formulary of the patient 1004, information relating to the patient's medical history 1005, and information relating to a substance 1006 to be prescribed to the patient. Moreover, the GUI is not so limited and may further comprise information relating to the other medications previously prescribed to the patient, current allergies or adverse reactions of the patient, or other previously recorded problems of the patient.

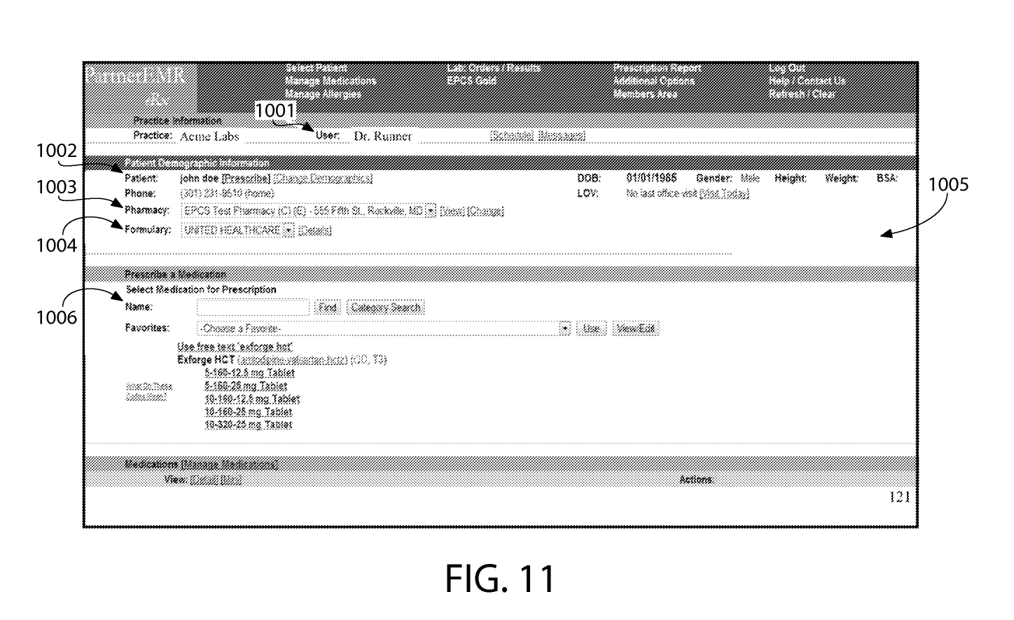

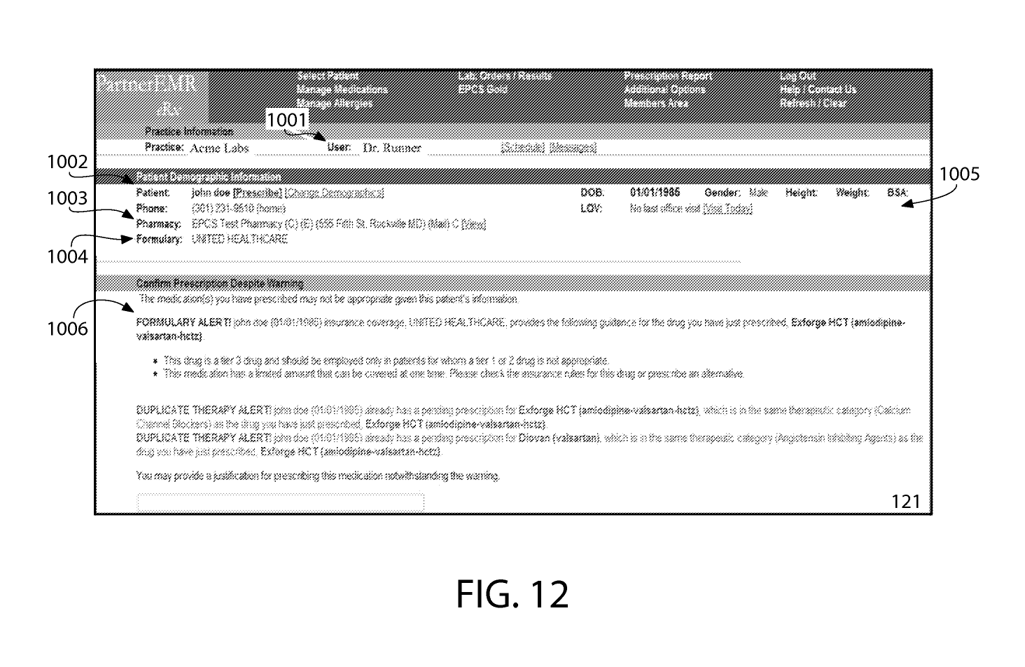

Referring to FIGS. 11-14, multiple, sequential graphical user interfaces (GUIs) 1011, 1012, 1013, 1014 generated by the EP module to allow the provider 101 to generate an electronic prescription for a patient according to one embodiment of the present invention are illustrated. In the GUI 1011 exemplified in FIG. 11, the provider 101 may select a medication for prescription. As shown, the provider 101 may search for a new substance to prescribe by name or may choose a substance from a pre-established list of favorites. As shown in the GUI 1012 of FIG. 12, after a provider 101 chooses a substance to prescribe to the patient, the EP module generates and displays the GUI 1012, which comprises drug interaction warnings, formulary alerts based on the patient's formulary status, and other medication alerts and warnings.

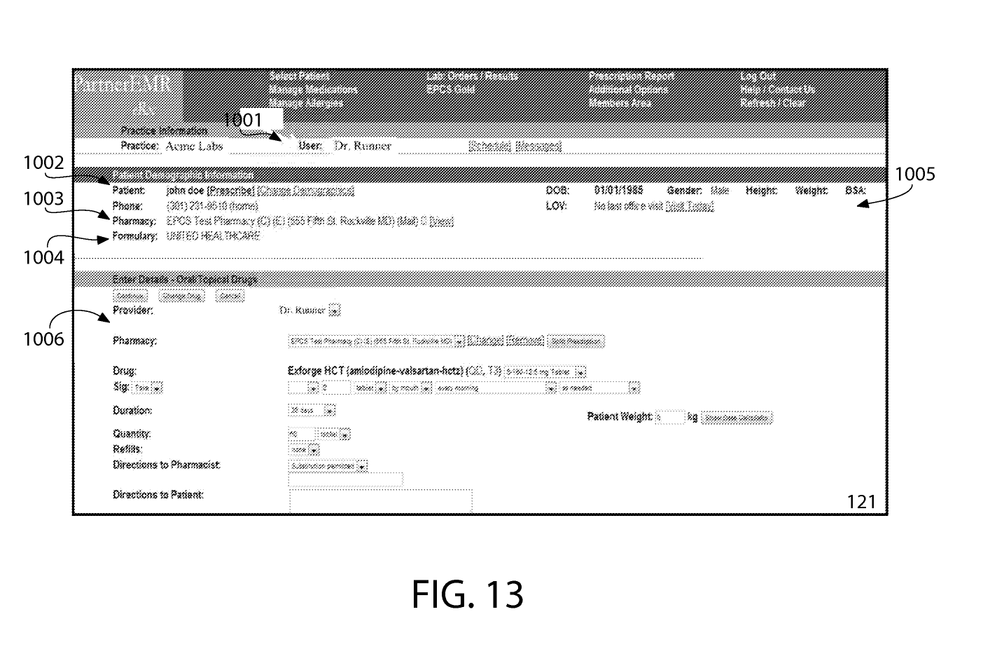

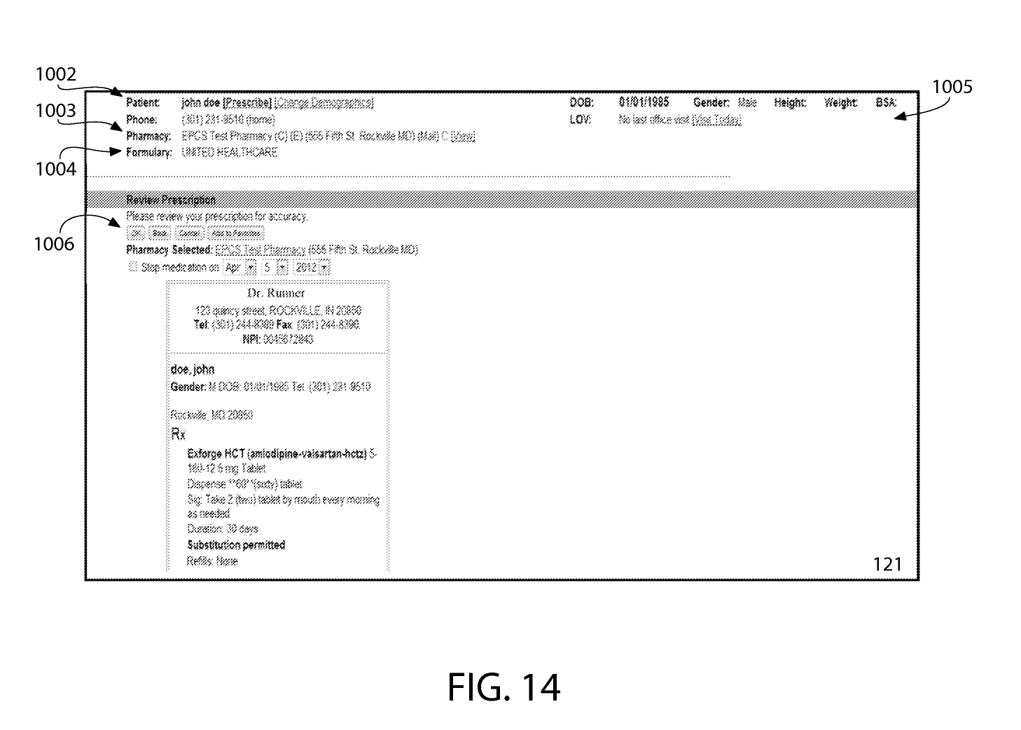

After the provider 101 confirms the substance in the GUI 1012, the EP module generates and displays GUI 1013 (shown in FIG. 13), which allows the provider to enter the details of the substance to be prescribed 1006. For example, substance details such as the names, dosage, strength, form, duration, quantity, and refills are displayed for provider 101 input, along with directions to the patient and/or pharmacist and other details relating to the filling pharmacy and provider 101. After the provider 101, has entered all the required information using the input device 122 of their terminal 120 of the HCP system 100, the EP module generates a displays GUI 1014. As exemplified in FIG. 14, the GUI 1014 provides a summary of the electronic prescription for the substance for the provider's review. After the provider 101 reviews and confirms that the prescription is accurate, the electronic prescription for the substance is created.

Still also referring to FIGS. 8a-8c, in the exemplified embodiment, after an electronic prescription for the substance is created by the provider 101, the SP widget 302 retrieves data relating to the electronic prescription from the thin-client portion of the EP module 203. The SP widget 302 then transmits the electronic prescription data to the central portion 301 of the SP module residing on the SP system 300, such that the central portion 301 of the SP module receives the electronic prescription data, thereby completing step 801 in FIG. 8a. The electronic prescription data comprises first patient data that is specific to the patient, first prescribed substance data that is specific to the prescribed substance, first provider data that is specific to the provider 101, and first payor data that is specific to the payor.

The first patient data comprises the information that is part of the prescription and relates to the patient, such as but not limited to, the patient's name, gender, date of birth (DOB), contact information (telephone and address), and the patient's formulary status.

The first prescribed substance data comprises information that is part of the prescription and relates to the prescribed substance, such as but not limited to, the name of the prescribed substance, the dosage, strength, form, duration, and quantity of the prescribed substance, and the number of refills listed on the prescription.

The first provider data comprises information that is part of the prescription and relates to the provider 101, such as but not limited to, the provider's name, the address and phone number of the provider's practice, and national provider identifier (NPI) number.

The first payor data comprises information that is part of the prescription and relates to the payor of the patient, such as but not limited to, the payor's name and the formulary status (or health care plan) of the patient.

However, the invention is not so limited, and in an alternate embodiment of the present invention, the electronic prescription data may not relate to an electronic prescription currently being prescribed by the provider 101 for the patient, but rather relate to a refill, a renewal, or a previously prescribed substance. In such embodiments, the electronic prescription data may be received by the SP module from one of the other databases of the system 1000 (e.g., the EP database 201, the records database 304, the patient prescription history database 505, etc.).

Once the central portion 301 of the SP module receives the electronic prescription data, the central portion 301 of the SP module retrieves additional data prior to determining supplemental programs for which the patient is eligible. However, it should be noted that the invention is not so limited and in alternate embodiments, the central portion 301 of the SP module may only retrieve a portion of the data listed herein or may not retrieve any additional data prior to determining supplemental programs for which the patient is eligible.

In the exemplified embodiment, the central portion 301 of the SP module retrieves patient data that is specific to the patient from the record database 304, thereby completing step 802. The retrieved patient data may be referred to as “additional” or “second” patient data, or simply patient data. The patient data comprises one or more of the patient's current medication, the patient's recent drug fills, the patient's drug fill history, the patient's demographics, the patient's health care plan or payor information, the patient's adherence information, and the patient's clinical trial cohort (if the patient is part of a clinical trial cohort). The patient adherence information may relate to the patient's past adherence to prescriptions for the same prescribed substance, for prescriptions to prescribed substances for the same disease state, and/or the patient's general adherence to any combination of the substances they have previously been prescribed to the patient. It should be noted that this information is in addition to the first patient data that was retrieved by the centralized portion of the SP module 301 from the created electronic prescription.

Further, the central portion 301 of the SP module may also retrieve prescribed substance data relating to the substance prescribed by the electronic prescription from the record database 304, thereby completing step 803. The retrieved prescribed substance data may be referred to as “additional” or “second” prescribed substance data, or simply prescribed substance data. The prescribed substance data comprises one or more of the prescribed substance's drug properties, the prescribed substance's therapeutic class(es), a prescribed substance substitution code, the prescribed substance's formulary data, and a prescription indicator. It should be noted that this information is in addition to the first prescribed substance data that was retrieved by the central portion 301 of the SP module from the created electronic prescription.

The central portion 301 of the SP module may also retrieve provider data relating to the health care provider 101 from the record database 304, thereby completing step 804. The retrieved provider data may be referred to as “additional” or “second” provider data, or simply provider data. The provider data comprises one or more of the provider's geographic location, the provider's state of residency, and the specialty of the provider 101. It should be noted that this information is in addition to the first provider data that was retrieved by the central portion 301 of the SP module from the created electronic prescription.

The central portion 301 of the SP module may also retrieve payor data relating to the payor (e.g. a health care insurance company) of the patient from the record database 304, thereby completing step 805. The retrieved payor data may be referred to as “additional” or “second” payor data, or simply payor data. Further, according to one embodiment, if the record database 304 does not have any of the patient's payor information stored therein (or even if it does), then the central portion 301 of the SP module may transmit a request to the payor system 600 and receive back the patient's payor information from the patient insurance database 601. The payor data comprises one or more of the formulary status (or health care plan) of the patient, the co-pay of the patient, and any other information relating to the payor of the patient. It should be noted that this information is in addition to the first payor data that was retrieved by the central portion 301 of the SP module from the created electronic prescription.

According to one embodiment of the present invention, the central portion 301 of the SP module first attempts to retrieve the relevant data from the records database 304. Thereafter, if the records database 304 does not comprise the relevant data required by the central portion 301 to determine the eligible supplemental programs, then the central portion 301 reaches out to at least one other database on the system 1000, such as, but not limited to the EP database 201 and the patient insurance database 601. In one embodiment, upon retrieving the relevant data from one of the other databases of the system 1000, the central portion 301 stores the relevant data in the records database 304 for future processing.

After the central portion 301 of the SP module retrieves the additional data required, the central portion 301, using the rules engine, determines, from a plurality of available supplemental programs, supplemental programs for which the patient is eligible based on the electronic prescription for the substance. As discussed above, a plurality of available supplemental programs are stored within one or more databases, which includes but is not limited to the supplemental program database 303 and the databases 401, 402, 403, 404 of the third party content providers 400. As noted above, according to one embodiment of the present invention each available supplemental program is a document that is provided to a patient or a service in which a patient is enrolled. Moreover, according to one embodiment, each available supplemental program is designed to increase patient adherence to the prescribed substance.

As also noted above, each supplemental program out of the plurality of available supplemental programs comprises one or more rules. Generally, the rules of a supplemental program must be met in order for the patient to be “eligible” for the supplemental program. The rules may relate to information relating to the patient, the prescribed substance, the provider, and/or the payor of the patient. Therefore, the rules of each of the available supplemental programs may act as constraints and/or restrictions dictating the eligibility of a patient for a particular available supplemental program.

Examples of rules include, but are not limited to, restricting a supplemental program to a specific prescribed substance or disease state, restricting a supplemental program to a specific prescribed substance of a specific dosage strength, restricting a supplemental program to patients or providers of a specific geographic region, restricting a supplemental program to patients who have a certain adherence history (whether with the prescribed substance or in general), restricting a supplemental program to patients who have a specific persistency rate for the prescribed substance (e.g., a persistency rate under 60%, a persistency rate between 30%-60%, or a persistency rate between 10%-85%), restricting a supplemental program to patients of a certain age or age range, restricting a supplemental program to patients who have been prescribed the substance for at least a predetermined time period, restricting a supplemental program to patient's who have a certain co-pay for a specific prescribed substance, restricting a supplemental program to patient's having a certain health insurance carrier, etc.

Therefore, for example, a specific supplemental program is only eligible to patients who meet the rules described above. Restricting the dissemination of supplemental programs on the basis of the rules listed above may be beneficial since supplemental programs will only go to those patients with which they will have the greatest effect. Therefore, for example, a pharmaceutical company is not blindly handing out coupons to patients whose habits may not be affected by the receipt of a coupon. Rather, the coupons are distributed on the basis of predetermined rules to increase the likelihood that the coupons will result in increased adherence by the patient, and in turn, sales of the prescribed substance and reduced costs to the other parties involved. Further, since the determination of eligibility is performed by the rules engine of the SP module, the health care provider 101, may, but is not required to calculate or analyze whether a patient would be incentivized by a supplemental program. This helps to alleviate some of the burden typically placed on health care providers 101 with regards to disseminating documentation to their patients.

Further, according to another embodiment of the present invention, rules may further include a patient's specific usage stage for a substance. Therefore, in one embodiment, a patient may only be eligible for supplemental program that provides a specific coupon if they are at a specific usage stage for a particular substance. For example, a patient may only be eligible for a coupon if they are after their second refill for a particular substance, or if they are between their third and fourth refill of a particular substance. In such embodiments, providing coupons to a patient based on their specific usage stage for a substance may encourage continued patient adherence for that substance.

The rules engine of the central portion 301 of the SP module determines the eligibility of each of the plurality of available supplemental programs for the patient by comparing the data received/retrieved by the SP module with the rules of each available supplemental program. As noted above, the data used in the comparison includes, but is not limited to, the first patient data received from the electronic prescription, the first prescribed substance data from the electronic prescription, the first provider data from the electronic prescription, the first payor data from the electronic prescription, the patient data retrieved by the central portion 301 of the SP module, the prescribed substance data retrieved by the central portion 301 of the SP module, the provider data retrieved by the central portion 301 of the SP module, and the payor data retrieved by the central portion 301 of the SP module. Therefore, the eligibility of each of the available supplemental programs is determined by the rules engine of the central portion 301 of the SP module using any combination of the data (or data elements) listed above.

Still referring to FIG. 8a, in decision step 806, the central portion 301 of the SP module, using the rules engine, determines the eligibility of the plurality of available supplemental programs by comparing the data received and retrieved (e.g., the patient data, the prescribed substance data, the provider data, and the payor data discussed above) with the rules of each of the available supplemental programs. If the received/retrieved data does not meet the rules of any of the plurality of available supplemental programs, then the process ends at step 807. However, if the received/retrieved data meets the rules of at least one available supplemental program, then the process continues to step 808. It should be noted that those supplemental programs whose rules are determined by the rules engine to meet the received and retrieved data are considered eligible supplemental programs.

Further, it should be noted that although exemplified as a single determination step, the invention is not so limited. In one embodiment of the present invention, the determination of eligible supplemental programs by the rules engine of the SP module is a multi-step comparison process. For example, in one embodiment of the present invention, during a first comparison step the central portion 301 of the SP module compares the prescribed substance data (including either the first prescribed substance data retrieved from the electronic prescription and/or the prescribed substance data retrieved from the record database 304) with the rules of each of the available supplemental programs. More specifically, the rules engine of the SP module may compare the brand name or formula of the prescribed substance with each of the plurality of available supplemental programs. If the brand name or formula of the prescribed substance matches the brand name or formula of a rule an available supplemental program, then that supplemental program passes the first comparison step of the rules engine.

If the prescribed substance data does meet the rules of at least one available supplemental program, then the central portion 301 of the SP module performs a second comparison step, whereby the SP module compares the patient data (including either the first patient data retrieved from the electronic prescription and/or the patient data retrieved from the record database 304) with the rules of each of the supplemental programs that passed the first comparison step. Thereafter, the SP module may perform subsequent comparison steps using the provider data and/or the payor data. In such embodiments, a patient is “eligible” for a supplemental program, if and only if, the supplemental program passes each step of the multi-step comparison process.

It should be noted that in such multi-step comparison embodiments, the invention is not limited to any specific number of comparison steps, the order of the comparison steps, or the types of comparison steps (e.g., steps using prescribed substance data, using patient data, using provider data, or using payor data).

Further, it should be noted that in an alternate embodiment of the present invention, the central portion 301 of the SP module transmits the data received and retrieved from the one or more databases (e.g., the patient, prescribed substance, provider, and payor data discussed above) to a third party system (e.g., one of the third party content providers 400). Thereafter, the third party system compares the data against the rules of each of the available supplemental programs to determine eligibility. After testing the data against the rules, the third party system transmits a signal back to the central portion 301 of the SP module indicating which of the available supplemental programs are eligible. Therefore, in such embodiments, the SP module determines the eligibility of the available supplemental programs by transmitting the appropriate data to a third party system and receiving back a signal indicating for which of the available supplemental programs the patient is eligible.

Although not exemplified, in one embodiment of the present invention, prior to performing step 806, the central portion 301 of the SP module retrieves provider preference data (and/or patient preference data) from the records database 304 and/or the supplemental program database 303. Provider preference data is information that relates to the preferences of the specific provider 101 who drafted the prescribed substance. Similarly, patient preference data is information that relates to the preferences of the patient which whom the substance is being prescribed. The preference data includes, but is not limited to, specific modes of delivery (e.g., print, email, SMS, etc.) and supplemental program types (e.g., educational material, coupons, reminder services, etc.) that the provider 101 and/or patient prefers.

If the SP module locates and retrieves preferences for the provider 101 and/or patient, then the following steps are limited to those supplemental programs and delivery modes that are preferred by the provider and/or patient. For example, if the provider 101 sets their preferences to select only a specific type of supplemental program (e.g., educational material), then the SP module will only determine eligible supplemental programs that are of that specific type of supplemental program. For purposes of this discussion, we will assume that the SP module does not retrieve any provider or patient preference data.

According to one embodiment of the present invention, the SP module receives provider 101 and/or patient preference data directly from the provider 101 via the input device 122 of the HCP system 100. However, it should be noted that in other embodiments of the present invention, the SP module may learn the preferences of a provider 101 and/or a patient based on one or more previous instances where the provider 101 and/or patient used the SP module. Upon receiving or learning provider 101 and/or patient preference data, the central portion 301 of the SP module stores the preference data in the record database 304.

After the SP module determines which of the available supplemental programs the patient is eligible, the central portion 301 of the SP module retrieves supplemental program data relating to each of the eligible supplemental programs from the supplemental program database 303, thereby completing step 808. It should be noted that, according to one embodiment of the present invention, the supplemental program data is not the actual supplemental program itself, but rather information relating to each of the supplemental programs.

In the exemplified embodiment, the supplemental program data comprises information about the eligible supplemental program, such as, but not limited to, the name of the eligible supplemental program, the specific type of document or service the eligible supplemental program comprises, and delivery mode data relating to the available delivery modes of each of the eligible supplemental programs. Further, it should be noted that if the received/retrieved data meets the rules of more than one available supplemental program, then the central portion 301 of the SP module retrieves supplemental program data relating to each of the plurality of eligible supplemental programs from the supplemental program database 303.

However, the invention is not so limited, and in another embodiment of the present invention, the central portion 301 of the SP module retrieves the supplemental program data from the one or more databases 401, 402, 403, 404 of the appropriate third party content provider 400. Further, in another alternate embodiment, the central portion 301 of the SP module may actual receive the supplemental programs itself at step 808.

After retrieving the supplemental program data in step 808, the central portion 310 of the SP module retrieves patient delivery mode data relating to the delivery modes that are available for the patient from the record database 304 of the SP system 300), thereby completing step 809. The patient delivery mode data comprises information relating to the patient, such as but not limited to, an email address of the patient, a phone number of the patient, and a mailing address of the patient. It should be noted that the central portion 301 of the SP module can retrieve information about the patient that is currently stored in the record database 304, along with patient data that is stored in the other, one or more databases of the system 1000.

After retrieving patient delivery mode data, the central portion 301 of the SP module compares the patient delivery mode data with the delivery mode data for each of the eligible supplemental programs, thereby completing step 810. As noted above, the delivery mode data for the eligible supplemental programs is retrieved by the central portion 301 in step 808. The comparison is done in order to determine qualified delivery modes for each of the eligible supplemental programs. A qualified delivery mode is a delivery mode that is available for a supplemental program and a delivery mode in which the patient delivery mode data (e.g., the patient's email address, phone number, etc.) relating to that delivery mode is stored in the SP system 300 and has been retrieved by the SP module.

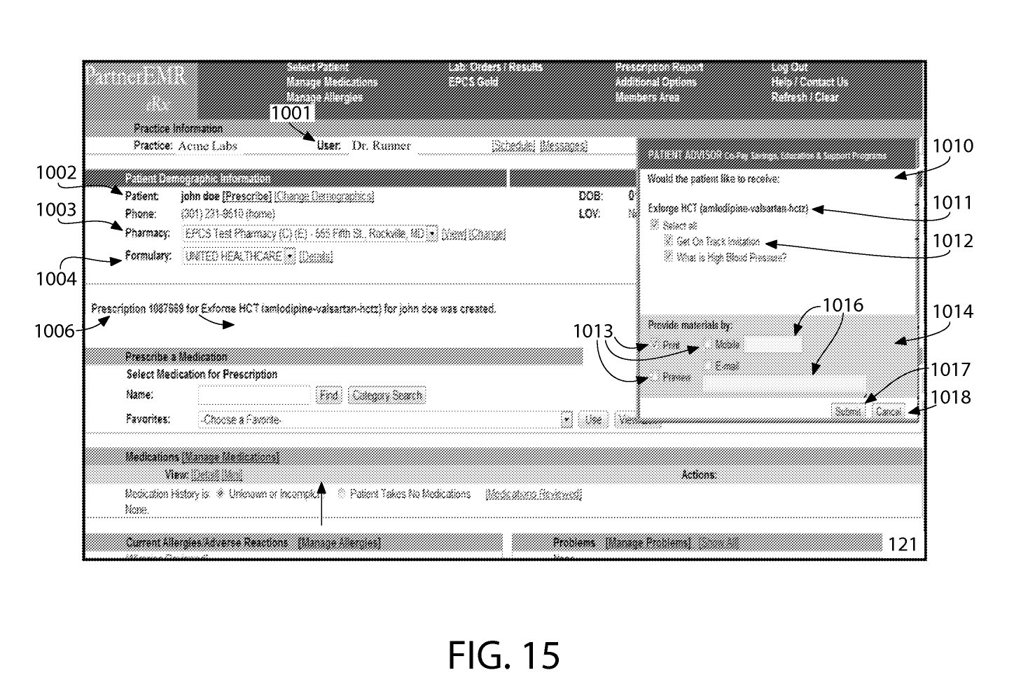

As discussed in more detail below and according to one embodiment of the present invention, eligible supplemental programs that do have qualified delivery modes may be preselected by the SP module for those specific delivery modes. Further, in another embodiment of the present invention, eligible supplemental programs that do not have at least one qualified delivery modes associated therewith may be locked so as to be incapable of selection by the provider 101. In such embodiments, if the provider 101 may be required to enter patient delivery mode information into the GUI of FIG. 15 described below in order to unlock the selection mechanism for that particular supplemental program. Further, it should be noted that the invention is not so limited, and in other alternate embodiments the qualified delivery modes may just be preselected by the SP module, while the non-qualified delivery modes are grayed-out or only selectable upon the provider 101 entering the appropriate patient delivery mode information.

Further, in yet another embodiment of the present invention, the SP module does not retrieve patient delivery mode data and, therefore a comparison between patient delivery mode data and delivery mode data for each of the eligible supplemental programs is not performed by the SP module. In such instances, all of the available delivery modes for each of the eligible supplemental programs may be displayed in the GUI to the provider 101 using the display device 121.

2. Receiving Confirmation from the Health Care Provider to Activate the Supplemental Programs

After the SP module has determined supplemental programs for which the patient is eligible, the SP module generates and displays a GUI to the provider 101 in order to receive confirmation from the provider 101 regarding which of the eligible supplemental programs should be activated.

Referring to FIG. 8b and after step 810, the SP module generates a GUI that comprises a list of the eligible supplemental programs for the provider's selection and confirmation by the health care provider 101, thereby completing step 811. In one embodiment of the present invention, the central portion 301 of the SP module generates the GUI that comprises the list of eligible supplemental programs for the patient, and then transmits the GUI to the SP widget 302 for display to the provider 101 in the display device 121. However, in alternate embodiments of the present invention, the GUI is generated and displayed by the SP widget 302.

After the GUI is generated, the SP widget 302 displays the GUI in the display device 121 of the terminal 120 to the provider 101, thereby completing step 812. One example of a GUI is shown in FIG. 1S. As exemplified by the GUI of FIG. 15, the GUI comprises a pop-up window 1010, which comprises information relating to the substance 1011 for which eligible supplemental programs are being presented, information relating to the eligible supplemental programs 1012, selection mechanisms 1013 for each of the eligible supplemental programs, information relating to delivery modes 1014 available for the eligible supplemental programs, delivery mode selection mechanisms 1015 for each of the delivery modes available for each of the eligible supplemental programs, delivery mode input fields 1016, a confirmation mechanism 1017, and a cancellation mechanism 1018.

Still referring to FIG. 15, although only one substance is listed in the window 1010, it should be noted that section 1011 may comprise information relating to a plurality of prescribed substances. For instance, if the provider 101 drafts more than one prescription relating to more than one substance for the patient and the SP module determines that there are eligible supplemental programs relating to more than one of the prescribed substances, then the window 1010 will comprises a list of each of the substances 1011 along with a list of each of their associated eligible supplemental programs 1012.

As further exemplified by the window 1010, section 1012 which comprises a list of the eligible supplemental programs for each of the prescribed substances, also comprises a selection mechanism 1013 to allow the provider 101 to determine which of the eligible supplemental programs they would like to activate for their patient. The selection mechanism 1013 allows each of the eligible supplemental programs to be selected and/or deselected by the provider 101 using the input means 122 of the HCP system 100. As discussed in more detail below, the eligible supplemental programs that are selected (e.g., via a check box) by the provider 101 using the selection mechanism 1013 when the confirmation mechanism 1017 is actuated by the provider 101 will be activated by the SP module for the patient upon the provider 101 actuating the confirmation mechanism 1017. Although exemplified as a check box, the invention is not so limited and in alternate embodiments the selection mechanism 1013 may be changed to include any selection mechanism known in the art.

Moreover, as discussed above, it should be noted that if the supplemental program database 303 and/or the records database 304 comprises provider preference data and/or patient preference data, then the SP module will upload that information and generate the window 1010 based on that information. For instance, if the preference data relates to specific types of supplemental programs or delivery modes preferred by the provider 101 or patient, then the selection mechanisms 1013, 1015 for those supplemental program and/or delivery modes will be pre-selected when the window 1010 is generated by the central portion 301 of the SP module and displayed by the SP widget 302 on the display device 121 for the provider 101.

Still referring to the window 1010 shown in FIG. 15, a list of available delivery modes 1014 for the eligible supplemental programs is also displayed for the provider 101. As shown, each delivery mode comprises a delivery mode selection mechanism 1015 that may be selected and/or deselected by the provider 101 using the input means 122. The delivery mode selection mechanisms 1015 allow the provider 101 to determine how the supplemental programs will be delivered to the patient. Further, it should be noted that more than one delivery mode may be selected by the provider 101. In such instances, the supplemental programs will be delivered to the patient via all of the selected delivery modes. Although the delivery modes are shown to comprise print, email, and text/SMS, the invention is not so limited and in alternate embodiments, the delivery modes may also include mailing to the patient's address, along with other methods of delivering documents to the patient.

Further, the window 1010 also comprises the delivery mode input fields 1016, which allow a provider 101 to manually enter in the patient's mobile phone number, email address, or other patient delivery mode information required for delivery of a supplemental program. If the provider 101 enters patient delivery mode information into a delivery mode input field 1016, then upon the provider 101 actuating the confirmation mechanism 1017, the SP module stores the patient's delivery mode information in one or more databases of the system 1000 (e.g., the records database 304) for future instances. Additionally, it should be noted that if the patient's delivery mode information (e.g., email, phone number, address, etc.) is previously stored in one or more of the databases of the system 1000 (e.g., the record database 304, the EP database 201, etc.), then the SP module will retrieve the patient's delivery mode information from the one or more databases and auto-populate the delivery mode input fields 1016 in window 1010.

Further, one of the delivery mode input field 1016 shown in the window 1010 is a preview field. The preview field allows the provider 101 to preview the eligible supplemental program(s) before activating the program(s) for the patient. If the supplemental program is a coupon, education material, or other document, then another window displaying the document or information relating to the document will be generated and displayed by the SP module in the display device 121. According to one embodiment of the present invention, if the supplemental program is a service, then another window displaying general information relating to the service will be generated and displayed by the SP module in the display device 121.

As noted above, according to one embodiment of the present invention, prior to generating and displaying the window 1010, the SP module retrieves delivery mode data relating to the eligible supplemental program and the patient. In the list of delivery modes 1014 exemplified in FIG. 15, “print” is a qualified delivery mode and the delivery mode input field 1016 for print has been pre-selected by the SP widget 302. Since the other delivery modes, such as email and mobile, do not comprise patient delivery mode data, they are not qualified delivery modes and are not pre-selected by the SP module.

Referring to both FIG. 8b and FIG. 15, after the provider 101 has selected the eligible supplemental programs and the delivery mode(s) for the eligible supplemental programs that they would like to activate for the patient, the provider 101 actuates the confirmation mechanism 1017. Upon actuating the confirmation mechanism 1017, the SP widget 302 generates and transmits an activation signal for each of the supplemental programs that have been selected by the provider 101 to the central portion 301 of the SP module, thereby completing step 813. Each of the activation signals comprises information relating to the eligible supplemental program itself, along with the deliver mode selected by the provider 101. However, the invention is not so limited and in alternate embodiments, the SP widget 302 generates and transmits a single activation signal that comprises information relating to all of the eligible supplemental programs that were selected by the provider 101.

Although exemplified as an icon in the window 1010, the confirmation mechanism 1017 is not so limited. In alternate embodiments, the confirmation mechanism 1017 may be a button, switch, lever, etc. that can be actuated by the provider to confirm the selected eligible supplemental programs and delivery modes.

However, if the provider 101 decides that they do not want to have any of the eligible supplemental programs activated for the patient, then the provider 101 may actuate the cancellation mechanism 1018. Upon actuating the cancellation mechanism 1018, the SP widget 302 generates and transmits a cancellation signal to the central portion 301 of the SP module. In such instances, none of the eligible supplemental programs are activated for the patient.

As shown in FIG. 15, the window 1010 is displayed concurrently with the electronic prescription interface that was used to generate the electronic prescription data previously received by the SP module. More specifically, the window 1010 overlays the electronic prescription interface and is automatically generated and displayed by the SP module in the display device 121 during the electronic prescriptions session undertaken by the provider 101. By using such a system, the provider 101 does not have to leave their electronic prescription writing interface in order to be presented with eligible supplemental programs for their patients. Stated simply, the SP module, due in part to the SP widget 302 being integrated into the EP module, provides one continuous interface for the provider 101 during their prescription writing/supplemental program activating process.

This is beneficial because it allows the provider 101 to know what sorts of supplemental programs are available for their patient and, specifically for the substance the provider 101 is currently prescribing for their patient, without having to leave their electronic prescription writing interface. Such a system encourages providers 101 to disseminate documents and enroll their patients in services to increase their patient adherence in their prescribed substances.

Further, additional benefits arise from granting the provider 101 the ability not only to select what specific supplemental programs will be activated for each and every one of their patients, but also the ability to preview the supplemental programs before they are activated for the patient. Additionally, the provider 101 may select the specific delivery mode for each patient. Therefore, the provider 101 may tailor the supplemental programs depending on the particular preferences of the patient, as well as what the provider 101 believes will result in the most beneficial results. Finally, allowing the provider 101 to be the gatekeeper between the supplemental programs and the patient encourages communication between the provider 101 and patient, which ultimately results in better care for the patient.

Although exemplified as pop-up window 1010, it should be noted that the invention is not so limited. In alternate embodiments, the provider interface created by the SP module may be any interface designed to allow the provider 101 to select and confirm the specific supplemental programs they would like to be delivered to the patient. For example, the interface may be a screen that takes up the entirety of the display device 121 or a window that is separate from the EP module (as opposed to pop-up window 1010, which is displayed on top of the electronic prescription writing interface). Stated simply, the current invention is not limited to the type of interface generated and displayed to the provider 101.

3. Activating the Eligible Supplemental Programs that have been Confirmed by the Health Care Provider

In general, activation of an eligible supplemental program begins when the provider 101 actuates the confirmation mechanism 1017 after selecting the programs they would like to be activated for their patient. In the embodiments discussed with reference to FIGS. 8a-8c, activation begins with step 813 and continues to step 818. However, it should be noted that in alternate embodiments of the present invention, activation further includes step 819 and sometimes even step 820. Moreover, in another embodiment of the present invention, activation only includes step 813, which comprises the SP widget 302 generating and transmitting an activation signal to the central portion of the SP module 301 upon the provider 101 actuating the confirmation mechanism 1017.

Referring to FIG. 8b, after the SP widget 302 generates and transmits the activation signal for each of the supplemental programs, the central portion 301 of the SP module receives the activation signals, thereby completing step 814. Using the received activation signals, the central portion 301 of the SP module determines which of the eligible supplemental programs the provider 101 has confirmed.

Thereafter, the central portion 301 of the SP module transmits the relevant data for one of the confirmed supplemental program to the appropriate third party content provider 400, thereby completing step 815. For instance, if the confirmed supplemental program is a document (e.g., a coupon, educational material, EduSAVE™, etc.), then the central portion 301 of the SP module transmits at least a request for the document(s) to the appropriate third party content provider 400. Similarly, if the supplemental program is a service (e.g., a prescription reminder service, a medication reminder service, an appointment reminder service, a patient adherence service, etc.), then the central portion 301 of the SP module transmits a request for patient enrollment in the service. Therefore, depending on the specific document or service requested, the central portion 301 of the SP module transmits the relevant request to the appropriate server 410, 420, 430, 440 of the third party content provider 400.

It should be noted that in some embodiments of the present invention, the central portion 301 of the SP module may also transmit patient delivery mode data to the third party content provider 400. This may be required if the third party content provider 400 is to deliver the content directly to the patient or enroll the patient directly into the service.

Upon receiving the request from the central portion 301 of the SP module, the appropriate third party content provider 400 determines whether the request is for a document or a service. If the request is for a document, then the third party content provider 400 generates the document and returns the document to the central portion 301 of the SP module. If the request is for a service, then the third party content provider 400 configures the service and transmits a configuration signal back to the central portion 301 of the SP module. Specifically, the corresponding document or service is retrieved from the appropriate one of the databases 401, 402, 403, 404.

Thereafter, the central portion 301 of the SP module receives the document(s) and/or enrollment confirmation signal from the third party content system 400, thereby completing step 816. Next, the central portion 301 of the SP module determines if there are any other eligible supplemental programs for which a request has yet to be delivered to the third party vendor system 400 at decision step 817. If there are additional confirmed supplemental programs for which relevant data has not yet been transmitted to the third party content system 400, then the process returns to step 815 and the central portion 301 of the SP module transmits the relevant data for another of the confirmed supplemental program to the appropriate third party content provider 400. However, if the relevant data has been transmitted to the third party content system 400 for each of the confirmed supplemental programs, then the process continues to step 819.

It should be noted that in one embodiment of the present invention, the central portion 301 of the SP module transmits the relevant data for all of the confirmed supplemental programs to the appropriate third party content provider 400 at step 815. In such instances, decision step 817 may be omitted.

Therefore, after a request has been delivered by the central portion 301 of the SP module to the appropriate third party content provide 400 for all of the eligible supplemental programs that were confirmed by the provider 101, the SP module has activated each of the supplemental programs. Generally, by activating a supplemental program the SP module either receives content, such as a document to the patient, that is to be delivered to the patient or enrolls the patient in one of the aforementioned services via the appropriate third party content provider 400.

A non-limiting list of examples whereby the SP module activates a supplemental program is discussed below. It should be noted that the invention is not limited to the explicit examples presented herein. In one embodiment, in which the supplemental program is a coupon service, the SP module activates the supplemental program by retrieving coupon data relating to the prescribed substance from the coupon database 401 of the appropriate third party content provider 400 and integrating the coupon data into the electronic prescription. The integration of the coupon data into the electronic prescription is done by the SP widget 302, which is integrated into the thin-client portion 320 of the EP module residing on the HCP system 100. Thereafter, the HCP system 100) may transmit the electronic prescription with integration coupon to the pharmacy system 500 for further processing.

In another embodiment, in which the supplemental program is a coupon service, the SP module activates the supplemental program by retrieving the coupon data and provisioning a coupon based on the coupon data. Further, in one embodiment, activation further includes the SP module delivering the coupon to the patient via the selected delivery mode. For instance, the coupon may be delivered to the HCP system 100 so the provider 101 may print the coupon out for the patient using the printer 130, or the coupon may be delivered directly to the patient via one of the delivery modes discussed above.

For further example, in one embodiment in which the supplemental program is a prescribed substance education service, the SP module activates the supplemental program by retrieving educational content relating to the prescribed substance from the educational information database 402 of the appropriate third party content provider 400. Thereafter, according to one embodiment, activation may further include the SP module delivering the education content to the patient via the selected delivery mode. Therefore, the education content may be delivered to the patient by transmitting the educational content to the HCP system 100 so the content may be printed by the provider 101 for the patient using the printer 130, or the educational content may be delivered directly to the patient via one of the delivery modes discussed above.

Additionally, in another embodiment in which the supplemental programs is a prescribed substance education service and/or a coupon service, the SP module activates the supplemental program by retrieving education content relating to the prescribed substance from the educational information database 402 of the appropriate third party content provider 400 and integrating the educational content into a coupon (such as the EduSAVE™ document shown in FIG. 9). Further, according to one embodiment of the present invention, activation may further include delivering the combined educational coupon to the patient via the selected delivery mode. Similarly, the combined educational coupon may be delivered to the patient by transmitting the educational content to the HCP system 100) so the educational coupon may be printed by the provider 101 for the patient using the printer 130, or the educational coupon may be delivered directly to the patient via one of the delivery modes discussed above.

In one embodiment, in which the supplemental program is a patient adherence service, the SP module activates the supplemental program by enrolling the patient in the patient adherence service. According to another embodiment of the present invention, in which the activated supplemental program is a prescription reminder service, the SP module activates the supplemental program by enrolling the patient in the prescription reminder service. In yet another embodiment of the present invention, in which the activated supplemental programs is an appointment reminder service, the SP module activates the supplemental program by enrolling the patient in the reminder service.

In the exemplified embodiments, the SP module enrolls the patient in the service by transmitting the relevant data to the appropriate third party content provider 400, and the appropriate third party content provider 400 signs the patient up for the service. For example, the relevant data may include data relating to the patient, data relating to the patient's past adherence, data relating to the electronic prescription, and data relating to the patient's appointment schedule. However, in alternate embodiments of the present invention the SP module may enroll the patient into the service without the use of the appropriate third party content provider 400. In such embodiments, the SP module may further comprise an enrollment engine in order to effectuate the enrollment of the patient in the appropriate service directly.

For example, in embodiments where the SP module further comprises an enrollment engine, the central portion 301 of the SP module would effectuate the enrollment of patients into the services that were activated for them, without the need of the SP module transmitting patient enrollment data to a third party content provider 400.

Referring back to FIG. 8c, after the SP module is done activating the eligible supplemental programs that have been confirmed by the health care provider 101, the SP module tailors the content relating to each of the activated supplemental programs for the specific delivery mode that was selected and confirmed by the provider 101, thereby completing step 819. Generally, the central portion 301 of the SP module alters the specific document depending on the specific delivery mode selected and confirmed by the provider 101. For instance, if the delivery mode is selected to be via email, then the content is configured to be most easily viewable by a web browser. If the delivery mode is selected to be via text/SMS to the patient's mobile phone, then the content is configured to be most easily viewable on the smaller screen of a mobile device. Further, if the delivery mode is selected so that the content is printed at the printer 130, then the content is configured to be most easily printed.

It should be noted that if the supplemental program is a service, the step of tailoring the content is typically not be performed. However, in some embodiments, the SP module may tailor a confirmation message of the patient's enrollment in the service for delivery to the patient via the specific delivery mode selected and confirmed above.

After the SP module tailors the content for the selected and confirmed delivery mode, the SP module delivers the content of each of the activated supplemental programs to the patient via the selected and confirmed delivery modes, thereby completing step 820. Generally, the central portion 301 of the SP module will delivery the content if the selected delivery mode is to the patient's mobile phone, email, or mailing address. However, if the selected delivery mode is for the content to be printed at the printer 130, then the central portion 301 of the SP module will transmit the content to the SP widget 302 residing on the HCP system 100, and the SP widget 302 thereby effectuates the printing of the content by a printer 130 of the HCP system 100.

As noted above, according to one embodiment of the present invention, one or both of steps 819 and 820 may be considered part of the activation step performed by the SP module. However, as also noted above, the invention is not so limited and the processing performed by steps 819 and 820 may also be considered separate, subsequent steps that are performed after the activation step of the SP module.

In one alternate embodiment, the supplemental program data relating to all of the available supplemental programs resides on the SP system 300 in its one or more databases. In such embodiments, the third party vendor system 400) is omitted, and the central portion 301 of the SP module does not have to reach out to the third party vendor system 400 to provide the patient with the documents or enroll the patient in the services.

In another embodiment of the present invention, the third party vendor system 400 may transmit the document directly to the patient or enroll the patient in the service upon receiving the request and the patient delivery module data. Therefore, in such embodiments, the central portion 301 of the SP module does not receive a document or confirmation signal from the third party content provider 400.

Moreover, it should be noted that some of the services require the patient to confirm their enrollment in the service. Therefore, enrollment cannot be fully effectuated by the SP module or the third party vendor system 400. In such instance, the SP module or the third party vendor system 400 would transmit the appropriate confirmation to the patient via the delivery mode chosen by the provider. Thereafter, if the confirmation is received by the SP module, then the SP module would transmit another enrollment signal back to the third party content provider 400. However, if the confirmation is received by the third party content provider 400, then the third party content provider 400 would enroll the patient in the service upon receiving the confirmation from the patient.

Further, in one embodiment of the present invention, a clinical staff personnel may perform the steps initiated by the provider 101. A clinical staff personnel may be a nurse, an office or hospital administrator, or any other personnel involved in the health care industry. In such embodiments, the clinical staff personnel would choose a previously prescribed substance to begin the process. Thereafter, the process would continue as described above, ultimately resulting in the patient receiving a document (e.g., coupon, educational material, etc.) or being enrolled in a service.

Finally, it should be noted that the SP system 300, and specifically the SP module, of the present invention further comprises control and management options for the provider 101 or an administrator of the HCP system 100. Therefore, using the control and management options, the provider 101 or administrator may adjust the look, functionality, and processes of the SP module, including but not limited to, adding, removing, or editing provider and patient preferences, altering the GUIs generated and displayed by the SP module, etc.

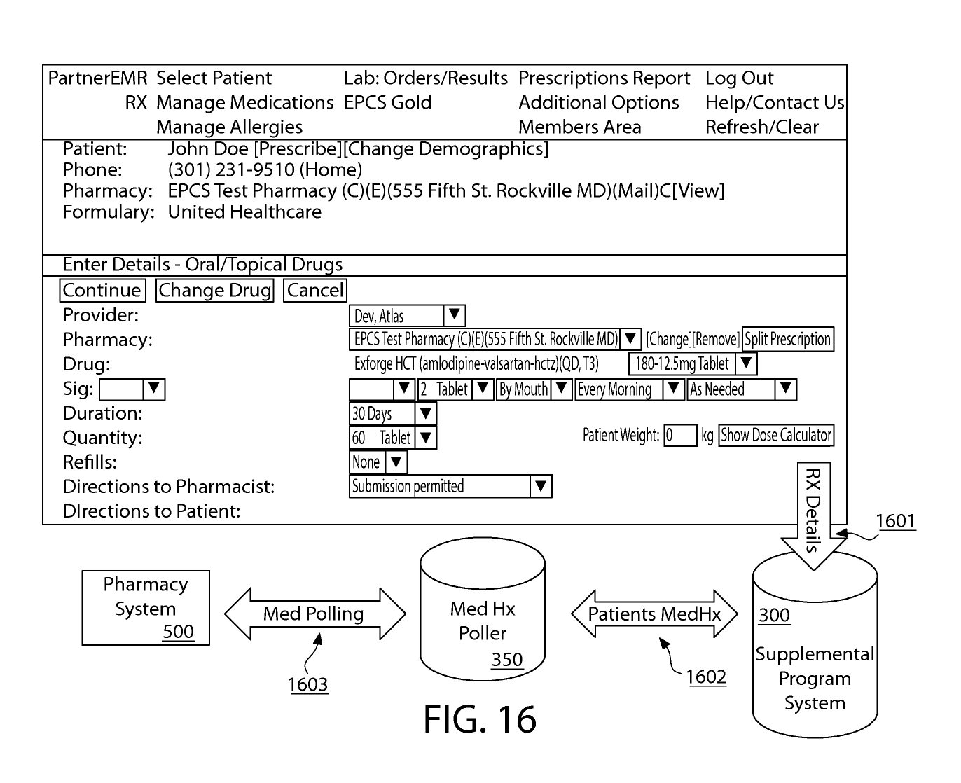

Referring now to FIG. 16, a flow diagram of one method of acquiring patient medication history data according to an embodiment of the present invention is illustrated. As shown, the process begins when the SP module residing on the SP system 300 retrieves data relating to an electronic prescription from the EP module, thereby completing step 1601. This may be accomplished in a manner similar to as discussed above.

Upon receiving the electronic prescription data, the SP module parses the data to determine information relating to the patient, such as, but not limited to the name of the patient, the age of the patient, and other identifying information. Further, the SP module may also parse the electronic prescription data to determine information relating to the prescribed substance, the provider, and/or the payor. Next, the SP module transmits the retrieved patient data (potentially along with other relevant data) to a Medication History Poller System 350 (also referred to herein as Medication Hx Poller for brevity), thereby completing step 1602.

The Medication History Poller System 350 receives and stores the patient data. Next, the Medication History Poller System transmits some of the patient data along with a request for patient medication history information to the pharmacy system 500 and/or the payor system 600, thereby completing step 1603. Thereafter, the Medication History Poller System 350 receives medication history data relating to the patient from the pharmacy system 500 and/or the payor system 600. It should be noted that in other embodiments of the present invention, the Medication History Poller System may be part of the SP module. Further, it should be noted that, as discussed above, the pharmacy system 500 may comprise a prescription routing sub-system 501 (e.g., Surescripts® and the prescription filling sub-systems 502.

Upon receiving the medication history data relating to the patient, the Medication History Poller System transmits the medication history data relating to the patient back to the SP module residing on the SP system 300. It should be noted that in some embodiments of the present invention, the Medication History Poller System parses and analyzes the medication history data relating to the patient to determine adherence data relating to the patient, including but not limited to, the patient's adherence history in general, the patient's adherence history over a specific time frame, and/or the patient's adherence history in relation to a specific prescribed substance or plurality of prescribed substances for the same disease state.

Upon receiving the medication history data relating to the patient from the Medication History Poller System, the central portion 301 of the SP module uses the patient's medication history data when determining eligibility of each of the plurality of available supplemental programs. Further, the central portion 301 of the SP module may further store the patient's medication history information in either or both of the records database 304 or a patient adherence database residing within the memory 313 of the SP system 300.

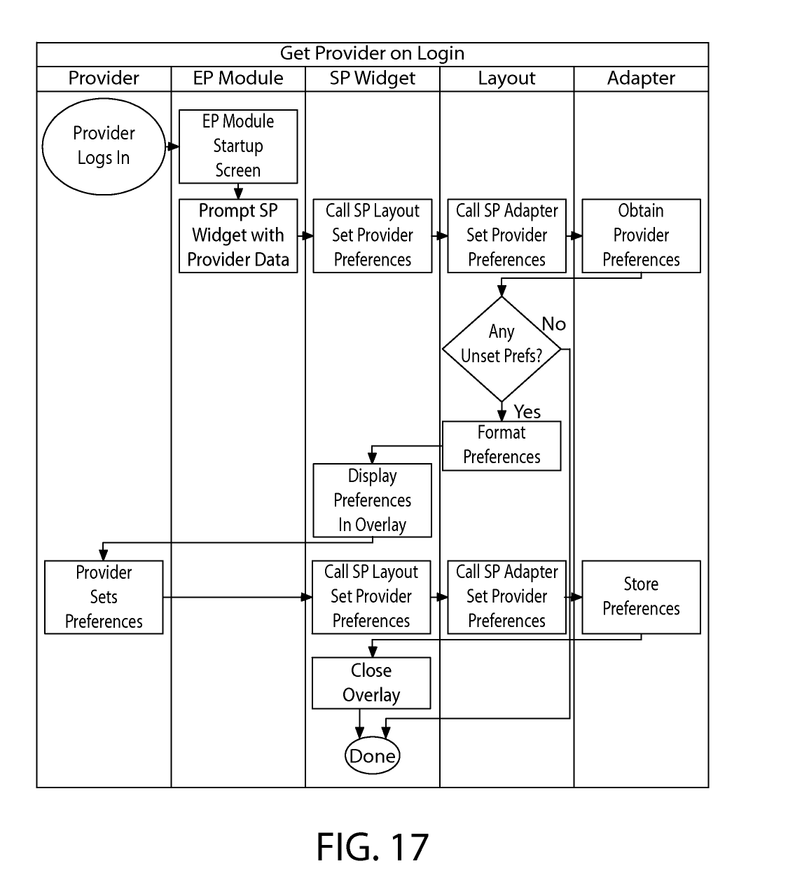

Referring now to FIGS. 17-28, event diagrams for supplementing patient and provider interactions to increase patient adherence according to other embodiments of the present invention are illustrated. It should be noted that the diagrams and methods described in reference to FIGS. 17-28 are in no way limiting of the present invention.

Referring to FIG. 17, an event diagram of one method for acquiring provider 101 preference data according to an embodiment of the present invention is illustrated. The method of FIG. 17 begins when the health care provider 101 logs into the EP module using their terminal 120. Thereafter, the EP module displays the startup screen to the provider 101 on the display device 121. Next, the EP module prompts the SP widget 302 to acquire provider preference information from the SP module. Upon being prompted by the EP module, the SP widget 302 calls the central portion 301 of the SP module. Specifically, as exemplified in FIG. 17, the SP widget 302 calls a layout portion of the central portion 301 of the SP module to set the provider's preferences.

According to one embodiment of the present invention, the central portion 301 of the SP module comprises two sub-portions, a layout and an adapter. The layout of the SP module generates the GUIs that are displayed to the provider 101 via the display device 121. The adapter of the SP module performs the transmission and receipt of data between the central portion 301 of the SP module and the other modules and systems of the system 1000.

After being called by the SP widget 302, the layout calls the adapter to set the provider's preferences. Thereafter, the adapter obtains a plurality of different provider preferences offered by the SP module. Next, the layout determines whether any provider preferences had been previously set by the provider 101 by searching the records database 304 of the SP system 300. If all of the preferences have been set by the provider 101, then the process ends. However, if there is at least one unset provider preference, then the layout generates a GUI comprising the unset preferences and transmits the GUI to the SP widget 302. Upon receiving the GUI, the SP widget 302 displays the GUI comprising the unset provider preferences to the provider 101 via the display device 121.

Next, the provider 101 sets their preferences using the input means 122 and via the GUI displayed on the display device 121. Thereafter, the SP widget 302 transmits a signal to the layout to set the provider's preferences. Upon receiving the provider's preferences, the layout calls the adapter to set the provider's preferences, and the adapter stores the provider preference information in the records database 304 of the SP system 300.

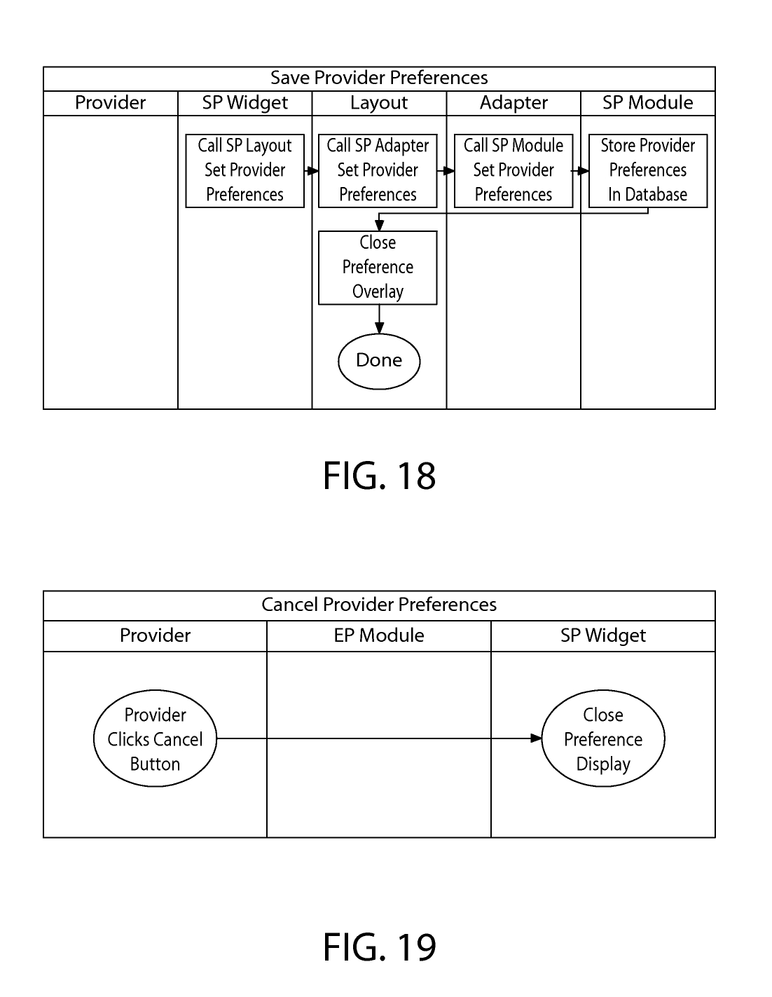

Referring to FIG. 18, an event diagram of one method for storing provider 101 preference data according to an embodiment of the present invention is illustrated. The method begins after the provider 101 selects their preferences in an appropriate GUI generated by the SP module and displayed via the display device 121. After selecting their preferences, the provider 101 actuates a save button on a GUI displayed by the SP widget 302. Actuating the save button causes the SP widget 302 to call the layout of the SP module, which in turn calls the adapter of the SP module, which causes the SP module to store the prescribed preference data in the records database 304.

Referring to FIG. 19, an event diagram of one method for cancelling provider 101 preferences according to an embodiment of the present invention is illustrated. The method begins when the provider 101 actuates a cancel button on a GUI displayed by the SP widget 302. This causes the SP widget to close or cancel out of the preference GUI.

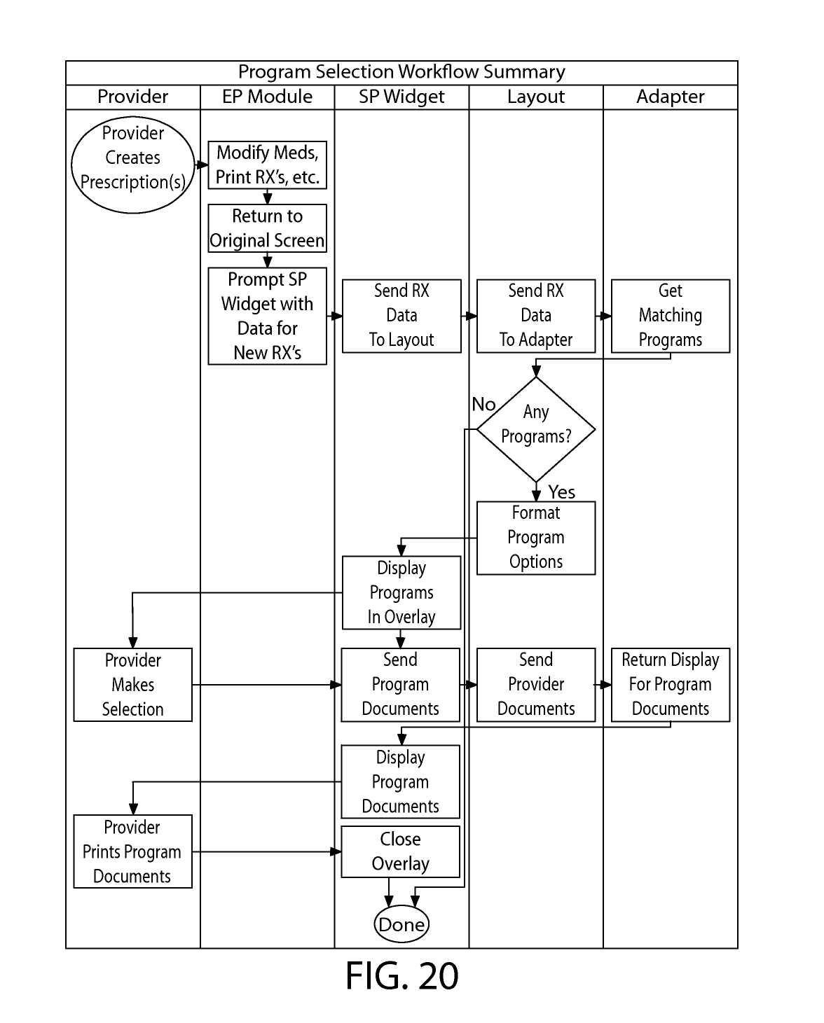

Referring to FIG. 20, an event diagram of one method for selecting supplemental programs according to an embodiment of the present invention is illustrated. The method begins when the provider 101 uses the EP module to create a new electronic prescription for a substance. After creating the electronic prescription, the provider 101 has the ability to modify the prescription using the EP module. Thereafter, the EP module prompts the SP widget 302 with data relating to the electronic prescription. After being prompted by the EP module, the SP widget 302 retrieves electronic prescription data relating to the electronic prescription from the EP module. Upon retrieving the electronic prescription data, the SP widget 302 transmits the data to the layout of the SP module, which in turn transmits the electronic prescription data to the adapter of the SP module.

Upon receiving the electronic prescription data, the adapter determines if there are any programs, out of the plurality of available supplemental programs, for which the patient and the electronic prescription are eligible. If there are not any eligible programs, then the process ends. However, if there are eligible supplemental programs, then the layout of the SP module formats the supplemental program option in a created GUI. Formatting may include a selection of the available delivery modes of each supplemental program and the generation of the GUIs that are to present the eligible supplemental programs to the provider 101. At least one GUI is then displayed by the SP widget 302 to the provider 101, so that the provider 101 may select and confirm which of the eligible supplemental programs they would like activated for the patient.

After the provider 101 makes a selection of eligible supplemental programs, the SP widget 302 transmits the provider's selections to layout of the SP module. The layout then transmits the provider's selection to the adapter. Thereafter, the adapter retrieves the selected supplemental programs from the supplemental program database 303 and transmits the selected eligible supplemental programs to the SP widget 302 for display to the provider 101 via the display device 121. Thereafter, the provider 101 may print the eligible supplemental programs for delivery to the patient.

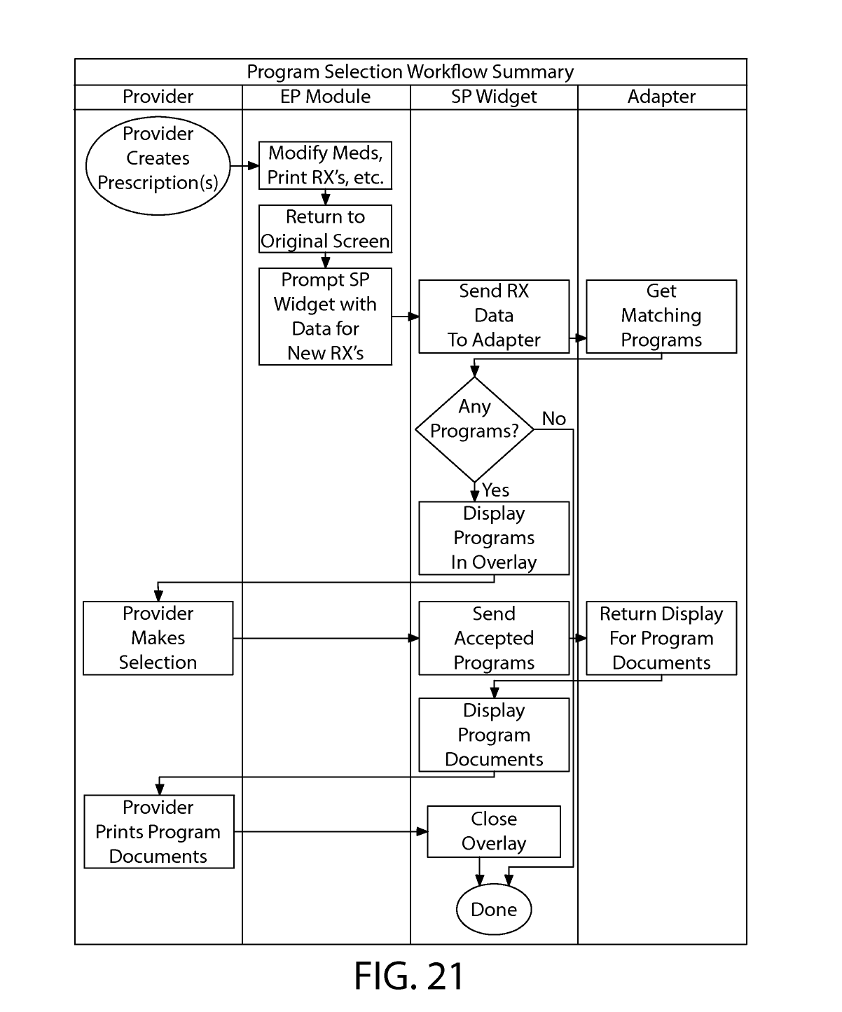

Referring to FIG. 21, an event diagram of another method for selecting supplemental programs according to an embodiment of the present invention is illustrated. The method of FIG. 21 is vastly similar to the method of FIG. 20. It should be noted that processes performed by the layout of the SP module in FIG. 20 are instead performed by the SP widget 302 in the method of FIG. 21. Such a system and method may be preferred to reduce the processing that occurs outside of the HCP system 100.

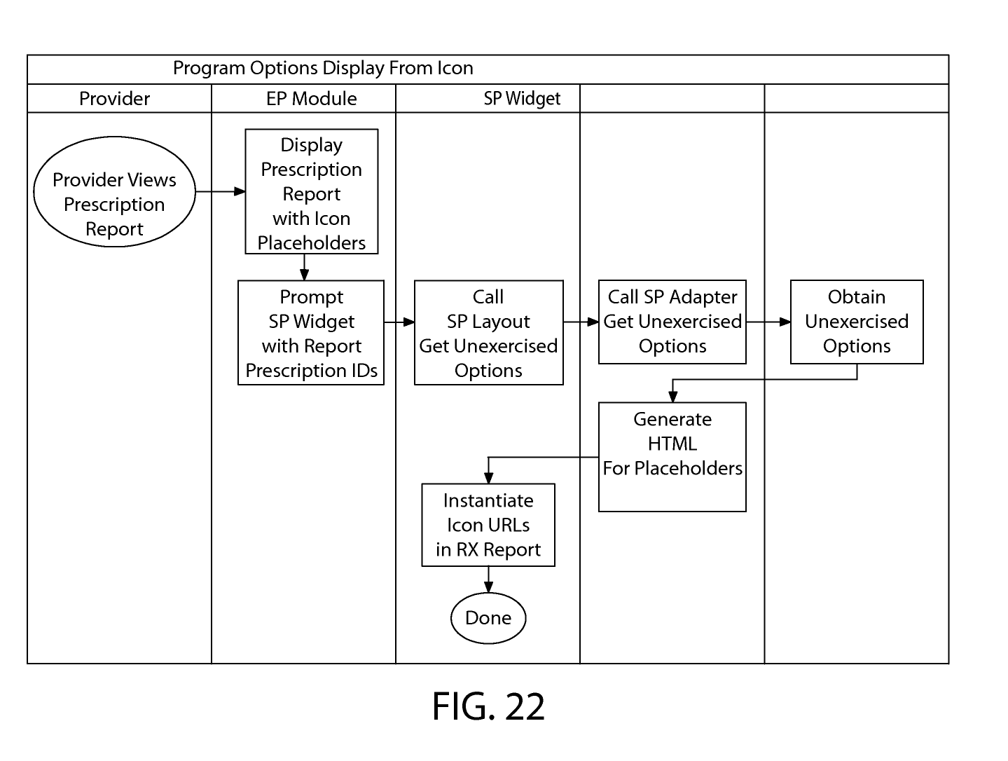

Referring to FIG. 22, an event diagram of one method for presenting unexercised options according to an embodiment of the present invention is illustrated. An unexercised option is an eligible supplemental program that the provider 101 did not select and confirm for activation. In one embodiment, the provider 101 may go back at a later time, and select unexercised options for activation by the SP module. This allows the provider 101 to activate supplemental programs for a patient outside of the prescription writing workflow.

According to one embodiment of the present invention, the method begins when the provider 101 selects and views a prescription report generated and display by the EP module. The EP module displays a prescription report that comprises icon placeholders, the icon placeholders representing prescriptions that the provider 101 previously selected for a subsequent selection of eligible supplemental programs. Next, the EP module prompts the SP widget 302 with report prescription identification data. Although exemplified as being displayed by the EP module, it should be noted that in alternate embodiments, the prescription report may be generated and displayed by the SP module.

Upon receiving the report prescription identification data, the SP widget 302 calls the layout of the SP module for the unexercised options that relate to each of the prescriptions identified by the report prescription identification data. Thereafter, the adapter obtains the unexercised options off the identified prescriptions, and the layout generates HyperText Markup Language (HTML) for placeholders for the unexercised options. Finally, the SP widget 302 instantiates icon Uniform Resource Locators (URLs) for the prescription report.

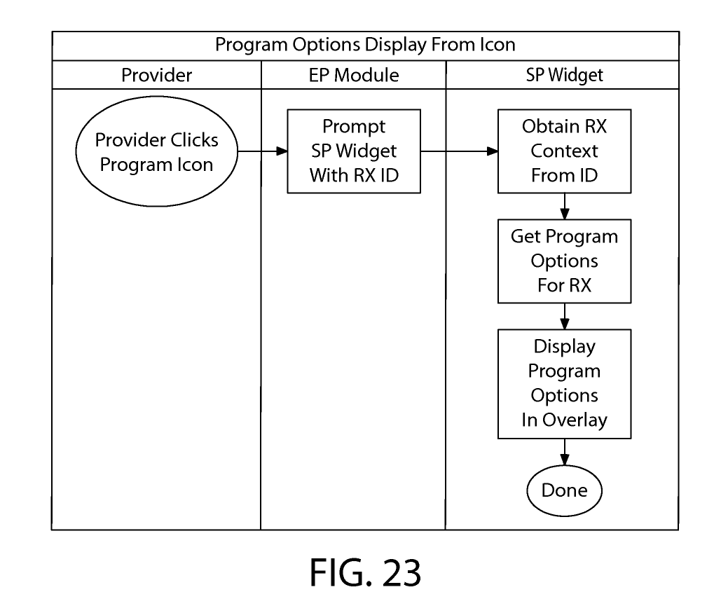

Referring to FIG. 23, an event diagram of one method for displaying supplemental program options according to an embodiment of the present invention is illustrated. This process begins when the provider 101 actuates a program icon from the prescription report, discussed above with reference to FIG. 22. The EP module receives the provider's input and prompts the SP widget 302 with the prescription identification. The SP widget 302 then obtains the prescription content from the prescription identification, retrieves the supplemental program options for the prescription and displays the supplemental program options to the provider 101 in an overlay, similar to that exemplified in FIG. 15. It should be noted that the SP widget 302 does not have to reach back out to the central portion of the SP module, because in such embodiments, the SP widget 302 comprises local memory in which the program options are stored.

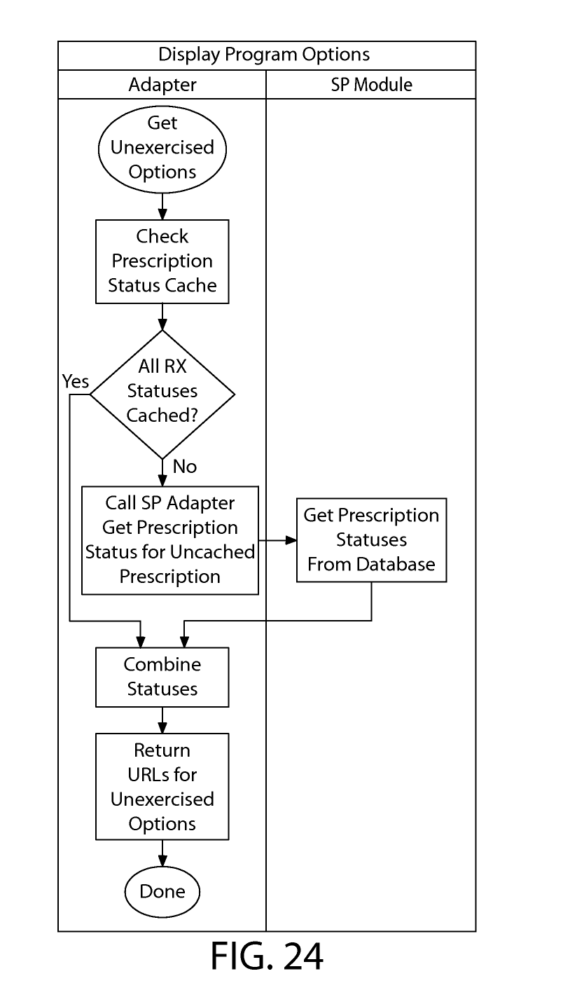

Referring to FIG. 24, an event diagram of one method of the adapter acquiring unexercised options according to an embodiment of the present invention is illustrated. The method exemplified in FIG. 24 is used when the SP widget 302 does not have stored the unexercised options of the prescriptions identified in the prescription report cached locally on the HCP system (100. As shown, the method of FIG. 24 begins with the adapter retrieving the unexercised options. Next, the adapter of the SP module checks to see if the prescription statuses are cached, and determines whether all the prescriptions have statuses that are cached. If not, then the adapter calls the SP module to get prescription statuses for all uncached prescriptions, and the SP module retrieves the prescription statuses from the records database 304. Thereafter, the adapter combines the statuses of the prescriptions and returns URLs for the unexercised options of each of the electronic prescriptions to the SP widget 302 for provider input.

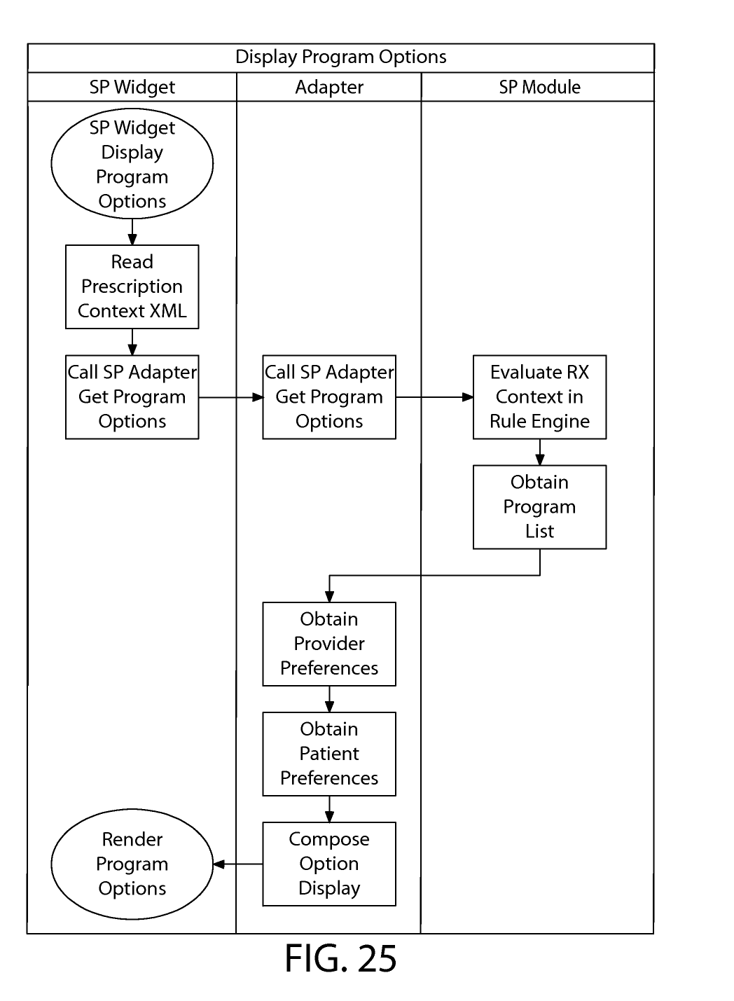

Referring to FIG. 25, an event diagram of one method for displaying supplemental program options according to an embodiment of the present invention is illustrated. The method begins with the SP widget 302 displaying supplemental program options to the provider 101 via the display device 121. The SP widget 302 then reads the electronic prescription context XML and calls the adapter of the central portion 301 of the SP module to get the options for the supplemental program. The SP module then evaluates the prescription context using the rules engine to obtain a list of eligible supplemental programs for the electronic prescriptions. After a list is obtained, the SP module obtains preference data relating to the provider 101 and the patient and composes a display for the supplemental program options. Finally, the SP widget receives a GUI comprising the supplemental program options and displays the GUI to the provider 101 via the display device 121.

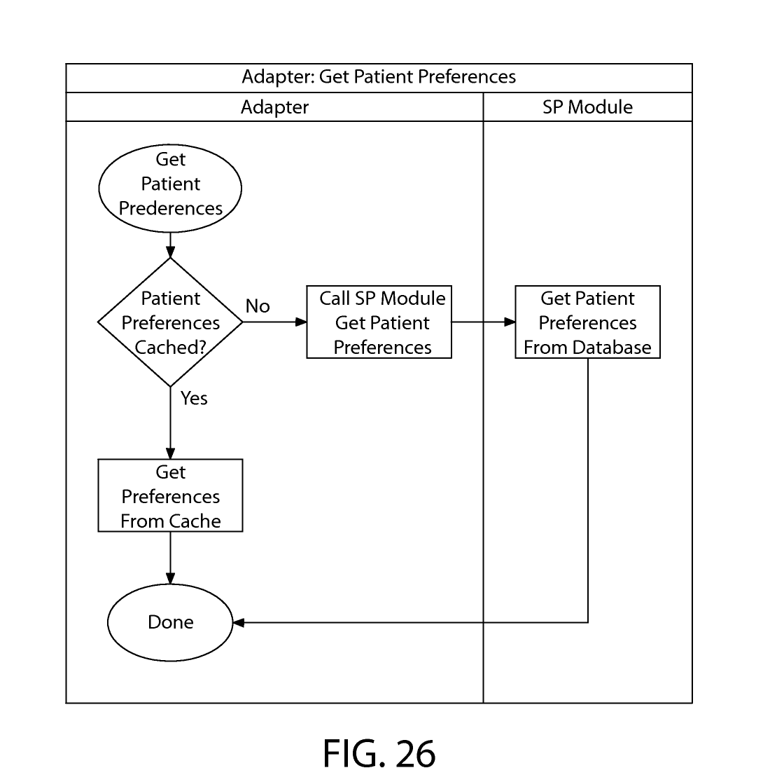

Referring to FIG. 26, an event diagram of one method for acquiring patient preference data according to an embodiment of the present invention is illustrated. The method begins with the adapter of the SP module receiving a request for patient preference data from the SP widget 302. The adapter determines whether the patient preferences are cached, and if so the adapter retrieves the patient preferences from the cached memory. If not, then the adapter retrieves the patient preferences from the record database 304.

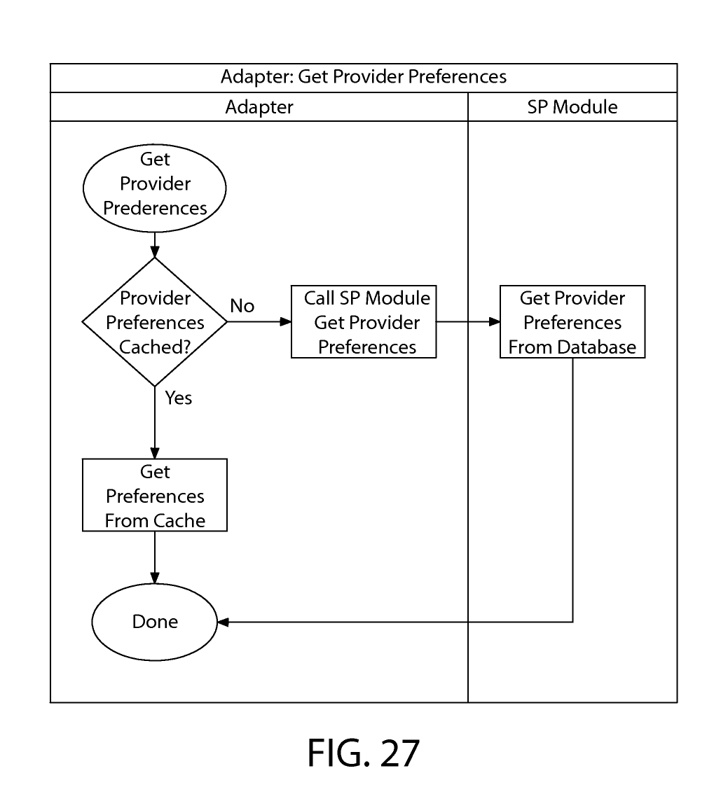

Referring to FIG. 27, an event diagram of another method for acquiring provider 101 preference data according to an embodiment of the present invention is illustrated. The method of FIG. 27 is very similar to that of FIG. 26. The method begins with the adapter of the SP module receiving a request for provider preference data from the SP widget 302. The adapter determines whether the provider preferences are cached, and if so the adapter retrieves the provider preferences from the cached memory. If not, then the adapter retrieves the provider preferences from the record database 304.

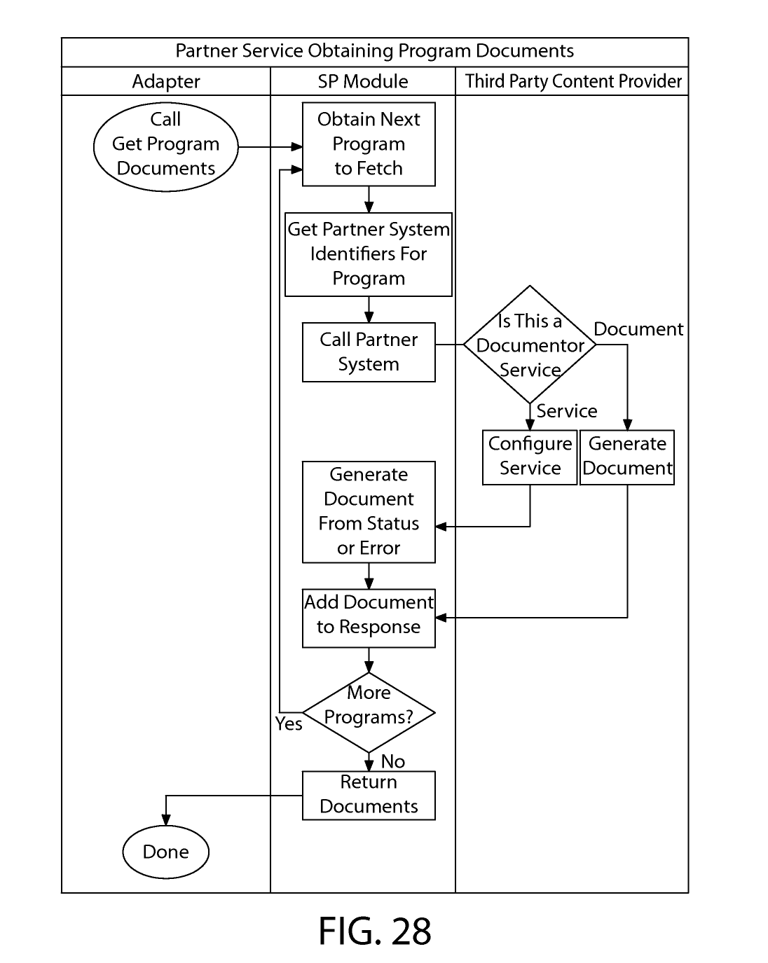

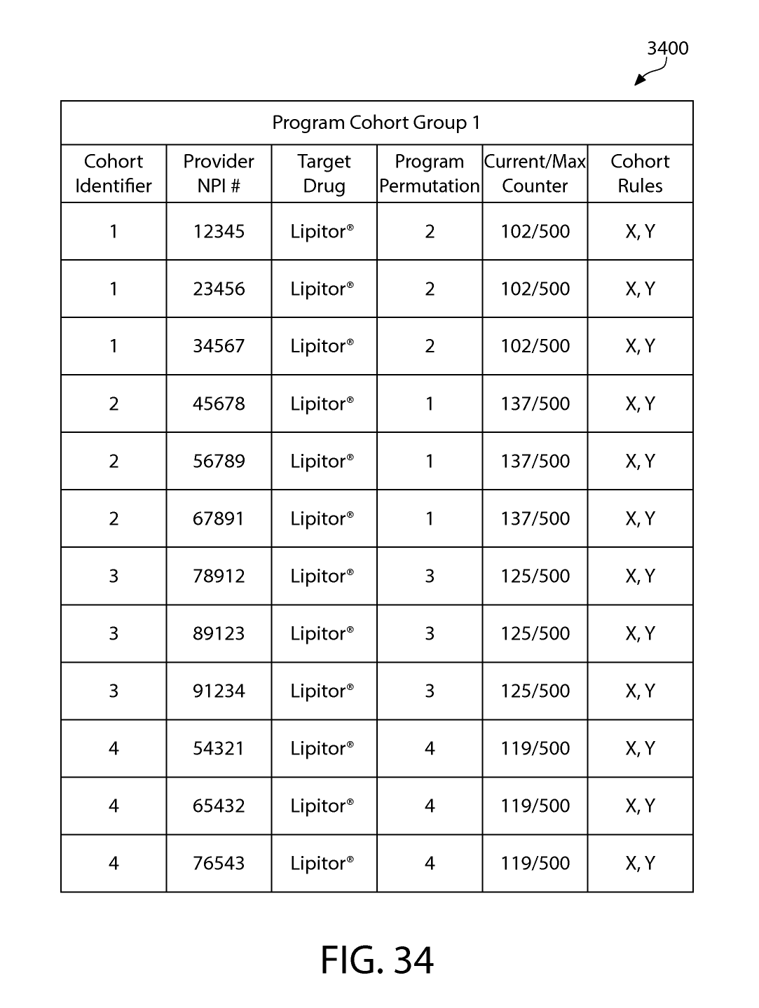

Referring to FIG. 28, an event diagram of one method for acquiring supplemental programs from a third party content provider 400 according to an embodiment of the present invention is illustrated. The method begins with the adapter calling the SP module for supplemental program documents that have been selected and confirmed by the provider 101. The SP module obtains one supplemental program at a time. The SP module first determines which supplemental program to fetch and then retrieves the third party content provider 400 identifiers for that particular supplemental program. The identifiers comprise information relating to the third party content provider 400 that stores the supplemental program. After retrieving the identifiers, the SP module calls the third party content provider system 400.

Upon receiving the signal from the SP module, the third party content provider 400 determines whether the request is for a document or a service based on the identifier of the supplemental program. If the request is for a document, then the third party content provider 400 generates the document. If the request is for a service, then the third party content provider 400 configures the service for the patient. Thereafter, the third party content provider 400 transmits a response to the SP module. The SP module then adds the document to a response and repeats the process for each of the supplemental programs that were selected and confirmed by the provider 101. After documents for all of the supplemental programs has been received by the SP module, the SP module returns the documents to the adapter, which in turn returns the documents to the SP widget 302 for presentation to the provider 101 via display device 121 and provider input.

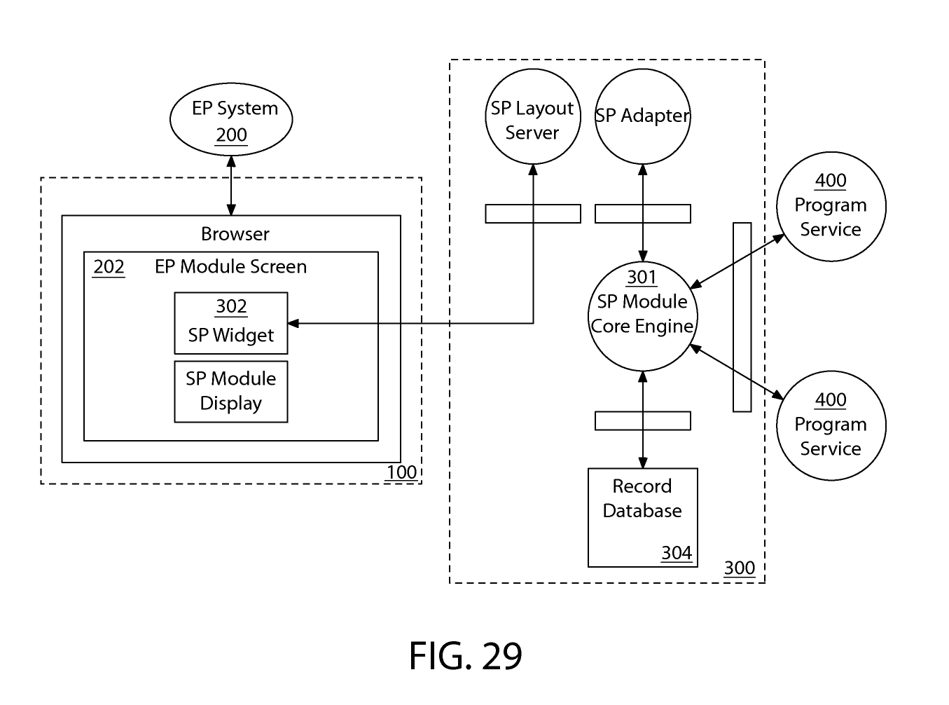

Referring to FIG. 29, a schematic diagram of a system for increasing patient adherence through the activation of supplemental programs according to another embodiment of the present invention is illustrated. As shown, the system comprises an HCP system 100, an EP system 200, an SP system 300, and third party content providers 400.

EduSave™

Referring to FIG. 9, an EduSAVE™ 900 document according to one embodiment of the present invention is illustrated. The EduSAVE™ 900 document is one type of combined educational coupon document and comprises a general information section 901, an educational information section 902, and a coupon section 903. The general information section 901 may comprise information relating to the health care provider 101 who issued the prescription for the patient, information relating to the patient, information relating to the pharmacy filling sub-system 502, and/or information relating to the patient's payor (e.g., health insurance company). The educational information section 902 comprises either general and/or specific information relating to the substance being prescribed and/or the disease state of the patient for which the substance is being prescribed. Finally, the coupon section 903 comprises coupon information relating to a discount, a rebate, or a voucher for the patient for the substance being prescribed. Although described as combining general information, educational information, and coupon information, it should be noted that in alternate embodiments of the present invention, the EduSAVE™ 900 document may comprises just educational information and coupon information, or any combination of health care provider 101 information, patient information, payor information, and pharmacy information along with educational information and coupon information.

One reason the EduSAVE™ 900 document is beneficial is because it provides for a single document that comprises both educational information and coupon information. Therefore, when the patient brings the EduSAVE™ 900 document to their pharmacy for redemption of the coupon, they are encouraged to read the educational information provided therewith. Further, if the patient has any questions or concerns regarding the substance after they have left the provider's office, the patient may easily access the provider's contact information on the EduSAVE™ 900 document.

According to one embodiment of the present invention, after an electronic prescription for the substance is created by a health care provider 101, the SP widget 302 retrieves data relating to the electronic prescription from the thin-client portion of the EP module 203. The SP widget 302 then transmits the electronic prescription data to the central portion 301 of the SP module residing on the SP system 300, such that the central portion 301 of the SP module receives the electronic prescription data. The electronic prescription data comprises first patient data that is specific to the patient, first prescribed substance data that is specific to the prescribed substance, first provider data that is specific to the provider 101, and first payor data that is specific to the payor. It should be noted that the specifics of the electronic prescription data are discussed in detail above.

However, the invention is not so limited, and in an alternate embodiment of the present invention, the electronic prescription data may not relate to an electronic prescription currently being prescribed by a health care provider 101 for a patient, but rather relate to a refill, a renewal, or a previously prescribed substance. In such embodiments, the electronic prescription data may be received by the SP module from one of the other databases of the system 1000 (e.g., the EP database 201, the records database 304, the patient prescription history database 505, etc.). Stated another way, the electronic prescription data may, but does not necessarily have to be generated by a health care provider 101.

Once the central portion 301 of the SP module receives the electronic prescription data, the central portion 301 of the SP module retrieves additional data prior to determining educational data and coupon data for the prescribed substance. The additional (or second) data may comprise one or more of patient data, prescribed substance data, provider data, and payor data. Further, the additional (or second) patient data may comprise patient adherence data. According to one embodiment of the present invention, the additional (or second) data is retrieved by the SP module from the records database 304 of the SP system 300. However, it should be noted that the invention is not so limited and in alternate embodiments, the central portion 301 of the SP module may only retrieve a portion of the data listed herein or may not retrieve any additional data prior to determining educational data and coupon data for the prescribed substance.

After receiving electronic prescription data, and possibly after retrieving additional data from the records database 304, the SP module determines educational data relating to the prescribed substance and coupon data relating to the prescribed substance. In one embodiment of the present invention, the determination is accomplished by the central portion 301 of the SP module in response to receiving the electronic prescription data. Thus, it may be said that the SP module determines the educational data and coupon data automatically upon receiving electronic prescription data according to one embodiment of the present invention. In one embodiment of the present invention, the determination of both the educational data and coupon data comprises the central portion 301 of the SP module searching one or more databases, such as the supplemental program database 303 or one of the databases 401, 402, 403, 404 of the appropriate third party content provider 400, for educational data and coupon data both relating to the prescribed substance. It should be noted that the determination of both the educational data and coupon data may be accomplished by the central portion 301 of the SP module using any combination of the first patient data, first prescribed substance data, first provider data, and first payor received from the electronic prescription data, potentially along with any of the additional (or second) data (patient data, prescribed substance data, provider data, and payor data) retrieved by the SP module.

In one embodiment of the present invention, the determination of educational data and coupon data for the prescribed substance requires the central portion 301 of the SP module to determine both educational data and coupon data for which the patient is eligible based on the electronic prescription. This is similar to as discussed above with reference to the determination of eligible supplemental programs. Therefore, in such embodiments, the educational data and coupon data may comprise rules that must be met in order for the educational data and coupon data to be eligible for the electronic prescription of the patient. Thus, in accordance with one embodiment of the present invention, the determination of both the educational data and coupon data may be accomplished by the SP module in a manner similar to as discussed above with reference to supplemental programs (FIG. 8a and steps 806-808).

However, the invention is not so limited, and in another embodiment of the present invention, the SP module simply transmits any combination of data (electronic prescription data and additional, retrieved data) to a third party system. This, in turn, causes the third party system to determine the educational data and/or the coupon data upon receiving the appropriate data from the SP module. Thus, in this embodiment of the present invention, the third party system determines the educational data and/or the coupon data that relates to the prescribed substance. Finally, upon determining the educational data and/or the coupon data, the third party system transmits the educational data and/or the coupon data to the SP module. Therefore, it may be said that the central portion 301 of the SP module receives the educational data and/or the coupon data from one or more of the databases 401, 402, 403, 404 of the appropriate third party content provider 400.

Upon determining the educational data and coupon data that relates to the prescribed substance, the central portion 301 of the SP module retrieves from one or more databases, such as the supplemental program database 303 or one of the databases 401, 402, 403, 404 of the appropriate third party content provider 400, the educational data and the coupon data. Thereafter, the central portion 301 of the SP module combines the educational data and the coupon data into a single data file, which may be considered a combined educational coupon since the file comprises both educational data and coupon data. It should be noted that when the central portion 301 of the SP module combines the educational data and the coupon data into a single data file, the central portion 301 of the SP module may combine a portion of or the entirety of the educational data and/or coupon data. Thus, the single data file may comprise just a portion of either or both of the educational data and the coupon data. Further, in one embodiment of the present invention, the single data file may be a text-based file, an image-based file, or a combined text and image based file. One example of a combined educational coupon is the EduSAVE™ 900 document exemplified in FIG. 9.

Further, in one embodiment of the present invention, prior to generating a single data file comprising the educational data and the coupon data, the central portion 301 of the SP module presents to a health care provider 101, in the display device 121, a list of the education data and the coupon data for selection and acceptance by the health care provider 101. Thereafter, the central portion 301 of the SP module generates the single data file, or the combined educational coupon, upon both the educational data and the coupon data being selected and accepted by the health care provider 101. It should be noted that this may be accomplished in any manner discussed above with reference to steps 811-814 of FIG. 8b. Finally, in one embodiment of the present invention, the central portion 301 of the SP module determines more than one separate portion of educational data and/or coupon data and presents the one or more educational data and/or coupon data to the health care provider 101 in a list via the display device 121. Thereafter, the health care provider 101 may select one or more of the educational data and/or coupon data, and the central portion 301 of the health care provider 101 combines the one or more of the educational data and/or coupon data into a single data file, the single data file being a combined educational coupon. Thus, the combined educational coupon is not limited to just one educational data file and one coupon data file, but may comprise more than one educational data file and/or coupon data file. Finally, after generating the combined educational coupon, the central portion 301 of the SP module may then store the combined education coupon in one or more databases (e.g., the records database 304 or the supplemental program database 303) of the SP system 300 for subsequent applications.

Finally, after the central portion 301 of the SP module has generated the single data file comprising the educational data and coupon data relating to the prescribed substance, the central portion 301 of the SP module may transmit the single data file to one or more systems or devices. These include, but are note limited to a pharmacy filling sub-system 502, an HCP system 100, and a patient computer device. It may be beneficial to transmit the single data file to a pharmacy filling sub-system 502 so that the patient does not have to remember to bring the combined educational coupon with them when picking up the prescription. Rather, the combined educational coupon is waiting for them at the pharmacy filling sub-system 502, such that the pharmacist may automatically deduct the coupon from the purchase price of the prescription and the educational material may be provided to the patient upon receiving their prescription. Further, it may be beneficial to transmit the single data file to the HCP system 100 so that the HCP system 100 may make the combined educational coupon available to patient while they are still in the presence of their health care provider 101. Therefore, if the patient has any questions or concerns, they may immediately speak with their health care provider 101 upon receiving the combined educational coupon. Finally, it may be beneficial to transmit the single data file to a patient computer device, such as a personal computer, smart phone, printer, fax machine, or other electronic device owned or controlled by the patient. This allows the patient to receive and view the combined educational coupon at their convenience.

Nonetheless, it should be noted that in accordance with one embodiment of the present invention, the central portion 301 of the SP module generates a combined educational coupon using the process described above with respect to supplemental programs. In such embodiments, the central portion 301 of the SP module parses out educational information data from an eligible supplemental program that relates to educational material, and coupon data from an eligible supplemental program that relates to a coupon. Thereafter, the central portion 301 of the SP module combines the educational information data and the coupon data, potentially along with other general data (e.g., provider data, patient data, etc.) into a single data file to create the combined educational coupon. Thereafter, the central portion 301 of the SP module may store the combined education coupon in the supplemental program database 303 of the SP system 300 for subsequent applications. Further, after creating the combined educational coupon, the central portion 301 of the SP module may transmit the combined educational coupon to the HCP system 100 as a single data file.

Further, it should be noted that in one embodiment of the present invention, the central portion 301 of the SP module may be considered a non-transitory computer-readable storage medium that is encoded with instructions which, when executed by the processor 311, perform a method of receiving data relating to an electronic prescription of a prescribed substance for a patient; searching one or more databases for educational data relating to the prescribed substance and coupon data relating to the prescribed substance; determining educational data relating to the prescribed substance and coupon data relating to the prescribed substance; retrieving from the one or more databases the educational data relating to the prescribed substance and the coupon data relating to the prescribed substance; and generating a single data file comprising the educational data relating to the prescribed substance and the coupon data relating to the prescribed substance.

Finally, it should be noted that in one embodiment of the present invention, the SP system 300 may be considered a computer system for electronically generating educational coupons for a prescribed substance, which comprises a processor 311; a storage device 313; a network interface 312; and instructions residing on the storage unit 313, which when executed by the processor 311, causes the processor 311 to: a) receive electronic prescription data for a prescribed substance for a patient; b) determine educational data relating to the prescribed substance and coupon data relating to the prescribed substance; and c) generate a single data file comprising the educational data relating to the prescribed substance and the coupon data relating to the prescribed substance.

Tailoring General and Specific Educational Content

As noted above, the supplemental programs comprise both general educational content and specific educational content. In one embodiment of the present invention, the general educational content comprises information relating to the prescribed substance, while the specific educational content comprises information relating, not only to the prescribed substance, but also the specific diagnostic reason(s) that the substance was prescribed to the patient, such as but not limited to, the specific disease(s) for which the substance was prescribed, along with a wide variety of signs, symptoms, abnormal findings, complaints, social circumstances, and external causes of injury or disease for which the substance was prescribed. Thus, the educational content (or material), both general and specific, is tailored to the specific needs and diagnoses of the patient.

Similar to as discussed above and according to one embodiment of the present invention, after an electronic prescription for the substance is created by a health care provider 101, the SP widget 302 retrieves data relating to the electronic prescription from the thin-client portion of the EP module 203. Further, the SP widget 302 may also retrieve a diagnostic code that is entered by the health care provider 101. Specifically, the provider 101 enters a diagnostic code into the SP widget 302 using the input device 122 of the terminal 120. The diagnostic code may be entered prior to, during, or after the creation of the electronic prescription by the health care provider 101.

A diagnostic code is a string of characters and/or numbers that are used to represent medical diseases and/or a wide variety of signs, symptoms, abnormal findings, complaints, social circumstances, and external causes of injury or disease. According to one embodiment, the diagnostic code is entered or provided by the health care provider 101 and provides a more specific reasoning as to why the patient is being prescribed a particular substance. For example, in one embodiment, the diagnostic code is an International Classification of Diseases, Ninth Revision (ICD-9) code entered by the provider 101 during the patient's visit.

After receiving data relating to an electronic prescription and a diagnostic code, the SP widget 302 then transmits the electronic prescription data and the diagnostic code to the central portion 301 of the SP module residing on the SP system 300, such that the central portion 301 of the SP module receives the electronic prescription data and the diagnostic code. It should be noted that the diagnostic code may, but does not necessarily have to be received in conjunction with the electronic prescription data. As discussed in detail above, the electronic prescription data comprises first patient data that is specific to the patient, first prescribed substance data that is specific to the prescribed substance, first provider data that is specific to the provider 101, and first payor data that is specific to the payor. Further, in one embodiment of the present invention, the electronic prescription data further comprises a National Drug Code identifier of the prescribed substance. The National Drug Code identifier is a unique product identifier for prescribed substances that are intended for human use. Finally, it should be noted that in one embodiment of the present invention, the electronic prescription data comprises the diagnostic code.

Further, in an alternate embodiment of the present invention, the electronic prescription data does not relate to an electronic prescription currently being prescribed by a health care provider 101 for a patient, but rather relates to a refill, a renewal, or a previously prescribed substance. In such embodiments, the electronic prescription data may be received by the SP module from one of the other databases of the system 1000 (e.g., the EP database 201, the records database 304, the patient prescription history database 505, etc.). Stated another way, the electronic prescription data may, but does not necessarily have to be generated by a health care provider 101.

Once the central portion 301 of the SP module receives the electronic prescription data and the diagnostic code, the central portion 301 of the SP module retrieves additional data prior to determining general and specific educational data. As discussed in more detail above, the additional (or second) data may comprise one or more of patient data, prescribed substance data, provider data, and payor data. Further, the additional (or second) patient data may comprise patient adherence data. According to one embodiment of the present invention, the additional (or second) data is retrieved by the SP module from the records database 304 of the SP system 300. However, it should be noted that the invention is not so limited and in alternate embodiments, the central portion 301 of the SP module may only retrieve a portion of the data listed herein or may not retrieve any additional data prior to determining general and specific educational data.

After receiving electronic prescription data and the diagnostic code, and possibly after retrieving additional data from the records database 304, the central portion 301 of the SP module searches one or more databases, such as the supplemental program database 303 or one of the databases 401, 402, 403, 404 of the appropriate third party content provider 400, for general educational data and specific educational data both relating to the prescribed substance. The general educational data relates to the prescribed substance, but is independent of the diagnostic code. Thus, the general educational data comprises broad and wide-ranging information that relates generally to the prescribed substance or the disease state for which the substance was prescribed to the patient. For example, general educational data may comprise information relating to high blood pressure in general.

By contrast, the specific educational data relates to the prescribed substance and is based on the received diagnostic code. Thus, the specific educational data comprises specific information about the particular prescribed substance or the disease state of the prescribed substance, and is particular to the exact reasons for which the provider 101 has written the prescription for the patient. For example, specific educational data may comprise information relating to malignant hypertension or renal hypertension, whereby the general educational data simply relates to high blood pressure in a broader or more general sense. Stated another way, the specific educational content may relate to one or more of the specific disease(s) for which the substance was prescribed, and/or the signs, symptoms, abnormal findings, complaints, social circumstances, and/or external causes of injury or disease for which the substance was prescribed to the patient. Further, as discussed in detail above, the educational data (both general and specific) may relate to an educational document or an educational service, as discussed above in more detail.

It should be noted that the determination of both the general and specific educational data may be accomplished by the central portion 301 of the SP module using any combination of the diagnostic code, the first patient data, first prescribed substance data, first provider data, and first payor received from the electronic prescription data, potentially along with any of the additional (or second) data (patient data, prescribed substance data, provider data, and payor data) retrieved by the SP module. Further, in one embodiment of the present invention, the general educational data is searched using the National Drug Code identifier, along with any combination of the electronic prescription data and retrieved data discussed above. Similarly, it should be noted that the specific educational data is searched using the diagnostic code received by the central portion 301 of the SP module, along with any combination of the electronic prescription data and retrieved data discussed above.

In one embodiment of the present invention, in order for the central portion 301 of the SP module to determine both the general educational data and the specific educational data, the central portion 301 of the SP module must also determine which general and specific educational data the patient is eligible for based on the electronic prescription. This is similar to as discussed above with reference to the determination of eligible supplemental programs. Therefore, in such embodiments, the general educational data and the specific educational data may comprise rules that must be met in order for the general educational data and the specific educational data to be eligible for the electronic prescription of the patient. Moreover, in accordance with one embodiment of the present invention, the determination of both the general educational data and the specific educational data may be accomplished by the central portion 301 of the SP module in a manner similar to as discussed above with reference to supplemental programs (FIG. 8a and steps 806-808).

However, the invention is not so limited, and in another embodiment of the present invention, the SP module simply transmits any combination of data (electronic prescription data, diagnostic code, National Drug Code identifier, and additional, retrieved data) to a third party system. This, in turn, causes the third party system to determine the general educational data and/or the specific educational data upon receiving the appropriate data from the SP module. Thus, in this embodiment of the present invention, the third party system determines the general educational data and/or the specific educational data that relates to the prescribed substance. Finally, upon determining the general educational data and/or the specific educational data, the third party system transmits the general educational data and/or the specific educational data to the SP module. Therefore, it may be said that the central portion 301 of the SP module receives the general educational data and/or the specific educational data from one or more of the databases 401, 402, 403, 404 of the appropriate third party content provider 400.

Upon determining the general educational data and the specific educational data that relates to the prescribed substance and the diagnostic code, the central portion 301 of the SP module retrieves from one or more databases, such as the supplemental program database 303 or one of the databases 401, 402, 403, 404 of the appropriate third party content provider 400, the general educational data and the specific educational data. According to one embodiment of the present invention, the central portion 301 of the SP module retrieves two data files, a first data file that is the general educational data and a second data file that is the specific education data. Thereafter, the central portion 301 of the SP module may combine the first data file (general educational data) and the second data file (specific educational data) into a single data file, thus creating a single data file that comprises both general educational data and specific educational data. It should be noted that when the central portion 301 of the SP module combines the general and specific educational data into a single data file, the central portion 301 of the SP module may combine a portion of or the entirety of the general educational data and the specific educational data. Thus, the single data file may comprise just a portion of either or both of the general and specific educational data. Moreover, according to one embodiment of the present invention, the central portion 301 of the SP module may combine one or more general education data file with one or more specific educational data file. However, it should be noted that the invention is not so limited, and in some embodiments of the present invention, the general educational data and the specific educational data is not combined into a single data file.

Further, in one embodiment of the present invention, the central portion 301 of the SP module presents to a health care provider 101, in the display device 121, a list that comprises the general education data and the specific educational data for selection and acceptance by the health care provider 101. In such embodiments, each of the general education data and the specific education data presented in the display device 121 is selectable and de-selectable by the health care provider 101 using the input device 122. It should be noted that the display of the list and the selection and acceptance of the general and specific educational data may be accomplished in any manner similar to as discussed above with reference to supplemental programs in steps 811-814 of FIG. 8b. Further, it should be noted that the list is not limited to only one general educational data file and one specific educational file, but rather may include any number of general and/or specific educational files for selection and acceptance by the health care provider 101.

According to one embodiment of the present invention, after a list of the general education data and the specific educational data is presented in the display device 121 to the health care provider 101 for provisioning to the patient, the central portion 301 of the SP module makes the general educational data and the specific educational data that is selected and confirmed by the health care provider 101 available to the patient. In one embodiment, this is accomplished by the SP module transmitting the general education data and the specific educational data that is selected and confirmed by the health care provider 101 to a patient computer device. This may be accomplished using at least one of email, SMS, WAP, and a mobile application.

Therefore, the diagnostic code may be used, in addition to the electronic prescription data and any additional retrieved data, by the central portion 301 of the SP module to determine if there is both general educational data and specific educational data for which the patient is eligible. Therefore, by using a diagnostic code (e.g., the ICD-9 code) to determine if there is any eligible specific educational data relating to why the prescribed substance was prescribed to the patient, the present invention may provide both general and specific educational material to the patient. For instance, the patient may receive general information relating to the substance they are being prescribed or the disease state in which they are diagnosed, while also receiving specific educational material directed to the specific reason(s) the patient has been prescribed the particular substance. This is beneficial because the educational documents and/or services help the patient in understanding not only their general health concerns and prescribed substances, but also their specific health concerns along with their specific diagnoses. Thus, the educational material (both general and specific) that is made available to the patient may be tailored to the specific needs and diagnoses of the patient.

Further, it should be noted that in one embodiment of the present invention, the central portion 301 of the SP module may be considered a non-transitory computer-readable storage medium that is encoded with instructions which, when executed by the processor 311, perform a method of receiving electronic prescription data for a prescribed substance for a patient, said electronic prescription data including a diagnostic code; searching one or more databases to determine: (1) general educational data relating to the prescribed substance independent of the diagnostic code; and (2) specific educational data relating to the prescribed substance based on the diagnostic code; and presenting to a health care provider, in a display device, a list of the general educational data and the specific educational data determined in step b) for provisioning to the patient.

Finally, it should be noted that in one embodiment of the present invention, the SP system 300 may be considered a computer system for electronically generating educational coupons for a prescribed substance, which comprises a processor 311; a storage device 313; a network interface 312; and instructions residing on the storage unit 313, which when executed by the processor 311, causes the processor 311 to: a) receive electronic prescription data for a prescribed substance for a patient, said electronic prescription data including a diagnostic code; b) search one or more databases to determine: (1) general educational data relating to the prescribed substance independent of the diagnostic code; and (2) specific educational data relating to the prescribed substance based on the diagnostic code; and c) present to a health care provider, in a display device, a list of the general educational data and the specific educational data determined in step b) for provisioning to the patient.

Method of Using Cohorts to Determine Effectiveness of Supplemental Programs

According to another embodiment of the present invention, the system 1000 described above may be used to determine the effectiveness of supplemental programs on patient adherence through the use of a plurality of cohorts. Generally, as used herein, a cohort is a group of health care providers 101 who activate the same supplemental programs for a particular prescribed substance. As discussed in more detail below, in accordance with one embodiment of the present invention a plurality of cohorts, each comprising different permutations (or groupings) of supplemental programs, are used to determine the respective effectiveness of the different permutations of supplemental programs on patient adherence to one or more prescribed substances.

According to one embodiment of the present invention, a method of determining the effectiveness of a plurality of available supplemental programs on patient adherence comprises four steps: (1) defining a plurality of cohorts, each cohort comprising at least one health care provider; (2) receiving data relating to an electronic prescription of the one or more prescribed substances generated by a health care provider and activating the supplemental programs associated with the cohort to which the health care provider belongs; (3) receiving patient adherence data relating to electronic prescriptions for the one or more prescribed substances issued by the plurality of health care providers; and (4) analyzing the patient adherence data to determine the effectiveness of the different permutations of the supplemental programs on patient adherence.

Although the processes and functions described below are described and exemplified as being performed by the SP module in general, it should be understood that the invention is not so limited, and in alternate embodiments the processes and function described herein with reference to cohorts may be preformed by any single portion, the central portion 301 or the SP widget 302, or a combination of the portions of the SP module.

Referring to FIG. 4, it should be noted that the memory 313 of the server 310 of the SP system 300 further comprises a cohort database 305, a Patient Adherence Generation Module 306, and a patient adherence database 307. As explained in more detail below, the cohort database 305 stores, among other things, information relating to a plurality of health care providers 101 who are part of at least one cohort, along with information relating to each of the cohorts defined by the SP module. For instance, after defining the cohorts, the SP module stores information relating to each cohort (e.g., the target drug data, the provider cohort data, the assigned health care providers 101, the assigned permutation of supplemental programs, the cohort rules, the maximum counter, etc.) in the cohort database 305 of the SP system 300.

As also discussed in more detail below, the Patient Adherence Generation Module 306 receives data relating to the patient's prescription history for the target drug from the pharmacy system 500 and/or the payor system 600. This information is referred to as patient medication history data. After receiving the patient medication history data, the Patient Adherence Generation Module 306 stores the patient medication history data in one or more databases, such as, but not limited to the patient adherence database 307. Thereafter, the Patient Adherence Generation Module 306 analyzes the patient medication history data to generate patient adherence data from the received patient medication history data. Finally, the Patient Adherence Generation Module 306 stores the patient adherence data in the patient adherence database 307 for further processing. In certain embodiments, the Patient Adherence Generation Module 306 obtains all of the drug fill data that it can for a patient for all drugs, not just the drugs for which the patient has prescriptions. Although in the exemplified embodiment the Patient Adherence Generation Module 306 does not use the data for drugs without a known prescription, it is contemplated that in certain other embodiments the Patient Adherence Generation Module 306 could use the data from both drugs with a known prescription and drugs without a known prescription.

Generally, and as discussed in more detail below, patient medication history data comprises information relating to the medication history of the patient and the patient's fill history for various prescriptions. As also discussed in more detail below, patient adherence data comprises information relating to the patient's adherence to previous prescriptions. Although sometimes described with reference to the target drug of a cohort, it should be noted that the patient medication history data and patient adherence data is not so limited, and in alternate embodiments of the present invention the patient medication history data and/or the patient adherence data may refer to prescriptions for any substances of the patient. Moreover, it should be noted that the patient adherence database 307 may store patient adherence data relating to various different cohorts for the same target drug, along with patient adherence data relating to various different cohorts for different target drugs. One non-limiting example of a Patient Adherence Generation Module 306 is the HMACS™ system by DrFirst®.

As discussed in more detail below, the Patient Adherence Generation Module 306 receives the patient medication history data either directly or indirectly from another system, such as but not limited to the pharmacy system 500) and the payor system 600. After receiving the patient medication history data, the Patient Adherence Generation Module 306 generates the patient adherence data using one or more algorithms that are stored in the patient adherence database 307. Thereafter, the SP module receives the patient adherence data from the patient adherence database 307 so that the SP module may parse and analyze the patient adherence data by cohort to determine the effectiveness of a plurality of different permutations of supplemental programs on patient adherence.

As noted above and as discussed in more detail below, the patient adherence database 307 stores information relating to one or more previously prescribed substances of one or more patients, such as, but not limited to patient medication history data and patient adherence data. It should be noted that in other embodiments of the present invention, prescription data, patient medication history data, and patient adherence data may be stored on separate databases.

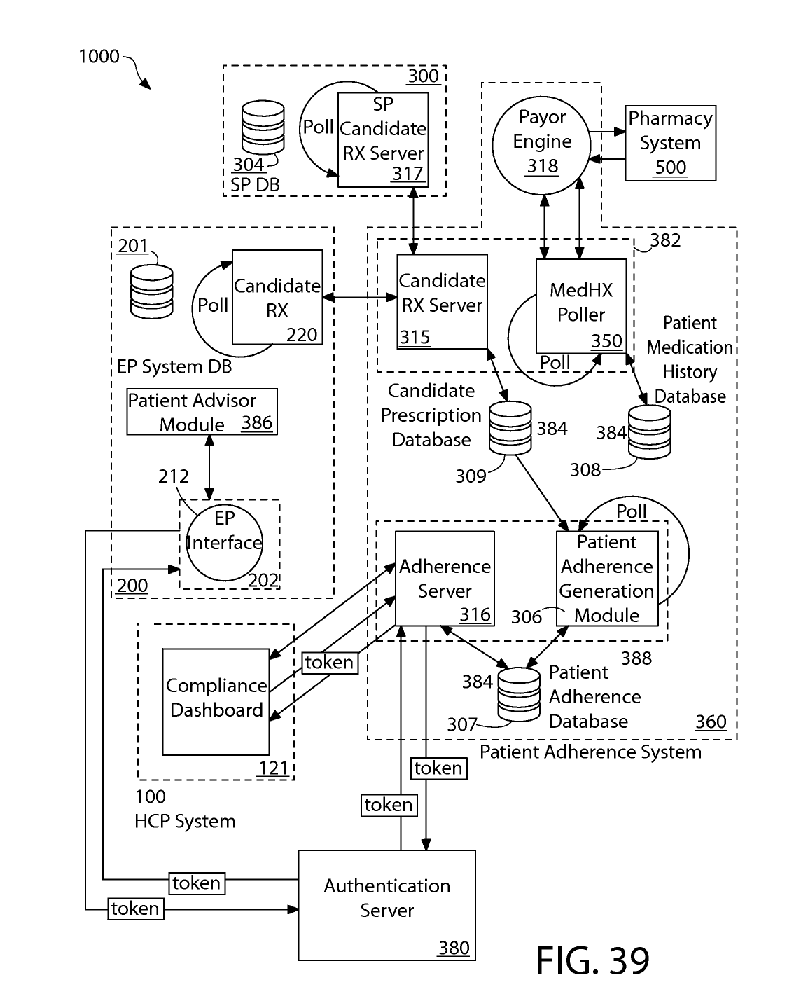

Since, in the exemplified embodiment of FIG. 4, the Patient Adherence Generation Module 306 resides within the memory 313 of the SP system 300, it may be said that the SP system 300 receives patient medication history data, parses the patient medication history data, and analyzes the data to generate adherence data for the patient for the target drug. Nonetheless, it should be noted that in other embodiments of the present invention, the Patient Adherence Generation Module 306 may reside on another system or within its own system as part of system 1000. Similarly, in other embodiments of the present invention, the adherence database 307 may also reside within the memory of another system of system 1000. For example, according to one embodiment of the present invention and as discussed in more detail below, the Patient Adherence Generation Module 306 resides on a separate system as part of the system 1000, and the adherence database 307 resides within the memory of the separate system, such that the Patient Adherence Generation Module 306 and adherence database 307 reside on their own separate system (e.g., a patient adherence system). In one embodiment, as shown in FIG. 39 and described below, the separate system may be patient adherence system 360.

1. Defining a Plurality of Cohorts

As noted above, the first step of determining the effectiveness of a plurality of supplemental programs on patient adherence comprises the defining (or creating) of a plurality of cohorts, whereby each cohort comprises a plurality of health care providers 101. Generally, the process of defining the plurality of cohorts comprises two steps: (1) assigning a sub-set of a plurality of health care providers 101 to each of the plurality of cohorts; and (2) assigning a different permutation of supplemental programs to each of the plurality of cohorts.

As used herein, the plurality of cohorts is used to test the effectiveness of different permutations of supplemental programs on patient adherence to a particular substance or a plurality of prescribed substances for a particular disease state. Therefore, each cohort out of the plurality of cohorts (of the same program cohort group) all relate to the same prescribed substance(s). For example, a particular prescribed substance, such as Lipitor®, may be assigned to a plurality of cohorts (of the same program cohort group), so that different permutations of supplemental programs may be tested to determine their effectiveness on the patients' adherence to Lipitor®. For further example, a plurality of prescribed substances, such as Lipitor®, Lescol®, Mevacor®, Pravachol®, and Zocor®, for the same disease state, high cholesterol, may be assigned to a plurality of cohorts so that different permutations of supplemental programs may be tested to determine their effectiveness on the patients' adherence to the prescribed substance for that particular disease state (high cholesterol).

It should be noted that when a plurality of cohorts are all related to one another (e.g., are used together as a single test group for the same prescribed substance(s)) they are considered to be part of the same program cohort group. Therefore, according to one embodiment of the present invention, a program cohort group is a group of a plurality of cohorts for the same prescribed substance or plurality of prescribed substances for a particular disease state. However, it should be noted that there may be different program cohort groups that relate to the same prescribed substance. Further, as discussed in more detail below, the related program cohort group for each of the plurality of cohorts is stored within the cohort database 305 of the SP system 300.

As noted above, each cohort of a plurality of cohorts is assigned a sub-set of health care providers 101. Further, as discussed in more detail below, each sub-set of health care providers 101 has a commonality of prescribing factors with relation to the prescribed substance(s) of the program cohort group. It should be noted that although a provider 101 may be associated with only one out of a plurality of cohorts for a particular prescribed substance (or plurality of prescribed substances for a particular disease state), a provider 101 may be a part of other, unrelated program cohort groups. Stated more simply, a provider 101 may only be associated with one cohort of a particular program cohort group, but the provider 101 may be associated with different cohorts of different program cohort groups.

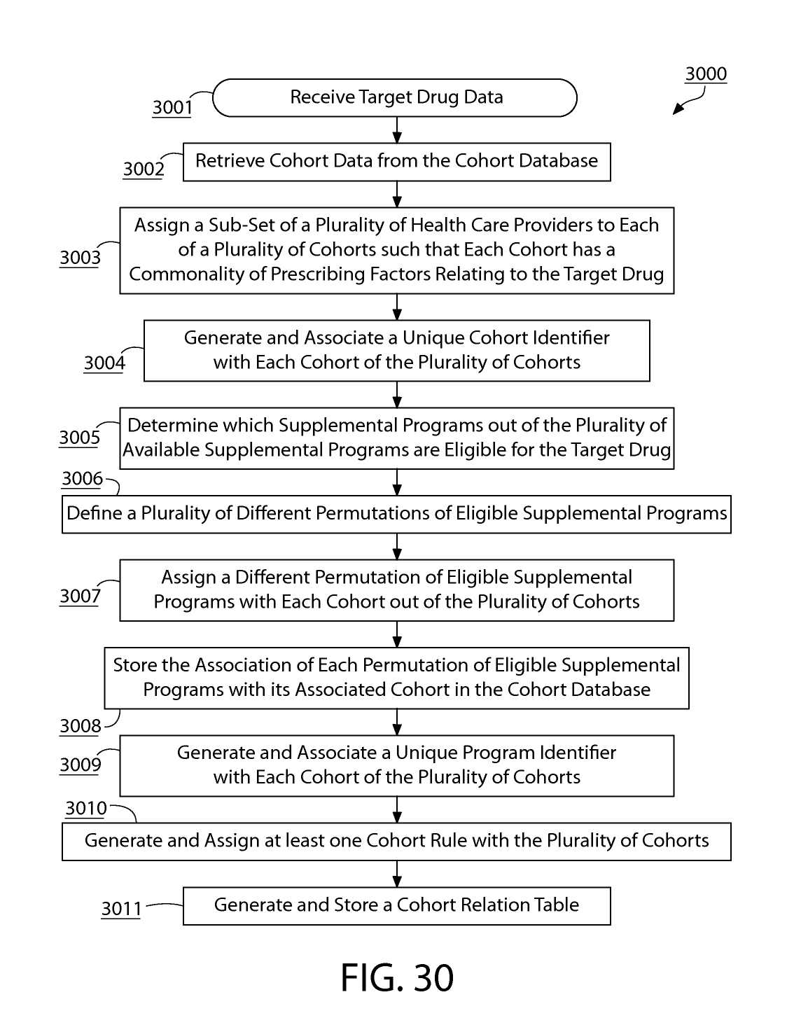

Referring to FIG. 30, a flow chart of a method 3000 for defining a plurality of cohorts of a program cohort group according to one embodiment of the present invention is illustrated. To begin, the SP module first receives target drug data, thereby completing step 3001. The target drug data comprises information relating to a particular prescribed substance or a plurality of prescribed substances for a particular disease state to which the plurality of cohorts will relate. After receiving the target drug data, the SP module stores the target drug data in the cohort database 305 of the SP system 300 in correlation with a program cohort group.

Therefore, the target drug data defines for which prescribed substance(s) the effectiveness of the available supplemental programs on patient adherence will be analyzed by the SP module. Stated another way, the SP module defines a plurality of cohorts to analyze the effectiveness of the available supplemental programs on patient adherence for only the prescribed substance(s) identified by the target drug data. For example, using the examples set forth above, the target drug data may be just Lipitor® or it may be the combination of Lipitor®, Lescol®, Mevacor®, Pravachol®, and Zocor®. For purposes of simplicity, the term “target drug” will be used to denote the particular prescribed substance or the plurality of prescribed substances for a particular disease state that is defined by the received target drug data. Thus, the term target drug may comprise one or more than one prescribed substance.

According to one embodiment of the present invention, the target drug data is received by the SP module via inputs from the administrator of the SP system 300. It should be noted that an administrator of the SP system 300 may be one or more individuals who have access to and may control the SP system 300 (including the modules residing thereon). In such embodiments, by defining the target drug data, the administrator of the SP system 300 selects the particular prescribed substance(s) that will be used for the cohorts of a program cohort group. It should be noted that the invention is not so limited, and in alternate embodiments the SP module may receive the target drug data from a pharmaceutical company or the target drug data may be derived jointly by both the administrator of the SP system 300 and a third party (e.g., a pharmaceutical company).

Still referring to FIG. 30, after the SP module receives the target drug data, the SP module retrieves provider cohort data from the cohort database 305 of the SP system 300, thereby completing step 3002. As discussed in more detail below, the provider cohort data comprises information relating to each of the plurality of health care providers 101, and more specifically, comprises information relating to the provider's history of prescribing the target drug.

According to one embodiment of the present invention, the provider cohort data comprises a decile level for one or more prescribed substances and/or a medical specialty of the health care provider 101. As understood in the art, a decile level is a rating or level, on a scale from 1 to 10, for which the provider 101 has prescribed a particular prescribed substance or prescribed substances for a particular disease state. For example, a provider 101 who has prescribed Lipitor® more than another provider 101 will have a higher decile level. Therefore, the SP module assigns a sub-set of the plurality of health care providers 101 to each of the plurality of cohorts such that the average decile level of the health care providers 101 assigned to each cohort of a program cohort group is similar. By assigning health care providers 101 to the cohorts based on their decile level, each of the plurality of cohorts of a program cohort group has a commonality of prescribing factors relating to the target drug. However, as discussed below, the invention is not so limited and in alternate embodiments, the SP module assigns health care providers 101 to a cohort based on other factors so long as each cohort of a program cohort group has a commonality of prescribing factors.

As noted above, the use of a decile level is one way to define the cohorts such that there is a commonality of prescribing factors between the health care providers 101 of each cohort of a program cohort group. The present invention may utilize any number of other methods to assign health care providers 101 such that each cohort has a commonality of prescribing factors. Therefore, the commonality of prescribing factors relates to the target drug, ensures that each cohort has a similar cross-section of providers 101 as they relate to the target drug, and may be defined by the SP module in any manner. For example, the SP module may define the commonality of prescribing factors between the plurality of health care provider 101 as a decile level, as a rate of prescription of the prescribed substance(s) defined by the target drug data, or a total number of prescriptions written by each provider 101 for the prescribed substance(s) defined by the target drug data. A commonality of prescribing factors could also be determined by the age groups of the prescriber's patients, or age and demographics of the town in which the prescriber is located.

Still Referring to FIG. 30, after retrieving the provider cohort data relating to each of the plurality of health care providers 101, the SP module assigns a sub-set of a plurality of health care providers 101 to each of a plurality of cohorts based on the retrieved provider cohort data, thereby completing step 3003. Stated another way, the SP module assigns at least one health care provider 101, and preferably more than one health care provider 101 to each of the plurality of cohorts of a program cohort group. In one embodiment of the present invention, the SP module assigns the health care providers 101 to the plurality of cohorts using the provider's NPI numbers. After assigning a sub-set of the plurality of providers 101 to each of the cohorts of a program cohort group, the SP module stores the provider's NPI number in the cohort database 305 in association with the a cohort identifier, as discussed below in more detail. However, the invention is not so limited and in alternate embodiments the assignment of health care providers 101 to cohorts may be done using name or any other identifying factor of the health care providers 101.

Further, it should be noted that the plurality of health care providers 101 that is broken down in sub-sets and assigned to the cohorts of a program control group may be chosen by the SP module via one or more methods. For example, the plurality of health care providers 101 may be selected using geographic location, commonality of prescribing factors, and/or input by an administrator of the SP module.

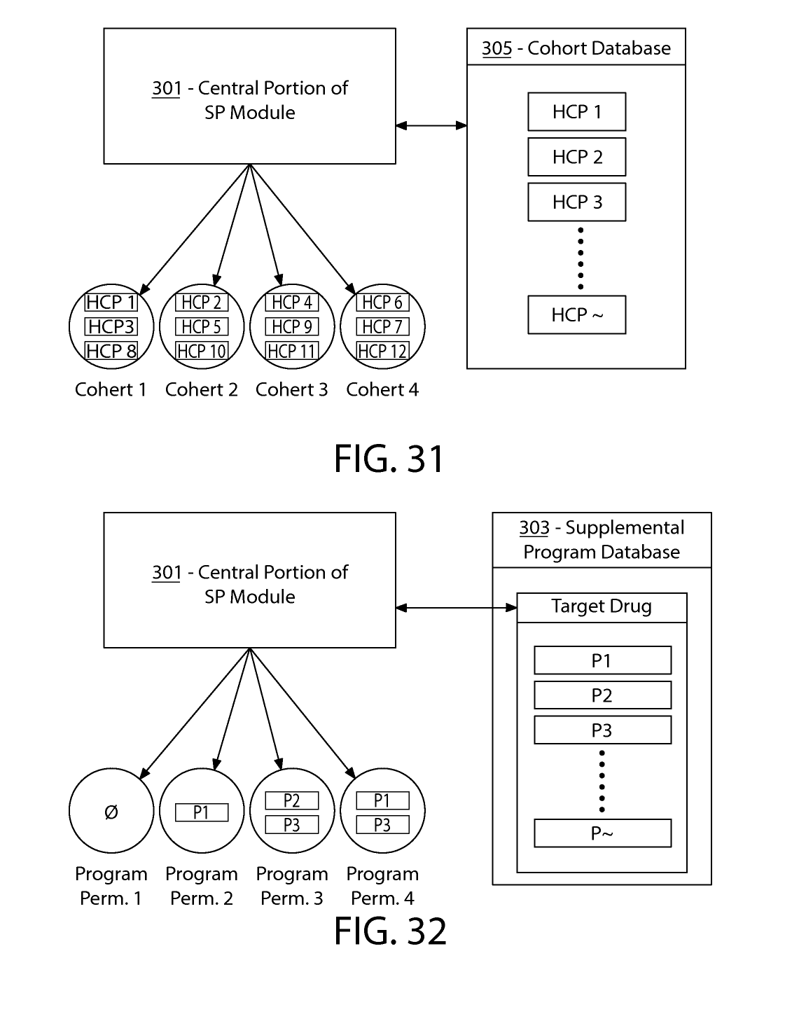

Referring to FIG. 31, a schematic diagram depicting how the SP module defines a plurality of cohorts according to one embodiment of the present invention is illustrated. The SP module retrieving provider 101 information (e.g., provider NPI numbers) from the cohort database 305 or the records database 303. After retrieving the provider 101 information, the SP module defines a plurality of cohorts such that each of the plurality of cohorts comprises a sub-set of the plurality of health care providers 101. It should be noted that in the preferred embodiment, each of the plurality of health care providers 101 is assigned to only one cohort of a program cohort group. For example, as shown in FIG. 31, cohort 1 is defined to comprise health care providers (HCP) 101 number 1, 3 and 8, cohort 2 is defined to comprise HCP 101 number 2, 4, and 10, cohort 3 is defined to comprise HCP 101 number 5, 9, and 11, and cohort 4 is defined to comprise HCP 101 number 6, 7, and 12. Although not exemplified, the health care providers 101 are assigned to each of the cohorts such that each cohort has a commonality of prescribing factors between their assigned providers 101.

Although four cohorts are defined by the SP module in the example exemplified by FIG. 31, the invention is not so limited and in alternate embodiments the SP module may define any number of cohorts for a particular program cohort group. Stated another way, the plurality of cohorts comprises at least two cohorts and may comprise any number of cohorts. Further, although each cohort of FIG. 31 is assigned only three health care providers 101, the invention is not so limited and in alternate embodiments, each cohort may be defined to comprise any number of health care providers 101 so long as each cohort has a commonality of prescribing factors between its assigned health care providers 101. Therefore, according to one embodiment of the present invention, different cohorts of a program cohort group may comprise a different number of health care providers 101.

Referring back to FIG. 30, and as mentioned above, after assigning a sub-set of health care providers 101 to each of the plurality of cohorts, the SP module generates a cohort identifier for each of the plurality of cohorts. In one embodiment, the cohort identifier is a unique string of numbers used by the SP module to identify that particular cohort. After generating a cohort identifier for each of the plurality of cohorts, the SP module associates the cohort identifier with each of the plurality of health care providers 101 of that particular cohort, thereby completing step 3004. Therefore, each health care provider 101 of a sub-set of health care providers 101 of a particular cohort is associated with the same unique cohort identifier of that cohort. Thereafter, the SP module stores the association of health care provider 101 (e.g. NPI number) and cohort identifier in the cohort database 305 of the SP system 300. As a result, and as discussed in more detail below, the SP module may more easily identify the associated cohort of a particular health care provider 101 using the provider's associated cohort identifier stored in the cohort database 305.

As noted above and in accordance with one embodiment of the present invention, the assignment of providers 101 between cohorts is accomplished by the SP module via inputs from the administrator of the SP system 300. In one embodiment, the instructions from the administrator of the SP system 300 specify which provider 101 is assigned to which cohort. In another embodiment, the instructions from the administrator of the SP system 300 specify rules by which the providers 101 will be assigned to each cohort (e.g., geographic location, specialty, prescribing history of the target drug, etc.). In yet another embodiment of the present invention, the SP module does not receive instructions, but rather automatically assigns providers 101 to each cohort using an algorithm stored within the cohort database 305, such that each cohort has a commonality of prescribing factors.

After assigning a sub-set of a plurality of health care providers 101 to each of the cohorts, the SP module assigns a different permutation of eligible supplemental programs to each cohort. As discussed above, the supplemental program database 303 of the SP system 300 stores general supplemental program data, including, but not limited to the name of the supplemental program, general information relating to the supplemental program, and the rules of each supplemental program. As noted above, each supplemental program comprises rules (non-cohort rules), such as a particular prescribed substance(s) for which the program is eligible and information relating to which patients are eligible for the supplemental program.

Still referring to FIG. 30, prior to assigning a different permutation of eligible supplemental programs to each cohort, the SP module determines which supplemental programs out of the plurality of available supplemental programs are eligible for target drug of the plurality of cohorts, thereby completing step 3005. According to one embodiment of the present invention, eligibility is determined by the SP module based on the target drug defined by the received target drug data. Therefore, the SP module determines which supplemental programs out of the available supplemental programs are eligible for the cohorts based on the received target drug data.

After determining which of the available supplemental programs are eligible for the plurality of cohorts based on the received target drug data, the SP module retrieves information relating to the plurality of eligible supplemental programs from the supplemental program database 303 of the SP system 300. After retrieving information relating to the plurality of eligible supplemental programs, the SP module defines a plurality of different permutations of the eligible supplemental programs, whereby the number of permutations of eligible supplemental programs equals the number of difference cohorts of the program cohort group, thereby completing step 3006. Therefore, the SP module creates an equal number of permutations of eligible supplemental programs and cohorts. Finally, after defining a plurality of different permutations of the eligible supplemental programs for the target drug, the SP module assigns a different permutation of supplemental programs with each cohort of the program cohort group, thereby completing step 3007.

According to one embodiment of the present invention, the SP module receives instructions regarding how to define the different permutations of eligible supplemental programs from the administrator of the SP system 300. For example, the administrator of the SP system 300 may transmit instructions to the SP module which dictate the exact configurations of each of the different permutations of eligible supplemental programs. This may be beneficial if the administrator would like to test specifically the effectiveness of particular combinations of supplemental programs on patient adherence. In such embodiments, if the instructions comprise the specific permutations of eligible supplemental programs, then the SP module may not have to determine which supplemental programs are eligible for the target drug, define a plurality of different permutations, and/or assign the different permutations to each of the cohorts.

In the preferred embodiment of the present invention, one of the permutations of supplemental programs is created such that the cohort of which it is associated is a control group. A control group is a cohort which is assigned a permutation of supplemental programs that either does not comprise any supplemental programs or comprises one or more supplemental programs that are also common to all of the plurality of permutations of supplemental programs assigned to the other cohorts of the program cohort group. Stated another way, a permutation of supplemental programs may be used as a control group if: (1) it does not comprise any supplemental programs, or (2) only comprises supplemental programs that are also included in each of the other permutations of supplemental programs of a program cohort group. The use of a control group is beneficial because it provides a baseline for the SP module to analyze the effectiveness of the other supplemental programs on patient adherence. Nonetheless, although it is preferred that one of the plurality of cohorts is a control group, it should be noted that in alternate embodiments of the present invention a control group may be omitted.

Further, according to one embodiment of the present invention, each cohort further comprises a current counter and a maximum counter. The maximum counter defines/stores the maximum number of times the permutation of supplemental programs for a cohort may be activated by the SP module, while the current counter defines/stores the number of times the permutation of supplemental programs for a particular cohort has been activated to date. Therefore, by using both a current count and a maximum counter, the SP module may ensure that the permutation of supplemental programs for each cohort of a program cohort group get activated an equal number of times. As discussed in more detail below, by limiting the total number of times the SP module may activate the permutation of supplemental programs for each cohort, each permutation of supplemental programs will have been activated the same number of times when the SP module determines the effectiveness of each permutation. This helps to provide a more accurate representation of the effectiveness of the supplemental programs on patient adherence. Further, in one embodiment of the present invention, when the current counter of all the cohorts of a program cohort group reach the maximum counter, the SP module ceases to activate the permutations of supplemental programs for the cohorts of the program cohort group, and analyzes patient adherence data to determine the effectiveness of the different permutations of the supplemental programs on patient adherence.

Referring to FIG. 32, a schematic diagram of a method of defining a plurality of different permutations of eligible supplemental programs for a target drug according to one embodiment of the present invention is illustrated. As exemplified, the SP module retrieves supplemental program data from the supplemental program database 303, the supplemental program data relating to supplemental programs which are eligible for the target drug. After retrieving the supplemental program data, the SP module defines a plurality of different permutations of eligible supplemental programs. This may be accomplished by the rules engine of the SP module or via instructions received by the SP module from the administrator of the SP system 300, as discussed in detail above.

Referring to FIG. 32, the permutations of supplemental programs are defined by the SP module such that permutation number 1 does not comprise any eligible supplemental programs, permutation number 2 comprises supplemental program number 1, permutation number 3 comprises supplemental program number 2 and 3, and permutation number 4 comprises supplemental program number 1 and 3. It should be noted that FIG. 32 is but just one example of the SP module defining a plurality of different permutations of supplemental programs. It should be noted that the present invention is not limited to the number of permutations of supplemental programs or the number of supplemental programs per permutation.

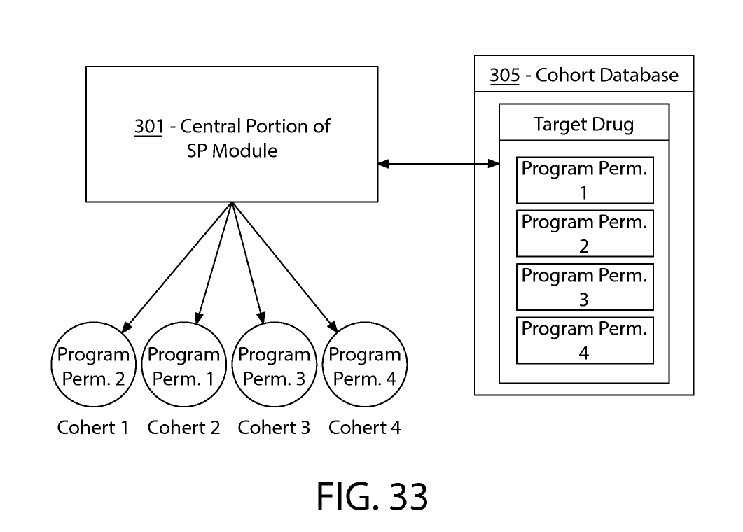

Referring to FIG. 33, a schematic diagram of a method of assigning a different permutation of eligible supplemental programs to each cohort out of a plurality of cohorts of a program cohort group according to one embodiment of the present invention is illustrated. After creating the plurality of permutations of the eligible supplemental programs, the SP module assigns a different permutation of eligible supplemental programs to each cohort. According to one embodiment of the present invention, the SP module may receive instructions from the administrator of the SP system 300 that defines how the SP module is to assign the different permutations of eligible supplemental programs to each cohort. However, the invention is not so limited, and in alternate embodiments of the present invention, the SP module may assign the permutation of supplemental programs to each cohort using an algorithm stored within the cohort database 305 that dictates how the permutations are to be assigned to each cohort.

For example and as exemplified in FIG. 33, the central portion 301 the SP module assigns program permutation number 2 to cohort number 1, program permutation number 1 to cohort number 2, program permutation number 3 to cohort number 3, and program permutation number 4 to cohort number 4. It should be noted that this is just one non-limiting example of the assignment of permutations of supplemental programs to cohorts in accordance with the present invention. Specifically, it should be noted that the permutations of the present invention are not limited to any specific number of supplemental programs. Therefore, although only a maximum of two supplemental programs are exemplified in any one permutation, in alternate embodiments of the present invention, a permutation may comprise any number of eligible supplemental programs.

As discussed in more detail below, since permutation number 1 does not comprise any supplemental programs, cohort number 2, which was assigned permutation number 1, is a control group. Stated another way, cohort 2 (and supplemental program permutation number 1) is a control group in which no supplemental programs are available for the target drug. For further example, it should be noted that a control group may comprise at least one supplemental program, as long as the supplemental program(s) of the control group are also assigned to the other cohorts of the program cohort group.

Referring back to FIG. 30, after assigning a different permutation of eligible supplemental programs to each of the cohorts, the SP module stores the association of each permutation of eligible supplemental programs with its associated cohort in the cohort database 305 of the SP system 300, thereby completing step 3008. Therefore, the cohort database 305 comprises a correlated list of the cohorts, the assigned health care providers 101 of each cohort, and the assigned permutation of supplemental programs of each cohort.

According to one embodiment of the present invention, the SP module generates a program identifier for each of the different permutations of supplemental programs. Similar to the cohort identifier discussed above, in one embodiment of the present invention the program identifier is a unique string of numbers used by the SP module to identify that particular permutation of supplemental programs. After generating a program identifier for each of the different permutations of supplemental programs, the SP module associates a program identifier with each of the plurality of health care providers 101 based on their associated cohort, thereby completing step 3009. Thereafter, the SP module stores the association in the cohort database 305 of the SP system 300.

Therefore, according to one embodiment of the present invention, all of the health care providers 101 of a particular cohort are associated with the unique cohort identifier of their associated cohort and the unique program identifier of the associated permutation of supplemental programs of their cohort in the cohort database 305. As a result, and as discussed in more detail below, the SP module may more easily identify the associated cohort and permutation of supplemental programs of a particular health care provider 101 using the cohort identifier and the program identifier stored in the cohort database 305.

Next, the SP module generates at least one cohort rule, and assigns at least one cohort rule to each cohort of the plurality of cohorts, thereby completing step 3010. A cohort rule is similar to a rule, as discussed in detail above, but a cohort rule is a restriction assigned to each of the plurality of cohorts, whereas the rules discussed above are restrictions assigned to at least one supplemental program. Therefore, the cohort rules further restrict a cohort to additional constraints in addition to the target drug and provider 101 restrictions discussed above. Thus, in order for a prescription to qualify for the permutation of supplemental programs of a cohort, the prescription must meet the target drug, provider 101, and cohort rules of a particular cohort. After generating and assigning cohort rules to each of the cohorts of a program cohort group, the SP module stores the cohort rules in association with each cohort in the cohort database 305.

As discussed in more detail below, the rules engine of the SP module applies the cohort rule to the prescription for the target drug to determine whether the prescription qualifies for the cohort, and thus the permutation of supplemental programs of that cohort. Therefore, although a prescription may be for a target drug of a cohort in which the provider 101 belongs, the cohort may still not be eligible for the permutation of supplemental programs of the cohort unless the prescription also meets the cohort rule(s). Thus, in such embodiments, a prescription will only be deemed eligible for a cohort if the rules engine of the SP module determines that the prescribed substance is the target drug of a cohort, the provider 101 is assigned to the cohort, and the prescription meets the cohort rules of the cohort. Nonetheless, it should be noted that the invention is not so limited, and in alternate embodiments of the present invention, each of the plurality of cohorts may not be assigned any cohort rules.

It should further be noted that the cohort rules are exclusionary rules, meaning that if there is an applicable cohort rule for a prescription, then other non-cohort rules (or “rules” as discussed above) are not applied by the rules engine of the SP module when determining whether the prescription qualifies for the cohort, and in turn the permutation of supplemental programs of that cohort. Additionally, in one embodiment of the present invention, the cohort rules comprise the name of the target drug so that the SP module may more easily apply the cohort rules to received prescription data. However, the invention is not so limited, an in alternate embodiments of the present invention, the SP module may apply both the cohort rules and non-conflicting non-cohort rules.

A cohort rule may be similar to any of the non-cohort rules discussed above. For further example, a cohort rule may relate to the dosage strength of the substance (e.g., the prescription of the target drug must be for 60 mg pills or the prescription of the target drug must be equal to or greater than 30 mg pills), the duration in which the patient has been receiving prescriptions for the target drug (e.g., the patient must have been prescribed the drug for at least 90 days prior to the current prescription), the age of the patient (e.g., the prescription must be for a patient who is greater than 18 years old or a patient who is less than or equal to 60 years old), the Medication Persistency Rate (MPR) of the patient, or any other patient adherence data.

Similar to the set-up of the permutations of supplemental programs, according to one embodiment of the present invention, the SP module receives instruction from an administrator of the SP system relating to the generation of the cohort rules of a plurality of cohorts. For example, the administrator of the SP system 300 may transmit instructions to the SP module which dictate the exact cohort rules for the plurality of cohorts. This may be beneficial if the administrator would like to specifically test the effectiveness of supplemental programs on a particular patient type, patients at a particular usage stage of the target drug, or prescriptions for a particular strength of the target drug. However, in an alternate embodiment of the present invention, the rules engine of the SP module generates the cohort rules such that each of the plurality of cohorts are configured to be activated for the most common types of patients receiving prescriptions for the target drug or for patients with a specific MPR range (e.g. patients who have an MPR between 30%-80%).

in accordance with one embodiment of the present invention, the cohort rules may be reconfigured or altered by the SP module at any time. For example, the administrator of the SP system 300 may determine that the results being received from a particular cohort are not ideal. Therefore, the administrator may remove, alter, or reconfigure any cohort rules at any stage after the cohorts are created. By allowing the administrator to alter the cohort rules after the cohorts are in use, the SP module enables the administrator to correct or alter the qualifications required for each cohort. For instance, in one embodiment, the SP module may allow an administrator to use a sliding scale to adjust the range of a particular cohort rule (e.g., a cohort rules restriction qualification of the cohort to prescriptions whose patients have an MPR in a certain range).

Further, in another embodiment of the present invention, the SP module may comprise an algorithm that is configured to automatically adjust a cohort rule based on a percentage of prescription that pass or fail the cohort rule. For example, the SP module may automatically adjust a cohort rules restriction qualification of the cohort to prescriptions whose patients have an MPR between 40-80% to an MPR between 30-90% in order to increase the number of prescriptions qualifying for the cohort.

Further, according to one embodiment of the present invention, one or more cohort rules may be used by the SP module to define the target drug of each cohort, select and allocate providers 101 for each cohort, define the maximum counter of each cohort, and/or select and allocate the permutation of supplemental programs for each cohort. In such instances, the SP module may not receive instructions from the administrator of the SP system 300 that define how to assign providers 101 between cohorts and/or select and allocate the permutation of supplemental programs for each cohort. For example, instead of receiving instructions relating to the specific assignment of providers 101 between cohorts, the SP module may receive instructions defining a cohort rule that automatically allocates specific permutations of supplemental programs to specific providers (e.g., providers living in a certain geographic location are allocated a particular permutation of supplemental programs for a particular prescribed substance(s)). Therefore, in such embodiments, the cohorts will be automatically defined and created by the SP module using cohort rules.

Still referring to FIG. 30 and as discussed above, the SP module stores a correlated list of the information relating to cohorts in the cohort database 305 to aid the SP module in performing additional processing steps. In step 3011, the SP module stores the cohort information in a cohort relation table created by the SP module, the cohort relation table being stored by the SP module in the cohort database 305 of the SP system 300. The cohort relation table associates or links a plurality of data relating to each cohort. For example, the cohort relation table may associate or link any combination of the data relating to each cohort, such as but not limited to, the cohort identifier of a cohort, the provider NPI numbers of a cohort, the target drug of a cohort, the permutation of supplemental programs of a cohort, the current and maximum counter of a cohort and/or the cohort rules of a cohort. Therefore, when the SP module receives prescription data, the rules engine may use the cohort relation table to determine whether a cohort is applicable to the received prescription data, the associated supplemental programs of a cohort, and the current and maximum counter of a cohort.

Referring to FIG. 34, a cohort relation table 3400 according to one embodiment of the present invention is illustrated. As discussed above, according to one embodiment of the present invention, the cohort database 305 stores a cross-referenced listing of cohort identifiers, health care provider NPI numbers, target drug(s), permutation of supplemental programs, currentimaximum counter, and cohort rules. Nonetheless, it should be noted that the cohort relation table may comprise a cross-referencing of any number of cohort related data items. Further, it should be noted that the information listed in the cohort relation table 340) is generically illustrated for purposes of simplicity.

The cohort relation table 3400 may be utilized by the SP module when cross-referencing the cohort database 305, such that the cross-referencing is accomplished using the cohort relation table 3400. This enables the SP module to determine whether a health care provider 101 is associated with a cohort, and if so, what specific cohort, what permutation of supplemental programs associated with the cohort, etc. the SP module should apply for an electronic prescription.

Although exemplified as a single table, it should be noted that in alternate embodiments of the present invention, the cohort relation table may consist of multiple separate tables that are linked to one another (e.g., mapping tables). Therefore, the SP module may determine associated data of one element (e.g., a cohort, a health care provider 101, a target drug, etc.) by searching through the appropriate mapping tables stored within the cohort database 305 of the SP system 300.

Further, in accordance with one embodiment of the present invention, the SP module may change a provider 101 between cohorts using the cohort relation table. Therefore, the SP module may move providers 101 between cohorts, and such changes would update their cohort association stored within the cohort relation table in the cohort database 305.

After storing the cohort relation table in the cohort database 305, the SP module has defined the plurality of cohorts of a program cohort group.

2. Receiving Data Relating to an Electronic Prescription and Activating the Supplemental Programs Associated with the Health Care Provider's Cohort

After a plurality of cohorts is defined by the SP module, the SP module is ready to analyze the effectiveness of the different permutations of supplemental programs on patient adherence for the target drug. However, the first step is for the SP module to activate the permutation of supplemental programs of each of the cohorts for electronic prescriptions. As discussed in more detail below, the SP module receives information relating to an electronic prescription for the target drug written by one of the health care providers 101, determines whether the health care provider 101 is part of an existing cohort, and activates that provider's permutation of supplemental programs for the patient upon the provider's request. Thereafter, the SP module receives patient adherence data and analyzes the effectiveness of the activated supplemental programs on the patient's adherence to the target drug. It should be noted, as discussed above, that the target drug may be just one or a plurality of prescribed substances as indicated by the target drug data.

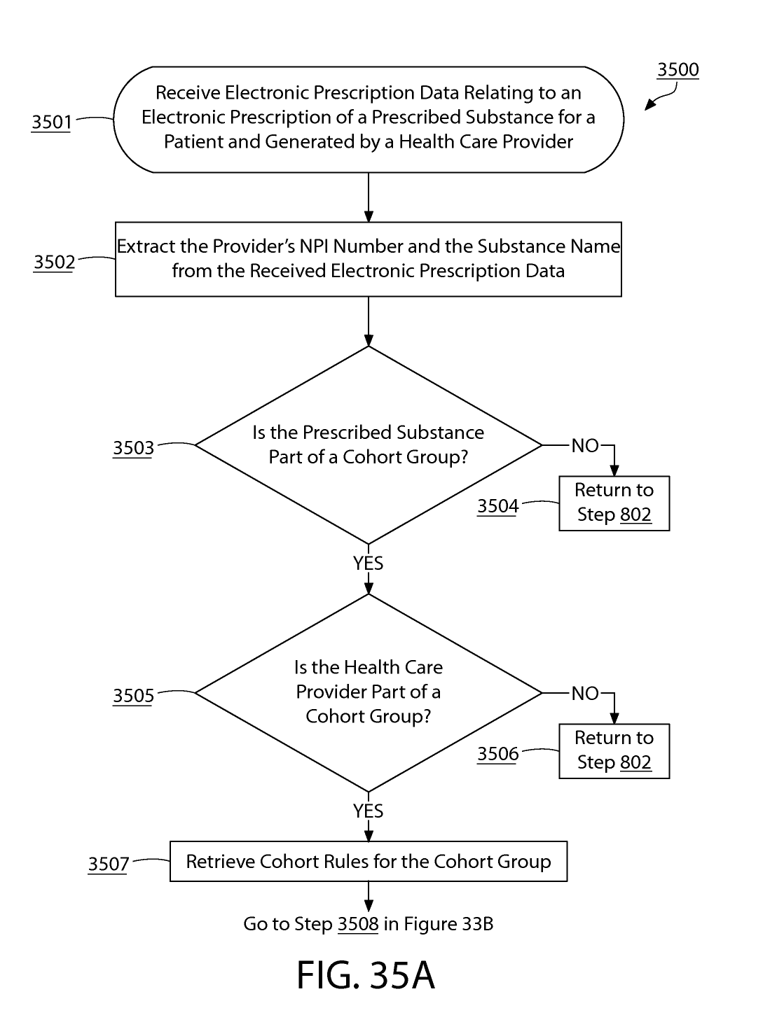

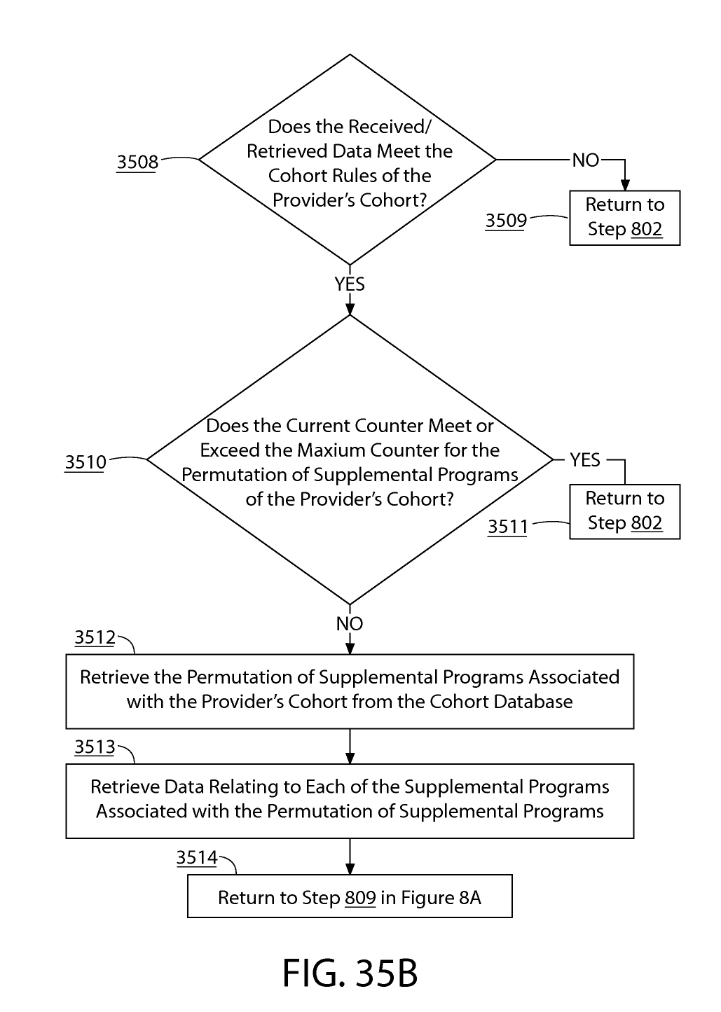

Referring to FIGS. 35a-35b, a flow chart of a method 3500 for receiving data relating to an electronic prescription for the target drug and activating the permutation of supplemental programs associated with the health care provider's cohort for the target drug according to one embodiment of the present invention is illustrated. It should be noted that the method 3500 of FIGS. 35a-35b may be considered an intervening method that works in conjunction with the method 800 exemplified in FIGS. 8a-8c. For example, according to one embodiment of the present invention, the method 3500 picks up after the health care provider 101 writes an electronic prescription for a prescribed substance using the thin client portion 203 of the EP module and the SP widget 302 retrieves data relating to the electronic prescription from the thin-client portion of the EP module 203. Therefore, the method 3500 begins with the central portion 301 of the SP module receiving data relating to the electronic prescription of the prescribed substance for the patient, similar to as discussed above with respect to step 801 of FIG. 8a, thereby completing step 3501.

Further, it should be noted that the method 3500 occurs after the performance of method 3000 by the SP module. Finally, as discussed above with respect to the method 800, the method 3500 is not a one-time transmission of information, but rather a recurrent process that occurs each time a health care provider 101 writes and/or transmits an electronic prescription.

After receiving the electronic prescription data, the SP module extracts the NPI number of the health care provider 101 who wrote the prescription and the prescribed substance of the electronic prescription from the received electronic prescription data, thereby completing step 3502. As noted above, the electronic prescription data comprises first patient data that is specific to the patient, first prescribed substance data that is specific to the prescribed substance, first provider data that is specific to the health care provider 101, and first payor data that is specific to the payor.

Next, the central portion 301 of the SP module determines whether the prescribed substance of the electronic prescription is part of a particular cohort in decision step 3503. According to one embodiment of the present invention, the central portion 301 of the SP module cross-references the prescribed substance data from the electronic prescription with cohort relation table stored in the cohort database 305 of the SP system 300 to determine if the prescribed substance of the electronic prescription is the target drug of one or more cohorts. For example, according to one embodiment of the present invention, the SP module determines whether the target drug name is associated with any of the defined cohorts.

If the prescribed substance is not associated with any cohorts, then the method moves to step 3504, and as a result, returns to step 802 in FIG. 8a. In such instances, the prescribed substance is not associated with any cohorts and, therefore the method returns to step 802 of FIG. 8. Nonetheless, the SP module may still determine eligible supplemental programs for the patient based on the received electronic prescription data, as discussed above in detail with respect to FIGS. 8a-8b. However, if the prescribed substance is the same as the (or a) target drug of one or more cohorts, then the method continues to step 3505.

Thereafter, the SP module determines whether the health care provider 101 who wrote the prescription is part of one of the cohorts identified in decision step 3505. According to one embodiment of the present invention, the SP module cross-references the provider data from the electronic prescription with the cohort database 305 of the SP system 300 to determine if the provider 101 has an associated cohort, and further if the target drug of the associated cohort is the same as the prescribed substance. For example, in one embodiment of the present invention, the SP module determines whether the provider's NPI number is associated with any of the cohorts for the target drug.

If the health care provider 101 is not associated with any cohorts, then the method moves to step 3506, and as a result, returns to step 802 in FIG. 8a. In such instances, even though the prescribed substance is the target drug of one or more cohorts, the provider 101 is not associated with any of the cohorts of that target drug, and therefore the cohort(s) of the target drug are not relevant for determining supplemental programs. Nonetheless, the SP module may still determine eligible supplemental programs for the patient based on the received electronic prescription data, as discussed above in detail with respect to FIGS. 8a-8b. However, if the health care provider 101 is associated with a cohort of the prescribed substance, then the process continues on to step 3507.

If the method continues to step 3507, then the health care provider 101 is associated with at least one cohort and the prescribed substance is the (or a) target drug of the provider's associated cohort. At that point, the rules engine of the SP module retrieves the cohort rules for that cohort from the cohort relation table stored within the cohort database 305. As noted above, the cohort rules define rules or restrictions that are used by the rules engine to determine whether or not the electronic prescription is eligible for the cohort, and in turn the permutation of supplemental programs of the cohort. It should be noted that in accordance with one embodiment of the present invention, the rules engine of the SP module further retrieves patient data, prescribed substance data, provider data, and/or payor data from the records database 304 of the SP module. This is similar to as discussed with reference to steps 802-805 of FIG. 8a.

Referring to FIG. 35b, at step 3508 the rules engine of the SP module determines whether the received (and potentially retrieved) data meets the cohort rules of the provider's cohort. If the received/retrieved data does not meet the cohort rules, then the method moves to step 3509 and returns to step 802 of FIG. 8a. In such instances, even though the provider 101 is a part of a cohort and the prescribed substance is the target drug of that cohort, the electronic prescription does not meet the other requirements, or cohort rules, of that cohort. Therefore, the electronic prescription is not eligible for the permutation of supplemental programs for that cohort.

However, if the received/retrieved data does meet the cohort rules, then electronic prescription is eligible for the cohort and the method continues to step 3510. At step 3510, the SP module determines whether the current counter of the permutation of supplemental programs meets or exceeds the maximum counter of the permutation of supplemental programs. The SP module makes the determination by checking the cohort relation table stored within the cohort database 305. If the current counter does meet or exceed the maximum counter of the permutation of supplemental programs, then the method continues to step 3511 and returns to step 802 in FIG. 8a. In such instances, even though the provider 101 is a part of a cohort, the prescribed substance is the target drug of that cohort, and the electronic prescription meets the cohort rules of that cohort, the permutation of supplemental programs for that cohort has been met or exceeded, so the SP module will not continue to activate that permutation of supplemental programs. However, if the current counter does not meet or exceed the maximum counter of the permutation of supplemental programs, then the method continues to step 3512. Further, it should be noted that in embodiments when the cohort does not comprise a current and maximum counter for the permutation of supplemental programs, steps 3510 and 3511 may be omitted.

At step 3512, the SP module retrieves the permutation of supplemental programs associated with the provider's cohort from the cohort database 305. According to one embodiment of the present invention, the SP module retrieves the cohort identifier of the provider's cohort from the cohort database 305, and in turn, using the cohort identifier, retrieves the program identifier of the cohort from the cohort database 305. The program identifier identifying each of the supplemental programs of the permutation of supplemental programs associated with the provider's cohort.

After retrieving the permutation of supplemental programs from the cohort database 305, the SP module retrieves data relating to each of the supplemental programs associated with the permutation of supplemental programs, thereby completing step 3513. Next, the method continues to step 3514, and as a result, returns to step 809 in FIG. 8a. Thereafter, the method may continue as discussed above with reference to FIGS. 8a-8c. The method may include, but not limited to, any of the embodiments described above.

Therefore, according to one embodiment of the present invention and as discussed in greater detail above, the SP module generates and displays a GUI comprising a list of the supplemental programs associated with the provider's cohort on the display device 121 for the provider's input. Therefore, each of the supplemental programs of the permutation of supplemental programs associated with the cohort to which the health care provider 101 belongs is displayed to the health care provider 101 for selection and activation. Also similar to as discussed above, the SP module will activate each of the supplemental programs associated with the cohort to which the health care provider 101 belongs that are selected and activated by the health care provider 101 using the input device 122 of the HCP system 100. As noted above, activation of a supplemental program may comprise many different steps, including, but not limited to, the delivery or transmission of content to the patient, the transmitting of patient information to sign a patient up for a service, or any other form as discussed above in detail.

However, the invention is not so limited and according to one embodiment of the present invention, and unlike as described above, the provider 101 does not have the opportunity to select or de-select the supplemental programs. Rather, since the provider 101 is associated with the particular cohort, all of the supplemental programs associated with that cohort are automatically activated by the SP module. In such embodiments, a GUI may be, but is not necessarily, displayed to the provider 101 via the display device 121. The supplemental programs are simply activated by the SP module for the patient.

It should be noted that among the processes discussed above that may be incorporated into the embodiments where the prescribing health care provider 101 is a part of a cohort, the use of delivery modes may be incorporated into herein. For example, in one embodiment of the present invention the SP module may retrieve delivery mode data relating to the patient and the supplemental programs of the cohort from the record database 304 and supplemental program database 303 respectively, as discussed in detail above. Thereafter, the SP module may compare delivery mode data relating to the patient with the delivery mode data relating to the supplemental programs to determine common delivery modes, and displaying the common delivery modes of the supplemental programs in the GUI via the display device 121 for selection and acceptance by the health care provider 101, as also discussed above in greater detail. Finally, in such embodiments, if activation of a supplemental program of the cohort causes content to be delivered to the patient, the delivery of the content is via the delivery mode that is selected and accepted by the health care provider 101.

Furthermore, it should be noted that in alternate embodiments of the present invention the SP module widget 302 and not the central portion 301 of the SP module performs the processes relating to the use of the plurality of cohorts. For example, in one embodiment of the present invention, the SP module widget 302 and not the central portion 301 of the SP module determines whether the provider 101 is a part of a particular cohort and/or whether the prescribed substance of the electronic prescription is the (or a) target drug of the provider's associated cohort. In such embodiments, the SP module widget 302 may track electronic prescriptions being prescribed by each one of the plurality of health care providers 101 that are part of one of the plurality of cohorts. Similar to above, the SP module widget 302 may cross-reference electronic prescription data with the cohort database 305. In such embodiments, the cohort database 305 may reside within the memory 113 of the HCP system 100. Thereafter, when a health care provider 101 out of the plurality of health care providers 101 that is a part of one of the plurality of cohorts writes an electronic prescription for the (or a) target drug of that cohort, the SP module widget 302 retrieves electronic prescription data for the target drug from the thin-client portion of the EP module 203 and transmits the electronic prescription data for the target drug to the central portion 301 of the SP module.

Generally, it should be noted that since each cohort is assigned a different permutation of supplemental programs, each cohort may be used to analyze the effectiveness of a specific permutation of supplemental programs on patient adherence. Stated another way, and as discussed in more detail below, each of the plurality of cohorts analyzes the effectiveness of its assigned supplemental programs on patient adherence for the prescribed substance(s) identified by the target drug data.

2a. Alternate Embodiment of Processing a Prescription to Determine Eligible Supplemental Programs Via Cohorts

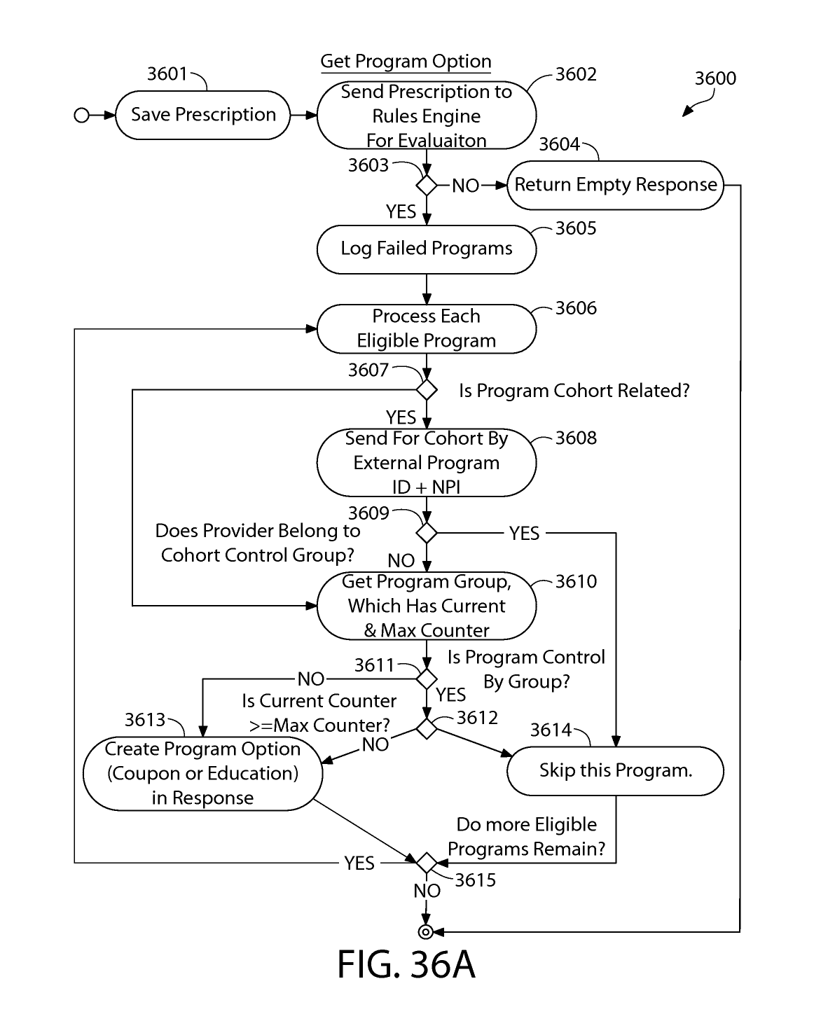

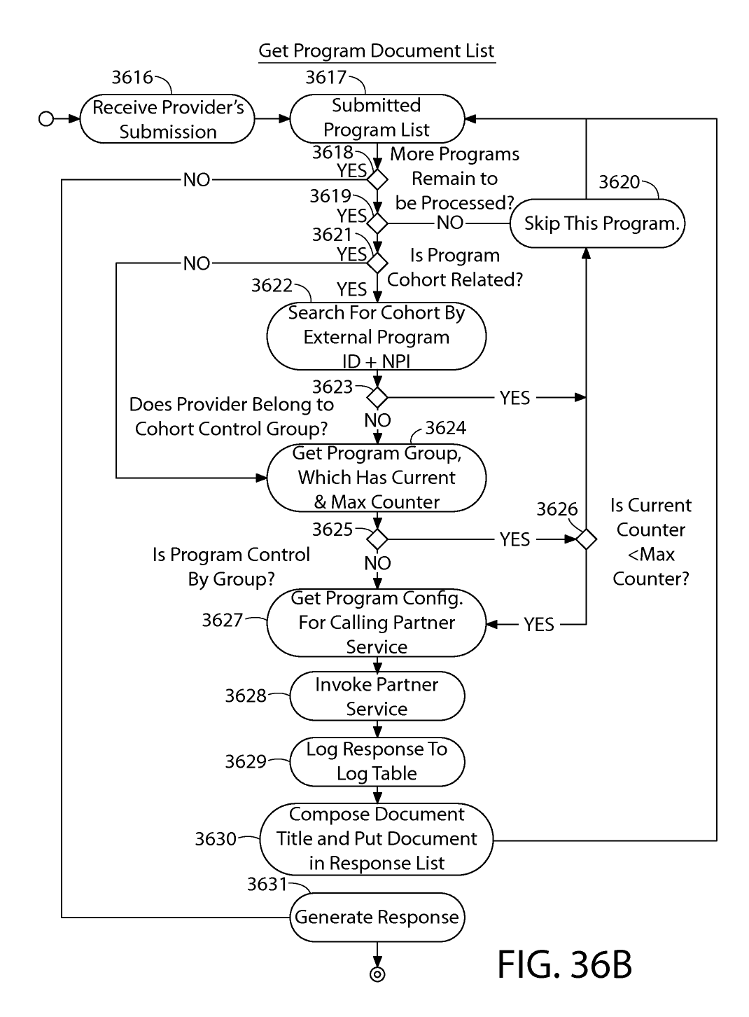

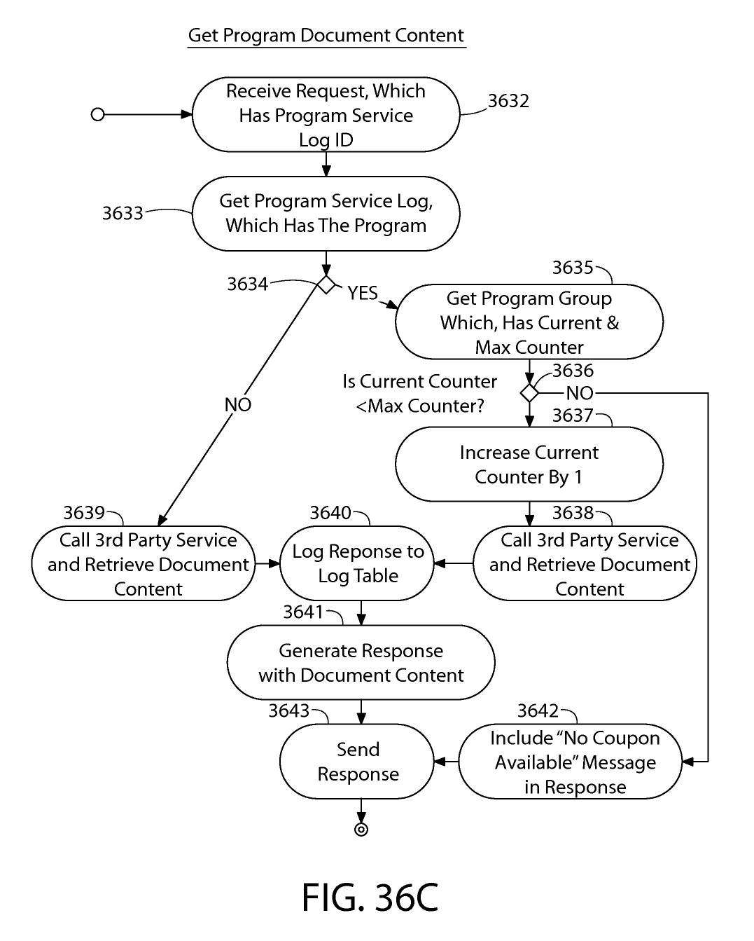

Referring to FIG. 36a, a flow chart of a method 3600 of retrieving supplemental program data in accordance with an alternate embodiment of the present invention is illustrated. Referring to FIG. 36b, a method 3600 of generating a document list of all eligible supplemental programs that are selected and accepted by a provider 101 for an electronic prescription according to one embodiment of the present invention is illustrated. Referring to FIG. 36c, a method 3600 of retrieving the document associated with supplemental programs that are selected and accepted by a provider 101 for an electronic prescription according to one embodiment of the present invention is illustrated.

It should be noted that the method 3600 is an alternate method to method 3500 discussed in reference to FIGS. 35a-35b above. Specifically, as opposed to the method 3500, in which the rules engine first determines whether the electronic prescription is eligible for a supplemental program prior to determining if there are any eligible supplemental programs, in the method 3600 the rules engine first determines if there are any supplemental programs for which the electronic prescription is eligible, and then subsequently determines whether any of the eligible supplemental programs are part of a predefined cohort of the provider 101. It should be further noted that in alternate embodiments of the present invention, the SP module may perform a combination of any of the steps of methods 3500 and 3600 when determining eligible supplemental programs for cohort related electronic prescriptions.

Further, it should be noted that steps 3601-3631 are performed by the rules engine of the SP module, while steps 3632-3634 are performed by the central portion 301 of the SP module. Therefore, although the process of steps 3601-3631 is discussed with reference to the “SP module,” it should be noted that the steps 3601-3631 are performed by the rules engine of the SP module. Nonetheless, the invention is not so limited and according to other embodiments of the present invention, the central portion 301 of the SP module and/or the rules engine may perform any of the steps 3601-3634 discussed below.

The method begins at step 3601 with the SP module storing received electronic prescription data in the memory 313 of the SP system 300. According to one embodiment of the present invention, the electronic prescription data may be stored in the record database 304. However, it should be noted that in other embodiments of the present invention, the electronic prescription data may be stored in its own database or in temporary memory within the SP system 300.

After storing the electronic prescription data, the SP module transmits the electronic prescription data to the rules engine for evaluation, thereby completing step 3602. Next, the rules engine evaluates the electronic prescription data to determine if there are any eligible supplemental programs out of the plurality available supplemental programs for the electronic prescription, thereby completing step 3603. If there are no eligible supplemental programs for the prescription, then an empty response is returned in step 3604, and the method ends. However, if there is at least one eligible supplemental program returned, then the method continues to step 3605.

At step 3605, the SP module stores, in a failed programs log in the record database 304, a listing of all of the supplemental programs of the target drug for which the electronic prescription was not eligible. For example, if the prescribed substance met the rules for the supplemental program, but the provider 101 or dosage of the substance did not meet the rules of the supplemental program, then that information is stored within the failed programs log. By storing all of the ineligible supplemental programs for each received prescription, the failed programs log provides a means by which the administrator of the SP system 300 may analyze why certain supplemental programs are being activated more or less than others. This is beneficial in determining how to increase or decrease the activation of certain supplemental programs.

Thereafter, the SP module processes each eligible supplemental program, preferably one at a time, in step 3606. First, at decision step 3607, the rule engine of the SP module determines whether the supplemental program is cohort related. According to one embodiment, the SP module cross references the program identifier of the supplemental program with the cohort relation table (or mapping tables) stored within the cohort database 305. This is beneficial if some of the supplemental programs returned by the rule engine in step 3603 are cohort related while others are not.

If the returned supplemental program is not cohort related (i.e., the provider 101 and/or the substance is not part of the same cohort, or the cohort rules are not met), then the method 3600 continues to step 3610. However, if the supplemental program is cohort related, then the method continues to step 3608. At step 3608, the rules engine of the SP module searches for the provider's cohort using the supplemental program identifier and the NPI number of the provider 101. Specifically, the rules engine cross-references the cohort relation table (or mapping tables) stored within the cohort database 305 to determine the specific cohort in which the supplemental program and electronic prescription belong.

Upon determining the provider's cohort for the substance of the electronic prescription, the rules engine of the SP module determines whether the provider's cohort is a control cohort (or control group), thereby completing decision step 3609. As discussed above, a control group is a cohort which is assigned a permutation of supplemental programs that either does not comprise any supplemental programs or comprises one or more supplemental programs that are also common to all of the plurality of permutations of supplemental programs of the other related plurality of cohorts. If the provider's cohort is a control group, then the method continues to step 3614, and a program option for the eligible supplemental program is not generated for display to the provider 101. However, if the provider's cohort is not the control group, then the method continues to step 3610.

Nonetheless, it should be noted that in some embodiments of the present invention, the method may continue to step 3610 although the provider's cohort is the control group. Specifically, this may be the case if the provider's control group is assigned a plurality of supplemental programs that are common to all of the plurality of permutations of supplemental programs assigned to each of the other cohorts of the program cohort group. In such instances, it is important that the supplemental programs assigned to the control group are also activated. Therefore, in such instance, the method may continue to step 3610.

At step 3610, the rules engine of the SP module retrieves the program cohort group of the provider's cohort, which may comprise a current counter and a max counter of the cohort, from the cohort database 305 of the SP system 300. After retrieving the program cohort group (and the current and max counter of the supplemental program for the provider's cohort), the SP module determines whether activation of the supplemental program is controlled by the provider's cohort in decision step 3611. It should be noted that one method of controlling the activation of a supplemental program is through the use of a current and max counter. If the activation of the supplemental program is not controlled by a current and max counter (e.g., the supplemental program is not related to a cohort, or the provider's cohort does not comprise a corresponding max counter for the supplemental program), then the method continues to step 3613. However, if the activation of the supplemental program is controlled by the current and max counter, then the method continues to step 3612.

At decision step 3612, the SP module determines whether the current counter of the supplemental program for the provider's cohort is greater than or equal to the maximum counter of the supplemental program for the provider's cohort. If the current counter is greater than or equal to the maximum counter, then the supplemental program has been activated its allotted amount of times for the particular cohort, and as such, the method continues to step 3614. At step 3614, the SP module skips the supplemental program such that the eligible supplemental program is not activated. However, if the current counter is less than the maximum counter, then the supplemental program has not been activated its allotted amount of times for the particular cohort, and as such, the method continues to step 3613.

At step 3613, the SP module generates a supplemental program option for the supplemental program in a response. As discussed below with reference to FIG. 36b, the response will be transmitted by the central portion 301 of the SP module to the SP widget 302 residing on the HICP system 100 so that the SP module may receive the provider's selection and activation of the eligible supplemental programs. According to one embodiment of the present invention, a response is a pop-up window 1010, such as that exemplified in FIG. 15, and the supplemental program option is the information relating to the eligible supplemental program option 1012 display in the pop-up window 1010 on the display device 121 to the provider 101 for the provider's selection and acceptance of each eligible supplemental program. It should be noted that the pop-up window 1010 and the information relating to the eligible supplemental program 1012 is but just one non-limiting example of a response for the supplemental program in accordance with the present invention.

It should be noted that the response may comprise information relating to supplemental programs that are part of the provider's cohort, along with information relating to supplemental programs that are not part of the provider's cohort. However, in one embodiment of the present invention, the SP module removes from the response the information relating to all non-cohort relating supplemental programs so that only those supplemental programs that are part of the provider's cohort are displayed to the provider 101.

After generating the supplemental program option in the response, the SP module continues to decision step 3615. At decision step 3615, the SP module determines whether the any more eligible supplemental programs remaining to be processed at step 3606. In one embodiment, this determination is made by the SP module through a cross-referencing of the supplemental programs determined to be eligible by the rules engine in step 3603. If there remains additional eligible supplemental programs that need to be processed through steps 3606-3615, then the method returns to step 3606 and another eligible supplemental program is processed. After all of the supplemental programs determined by the rules engine in step 3603 to be eligible have been processed through step 3606-3615, the method of FIG. 36a is complete.

Referring to FIG. 36b, a method 3600 of generating a document list of all eligible supplemental programs that are selected and accepted by a provider 101 for an electronic prescription according to one embodiment of the present invention is illustrated. It should be noted that the method of FIG. 36b is a continuation of the method of FIG. 36a. Therefore, as illustrated, the method 3600 of FIG. 36b begins with step 3616. It should be noted that between step 3615 and step 3616, the central portion 301 of the SP module has transmitted the response comprising the information relating to the eligible supplemental programs to the SP widget 302, the SP widget 302 has displayed a list of the eligible supplemental programs on the display device 121 to the provider 101, the provider 101 has selected and accepted the eligible supplemental programs they would like to activate for the patient, and the SP widget 302 has generated a signal indicating the supplemental programs that were both selected and accepted by the provider 101.

At step 3616, the SP module receives a signal from the SP widget 320 indicating which of the supplemental programs are both selected and accepted by the provider 101. In one embodiment, the signal may be the activation signal as discussed above with reference to FIGS. 8a-8c. Next, at step 3617, the SP module retrieves the list of eligible supplemental programs that were displayed for the provider's selection and acceptance. The submitted program list comprising the information relating to each of the eligible supplemental programs, regardless of whether the supplemental programs were selected and accepted by the provider 101 for activation.

Thereafter, at decision step 3618, the SP module determines whether there are any supplemental programs that remain to be processed by the SP module. If so, then the SP module selects one supplemental program from the supplemental program list and determines whether the signal received from the SP widget 302 indicates that the supplemental program was selected and accepted by the provider 101. If the supplemental program was not selected and accepted by the provider 101, then the method continues to step 3620 and the supplemental program does not get activated. However, if the supplemental program was selected and accepted by the provider 101, then the method continues to step 3621.

It should be noted that the process of steps 3621-3623 is very similar to the process of steps 3607-3609 discussed above with respect to FIG. 36a. At decision step 3621, the SP module determines whether the supplemental program is cohort related. As noted above, in one embodiment, the SP module cross references the program identifier of the supplemental program with the cohort relation table (or mapping tables) stored within the cohort database 305. Further, it should be noted that in one embodiment of the present invention, steps 3621-3623 are omitted. In such embodiments, the method goes from step 3620 directly to step 3624.

If the supplemental program is not cohort related, then the method continues to step 3624. However, if the supplemental program is cohort related, then the method continues to step 3622. At step 3622, the rules engine of the SP module searches for the provider's cohort using the supplemental program identifier and the NPI number of the provider 101. Specifically, the rules engine cross-references the cohort relation table (or mapping tables) stored within the cohort database 305 to determine the specific cohort in which the supplemental program and electronic prescription belong.

Upon determining the provider's cohort, the rules engine of the SP module determines whether the provider's cohort is a control cohort (or control group), thereby completing decision step 3623. If the provider's cohort is a control group, then the method continues to step 3620, and the eligible supplemental program is not activated. However, if the provider's cohort is not the control group, then the method continues to step 3624.

Nonetheless, similar to as discussed above, in some embodiments of the present invention, the method may continue to step 3624 although the provider's cohort is the control group. Specifically, this may be the case if the provider's control group is assigned a plurality of supplemental programs that are common to all of the plurality of permutations of supplemental programs assigned to each of the other cohorts of the program cohort group. In such instances, it is important that the supplemental programs assigned to the control group are also activated. Therefore, in such instance, the method may continue to step 3624.

At step 3624, the rules engine of the SP module retrieves the program cohort group of the provider's cohort, which may comprises a current counter and a max counter of the cohort, from the cohort database 305 of the SP system 300. After retrieving the program cohort group (and the current and max counter of the supplemental program for the provider's cohort), the SP module determines whether activation of the supplemental program is controlled by the provider's cohort in decision step 3625. If the activation of the supplemental program is not controlled by a current and max counter, then the method continues to step 3627. However, if the activation of the supplemental program is controlled by the current and max counter, then the method continues to step 3626.

At decision step 3626, the SP module determines whether the current counter of the supplemental program for the provider's cohort is greater than or equal to the maximum counter of the supplemental program for the provider's cohort. If the current counter is greater than or equal to the maximum counter, then the supplemental program has been activated its allotted amount of times for the particular cohort, and as such, the method continues to step 3620. At step 3620, the SP module skips the supplemental program such that the eligible supplemental program is not activated. However, if the current counter is less than the maximum counter, then the supplemental program has not been activated its allotted amount of times for the particular cohort, and as such, the method continues to step 3627.

At step 3627, the SP module retrieves the service configuration from the supplemental program database 303 for calling a third party program vendor 400. The service configuration comprises information relating to the specific third party program vendor 400 that comprises the supplemental program. As noted above, in accordance with one embodiment of the present invention, the SP module does not store the physical documents or run the services that are the supplemental programs. Rather, the SP module simply stores information relating to the supplemental programs so that upon activation, the SP module may retrieve the actual document from the appropriate third party program vendor 400 or enroll the patient in the service by transmitting patient data to the appropriate third party program vendor 400. Nonetheless, in one embodiment of the present invention, the SP module does store the actual documents and run the actual services that are the supplemental programs. In such embodiments, steps 3627-3629 may be omitted.

Next, at step 3628, the SP module transmits a signal to the appropriate third party program vendor 400 to invoke the vendor 400 to confirm that the third part program vendor 400 does in fact have stored the actual document or service relating to the supplemental program. Thereafter, the SP module receives the confirmation signal from the appropriate third party program vendor 400, and logs the confirmation from the third party program vendor 400 in a log table at step 3629, the log table being stored within the cohort database 305.

Next, at step 3630, the SP module generates the supplemental program title and puts the supplemental program title in a response list, the response list stored in the cohort database 305. As discussed in more detail below, the response list comprises the titles of the supplemental programs that were selected and accepted by the provider 101. After putting the document title in the response list, the method returns to steps 3617 and 3618 and the SP module determines if there are any remaining supplemental programs that need to be processed. Upon the SP module processing each of the selected and accepted supplemental programs, the method continues to step 3631 and the SP module generates a response, the response comprising the response list that comprises the titles of the supplemental programs that were selected and accepted by the provider 101.

Referring to FIG. 36c, a method 3600 of retrieving the document associated with supplemental programs that are selected and accepted by a provider 101 for an electronic prescription according to one embodiment of the present invention is illustrated. It should be noted that the method of FIG. 36c is a continuation of the method of FIG. 36b.

At step 3632, the central portion 301 of the SP module receives a request from the rules engine which comprises the response listing a log identifier for the supplemental programs that were selected and accepted by the provider 101 for activation. The log identifier has the program identifiers for the supplemental programs that were selected and accepted by the health care provider 101.

Next, in step 3633, the central portion 301 of the SP module retrieves the supplemental program service log from one or more of the databases of the SP system 300. The supplemental program service log indicates the supplemental programs that were selected and accepted by the provider 101 for activation.

Next, at decision step 3634, the central portion 301 of the SP module determines whether the supplemental program is related to the provider's cohort. If the supplemental program is cohort related, then the method continues to step 3635 and the central portion 301 of the SP module retrieves the program group of the supplemental program, which comprises the current and maximum counter. However, if the supplemental program is not cohort related, then the method continues to step 3639, as discussed in more detail below.

Assuming the supplemental program is cohort related and after retrieving the current and maximum counter of the supplemental program for the provider's cohort, the central portion 301 of the SP module determines whether the current counter is less than the maximum counter at decision step 3636. If the current counter is not less than the maximum counter, then the central portion 301 of the SP module generates a message indicating that the supplemental program is not available for activation (e.g., “No Coupon Available”), and includes that message in a response that is transmitted to the SP widget 302 for display to the provider 101 on the display device 121. However, if the current count is less than the maximum counter, then the central portion 301 of the SP module increases the current counter by one, such increase being stored in the cohort database 305, thereby completing step 3637.

Next, the central portion 301 of the SP module calls the appropriate third party program vendor 400 and retrieves the actual document or information relating to the service of the supplemental program. In one embodiment, the central portion 301 of the SP module transmits the program identifier to the third party program vendor 400 and receives the actual document or information relating to the service of the supplemental program from the third party program vendor 400. However, the invention is not so limited, and in alternate embodiments the central portion 301 of the SP module may transmits any signal indicating the specific supplemental program to the appropriate third party program vendor 400.

Referring back to step 3634, if the supplemental program is not cohort related, then the central portion 301 of the SP module calls the appropriate third party program vendor 400 and retrieves the actual document or information relating to the service of the supplemental program, thereby completing step 3639. This is similar to the process described with respect to step 3638.

Thereafter, the SP module receives the actual document or information relating to the service of the supplemental program from the appropriate third party program vendor 400, and stores the actual document or information relating to the service of the supplemental program in the supplemental program database 303 (or other temporary memory). Thus, the SP module has, within one or more of its databases, the actual document or information relating to the service of the supplemental program. Thereafter, the SP module logs the response from the third party program vendor 400 in a log table at step 3640, the log table being stored within the cohort database 305.

Next, the central portion 301 of the SP module generates a response that comprises the actual document or information relating to the service of the supplemental program. It should be noted that the response may comprise more than one document or other supplemental program related information. Thereafter, the central portion 301 of the SP module transmits the response, along with the associated documents and information, to the SP widget 302, thereby completing step 3643.

Upon receiving the response, the SP widget 302 may display a GUI to the provider 101 that allows the provider 101 to distribute the document or other supplemental program information to the patient. In an alternate embodiment of the present invention, the SP widget 302 may transmit the documents directly to a printer without requiring provider interaction. Nonetheless, it should be noted that, upon receiving the response, the SP widget 302 may cause the documents and other information to be disseminated in any manner consistent with the present invention.

3. Receiving Patient Adherence Data

After the SP module activates the supplemental programs of the cohort that were selected and accepted by the provider 101, the patient receives the activated supplemental programs. Thereafter, as discussed in detail below, the SP module receives patient adherence data relating to the electronic prescription. It should be noted that since there are a plurality of different cohorts and since each cohort comprises a sub-set of health care providers 101, the SP module will receive patient adherence data relating to a plurality of different electronic prescriptions generated by different health care providers 101, some of these prescriptions for a target drug of a cohort and other not. Further, the SP module will be reaching patient adherence data while the program cohort groups are still active. Thereafter, upon receiving patient adherence data, the SP module must parse the patient adherence data by the cohort in which the patient adherence data relates.

As noted above, according to one embodiment of the present invention, the memory 313 of the SP system 300 further comprises a Patient Adherence Generation Module 306. The SP system 300, and more particularly the Patient Adherence Generation Module 306, receives patient medication history data relating to a plurality of electronic prescriptions for which supplemental programs were previously activated. It should be noted that the received patient medication history may, but does not have to relate to prescriptions that met all of the cohort rules and caused the activation of the permutation of supplemental programs for a cohort. Stated another way, the Patient Adherence Generation Module 306 receives patient medication history data relating to a plurality of electronic prescriptions, regardless of whether supplemental programs of a cohort (as opposed to supplemental programs in general) were activated for the prescription. As discussed in more detail below, the Patient Adherence Generation Module 306 receives the patient medication history data from another system, such as but not limited to the pharmacy system 500 and the payor system 600.

Generally, the patient medication history data comprises information relating to the medication history of the patient for one or more prescribed substances. This may, but does not necessary include prescriptions for the target drug of a cohort. For example, patient medication history may comprise any of the substance data described above (e.g., substance details such as the dosage, strength, form, duration, quantity, date, and refills) with reference to a prescription, the prescription start date and stop date, information relating to whether the patient picked up the prescription, the duration in which the prescription sat at the pharmacy prior to patient pickup, the number of refills of the prescription that the patient filled, and the time frame between refills in comparison to the duration of each prescription. Further, it should be noted that the patient medication history data may comprise information relating to any number of prescriptions for any number of patients, regardless of whether supplemental programs were activated by the SP module for those prescriptions.

However, in one embodiment of the present invention, the Patient Adherence Generation Module 306 only receives patient medication history data for prescriptions in which supplemental programs were activated. Further, in other embodiments, the Patient Adherence Generation Module 306 only receives patient medication history data for prescriptions of a target drug of a cohort in which the permutation of supplemental program of that cohort were activated.

After receiving the patient medication history data, the Patient Adherence Generation Module 306 generates patient adherence data from the received patient medication history data. After generating the patient adherence data, the Patient Adherence Generation Module 306 stores the patient adherence data in the patient adherence database 307. According to one embodiment of the present invention, the Patient Adherence Generation Module 306 generates the patient adherence data by applying the received patient medication history data to one or more algorithms configured to determine patient adherence metrics from the received patient medication history data. Through use of the algorithms, the Patient Adherence Generation Module 306 generates one or more adherence analytics for a particular prescription and/or medication history data of a patient. In such embodiments, the algorithms are stored in the patient adherence database 307 of the SP system 300.

It should be noted that, in accordance with one embodiment of the present invention, a prescription and drug till (which is a type of patient medication history data—e.g., the date on which a prescription was filled by a patient) must qualify for calculating patient adherence for a given patient and substance in order to be used by the SP module when determining patient adherence data. A prescription qualifies if the prescription matches the target drug by name, has a stop date that is after the compliance interval start date, and is either the most recent matching prescription or has a stop date that is within N days (e.g. 30) of the start date of the next most recent prescription. A drug fill qualifies if it matches the target drug by name, has a fill date that is after the compliance interval start date, and has a fill date that is between the start and stop date of a qualifying prescription. The compliance interval start date is the start of a compliance interval of interest.

Generally, patient adherence data comprises information relating to a patient's adherence, compliance, and/or persistency to prescriptions issued to the patient. As noted above, the prescriptions may, but do not necessarily have to be for the target drug of a cohort. For example, the patient adherence data may comprise information relating to the patient's first fill compliance of a prescription, the patient's first fill interval of a prescription, the patient's compliance interval of a prescription, and any other information relating to the patient's adhere, compliance, or persistency to a prescription.

For further example, in one embodiment of the present invention, patient adherence data comprises first fill compliance (FFC) data and patient Medication Persistency Rate (MPR) data. Generally, FFC data comprises information relating to whether or not the patient has been prescribed a particular prescribed substance (e.g., the target drug) in the past and/or whether the patient picked-up or took the particular prescribed substance (e.g., the target drug) in the past.

Further, in one embodiment of the present invention, FFC data of a prescription has three possible values: (1) present; (2) absent; or (3) unknown. The FFC data has a value of present if there exists a qualifying drug fill where: (1) the fill date of the prescription is after the start date of the prescription; and (2) the fill date of the prescription is before the end of the end of the first fill interval of the prescription. In such instances, the prescription was filled by the patient after the prescription was written by the health care provider 101, but before the end of the first fill interval of the prescription. Therefore, the prescription is first fill compliant.

The FFC data has a value of unknown if the start date of the prescription is after the end of the first fill interval of the prescription. In such instances, the prescription occurred after the first fill interval and therefore may be a refill of the prescription. Thus, information relating to a refill of a prescription does not indicate whether the patient was compliant with filling their prescription on the first fill. In all other instances, the FFC data has a value of absent.

Generally, MPR data comprises information relating to the patient's adherence to a particular prescribed substance (e.g., the target drug). For example, MPR data may comprise information relating to the degree or extent of conformity of the patient to the recommendations about day-to-day treatment by the health care provider 101 with respect to the timing, dosage, and/or frequency of a particular prescribed substance (e.g., the target drug), information relating to the extent to which a patient acts in accordance with the prescribed interval and dose of a dosing regimen of the particular prescribed substance (e.g., the target drug), and information relating to the continuation the treatment by the patient for the prescribed duration of the particular prescribed substance (e.g., the target drug). Therefore, in one embodiment of the present invention, the MPR data comprises, as a percentage, information relating to how often the patient filled a prescription compared with how often s/he could have filled it optimally. Finally, it should be noted that in some embodiments of the present invention, MPR data may be referred to as medication possession ratio data.

According to one embodiment of the present invention if there are fewer than three qualifying fills of a particular prescription, then the MPR data for that prescription has a value of unknown. Otherwise, if there are three or more qualifying fills of a particular prescription, then the MPR data is calculated as follows. First, the Patient Adherence Generation Module 306 of the SP system 300 calculates compliance interval days for the prescription. Compliance interval days are the number of days in a compliance interval, or the number of days that a supply of prescription is available to the patient during the compliance interval. For each qualifying prescription, the Patient Adherence Generation Module 306 determines the adjusted prescription start date (the later of the start date of the prescription and the compliance interval start date), the adjusted prescription stop date (the earlier of the prescription stop date or the current date), and the compliance interval days of the prescription (the adjusted stop date minus the adjusted start date).

Next, the Patient Adherence Generation Module 306 calculates the total fill days of the prescription. Total fill days is a measure of the number of days that a supply of a prescription is actually filled by the patient during the compliance interval. For each qualifying prescription, the Patient Adherence Generation Module 306 calculates the adjusted fill start date (the later of the fill date of the prescription and the compliance interval start date of the prescription) and the adjusted fill stop date (the earlier of the fill date plus the fill days and the current date). Next, the Patient Adherence Generation Module 306 calculates the total fill days of the prescription (the adjusted fill stop date minus the adjust fill start date). Finally, the Patient Adherence Generation Module 306 calculates the MPR data for the prescription (the total fill days divided by the compliance interval days−multiplied by 100 to show as percentage).

After the patient adherence data is generated by the Patient Adherence Generation Module 306, the Patient Adherence Generation Module 306 transmits the patient adherence data to the central portion 301 of the SP module so that the SP module may parse and analyze the patient adherence data by cohort to determine the effectiveness of a plurality of different permutations of supplemental programs on patient adherence.

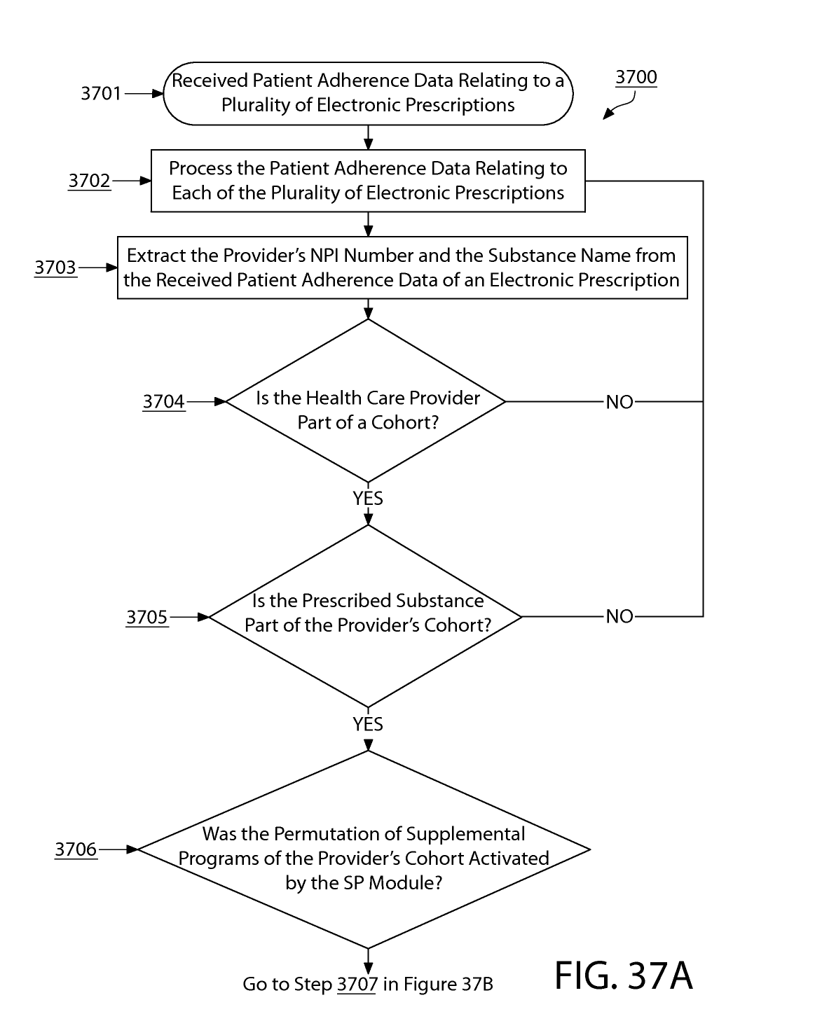

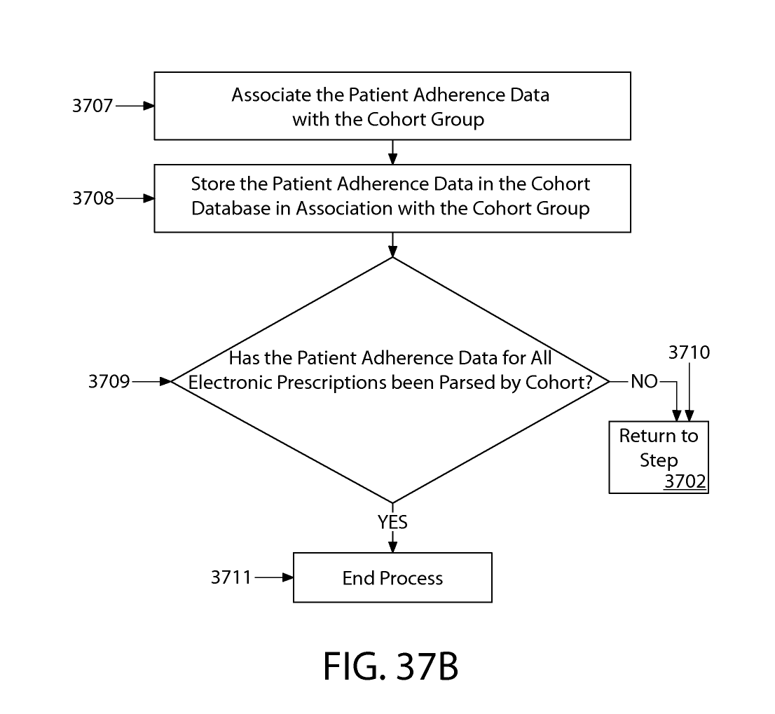

Referring to FIGS. 37a-37b, a flow chart of a method of parsing patient adherence data into data grouping based on a plurality of different cohorts according to an embodiment of the present invention is illustrated. The method 3700 begins when the SP module receives patient adherence data relating to a plurality of electronic prescriptions, thereby completing step 3701. It should be noted that the SP module may receive patient adherence data on a periodic basis (e.g., once a day), or the SP module may receive patient adherence data on a continuous basis. Further, the patient adherence data may relate to prescriptions that were associated with a particular cohort or not. As discussed in more detail below, the SP module parses the patient adherence data on the basis of cohort to determine the effectiveness of the permutation of supplemental programs of each cohort.

After receiving patient adherence data, the SP module processes the data and extracts the provider's NPI number and prescribed substance name from the electronic prescription associated with the patient adherence data, thereby completing step 3702 and 3703. It should be noted that the patient adherence data comprises information that relates to a corresponding electronic prescription processed by the EP module, and is therefore stored within the record database 304 of the SP system 300. As a result, the SP module can extract the provider's NPI number and substance name from the underlying electronic prescription associated with the patient adherence data.

After extracting the provider's NPI number and substance name, the SP module determines whether the health care provider 101 identified by the NPI number is associated or part of a cohort, thereby completing decision step 3704. According to one embodiment of the present invention, the determination is made by the SP module by a cross-referencing of the cohort relation table discussed above. In such instances, the SP module may cross-reference the provider's NPI number with the cohort relation table to determine whether the provider is part of a cohort. If the provider 101 identified by the NPI number is not associated with a cohort, then the method returns to step 3702 and the SP module processes patient adherence data relating to another prescription. However, if the provider 101 identified by the NPI number is associated with a cohort, then the method continues to decision step 3705.

At decision step 3705, the SP module determines whether the prescribed substance identified by the electronic prescription is associated with one of the provider's cohort(s) identified in step 3704. Similar to above and according to one embodiment of the present invention, the determination is made by the SP module by a cross-referencing of the cohort relation table discussed above. In such instances, the SP module may cross-reference the prescribed substance name with the cohort relation table to determine whether the prescribed substance is associated with one of the provider's cohort(s) identified in step 3704. If the prescribed substance name does not correspond with the prescribed substance of one of the provider's cohort(s), then the method returns to step 3702 and the SP module processes patient adherence data relating to another prescription. However, if the prescribed substance name does correspond with the provider's cohort, then the method continues to step 3706.

It should be noted that in such instances, the patient adherence data relates to an electronic prescription that meets all the cohort rules of the provider's cohort. However, at decision step 3706, the SP module determines whether the electronic prescription caused the permutation of supplemental programs of the provider's cohort were activated by the SP module. Stated another way, the SP module determines whether the cohort rules were met by the electronic prescription and whether the current counter was at or below the maximum counter when the SP module processed the electronic prescription when determining if the permutations of supplemental programs for the cohort would be activated.

In one embodiment of the present invention, when a permutation of supplemental programs of a cohort is activated for a prescription, the SP module tags the corresponding prescription. The corresponding prescription, the permutation of supplemental programs, and the tag are all stored in correlation with each other in the records database 304 or another databases of the SP system 300. Thereafter, the SP module uses the tag to determine whether the permutation of supplemental programs of a cohort was activated for an electronic prescription. For example, when receiving patient adherence data, SP module cross-references the records database 304 to see if the appropriate tag is associated with the corresponding prescription, thereby indicating that the permutation of supplemental programs was activated. Nonetheless, the invention is not so limited, and in alternate embodiments of the present invention, the Patient Adherence Generation Module 306 may determine whether the permutation of supplemental programs was activated for a particular prescription using other methods.

Next, after the SP module determines that the electronic prescription caused the permutation of supplemental programs of the provider's cohort to be activated by the SP module, the SP module associates the patient adherence data with the corresponding cohort of the health care provider 101, thereby completing step 3707. Thereafter, the SP module stores the patient adherence data in association with the health care provider's cohort in the cohort database 305, thereby completing step 3708.

Next, at decision step 3709, the SP module determines whether all of the received patient adherence data for all the prescriptions has been parsed by cohort. If so, then the process ends at step 3711. However, if there remains patient adherence data that has not bee parsed by the SP module, then the method 3700 continues to step 3710, and as such, returns to step 3702 discussed above.

According to one embodiment of the present invention, more than one prescription of a patient may be combined in order to determine compliance data. Thus, if a patient has more than one prescription for a given substance, it may be the case that the prescriptions should be combined for the purposes of calculating compliance data. For example, prescriptions may be combined if they are for the same patient and the same substance, and the prescriptions have overlapping prescription dates. For example, if prescription 1 has a start date of Mar. 1, 2011 and stop date of Jun. 1, 2011 and prescription 2 has a start date of May 1, 2011 and a stop date of Oct. 1, 2011, then the prescriptions may be combined and considered one prescription for the purposes of determining patient adherence data.

4. Analyzing the Patient Adherence Data to Determine the Effectiveness of the Different Permutations of Supplemental Programs on Patient Adherence

After parsing the patient adherence data by cohort, the SP module analyzes the patient adherence data to determine the effectiveness of each of the different permutations of supplemental programs on patient adherence. In one embodiment of the present invention, when the current counter of all the cohorts of a program cohort group reach the maximum counter, the SP module ceases to activate the permutations of supplemental programs for the cohorts of the program cohort group, and begins to analyze patient adherence data to determine the effectiveness of the different permutations of the supplemental programs of a program cohort group on patient adherence. However, in other embodiments of the present invention, the SP module may analyze patient adherence data continuously in real-time, even as the SP module is also still activating permutations of supplemental programs for a program cohort group.

According to one embodiment of the present invention, one of the cohorts out of the plurality of cohorts of the program cohort group is a control group. Since the control group either does not comprise any associated supplemental programs (i.e., the permutation of supplemental programs of the control group is empty) or the control group comprises one or more supplemental programs that are also associated with every one of the other cohorts of the program cohort group, then the control group can be used as a basis of comparison to determine the effectiveness of the supplemental programs of the other cohorts of the program cohort group. Stated more simply, the SP module may determine the effectiveness of the permutations of supplemental programs by using the control group as a baseline indicator of standard patient adherence to the target drug.

In embodiments that do not comprise a control group, the basis of comparison may be the average patient adherence for the target drug in general. This may be determined by the SP module in many ways, including but not limited to, the patient adherence data for the target drug that is stored within the patient adherence database 307 and was generated by the Patient Adherence Generation Module 306. Further, in other embodiments that do not comprise a control group, the different cohorts may be simply compared to one another, with the assumption that the permutations of supplemental programs have a beneficial effect on patient adherence. After determining a basis of comparison (e.g., the control group), the SP module will analyze the patient adherence data of each cohort of a program cohort group to determine the effectiveness of each of the different permutations of supplemental programs on patient adherence.

In one embodiment of the present invention, the SP module determines the effectiveness using one or more algorithms that are configured to compare multiple sets of data to one another. According to one embodiment of the present invention, the algorithms are stored within the cohort database 305. The data that is compared to determine the effectiveness of the permutations of supplemental programs on patient adherence includes, but is not limited to, patient adherence data, coupon redemption data, and patient feedback data.

After the data is compared using the one or more algorithms, the SP module may display effectiveness data on a display device to an administrator of the SP system 300. This allows the administrator of the SP system 300 to visually interpret which permutation of supplemental programs was most effective for encouraging patient adherence to the target drug. As discussed in more detail below, the effectiveness data may be displayed in graphical representations or in numerical values.

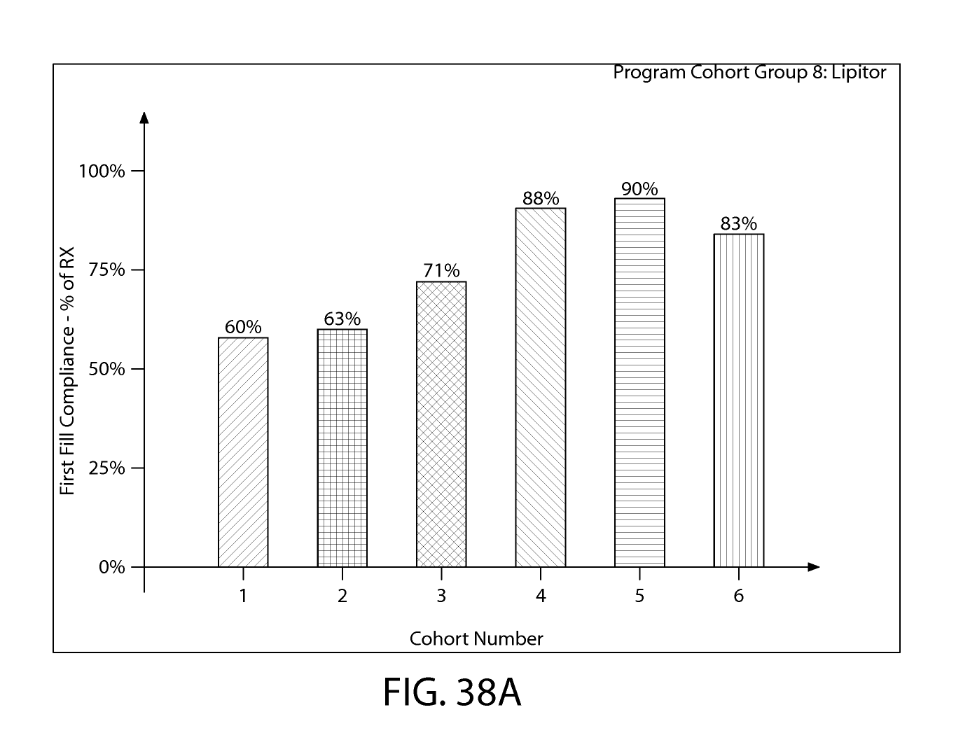

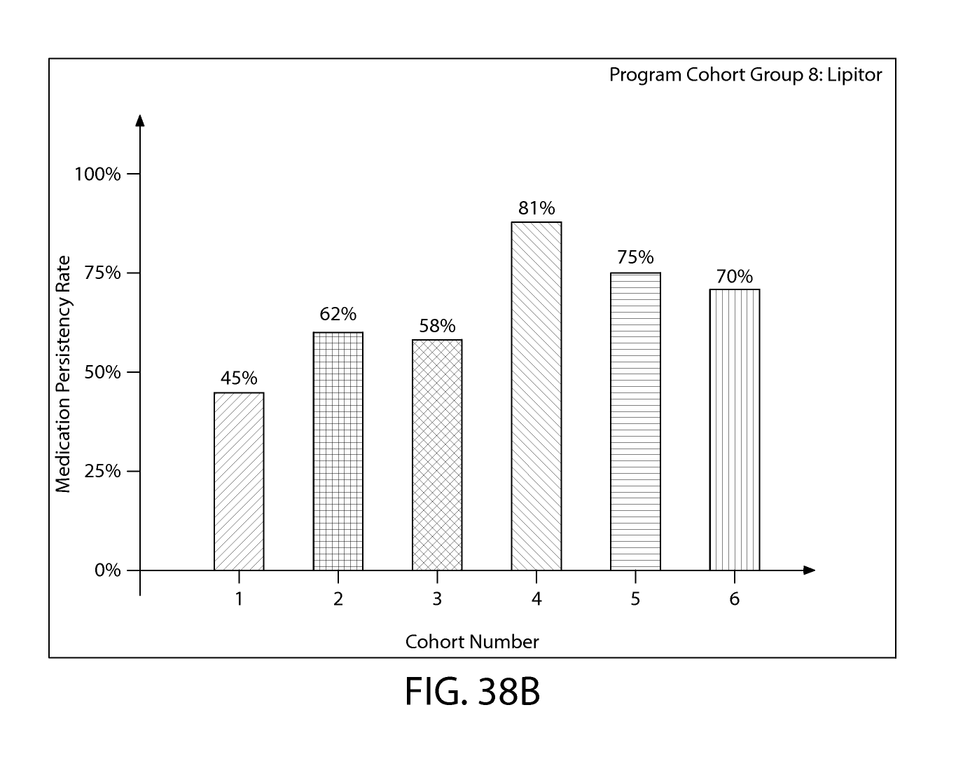

Referring to FIG. 38a, a graphical representation of the effectiveness of different permutations of supplemental programs on patient's first fill compliance according to one embodiment of the present invention is illustrated. For example, in one embodiment of the present invention, the SP module determines the effectiveness of the permutations of supplemental programs by comparing the first fill compliance data of the prescriptions of a cohort to the other cohorts of the program cohort group. It should be noted that first fill compliance (FFC) data indicates whether the patient filled the medication promptly after receiving the prescription. Further, in embodiments where one of the cohorts out of the plurality of cohorts is a control cohort, the SP module will compare the FFC data of the prescriptions of each cohort with the control cohort in order to determine the effectiveness of the supplemental programs of each cohort. The permutation of supplemental programs of the cohort whose prescriptions have the highest FFC data will be considered the most effective on patient adherence. This is because the patients receiving that permutation of supplemental programs of that cohort were more likely to comply with the first fill of the prescription, and this increase in adherence is determined to be due from the supplemental programs those patients received.

Referring to FIG. 38b, a graphical representation of the effectiveness of different permutations of supplemental programs on patient's medication persistency rate displayed on a display device according to one embodiment of the present invention is illustrated. For further example, in one embodiment of the present invention, the SP module determines the effectiveness of the permutations of supplemental programs by comparing the patient Medication Persistency Rate (MPR) data of the prescriptions of a cohort to the other cohorts of the program cohort group. It should be noted that MPR data is a percentage (from 1-100%) that indicates how often a patient filled a medication compared with how often s/he could have done so. If there is no available MPR data, a result is returned indicating N/A in place of an MPR percentage. Specifically, in embodiments where one of the cohorts out of the plurality of cohorts is a control cohort, the SP module will compare the MPR data of the prescriptions of each cohort with the control cohort in order to determine the effectiveness of the supplemental programs of each cohort. The permutation of supplemental programs of the cohort whose prescriptions have the highest MPR data will be considered the most effective on patient adherence. This is because the patients receiving that permutation of supplemental programs of that cohort were more likely to fill their prescription when having the opportunity.

Specifically, referring to FIGS. 38a and 38b concurrently, cohort number 1 is the control cohort, while cohort numbers 2-6 are other cohorts of the program cohort group that were each assigned a different permutation of supplemental programs to measure the effectiveness of those programs on patient adherence. It should be noted that cohort number 1 was not assigned any supplemental programs (i.e., its permutation of supplemental programs is empty). Further, the program control group is program control group 8, and the target drug is Lipitor®. As illustrated in FIG. 38a, cohort number 1, which was the control group, has a FFC of 60%. This means that 60% of the prescriptions that were written by the health care providers 101 of cohort 1 for the target drug were filled within the first fill interval of the prescription. Further, as illustrated in FIG. 38b, cohort number 1, which was the control group, has a MPR of 45%. This means that, on average, the patients who were prescribed the target drug by the health care providers 101 of cohort 1 had an MPR of 45%. Cohort number 1's FFC of 60% and MPR of 45% may be used as a baseline to determine the effectiveness of the other permutations of supplemental programs were assigned to the other cohorts.

As noted above, FIGS. 38a and 38b are two examples of graphical representations of the effectiveness of different permutations of supplemental programs on patient adherence. As exemplified in FIG. 38a, cohort number 5 has the highest FFC rate of 90%, and therefore, the permutation of supplemental programs assigned to cohort number 5 is the most effective at increasing patient's first fill compliance to the target drug. By contrast, cohort number 2 has the lowest FFC rate of the non-control cohorts of 63%, and therefore, the permutation so supplemental programs assigned to cohort number 2 is the least effective in increasing patient's first fill compliance to the target drug. Moreover, as exemplified in FIG. 38b, cohort number 4 exemplifies the highest MPR of 81%, and therefore, the permutation of supplemental programs assigned to cohort number 4 is the most effective at increasing a patient's persistence to the target drug regimen. By contrast, cohort number 3 exemplifies the lowest MPR rate of the non-control cohorts of 58%, and therefore, the permutation of supplemental programs assigned to cohort number 3 is the least effective at increasing a patient's persistence to the target drug regimen. Thus, as illustrated, depending on the means of measurement of patient adherence (FFC, MPR, etc.), different permutations of supplemental programs may be most effective. As a result, by using cohorts to test the effectiveness of supplemental programs on a variety of different measurements of patient adherence, the SP module may be used to determine the most effective combination of supplemental programs to increase patient adherence in the most desired manner.

However, it should be noted that the invention is not so limited, and in other embodiments of the present invention, the SP module determines the effectiveness of the permutations of supplemental programs by comparing one or more forms of patient adherence data of the prescriptions of the plurality of cohorts of the program cohort group. Stated another way, the invention is not limited to comparing FFC data and MPR data when determining the effectiveness of the plurality of cohorts of a program cohort group. Any patient adherence data may be used by the SP module. Finally, it should be noted that the graphic representation exemplified in FIGS. 38a and 38b may be displayed on a display device of the administrator of the SP system 300, to a pharmaceutical company, or to any other person or system of the system 1000.

For even further example, in another embodiment of the present invention, every cohort of a program cohort group, including a control cohort comprises a supplemental program that distributes a coupon for the target drug to the patient upon activation. In such instances, the non-control cohorts of the program cohort group all comprise different supplemental programs in addition to the supplemental program that distributes a coupon. As a result, the SP module measures the effectiveness of each permutation of supplemental programs by comparing the rates of coupon redemption of the prescriptions of each cohort of the program cohort group. Therefore, the patients who are receiving the permutation of supplemental programs of the cohort with the highest effectiveness on patient adherence will have redeemed their coupon more often than the patients receiving the permutations of supplemental programs of the other cohorts.

According to one embodiment of the present invention, after determining the effectiveness of the supplemental programs on patient adherence, the SP module generates patient adherence reports based on the determined effectiveness. After generation of the reports, the SP module mail deliver the reports to any one of the administrators of the SP system 300, any other system or module of the system 1000, or a particular pharmaceutical company. Examples of graphical reports are exemplified in FIGS. 38a and 38b. Nonetheless, it should be noted that the invention is not limited to any specific type or format or graphical report. Further, in alternate embodiments of the present invention, the patient adherence data of each cohort may be displayed purely as numerical value, as numerical values and graphical representations, or just graphical representations.

After the graphical report is generated by the SP module, the graphical report is saved to the cohort database 305 of the SP system 300. Further, according to one embodiment of the present invention, the cohort relation table is updated with the graphical report stored in association with the associated health care provider 101 and cohort of the graphical report.

### Patient Advisor System

According to another aspect of the invention, a patient advisor system is provided for tracking patient adherence to following a prescription drug or medication treatment regimen, and timely reporting details on the same to the health care provider contemporaneous with the time and at the point of service. In one embodiment, as shown in FIG. 1, the patient advisor system may comprise a patient adherence system 360 which is in operable communication with other component systems of the overall system such as via the internet or other suitable communication links. The patient adherence system 360 is configured and operable to retrieve, analyze, calculate, and transmit display patient adherence information via interacting with the other sub-systems. The patient adherence system 360 includes a Patient Adherence Generation Module 306 previously described herein.

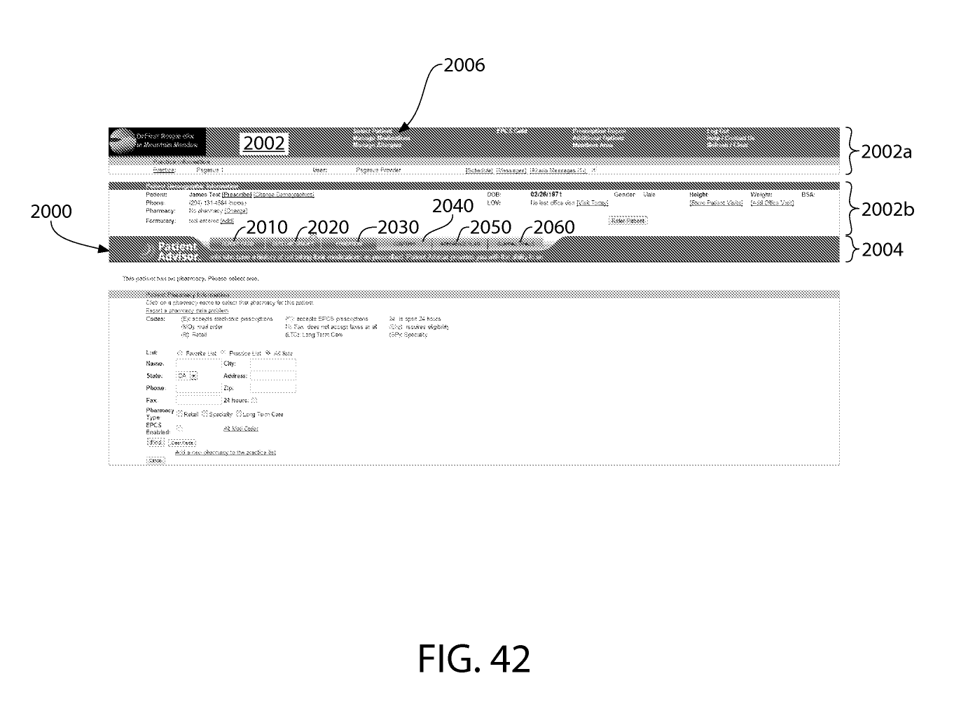

In one embodiment, the patient advisor system further is configured to generate a user interface which may be in the form of an interactive toolbar 2004 (see, e.g. FIG. 42) that is presented on a display of the HCP system or another display, as further described below. The toolbar provides a GUI interface that provides a health care provider or other user with access to various content related to patient medication adherence information and metrics, educational materials, clinical studies, and other information relevant to prescription medications for improving patient compliance with their medication regimens.

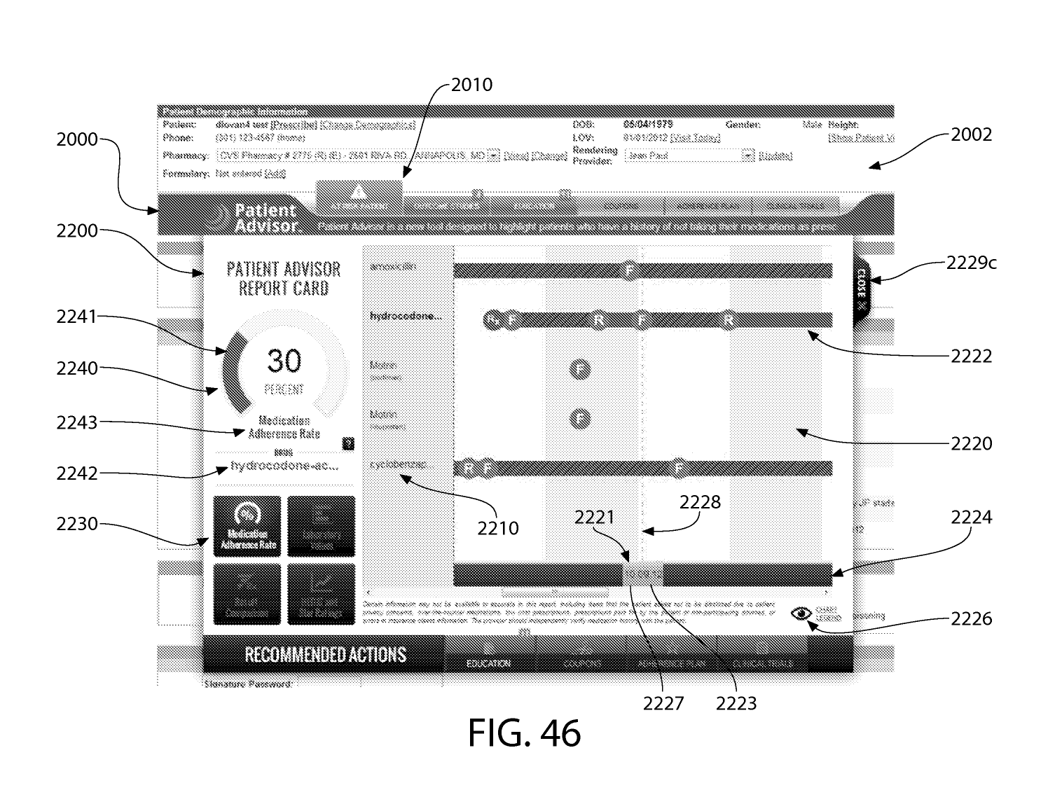

Embodiments of the toolbar 2004 may include a visual indicia displayed on the toolbar which alerts the health care provider of an “at risk” patient that is not following his or her prescribed medication regimen so that the health care provider can intervene with the patient at the time and point of service. In further embodiments of the patient adherence system, the degree to which the “at risk” patient has not been following the prescribed medication regimen is also graphically displayed in a manner which is visually and/or audibly readily recognizable by the health care provider using various indicia and/or sounds as described herein. The toolbar 2004 is further operable to access a patient advisor report card 2200 (see, e.g. FIG. 46) which gives the user a graphical overview of the patient's active medication list and associated medication adherence information, as further described below.

The patient advisor system advantageously enables health care providers to support patients between office visits with evidence-based patient education, co-pay savings, tools and resources. The system aims to help reduce first fill prescription abandonment, improve medication adherence rates with sustainable results, and allow providers to gain insight into patient behaviors. In one embodiment, the patient advisor system includes a set of services presented which may be accessed via the toolbar 2004 displayed across the EP system GUI such that when a patient has been identified, relevant information and services will be made accessible. In addition, a series of web service APIs are provided between the EP system 200 and the patient advisor system such that during the course of the drug prescribing event, the patient advisor system can provide context based co-pay savings and adherence materials for diseases and illnesses related to the drug being prescribed. Moreover, the patient advisor system is helpful to the health care provider in assessing whether symptoms observed during the present patient visit may possibly be attributable to the patient's lack of compliance with their prescribed medication regimen so that an appropriate intervention can be implemented.

FIG. 39 illustrates an exemplary embodiment of a system 1000 which includes a patient adherence system 360 having patient adherence reporting and display capabilities.

Referring initially to FIG. 1, the system 1000 includes the HCP system 100, EP system 200, SP system 300, pharmacy system 500, payor system 600, and a patient adherence system 360. Although all of the elements of the HCP system 100, EP system 200, SP system 300, pharmacy system 500, and payor system 600 are not explicitly depicted in FIG. 39, it should be recognized these systems are nonetheless included as shown in FIG. 1 and may be similar as discussed above in detail with reference to FIGS. 1-7. It should be noted that the communication links between the foregoing systems and components forming each part of the system (as illustrated via lines with arrows showing the flow of data/information exchange and signal transmission) may be accomplished by any suitable data communication link such as without limitation via the Internet (see, e.g. FIG. 1) and/or another form of wireless or wired communication links depending on the physical location and proximity of each system and components which operably interface with patient adherence system 360.

With reference to FIG. 39, the patient adherence system 360 in one embodiment generally includes a Medication History (“Medication Hx” for short) Service 382, a Patient Adherence Core 388, and a Payor Engine 318. Authentication server 380 is also shown which interacts with the patient adherence system 360 and EP system 200, as further described herein.

Patient adherence system 360 may further include a patient adherence database 307, a patient medication history database 308, and a candidate prescription database 309 as shown in FIG. 39. In general, patient adherence database 307 stores patient medication adherence data and calculated adherence metrics (e.g. MAR/MPR, FFC, etc.) which may be categorized by each patient. The patient medication history database 308 stores patient medication history data which may be categorized by each patient. The candidate prescription database 309 stores prescription data which may be categorized and associated with each patient. In one embodiment, databases 307, 308, and 309 may be embodied in computer readable medium 384 accessible to one or more of the servers which are configured for storing, retrieving, and organizing data stored in each database, as described below. In various embodiments, two of the foregoing databases may be combined and/or additional databases may be provided.

Medication Hx Service 382 is a functional sub-system of patient adherence system 360 which includes Candidate Prescription Server 315 and Medication 1H-x Poller 350. Medication Hx Poller 350 is a software program or routine running on and which configures Candidate Prescription Server 315 to perform the functions further described herein. In one embodiment, Candidate Prescription Server 315 is operably connected to patient medication history database 308 and a candidate prescription database 309 for data exchange shown in FIG. 39.

Patient Adherence Core 388 is a functional sub-system of the patient adherence system 360 which includes Adherence Server 316 and Patient Adherence Generation Module 306. Patient Adherence Generation Module 306 is a software program or routine running on and which configures Adherence Server 316 to perform the functions further described herein. In one embodiment. Adherence Server 316 is operably connected to patient adherence database 307 for data exchange as shown in FIG. 39.

In patient adherence system 360 shown in FIG. 39, it should be noted that the Patient Adherence Generation Module 306 (see, e.g. FIG. 4), the Medication History Poller 350 (see, e.g. FIG. 16), and the patient adherence database 307 (see, e.g. FIG. 4) of patient adherence system 360 may generally be similar in configuration and function to those as described above and previously shown in the parenthetical figures. In other embodiments, these components may the different.

The patient medication history database 308 stores information relating to the medication history of patients. Generally, the patient medication history data comprises information relating to the medication history of the patient for one or more prescriptions of one or more prescribed substances or drugs. Patient medication history data includes, but is not limited to, information relating to prescriptions written for a patient and information relating to prescription fills and refills (i.e., drug fill and refill data). More specifically, patient medication history may comprise any of the drug-related data described above (e.g., drug details such as the dosage, strength, form, duration, quantity, date, and refills) with reference to a prescription, the prescription start date and stop date, information relating to whether the patient picked up the prescription, the duration in which the prescription sat at the pharmacy prior to patient pickup, the number of refills of the prescription that the patient filled, the time frame between refills in comparison to the duration of each prescription, information relating to the prescription filling sub-system 502, information relating to the payor, and information relating to the patient. In one embodiment of the present invention, the medication history relates to prescriptions that were processed by the EP module or the SP module. However, the invention is not so limited, and in other embodiments, the patient medication history relates to all prescriptions that were previously processed for any patients. Further, it should be noted that the patient medication history data may be similar to the patient medication history data stored in the EP database 201 and the record database 304, as discussed in more detail above.

Although exemplified as two separate databases, it should be noted that the invention is not so limited, and in other embodiments of the present invention, the candidate prescription database 309 and the patient medication history database 308 may be combined. Further, in one embodiment of the present invention, the candidate prescription database 309, the patient medication history database 308, and the patient adherence database 307 may be combined into a single database. For example, in one such embodiment, the candidate prescription database 309 and the patient medication history database 308 may be combined into the patient adherence database 307. Thus, in such embodiments, the patient adherence database 307 stores prescription data, patient medication history data, and patient adherence data.

According to the one embodiment, with reference to FIG. 39, the Candidate Prescription Server 315 of the Medication Hx Service 382 may receive data from the SP system 300 relating to patient prescriptions in which supplemental programs were activated, by the SP Candidate Prescription Module 317. Specifically, the Candidate Prescription Server 315 in this case receives supplemental program (SP) events relating to electronic prescriptions from a SP Candidate Prescription Module 317 which is a software program or routine that runs on SP Server 310 (see also FIG. 4) and resides on the SP system 300 in a non-transitory computer readable medium such as without limitation memory 313.

In general, the SP Candidate Prescription Module 317 polls the record database 304 as shown in FIG. 39 for information relating to electronic prescriptions in which supplemental programs were activated. Thus, in one embodiment of the present invention, when the SP module activates one or more supplemental programs for an electronic prescription, the SP Candidate Prescription Module 317 generates a record of such and stores the record in the SP record database 304. These records are called “SP events” herein and comprise information relating to the patient, the prescribed substance, and the activated supplemental programs for the electronic prescription. However, in other embodiments of the present invention, the SP module generates SP events after activating supplemental programs.

Therefore, according to one embodiment of the present invention, the SP candidate prescription server 317 periodically polls the record database 304 for SP events. Upon identifying SP events, the SP candidate prescription server 317 creates a log of SP events and stores the log in the record database 304. Thereafter, the SP candidate prescription server 317 transmits the log comprising the SP events to the candidate prescription server 315. According to one embodiment of the present invention, the SP candidate prescription server 317 transmits the log comprising the SP events to the Candidate Prescription Server 315 on a daily basis. However, the invention is not so limited, and in other embodiments, the SP candidate prescription server 317 transmits the log comprising the SP events to the candidate prescription server 315 on a periodic basis other than daily including “on the fly” (i.e. on demand) upon receiving a request.

According to one embodiment of the present invention, after receiving the log of SP events, the Candidate Prescription Server 315 transmits the log of SP events to the Candidate Prescription Module 220. After receiving the log of SP events, the Candidate Prescription Module 220 periodically polls the EP database 201 for prescriptions that match the prescriptions identified in the log of SP events. After identifying the relevant prescriptions, the Candidate Prescription Module 220 retrieves information relating to those prescriptions and transmits the prescription data to the Candidate Prescription Server 315. Thus, the Candidate Prescription Server 315 operably receives prescription data from the EP database 201; the prescription data relating specifically to those prescriptions identified in the log of SP events and in which supplemental programs were activated by the SP module. According to one embodiment of the present invention, the candidate prescription module 220 matches prescriptions to SP events using the patient information, the drug name, the insurance companies, the drug classifications, etc. and only transmits prescription data relating to those prescriptions to the candidate prescription server 315.

Therefore, after receiving the log of SP events from the SP Candidate Prescription Module 317, the Candidate Prescription Server 315 receives prescription data relating to the prescriptions identified in the log of SP events from a Candidate Prescription Module 220. According to one embodiment of the present invention, the Candidate Prescription Module 220 is a software program or routine that resides on the EP system 200 and polls the EP database 201 for new prescription data. Thus, by providing the Candidate Prescription Server 315 with the log of SP events, the candidate prescription server, and ultimately the Medication Hx Poller 350, may receive more detailed information relating to the prescriptions in which supplemental programs were activated from the EP database 201. In turn, the Patient Adherence Generation Module 306 may then generate patient adherence data for those prescriptions in order to perform any subsequent processing (e.g., determining the effectiveness of different permutations of supplemental programs for cohort analysis). However, the invention is not so limited, and in alternate embodiments, the Candidate Prescription Module 220 may reside on the patient adherence system 360 or the SP system 300.

According to another embodiment of the present invention, the Candidate Prescription Server 315 simply receives information relating to all prescription events from both the SP Candidate Prescription Module 317 and/or the Candidate Prescription Module 220. In such embodiments, whenever a prescription is processed by either the EP module or the SP module, an event is recorded by the respective module of the EP system or the SP system. Thereafter, the Candidate Prescription Module 220 or SP Candidate Prescription Module 317 transmits information relating to that prescription (e.g., prescription data) to the Candidate Prescription Server 315. Thus, in such embodiments, the Candidate Prescription Server 315 receives prescription data for all prescriptions that were processed by either the EP module or the SP module. Nonetheless, it should be noted that in other embodiments of the present invention, any number of constraints may be placed on the transmission of prescription data to the Candidate Prescription Server 315.

In yet other embodiments, the Candidate Prescription Server 315 may receive information relating to all prescription events from only the Candidate Prescription Module 220 of the EP system for which prescriptions are processed. Accordingly, it will be appreciated that any of the foregoing process and data flow paths for transmitting prescription data to Candidate Prescription Server 315 may be accomplished by configuring the Candidate Prescription Server with an appropriately constructed computer program instructions.

The prescription data is information relating to prescriptions that were written by a health care provider 101 for a patient. Prescription data includes, but is not limited to, patient information, prescribed substance information (name, date, dosage, refills, strength, etc.), health care provider information, and payor information. In one embodiment of the present invention, the received prescription data is only for electronic prescriptions in which supplemental programs were activated for the patient by the SP module. However, the invention is not so limited, and in alternate embodiments, the candidate prescription server 315 may receive prescription data for prescriptions in which supplemental programs were not activated. After receiving the prescription data, the candidate prescription server 315 stores the prescription data in the candidate prescription database 309. Thus, the candidate prescription database 309) stores information relating to prescriptions that were processed by the EP module and/or the SP module.

The foregoing components of the patient adherence system 360 and related processes are described in further detail below.

Candidate Prescription Server

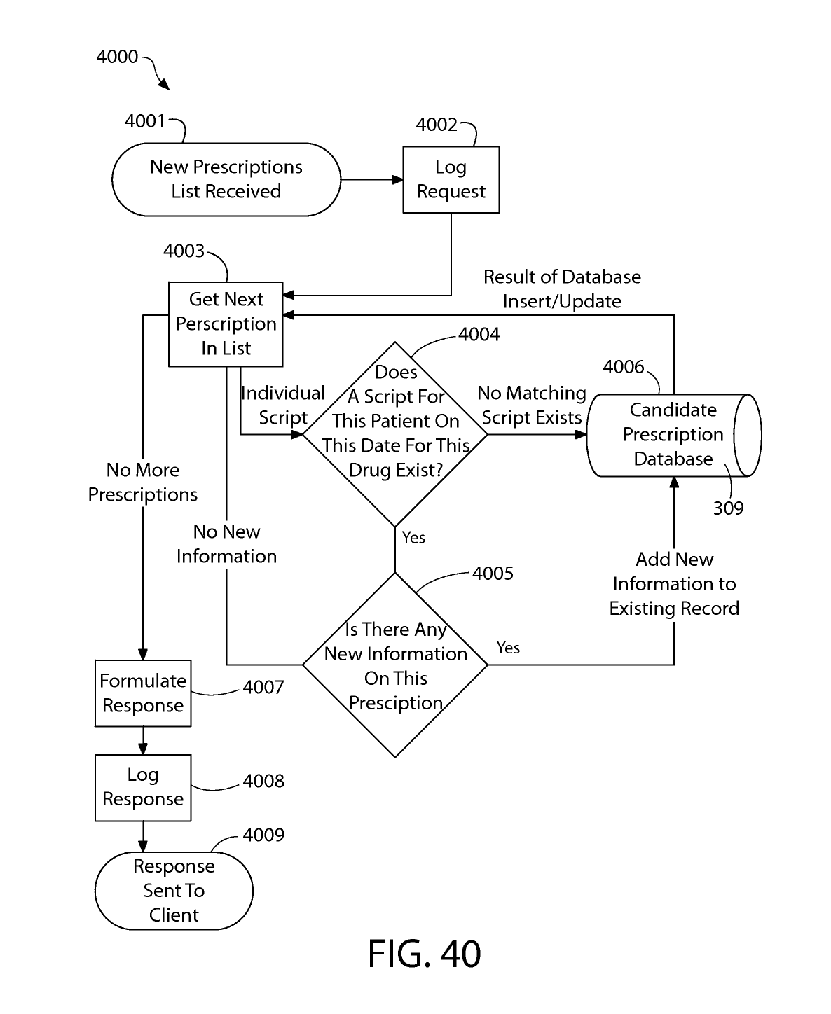

Referring to FIG. 40, a schematic flow chart of the processing of the Candidate Prescription Server 315 according to one embodiment of the present invention is illustrated. FIG. 40 exemplifies one non-limiting example of a method 4000 depicting steps showing how the Candidate Prescription Server 315 may receive prescription data according to one embodiment of the present invention. In step 4001, the Candidate Prescription Server 315 receives a list of prescriptions. As noted above, this may be from either the SP Candidate Prescription Module 317 or the Candidate Prescription Module 220. After receiving the list of prescriptions, the Candidate Prescription Server 315 logs the request in step 4002, and picks a prescription off of the list in step 4003. Moreover, it should be noted that the Candidate Prescription Server 315 may receive information relating to all prescriptions processed by the SP module and the EP module, such information received via the SP Candidate Prescription Module 317 and the Candidate Prescription Module 220, respectively.

Next, in decision step 4004, the Candidate Prescription Server 315 determines whether the candidate prescription database 309 has stored prescription data that relates to the prescription indicated on the received prescription list. This determination may be made using the prescription data, the patient data, and the prescribed substance data. For example, in one embodiment of the present invention, the Candidate Prescription Server 315 determines that prescription data exists if there is existing prescription data that matches in both patient information and prescribed substance information.

If no matching information exists in the candidate prescription database 309, the Candidate Prescription Server 315 creates a record of prescription data relating to the prescription, and stores such in the candidate prescription database 309, thereby completing step 4006. However, if prescription data already exists for the prescription, then the method continues to step 4005, and the Candidate Prescription Server 315 determines if there is any additional information received from either the SP Candidate Prescription Module 317 or the Candidate Prescription Module 220 relating to the prescription. There may be new or additional prescription information if information relating to the prescription was stored in the candidate prescription database 309 prior to the prescription being processing by either the EP module or the SP module. If there is any new or additional information relating to the prescription, then the Candidate Prescription Server 315 adds the additional prescription information to the associated prescription data and stores such in the candidate prescription database 309, thereby completing step 4006. However, if no new information exists, then the method returns to step 4003, and the Candidate Prescription Server 315 retrieves another prescription from the list. Further, it should be noted that after completing step 4006, the Candidate Prescription Server 315 also returns to step 4003 and retrieves another prescription from the list.

This method continues until the Candidate Prescription Server 315 has analyzed each prescription of the received list of prescriptions. Thereafter, the Candidate Prescription Server 315 formulates and logs a response, thereby completing steps 4007 and 4008, and transmits the response back to either the SP Candidate Prescription Module 317 or the Candidate Prescription Module 220. Thus, by performing the method 400, Candidate Prescription Server 315 may populate the candidate prescription database 309 with updated prescription records for all new prescriptions processed by either the EP module or the SP module.

Medication History Poller

In general, the Medication History Poller (Medication Hx Poller) 350 includes a software program or routine in some embodiments that polls the candidate prescription database 309 for eligible prescriptions, obtains medication history data for patients of eligible prescriptions, and stores the medication history data in the patient medication history database 308. According to one embodiments of the present invention, with reference to FIG. 39, the Medication Hx Poller 350 begins by first polling the candidate prescription database 309 to obtain all of the patient prescriptions that are still active. It should be noted that, in accordance with one embodiment of the present invention, the candidate prescription database 309 stores prescription data for the prescriptions in which supplemental programs were activated (i.e. SP events). Thus, in such embodiments, the Medication Hx Poller 350 gathers prescription data from the candidate prescription database 309 for patients for whom supplemental programs were activated such that patient adherence data may be generated for those patients.

As noted above, however, the Candidate Prescription Server 315 receives prescription data from both the EP system 200 and/or the SP system 300), and stores the prescription data in the candidate prescription database 309. Consequently, the Medication Hx Poller 350 periodically polls the candidate prescription database 309 to obtain all active prescription (Rx) data stored in the database regardless of the source of the prescriptions.

As noted above, according to one embodiment of the present invention, the Medication Hx Poller 350 polls the candidate prescription database 309 to obtain prescription data for all of the prescriptions that are still active. Such prescriptions are considered to be eligible prescriptions. The Medication Hx Poller 350 determines that a particular prescription is “active” if the stop date of the prescription is greater than or equal to the current date. It should be noted that the stop data of the prescription is the total duration of the prescription, which includes all of the possible refills, from the start date of the prescription. For example, if a prescription is written on Jan. 1, 2012 (the prescription start date), comprises 30 pills, directs the patient to take 1 pill per day, and has 2 refills, then the total duration of the prescription is 90 days. Thus, the stop date of the prescription is Mar. 30, 2012 (90 days from Jan. 1, 2012). Further, in an alternate embodiment, a prescription will only be considered to be “active” if the current date is not within a predetermined number of days (e.g. 7 days) from the stop date of the prescription.

Further, according to one embodiment of the present invention, the Medication Hx Poller 350 may be configured to only obtain prescription data for those patients who have not had their medication history queried for a predetermined period of time. This may be referred to as the drug history fetch interval. Thus, the Medication Hx Poller 350 will only obtain prescription data if the patient of the prescription has not had their medication history obtained in the past predetermined number of days (e.g., 14 days). This helps to improve the overall efficiency of the Medication Hx Poller 350. Nonetheless, it should be noted that the invention is not so limited, and in other embodiments of the present invention, the Medication Hx Poller 350 polls the candidate prescription database 309 for prescription data of prescriptions regardless of how recent the Medication Hx Poller 350 had last obtained patient medication history data for the patient of those prescriptions. Further, it should be noted that the invention is not limited to the specific order of processing performed by the Medication FHx Poller 350.

According to one embodiment of the present invention, after obtaining the prescription data for all active prescriptions (whose patients have not had their medication history queried for a predetermined period of time in some embodiments), the Medication Hx Poller 350 parses the prescription data to determine information relating to the patient, such as, but not limited to the name of the patient, the age of the patient, and other identifying information. Further, the Medication Hx Poller 350 may also parse the prescription data to determine information relating to the prescribed substance, the provider, and/or the payor.

Next, with continuing reference to FIG. 39, in addition to obtaining active prescription data from candidate prescription database 309 as described above, Medication Hx Poller 350 then also requests and obtains the medication history data for the eligible active prescriptions. Specifically, the Medication Hx Poller 350 may transmit at least some of the patient data, the prescribed substance or drug data, the provider data, and/or the payor data obtained from the prescription data stored in the candidate prescription database 309, along with a request for patient medication history information to the Payor Engine 318. In one embodiment, the Payor Engine 318 is a computer program or set of instructions (e.g. software) residing in patient adherence system 360 on any one of the computer readable medium or memory devices described herein which may be accessible to and running on Candidate Prescription Server 315 or Adherence Server 316.

Upon receiving the information, the Payor Engine 318 transmits the information along with a request to the pharmacy system 500 (e.g. Surescripts®) for patient medication history data. Thereafter, the Payor Engine 318 receives the requested medication history data relating to active prescriptions for each patient requested from the pharmacy system 500. Upon receiving the medication history data relating to the prescription for the patient, the Payor Engine 318 transmits the medication history data to the Medication Hx Poller 350, which in turn stores the patient medication data in the patient medication history database 308. This patient medication history data will be used by the Patient Adherence Core 388 to calculate patent medication adherence metrics, as further described herein.

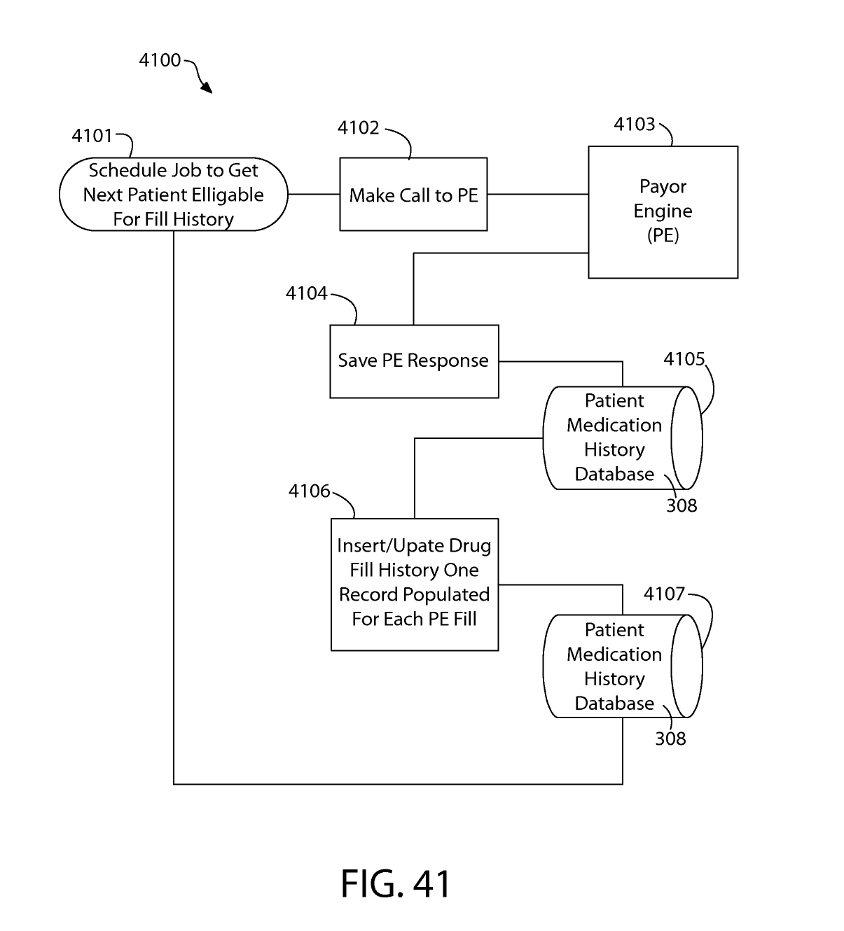

Referring to FIG. 41, a schematic flow chart is shown illustrating an exemplary method for the Medication Hfx Poller 350 to obtain medication history data via the Payor Engine 318 according to one embodiment of the present invention. The method 4100 begins at step 4101 with the Medication Hx Poller 350 scheduling a job to obtain patient medication history data. This may be scheduled through either (1) Poller 350 selecting an eligible prescription from candidate prescription database 309 for which to obtain medication history data, which in some embodiments may be initiated via a predetermined polling schedule programmed into the Poller 350, or (2) upon receipt of a specific request for medication history data for a particular patient or another triggering event received by the Medication Hx Service 382 from an external source (e.g. EP system 200 or HP system 100).

After selecting an eligible prescription from either the candidate prescription database 309 or receiving a patient specific request, the Medication Hx Poller 350 transmits information relating to the eligible prescription with a request to obtain medication history data to the Payor Engine 318 for a specific patient, thereby completing step 4102. Next, at step 4103, the Payor Engine 318 receives the information and processes the request, and thereafter transmits the request to one or more systems, such as without limitation the pharmacy system 500. Thereafter, the Payor Engine 318 receives the requested medication history data from pharmacy system 500 relating and transmits the medication history data to the Medication Hx Poller 350. Next, at steps 4104 and 4105, the Medication Hx Poller 350 aggregates the data received from the Payor Engine 318 and saves the medication history data (“response”) from the Payor Engine 318 in patient medication history database 308.

After saving the response, in step 4106, the Medication Hx Poller 350 next checks the patient medication history database 308 for existing medication history data that corresponds to the received medication history data, and combines or associates the aggregated medication history data received from the Payor Engine 318 with corresponding medication history data previously stored in the patient medication history database 308. Thereafter, the Medication Hx Poller 350 stores the combined medication history data in the patient medication history database 308 in correlation with the associated prescription. Thus, when completed, the patient medication history database 308 has an up-to-date and aggregated collection of medication history data stored by prescription on a per patient basis. Medication history data comprised of fill data for all active medications prescribed for each patient over an interval of time is therefore stored in patient medication history database 308.

Patient Adherence Generation Module

As noted above, the patient adherence system 360 further comprises Patient Adherence Generation Module 306. In general, the Patient Adherence Generation Module 306 is a software program or routine running on Adherence Server 316 that retrieves/loads medication history data and prescription data as required from patient medication history database 308 which is populated by Medication Hx Poller 350, and then calculates and generates patient adherence analytics or data (e.g. “adherence metrics”) using appropriately configured algorithms. The adherence metrics may be MAR (aka MPR), FFC, and others which typically have a calculated numeric value as further described herein.

According to one non-limiting embodiment of the present invention, the Patient Adherence Generation Module 306 may calculate and generate patient adherence data/metrics through essentially six primary steps described below to provide one non-limiting example for illustrating the basic process: (1) loading prescription data and prescription fill data (patient medication history data) for a given patient and all active patient prescriptions; (2) merge prescription and prescription fill data; (3) calculate patient adherence data/metrics (e.g. MAR, etc.); (4) calculate risk level for controlling patient advisor compliance dashboard display; (5) build drug list for medication menu; and (6) generate fill event timelines for each drug on list. These steps are further described below. As noted above, one example of a Patient Adherence Generation Module 306 is the HMACS module by DrFirst®.

Load Qualified Prescriptions

Referring to FIG. 39, the Patient Adherence Generation Module 306 begins by loading data relating to a selected given patient's active prescriptions from the candidate prescription database 309 which has been populated by Candidate Prescription Server 315 and historical prescription fill data (patient medication history data) for the given patient from patient medication history database 308 which has been populated by the Medication Hx Poller 350.

To complete this step in the process, the Patient Adherence Generation Module 306 polls the patient medication history database 308 for all drug fills for a given prescription and patient. According to one embodiment, the Patient Adherence Generation Module 306 may identify the drug fill data for a prescription using the patient's identification information (e.g., the patient's name, social security number, etc.). Upon identifying all active drug fill data that relates to prescriptions for the given patient, the Patient Adherence Generation Module 306 then retrieves and loads the drug fill data from the patient medication history database 308.

Similarly, the Patient Adherence Generation Module 306 polls the candidate prescription database 309 for all drug prescriptions for the same given patient based on the patient's identification information (e.g., the patient's name, social security number, etc.). Upon identifying all active drug prescriptions for the given patient, the Patient Adherence Generation Module 306 then retrieves and loads a list of active prescriptions from the candidate prescription database 309.

(2) Merge Prescription and Fill Data

Next, Patient Adherence Generation Module 306 compares and merges the prescription data (i.e. active prescriptions written and submitted via the EP system 200 for a given patient, as described herein) for the given patient and their active prescriptions with the medication history data such as drug fill data. As noted above, the drug fill data comprises information relating to the fill days, the fill quantity, the first fill interval, and the fill date of the prescription. Specifically, according to one embodiment, the Patient Adherence Generation Module 306 searches for and matches the prescription data for each given patient prescription with its corresponding historical drug fill data, which in one embodiment is sourced from the pharmacy system 500 as further described herein.

The patient adherence generation module 306 may match the drug fill data with the prescription data by using at least one of the drug name (including the matching of brand names to generics and vice versa), the drug fill date with the start date of the prescription (e.g. if the drug fill date is greater than or equal to the start date of the prescription), and the drug fill date with the stop date of the prescription (e.g., if the drug fill date is less than or equal to the stop date of the prescription). Further, according to one embodiment of the present invention, the substance of a drug fill data matches a prescribed substance by strength if the substance of the drug fill and the prescribed substance is equivalent in name and strength. It should be noted that in one embodiment of the present invention, if there is more than one prescription that matches with drug fill data, then the patient adherence generation module 306 will only match the most recent prescription with the drug fill data.

Further, it should be noted that, in accordance with some embodiments of the present invention, if a patient has more than one prescription for a given prescribed substance, the patient adherence generation module 306 may combine the prescription data for those prescriptions for purposes of calculating adherence data. Thus, in such embodiments, the patient adherence generation module 306 combines all the related prescription data for the given patient. Specifically, the patient adherence generation module 306 may combine the prescription data for two or more prescriptions for purposes of determining patient adherence data if the two or more prescriptions are for the same substance and the prescription total days of the two or more prescriptions overlap. In such instances, the patient adherence generation module 306 sets the prescription start date of the combined prescriptions are the earliest of the start dates of the prescriptions individually. Similarly, the patient adherence generation module 306 sets the prescription stop date of the combined prescriptions are the latest of the stop dates of the prescriptions individually. After combining the two or more prescriptions, the patient adherence generation module 306 treats the combined prescription as one for all other purposes.

(3) Calculate and Generate Patient Adherence Data/Metrics

In the next step, the Patient Adherence Generation Module 306 calculates and generates patient adherence data and metrics. In general, patient adherence data comprises information relating to a patient's adherence, compliance, and/or persistency to taking the prescription medications prescribed for the patient by the health care provider. The patient adherence data may comprise information of value to the health care provider which are a numerical measure of medication regimen adherence metrics such as without limitation the patient's Medication Adherence Rate (MAR) data (also referred to as Medication Persistency Rate-MPR), the patient's first fill compliance (FFC) data, and other relevant adherence data.

In one embodiment, MAR is calculated. The Patient Adherence Generation Module 306 is configured with the appropriate algorithms necessary to calculate the MAR or other adherence data/metrics of interest using the patient medication history data previously downloaded from the patient medication history database 308.

After generating the patient adherence metric data for one of the given patient's prescription medications, the patient adherence generation module 306 stores the adherence data in the patient adherence database 307. After generating patient adherence data for the foregoing single prescription drug associated with the given patent, the patient adherence generation module 306 then repeats the process to calculate and generate patient adherence data for each additional drugs prescribed for the patient until adherence data has been generated for all of the active prescriptions associated with the patient. Further, it should be noted that if the patient adherence generation module 306 loaded existing adherence data for the patient prior to generating the additional or updated patient adherence data, the patient adherence generation module 306 updates the existing patient adherence data in the patient adherence database 307 to reflect the newly generated patient adherence data. Thus, the patient adherence database 307 comprises up-to-date adherence data for all active prescriptions associated with the given patient.

As noted above, in one embodiment of the present invention, patient adherence data may include first fill compliance (FFC) data and patient Medication Adherence Rate (MAR) data. These two parameters provide are valuable to the health care provider 101 as relevant indicators which yield quick snapshot of how diligent a given patient has been in following their prescription medication treatment regimen for one or a plurality of prescribed medications or substances. Generally, FFC data comprises information relating to whether or not the patient has been prescribed a particular prescribed substance (e.g. the target drug) in the past and/or whether the patient picked-up or took the particular prescribed substance (e.g., the target drug) in the past.

In one embodiment of the present invention, FFC data of a prescription has three possible values: (1) present; (2) absent; or (3) unknown. The FFC data has a value of present if there exists a qualifying drug fill where: (1) the till date of the prescription may be on the same or after the start date of the prescription; and (2) the fill date of the prescription is before the end of the end of the first fill interval of the prescription. Thus, the prescription has a FFC value of present if the prescription was filled by the patient after the prescription was written by the health care provider 101, but before the end of the first fill interval of the prescription. If the prescription has a FFC value of present, then the prescription is first fill compliant.

The FFC data has a value of unknown if the start date of the prescription is after the end of the first fill interval of the prescription. In such instances, the prescription occurred after the first fill interval and therefore may be a refill of the prescription. Thus, since information relating to a refill of a prescription does not indicate whether the patient was compliant with filling their prescription on the first fill, the prescription has a FFC value of unknown. In all other instances, the FFC data has a value of absent.

Generally, MAR data comprises information relating to the patient's adherence to a particular prescribed substance. For example, MAR data may comprise information relating to the degree or extent of conformity of the patient to the recommendations about day-to-day treatment by the health care provider 101 with respect to the timing, dosage, and/or frequency of a particular prescribed substance, information relating to the extent to which a patient acts in accordance with the prescribed interval and dose of a dosing regimen of the particular prescribed substance, and information relating to the continuation the treatment by the patient for the prescribed duration of the particular prescribed substance. Therefore, in one embodiment of the present invention, the MAR data comprises, as a numerical percentage, information relating to how often the patient filled a prescription compared with how often they could have filled it optimally.

According to one embodiment of the present invention, if there are fewer than two drug fills or refills of a particular prescription, then the MAR data for that prescription may be assigned a value of “unknown” and displayed in the toolbar as “N/A” in some embodiments. In one embodiment, four events are needed to calculate MAR including (1) start date of prescription, (2) first fill, (3) a refill, and (4) end date of prescription. The MAR data is calculated as follows:

First, the Patient Adherence Generation Module 306 calculates adherence interval days for the prescription. As noted above, the adherence interval is the number of days in an adherence interval, or the number of days that a supply of prescription is available to the patient during the adherence interval. For each qualifying prescription, the Patient Adherence Generation Module 306 determines the adjusted prescription start date (the later of the start date of the prescription or the adherence interval start date), the adjusted prescription stop date (the earlier of the prescription stop date or the current date), and the adherence interval days of the prescription (the adjusted stop date minus the adjusted start date).

Next, the Patient Adherence Generation Module 306 calculates the total fill days of the prescription. As noted above, the total fill days are a measure of the number of days that a supply of a prescription is actually filled by the patient during the adherence interval. For each qualifying prescription, the patient adherence generation module 306 calculates the adjusted fill start date (the later of the fill date of the prescription or the adherence interval start date of the prescription) and the adjusted fill stop date (the earlier of the fill date plus the fill days or the current date). Next, the Patient Adherence Generation Module 306 calculates the total fill days of the prescription (the adjusted fill stop date minus the adjust fill start date). Finally, the patient adherence generation module 306 calculates the MAR data for the prescription (the total fill days divided by the adherence interval days−multiplied by 100 to show as numerical percentage).

As already noted herein, it should be recognized that the patient medication adherence metric Medication Adherence Rate (MAR) may alternatively be expressed as Medication Persistency Rate (MPR) which has the same meaning and is calculated in the same foregoing manner as MAR using historical pharmacy fill information. Accordingly, the terms MPR and MAR may be used interchangeably herein. The MPR or MAR value, which will numerically be a fraction, is multiplied by 100 herein to calculate a numeric MAR % for each medication where possible. In general, the theoretical range of possible MPR/MAR values expressed as a percentage may be 1% to 100%.

(4) Calculate Risk Level

In some embodiments, the Patient Adherence Generation Module 306 may optionally calculate a “risk level” associated with the patient's adherence data such as MAR. In general, the lower the MAR %, the greater the patient risk for experiencing health related problems associate with not following their prescribed medication regimen. In one embodiment, the calculated risk level may be used to control the display and/or appearance of information and/or icons appearing on the GUI of display device 121 of the HCP system 100 for interacting with the EP (electronic prescription) system 200, as more fully described below. Briefly, in one non-limiting example, the Report Card tab 2010 appearing in the patient advisor toolbar 2004 may change color as follows: Green—MAR is 71% or greater: Yellow—MAR is between 60% to 70%; Red—MAR is less than 60%; which visually presents the level of patient risk (see, e.g. FIGS. 42-45). This same approach may analogously be used to change of the appearance and/or color of the patient advisor report card summary field 2240 which displays the MAR % numeric value (see, e.g. FIG. 46). It will be appreciated that other uses of the risk level may be employed for the benefit of the health care provider and patient.

(5) Build Drug List

The Patient Adherence Generation Module 306 may construct or build a list of all active drugs which have been retrieved and analyzed in the foregoing steps associated with the given patient presently being analyzed for medication adherence data. In one embodiment, as further described below, the list of active drugs may be used to compile and generate a medication menu 2210 displayable in the patient advisor report card 2200 (see, e.g. FIG. 46). The list of drugs is saved to patient adherence database 307 by Patient Adherence Generation Module 306.

(6) Generate Prescription Fill Events

Using the list of active drugs for the given patient, the Patient Adherence Generation Module 306 identifies and generates prescription fill events for each medication. The fill events are based on the historical patient medication history downloaded to Module 360 from the patient medication history database 308, as described above. In one embodiment, Patient Adherence Generation Module 306 is operable to generate individual drug timelines for each medication which includes information such as without limitation prescription date), fill date, expected fill date, prescription end date, gap in fill date, and prescription duration. A drug timeline is construction and associate with each drug by brand or generic name where sufficient data exists to generate a timeline (e.g. a sufficient number of fill/refill events). The drug timelines and other fills event information is saved to patient adherence database 307 by Patient Adherence Generation Module 306.

It will be appreciated that the foregoing steps may be performed in any suitable sequence which may be different than presented herein, and some of the steps may be performed simultaneously in some embodiments. Additional steps and sub-steps may be provided in other embodiments. Accordingly, the present invention is not limited to the foregoing steps and sequence.

Adherence Server—Generation and Display of Adherence Data

According to one aspect of the patient advisor system, a graphical user interface (GUI) comprising a compliance dashboard with interactive toolbar is provided which is displayable on a video display device such as without limitation display 121 of the HCP system 100. The compliance dashboard may include lists of all active medications/drugs for each patient and charts which graphically depict patient medication adherence data in visual and graphical formats which can be readily viewed and easily interpreted by a health care provider 101. The compliance dashboard may further include a medication report card for each patient which displays patient medication adherence data and metrics.

In general, with reference to FIG. 39, the Adherence Server 316 is a front end device of the patient adherence system 360 that receives and processes requests for patient medication adherence data originating from the EP module 202 of the electronic prescription system 200 (see also FIGS. 1 and 4) or other systems that may be operably connected to patient adherence system 360. In some embodiments, the adherence data requested may include without adherence metrics such as without limitation MAR (MPR), FFC, or others based on programming Patient Adherence Generation Module 306 with the appropriate calculation algorithms for the metric to be determined.

In one embodiment, as further described herein, the request for patient adherence data may be automatically generated by EP module 202 in conjunction with a health care provider 101 electronically prescribing a medication or pharmaceutical substance for a patient via their terminal 120 using the EP system 200 such as by the health care provider selecting/inputting a patient name in the EP system, as further described herein.

Referring to FIG. 39, after the Adherence Server 316 receives the patient adherence data request from EP module 202, the Adherence Server 316 routes the request to the Patient Adherence Generation Module 306. Thereafter, the Patient Adherence Generation Module 306, based on the received request, retrieves the respective adherence data from patient adherence database 307 for the patient.

In some embodiments, the Patient Adherence Generation Module 306 is further operable to generate interactive adherence GUIs comprising visual data images and icons such as charts, graphs, symbols, etc. in one or more colors which are representative of patient medication adherence data and presented to health care providers 101 in easy to view formats. The Patient Adherence Generation Module 306 is operable to generate the patient advisor GUIs comprising the requested patient adherence data in a visual format for display on the display device 121 of the HCP system 100. Thus, the Patient Adherence Generation Module 306 not only generates the patient adherence data, but also generates the GUIs comprising user selectable images or icons for display on the display device 121 of the health care provider 101.

As discussed in more detail below, one example of a GUI generated by the patient advisor system that provides access to and comprises patient adherence data generated by the patient adherence system 360 is a graphical compliance dashboard which includes an interactive toolbar, as further described in detail below.

Referring back again now to FIG. 39, the process which causes the Adherence Server 316 to route the request for patient adherence data to the Patient Adherence Generation Module 306 begins with the Adherence Server 316 receiving the request from EP module 202 via EP interface 212. EP module 202 may reside on EP system 200 or alternatively on an HCP system 100, as discussed in above. In yet other embodiments, a request for adherence data may be received by Adherence Server 316 which originates from a third party electronic prescription system other than EP system 200. Accordingly, the request for adherence data may originate from a variety of sources and the present invention is not limited to any particular source.

According to one embodiment of the present invention, the incoming request for patient medication adherence data may include specific patient data (e.g. name, birthdate, social security number, or other relevant identifiers) and prescribed medication or substance data (e.g. name of drug). The Adherence Server 316 then routes the request to the Patient Adherence Generation Module 306 for processing. In yet other possible embodiments, the adherence data request may include only patient identifier data and a request for adherence data related to all prescription medications taken by the patient within a predetermined timeframe (e.g. last year, 2 years, 3 years, etc.).

The Patient Adherence Generation Module 306 searches the patient adherence database 307 for the most recent adherence data for the specific patient and prescribed substance or drug identified in the request if a single drug is identified, or for all prescribed substances. After identifying the relevant adherence data, the Patient Adherence Generation Module 306 loads the adherence data from the patient adherence database 307 and generates a GUI that includes the requested patient adherence data in a combination of both numerical and/or graphic formats, as further described below. Thereafter, the Patient Adherence Generation Module 306 transmits the GUI to the Adherence Server 316 which transmits the GUI back through the EP interface 212 to PE module 202, which in turn relays the GUI to the HCP system 100 for display on the display device 121 for viewing by the health care provider 101 (see FIG. 39).

In some embodiments, the adherence GUI may be previously generated in advance by the Patient Adherence Generation Module 306 and stored in patient adherence database 307 prior to receiving the request for adherence data. However, in other embodiments of the present invention, the Patient Adherence Generation Module 306 generates the adherence GUI upon receiving the corresponding request for patient medication adherence data from the EP module 200.

According to one embodiment of the present invention, the Patient Adherence Generation Module 306 generates an adherence graph when there is new drug fill data for corresponding to an existing graph or a new adherence event occurs. According to one embodiment, the Patient Adherence Generation Module 306 generates an image of an adherence graph. In such embodiments, after corresponding adherence data is calculated by the Patient Adherence Generation Module 306, the Patient Adherence Generation Module 306 generates a new graph or amends an existing graph with the updated adherence data. Next, the Patient Adherence Generation Module 306 stores the image in the patient adherence database 307. Thereafter, the Patient Adherence Generation Module 306 loads the image when a request is received, and the image is embedded into a GUI that is ultimately displayed on the display device 121 to the provider 101. However, the invention is not so limited, and according to another embodiment of the present invention, the Patient Adherence Generation Module 306 generates and stores the graph at the time the request is received from the EP module.

Further, it should be noted that in some embodiments of the present invention, the Adherence Server 316 may receive requests comprising more than one corresponding pairs of patient data and prescribed substance data, such that the Patient Adherence Generation Module 306 may process multiple different requests at one time.

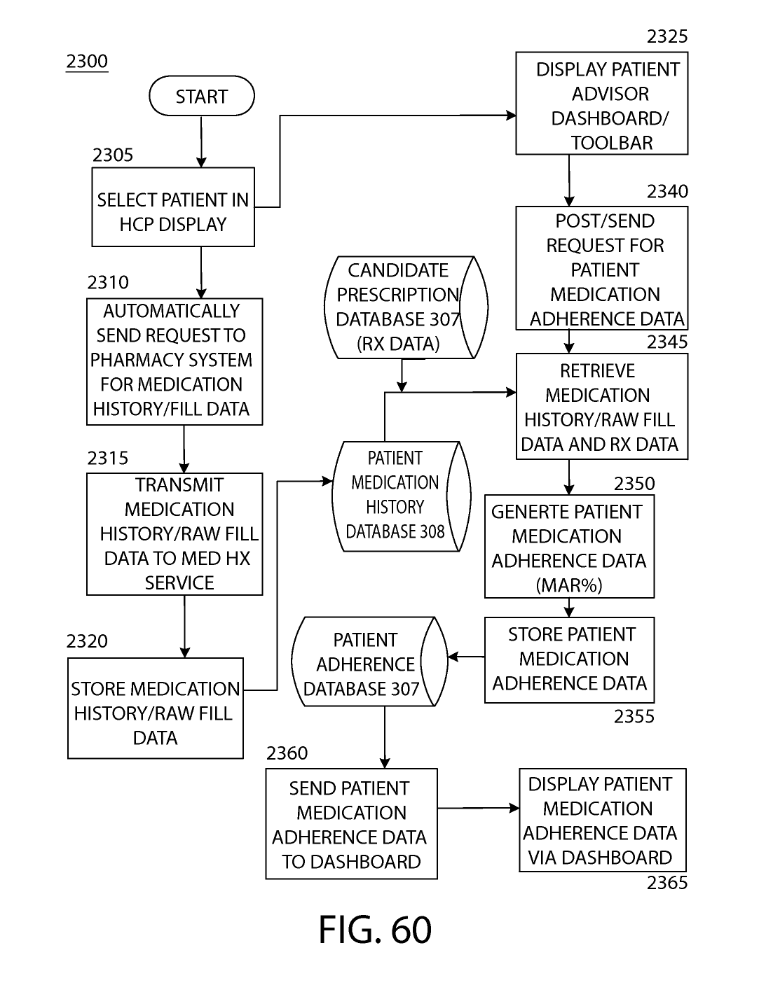

FIG. 60 shows a flow chart summarizing the foregoing exemplary computer processor-implemented method executed by patient adherence system 360 which utilizes the Patient Adherence Generation Module 306 in the manner described above to generate and transmit patient medication adherence data to patient advisor system compliance dashboard for display to a user such as the health care provider 101. Additional reference should be made to FIGS. 1-7 and 39 as appropriate, in description of the process which follows.

Process 2300 begins in step 2305 with a health care provider 101 logging into the EP system 200 and manually selecting a patient via name in the main electronic prescription (EP) system GUI 2002 on display device 121 of the HCP system 100. This interface may be enabled on the HCP system 100 by the thin client 203 portion of the EP Module which resides in the non-transitory computer readable medium (memory 113 in this case) accessible to server 110 (see FIG. 2). Selecting the patient's name automatically generates and sends a request from the EP system to the Payor Engine 318 specific to the selected patient. In other possible embodiments, the patient name may be selected in any type of healthcare related system operably linked to communicate with the patient adherence system 360 other than an EP: the invention not being limited to an EP system interface alone.

Next, in step 2310, the Payor Engine 318 receives the eligibility request and automatically sends a request for patient medication history and pharmacy fill data to the pharmacy system 500. The request is patient specific for the given patient selected in the preceding step. In response, the pharmacy system 500 compiles and sends the requested medication history and raw fill data to Payor Engine 318 in step 2315. The Payor Engine 318 in turn transmits/sends the medication history and raw fill data to Medication Hx Poller 350 of the Medication Hx Service 382. The Medication Hx Poller 350 may check for and resolve duplication in the raw fill data. In step 2320, the Medication Hx Poller 350 may then store the raw fill data and medication history data in the patient medication history database 308. In some embodiments, the Medication Hx Poller 350 may be configured to also poll and retrieve prescription data (Rx data) from candidate prescription database 309, and may also save the prescription data to the patient medication history database 308 in addition to the raw fill data. In other embodiments, the prescription data may remain only in candidate prescription database 309 and will be accessed later in the process by Patient Adherence Generation Module 306 as described herein.

With continuing reference to FIG. 60, upon selecting the patient's name in the in the main electronic prescription (EP) system in step 2305, or alternatively after step 2320, the patient adherence system 360 system triggers display of the compliance dashboard 2000 with interactive toolbar 2004 on display 121 of the HCP system in step 2325, as further described in detail below. The compliance dashboard 2000 then posts/sends the relevant patient demographics (e.g. name, date of birth, etc.) and a request for patient medication adherence data to the Patient Adherence Core 388, and more particularly in one embodiment to Adherence Server 316 and the Patient Adherence Generation Module 306 (step 2340) running on the Adherence Server. In one embodiment, the Patient Adherence Core 388 searches for current (e.g. on date corresponding to the adherence data request date) calculated patient medication adherence data in patient adherence database 307 for the selected patient. If a result (calculated adherence data) is found and not expired (i.e. current date), control moves to the next step 2345. If outdated or no result is found, Patient Adherence Generation Module 306 may send a request for prescription data and medication history/fill data to the Medication Hx Service 382 for retrieval in the manner already described herein to enable patient medication adherence data to be calculated based on current information.

In step 2345, the Patient Adherence Generation Module 306 retrieves medication history/fill data and prescription data (Rx data) for the selected patient. In step 2350, the Patient Adherence Generation Module 306 calculates and generates patient medication adherence data metrics such as medication adherence rate (MAR) % in the manner already described herein. The Patient Adherence Generation Module 306 stores the patient medication adherence data in patient adherence database 307 in step 2355.

In step 2360, the patient adherence system 360, specifically Adherence Server 316 in one embodiment, sends the patient medication adherence data to the patient advisor compliance dashboard 2000. The patient medication adherence data is then displayed in step 2365 by EP server 210 on the GUI of the health care provider display 121 via the compliance dashboard 2000, as further described in additional detail below. In other embodiments, as shown in FIG. 39, the HCP system 100 may communicate directly with the adherence server 316 (following the token authentication process described herein) via communication links as shown in FIG. 1 wherein the HCP server 110 may display the patient medication adherence data.

Patient Advisor System Toolbar and Compliance Dashboard

As noted herein, the Patient Adherence Generation Module 306 calculates and stores patient medication adherence data in patient adherence database 307 (see FIG. 39). The Adherence Server 316, upon receiving a request initiated by the health care provider through the GUI 2002 on display 121 of the HCP system 100, retrieves and transmits adherence data back the HCP system 100 for viewing on display 121.

In one embodiment, the adherence data is incorporated into a GUI in the form of a patient advisor compliance dashboard 2000 as initially shown in FIG. 42. In general, the compliance dashboard is an application specific interactive GUI, or a plurality of GUIs, that offers a health care provider 101 with graphical and alphanumerical representations of the applicable patient medication adherence data. The adherence data may be displayed in the form of any number and type of graphical images or icons and alphanumeric characters. In one embodiment, the compliance dashboard 2000 includes an interactive toolbar 2004.

According to one embodiment of the present invention, the compliance dashboard 2000 with toolbar 2004 may be provided as a separate software module 386 which is hosted on the EP system server 210, or alternatively a third party EP system server. As such, the health care provider 101 may easily switch between prescription writing for a patient and the compliance dashboard that provides access to the patient's past adherence data at the point and time of service at the health care provider's facilities. Thus, the health care provider 101 may engage the patient regarding their adherence history relating to previous prescriptions prior to drafting a new prescription for that patient in hopes of increasing the patient adherence to filling/refilling, picking up, and taking their prescribed medications per their treatment regimen. Advantageously, the compliance dashboard 2000 provides a quantitative means for the health care provider 101 to engage their patients in prescription adherence discussions.

It should be noted that the present invention allows for both synchronous and asynchronous methods of displaying patient compliance data via the compliance dashboard 2000) to the provider 101 through the health care provider's display device 121 (see FIG. 2). In the synchronous model, a single continuous user interface (which can include multiple sequential GUIs) is displayed and interfaced with by the health care provider 101 for both generating an electronic prescription using the EP module 202 and viewing patient compliance data generated by the Patient Adherence Generation Module 306 in the compliance dashboard 2000 (reference FIGS. 3 and 39). Therefore, the synchronous model may be used when the EP module 202 and the Patient Adherence Generation Module 306 utilize the same GUI (e.g., when the EP module is Rcopia®). When using the synchronous model, the provider 101 may view patient compliance data generated by the Patient Adherence Generation Module 306 via compliance dashboard 2000 and fill out prescriptions for the patient using the EP module, using the same user interface and display screen. FIGS. 42-59 show an example of various synchronous models of compliance dashboard 2000 in which the compliance dashboard GUI is overlaid on the patient summary screen of the main EP system GUI 2002 which are both simultaneously displayed on the health care provider's display 121. It should be noted that in some embodiments, the EP system GUI 2002 may be generated by the thin client EP module 203 residing on the HCP system 100 (see FIG. 2).

In the asynchronous model, the EP module 202 and the compliance dashboard 2000 of the Patient Adherence Generation Module 306 will have different GUIs displayed separately in different windows of the health care provider display 121. In this manner, the Patient Adherence Generation Module 306 may be configured for use with a plurality of different third party EP systems and EP modules, regardless of their GUIs. According to one embodiment of the present invention using the asynchronous model, upon receiving a request from a provider 101 to view patient compliance data, the Patient Adherence Generation Module 306 generates and displays a GUI that is distinct from the GUIs generated and displayed by the third party EP module.

The compliance dashboard 2000 and associated system and user processes will now be described in greater detail. Referring to FIG. 42, the patient summary screen of the main EP system GUI 2002 viewed by the health care provider 101 on display 121 may include several fields including a top header navigation field 2002a having a plurality of user-selectable buttons or links as shown which provides a user interface to access and operate the EP system 200 for electronically writing scripts and ordering medications for a patient as described herein. A patient information field 2002b is provided which may include patient name and personal demographic details, preferred pharmacy, health care provider's name, and other information. GUI 2002 may further include a prescription entry field 2002c for entry and/or selection of a prescription drug or medication and a medication history field 2002d which displays a list of active medications taken by the patient. It will be appreciated that these fields 2002a-2002d and other fields that may be provided in the context of the EP system interface for the health care provider may be arranged in any suitable manner or order and have many different appearances other than those explicitly depicted in FIG. 42. Accordingly, the invention is not limited to the layout and appearance of GUI 2002 shown.

Referring to FIG. 42, in the main EP system GUI 2002, access to the compliance dashboard 2000 may start with a health care provider 101 first selecting a patient name by selecting the “Select Patient” active link or button 2006 in field 2002a. It should be noted that button 2006 and other “active” buttons or graphical icons in GUI 2002 may be selected by any suitable input device 122 (reference FIG. 2), such as for example without limitation a cursor or pointer displayed in the HCP display 121 which is controlled via a mouse, touch pad, trackball, keyboard, etc. or directly via a finger or stylus contact with the on-screen active button/icon in the case where display 121 is a touch screen. It should further be noted that “active” buttons or alphanumerical indicia are defined herein as those icons which may be considered dynamic links (e.g. dynamic icons) in nature wherein when selected by a user trigger a further action to be implemented and executed by the system (e.g. data retrieval, display, etc.), in contrast to “inactive” screen icons or alphanumerical indicia which display static information in graphical and/or alphanumerical forms.

Selection of a patient name in the EP system 200 by the health care provider 101 via the main EP system GUI 2002 (see, e.g. FIG. 39) is a triggering event in one embodiment which causes the patient advisor module 386 to then display the patient advisor compliance dashboard 2000 GUI with interactive toolbar 2004 in the main EP system GUI 2002. The dashboard with toolbar is displayed and viewable by the health care provider on display 121 of the HCP system 100, as shown. In other suitable embodiments, the compliance dashboard 2000 may remain visible at all times whenever the main EP system GUI 2000 is displayed on the health care provider's display 121. The invention is not limited to either display scenario or configuration of the patient advisor system.

It should be noted that the patient advisor module 386 which generates the compliance dashboard 2000 and interactive toolbar 2004 GUI can be hosted on either EP server 210 of the EP system 200 (see FIG. 39) or a third party electronic prescription server (not shown). In the present embodiment being described, the patient advisor module 386 is hosted on EP server 210.

In one embodiment, the triggering event of selecting a patient name in the EP system 200 as noted above may cause the patient advisor compliance toolbar 2000 to be display through operation of Authentication Server 380 shown in FIG. 39. The user such as a health care provider initially logs into the EP system 200 through the EP interface 212 which communicates with central portion 202 of the EP module (see also FIG. 3). A token is first obtained at the login and transmitted to the Authentication Server 380. The Authentication Server 380 then returns the token to the EP interface of the EP system. Next, the token is passed (transmitted) to the HCP system 100 via the network interface 112 (see FIG. 1), and in turn then passed onto Adherence Server 316 of the patient adherence system 360. The Adherence Server 316 passes the token to the Authentication Server 380 for verification, and receives notice back that the token is valid and authenticated. The Adherence Server 316 may then display the patient advisor compliance dashboard 2000 with interactive toolbar 2004 in the user's display 121 and is operable to transmit patient medication adherence data/metrics to the user for display via the dashboard.

In one embodiment, the interactive toolbar 2004 may be displayed horizontally across the display screen of the HCP display device 121. In other embodiments, the toolbar may be vertically oriented. Toolbar 2004 may be interspersed between existing fields 2002a-2002d of GUI 2002 in a manner that does not obscure and allows access to the information and active links embedded in the fields simultaneously with use of the toolbar.

The toolbar 2004 may comprise a plurality of user-selectable active icons or buttons (see, e.g. FIGS. 42-45), which in one non-limiting embodiment may be in the form of content type dynamic tabs 2010, 2020, 2030, 2040, 2050, and 2060 in some embodiments. In one embodiment, content tabs 2010-2060 are axially aligned in a horizontal line across GUI 2002 as shown and may have the appearance of folder tabs which serve as portals for a user to access and reveal different type information in each. Any suitable number and types of user-selectable tabs may be used. Tabs 2010-2060 may be active/dynamic links which display content, data, and information related to the subject matter shown on the tab when selected and activated by the user. In one embodiment, for example without limitation, the tabs may include the following indicia: “Report Card” (2010), “Outcome Studies” (2020). “Education” (2030). “Coupons” (2040), “Adherence Plan” (2050), and “Clinical Trials” (2060). Additional or less tabs may be used as well as other type information content. Accordingly, the invention is not limited to the tabs or content shown and described herein.

The Report Card tab 2010 is an active button which operably retrieves and displays patient medication adherence data in alphanumerical and/or graphical form on the EP system GUI 2002. In one embodiment, Report Card tab 2010 may be displayed in two different modes having a different appearance and indicia in each display mode. The display modes may include a “normal” display mode and an “alert” display mode. In one embodiment, the display mode which is displayed is determined and triggered by correlation to a quantitative value of patient adherence data generated by Patient Adherence Generation Module 306 (see FIG. 39) which is stored in patient adherence database 307 of the patient adherence system 360. In one embodiment, the triggering adherence data may be MAR (medication adherence rate) as already described herein which provides a snapshot of patient medication adherence habits.

In one exemplary embodiment, simultaneously with triggering the generation and display of the patient advisor toolbar 2004 by selecting the patient name, this user action also causes the EP module 202 (see, e.g. FIG. 39) to send a request for retrieval of patient medication adherence data to the Adherence Server 316 as described herein. The Adherence Server 316 retrieves the requested adherence data from patient adherence database 307.

In one embodiment, the adherence data requested for retrieval by EP module 202 may be MAR. The MAR or other adherence data retrieved by the patient advisor module may be for all active medications currently prescribed for the patient, which may or may not include the specific drug presently being prescribed. Accordingly, the compliance dashboard 2000 may provide patient medication adherence data to the health care provider for the patient's entire prescription medication regimen in a snapshot. In one embodiment, the patient advisor module 386 uses the MAR data to determine which of the two foregoing display modes of Report Card tab 2010 (i.e. “normal” or “alert”) to implement, as described in further below.

It will be appreciated that any one or all of the tabs 2010-2060 may be displayable in at least two different display modes comprised of a “normal” display mode and an “alert” display mode.

FIG. 42 shows toolbar 2004 with Report Card tab 2010 in a first “normal” display mode being of a first color, a first size, and with first alphanumerical indicia which may simply read “Report Card.” The health care provider uses this tab to access the patient's medication history adherence report card, as further described below. In one embodiment, the color of Report Card tab 2010 in the normal display mode may be the same size and color as the remaining tabs 2020-2060 so as to be visually indistinguishable by size or color alone in appearance. Any suitable color may be used for the tabs.

In one embodiment, the first “normal” display mode for the Report Card tab 2010 may be displayed by the patient advisor module 386 to the health care provider on display 121 when the MAR value calculated by the Patient Adherence Generation Module 306 exceeds a predetermined MAR threshold value, thereby indicating that the patient is at least fairly diligent in filling, refilling, and taking their prescribed medications. In one embodiment, for example, an MAR of greater 70% may be used as the threshold value for displaying the Report Card tab 2010 in the “normal” display mode. Other suitable MAR threshold values may be used.

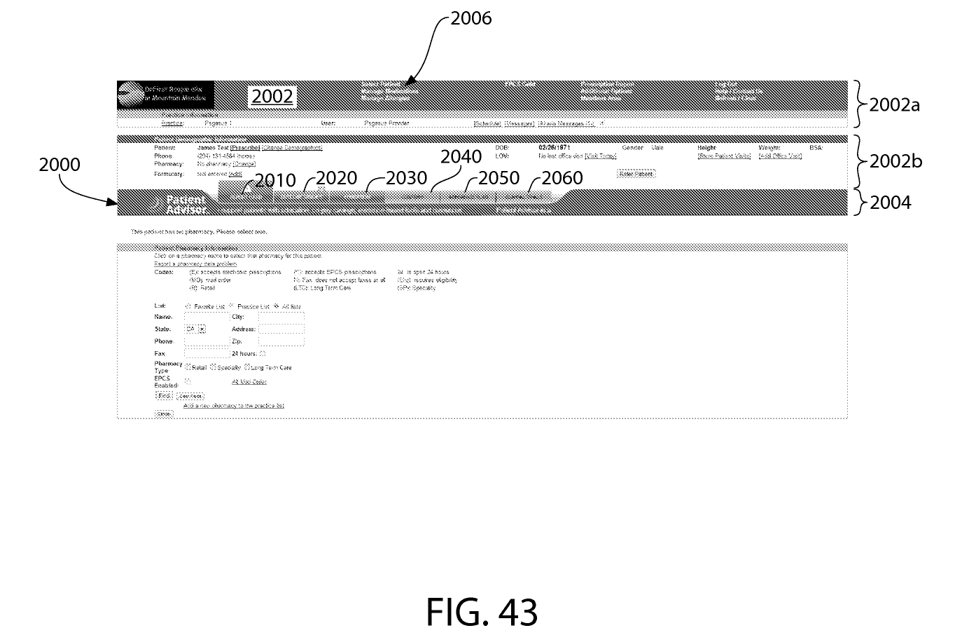

Hovering or rolling the cursor of an input device over a tab 2010-2060 may also change the appearance (e.g. size, color, and/or indicia) of a tab. In FIG. 43, the Report Card tab 2010 for example is shown enlarged in size in response to hovering or rolling the cursor over this tab. The Report Card tab 2010 has a second size which is larger than the first size when a cursor is not placed over the tab in the display. Hovering the curser over the tab may also change the indicia on the tab as shown. Here, a triangle with exclamation mark is added to the tab above the words “Report Card.”

In one embodiment, a second “alert” display mode for the Report Card tab 2010 may be displayed by the patient advisor module 386 to the health care provider on display 121 when the MAR value calculated by the Patient Adherence Generation Module 306 is less than a predetermined MAR threshold value. In one embodiment, an MAR of less than or equal to 70% may be used, thereby indicating that the patient has not been diligent in filling, refilling, and taking their prescribed medications. It will be appreciated that other MAR threshold values may instead be used.

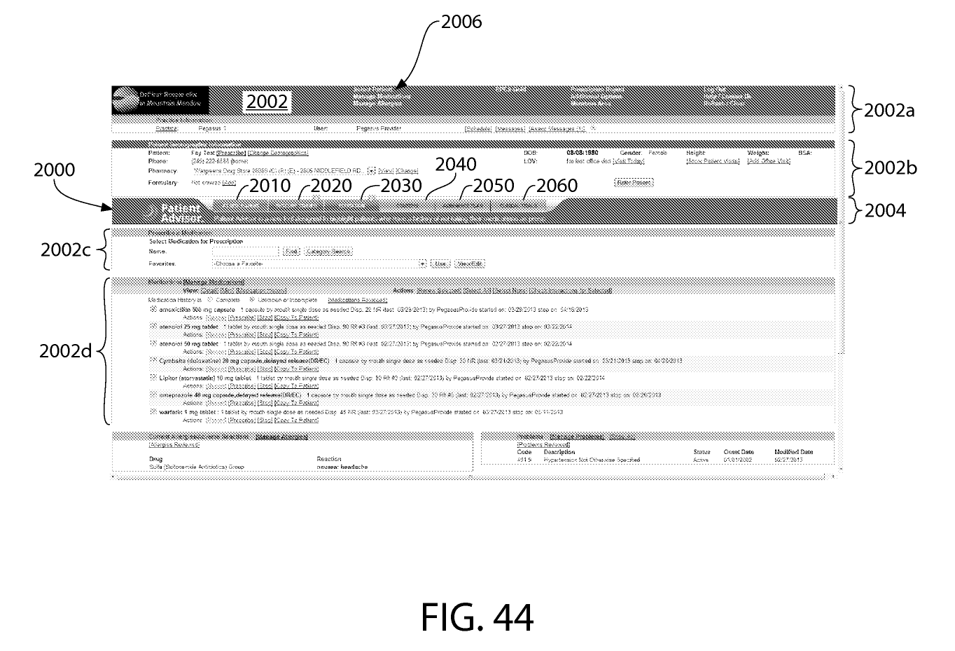

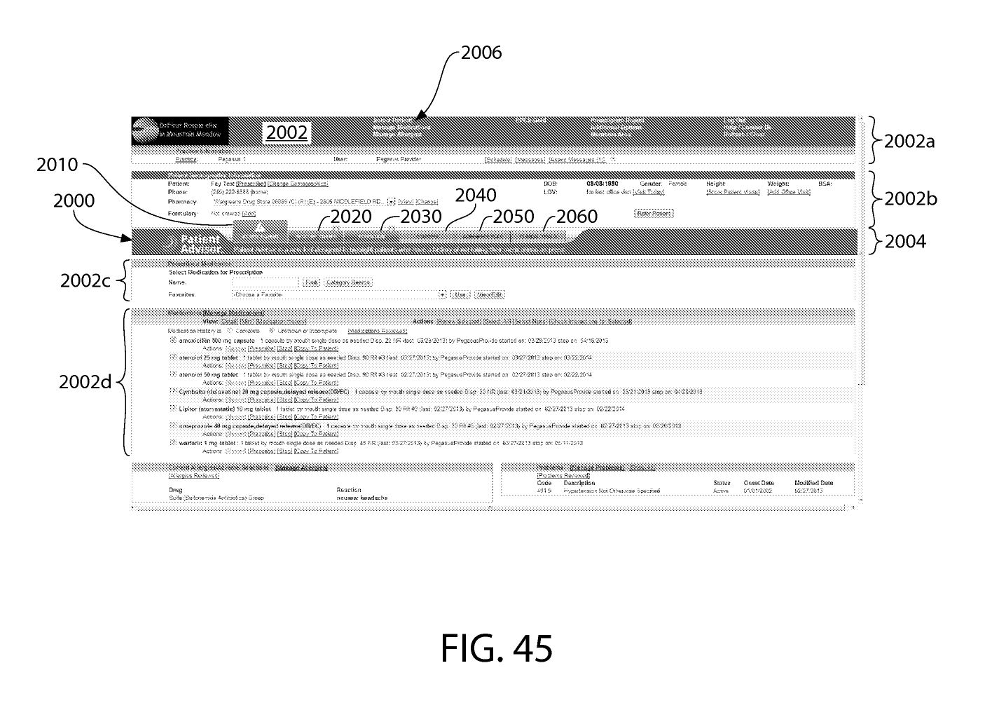

FIG. 44 shows toolbar 2004 with Report Card tab 2010 in the second “alert” display mode being of a second color and with second alphanumerical indicia, which in some embodiments may read “At Risk Patient” or something equivalent. In one embodiment, the size of the Report Card tab 2010 may be the same as the first normal size, or in other embodiments an enlarged tab in contrast to the normal size of tabs 2010-2060 may be displayed in the “alert” display mode further urging the health care provider to select the tab for adherence information. The appearance of the tab (size, color, and/or indicia) in the “alert” display mode visually communicates a greater sense of urgency for the health care provider to view the patient's medication adherence information. In one embodiment, hovering or rolling the cursor of an input device over the “At Risk Patient” tab may enlarge the tab as shown in FIG. 45 and change the alphanumeric indicia on the tab as shown (see exclamation point triangle). It should be noted that the health care provider still uses this same tab 2010 to access the patient's medication history adherence report card, as noted above.

In one embodiment, the color of Report Card tab 2010 in the second “alert” display mode is a different and preferably more vibrant color than in the first color in the normal display mode to visually communicate that the patient being seen is “at risk” in terms of potential medical complications stemming from a lack of adherence to their prescription medication regimen. Any suitable color may be used to signify an “alert” to the health care provider. In some embodiments, the second color of the Report Card tab 2010 in the “alert” display mode may be for example without limitation yellow, orange, or red. In yet other embodiments, the patient advisor module 386 may be programmed to change the display color of Report Card tab 2010 in the “alert” display mode to a color directly correlated to the degree of a patient's MAR compliance with taking their medications. In one non-limiting example, the Report Card tab 2010 may change color as follows: Green—MAR is 71% or greater; Yellow—MAR is between 60% to 70% Red—MAR is less than 60%. Other suitable colors and/or ranges may be used. It will be appreciated that these colors and numerical ranges are for example only and are in no way intended to be limiting, but rather are used to broadly demonstrate the concept.

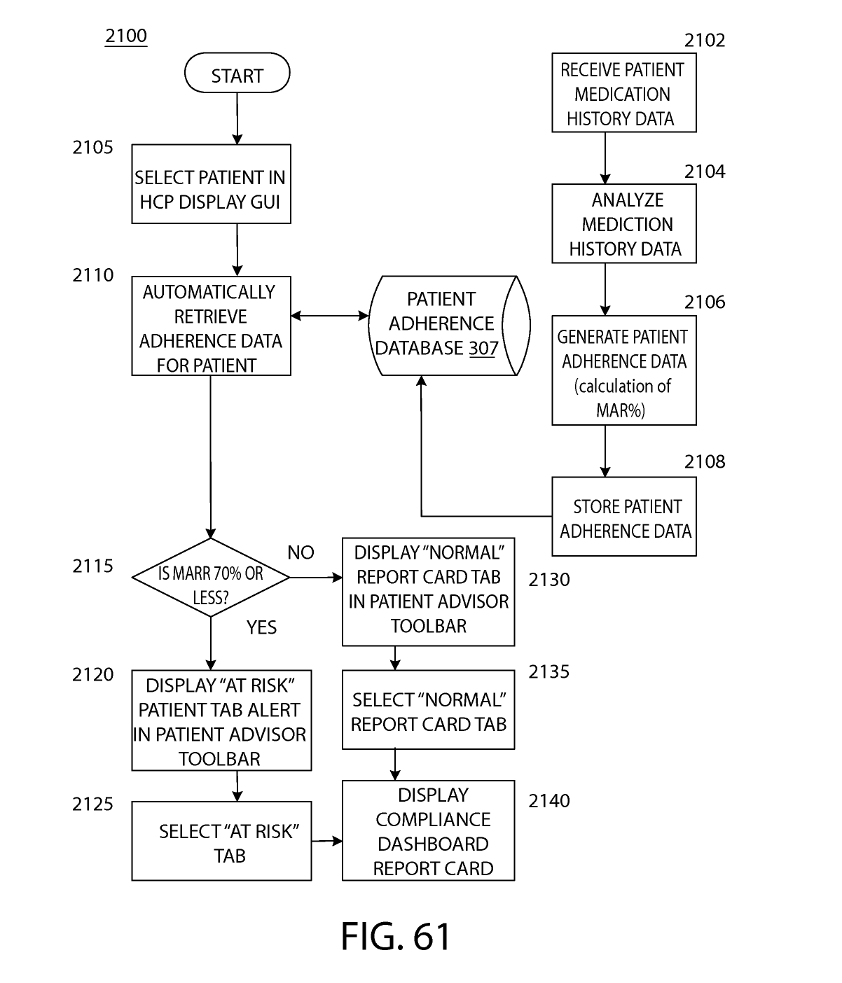

FIG. 61 shows a flow chart summarizing the foregoing computer processor-implemented process of retrieving and displaying either the “normal” display mode of Report Card tab 2010 or the “alert” display mode (“At Risk Patient”) of the tab. Additional reference is made to FIG. 39. Process 210 (begins in step 2105 with a health care provider 101 manually selecting a patient in the main EP system GUI 2002 on display device 121 of the HCP system 100. In one embodiment, the selection automatically generates and sends a request to Adherence Server 316 of the patient adherence system 360 to retrieve MAR adherence data for all active prescription medications currently prescribed for the selected patient (step 2110), as already described herein. The MAR data for all active prescriptions related to the selected patient is stored in patient adherence database 307, having previously been generated by Patient Adherence Generation Module 306 (step 2106) and stored in the database 307 (step 2108) in the form of graphs, charts, numerical data, etc. (see also FIG. 60 and discussion herein). In one embodiment, the MAR data may b generated “on the fly” (i.e. on demand) for a single specific patient at a time when a specific request is made such as by selecting a patient name in the EP system 200, as already described herein with reference to FIG. 60. This approach minimizes the demand on Patient Adherence Generation Module 306 to analyze, generate, and store patient adherence database 307 at a given time. In alternative embodiments, patient medication adherence data may be generated and stored in advance for a plurality of patients by configuring the patient adherence system 360 to cause the Patient Adherence Generation Module 306 to routinely poll patient medication history database 308 and retrieve patient medication history data (step 2102) from patient medication history database 308, which may be routinely populated with medication history data by Med Hx Poller 350 as described herein. Patient Adherence Generation Module 306 then routinely analyzes the medication history data (step 2104) including calculation of MAR % for all medications, generates the adherence data associated with all active prescription medications taken by a plurality of patients polled via the Payor Engine 318, and stores the adherence data in patient adherence database 307.

With continuing reference to FIGS. 39 and 61, in step 2115 the patient advisor module 386 analyzes the MAR data for the selected patient, compares the predetermined threshold MAR criteria (value) to the MAR data for all active prescriptions, and determines if any one of the plurality of active prescription medication values falls below the threshold value as failure to take a single prescribed drug may be responsible for symptoms exhibited by the patient during the visit to the health care provider 101 or may exacerbate the patient's health in the future. In addition, the health care provider may be able to determine whether the failure to fill/refill and take the prescribed medications may be related to financial reasons, lack of education or belief about the effectiveness of the medication, or other reasons which can then be addressed to get the patent to take their medications regularly.

If in step 2115 the patient advisor module 386 determines that the MAR % is below the predetermined threshold value (e.g. less than or equal to 70% MAR in this non-limiting example) indicating failure of the patient to adhere to their medication regimen, a “Yes” condition is returned which causes the process flow to proceed to step 2120. The “At Risk Patient” alert display mode of the Report Card tab 2010 is displayed to the health care provider. In some embodiments, this visual tab display event may be coupled with an audible indication of non-adherence that is produced by the HCP terminal 120 when the alert display mode is initiated such as any suitable preprogrammed notification sound to further get the health care provider's attention. The health care provider may then select (e.g. click) this alert condition tab in step 2125 in which case the patient advisor MAR report card 2200 is displayed (see, e.g. FIG. 46) in step 2140, the contents of which are further described herein below. The health care provider may now explore the extent and degree of the patient's non-compliance with their medication treatment regimen in greater detail to take corrective action.

If in step 2115 the patient advisor module 386 determines that the MAR % is instead above the predetermined threshold value (e.g. greater than 70% MAR in this non-limiting example) indicating that the patient generally adheres to their medication regimen, a “No” condition is returned which causes the process flow to proceed to step 2130. The “Report Card” normal display mode of the Report Card tab 2010 is displayed to the health care provider. The health care provider may then select (e.g. click) this normal condition tab in step 2135 in which case the patient advisor MAR report card 2200 is displayed (see, e.g. FIG. 46) in step 2140, the contents of which are further described herein below. The health care provider may now explore patient's adherence to their medication treatment regimen in greater detail if desired, albeit with a lesser degree of urgency for a compliant patient.

The patient advisor report card 2200 accessed via Report Card tab 2010 in step 2140 will now be described in greater detail. In one embodiment, the report card is based on MAR (medication adherence rate); however, other relevant patient medication adherence data may be used in other embodiments.

Patient Advisor Report Card Tab

FIG. 46 shows an embodiment of a patient advisor report card 2200 which is displayed when the health care provider selects the Report Card tab 2010. In one embodiment, report card 2200 may be an enlarged pop-up screen or window which is an interactive GUI that may be displayed in overlay fashion onto the patient summary screen of the main EP system GUI 2002. Report card 2200 may include a prescription medication list or menu 2210 having one or more items comprised of active medications currently prescribed for the patient, patient medication adherence chart 2220 comprising a graphical display of statistics pertaining to the patient's medication regimen adherence habits, dynamic chart navigation control tags 2230, and a quick-view report card summary field 2240.

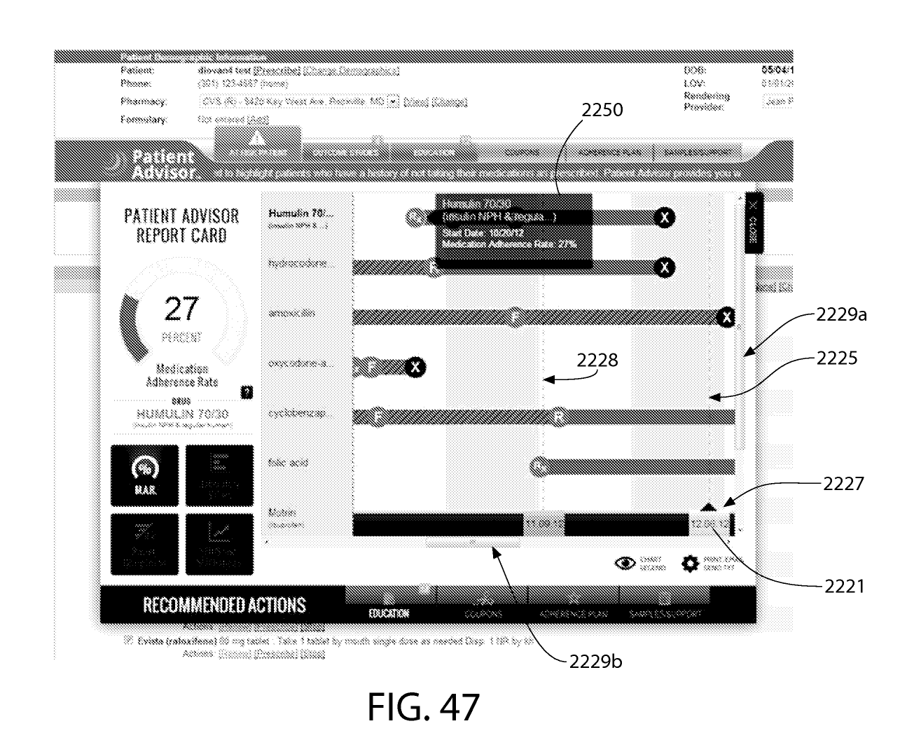

In some embodiments, the drugs listed in active medications menu 2210 may match the list of active drugs shown in the medication history field 2002d of the patient summary screen in the main EP system GUI 2002. Each of the drugs listed by name in the medication menu 2210 are dynamic links which are user selectable to control and change the MAR displayed in the report card summary field 2240. In the example shown in FIG. 46, the drug name hydrocodone-acetaminophen has been selected by the health care provider which may be emboldened or otherwise highlighted for visual contrast relative to the other unselected drugs listed whose names are displayed normally in a different and preferably more subdued manner. The drug name may be selected via a cursor click associated with an input device or by finger or stylus touch if a touch screen input device is used as terminal 120 (see FIG. 2). Selecting hydrocodone-acetaminophen causes its MAR to be displayed in summary field 2240, further described below. Selecting a different drug causes its corresponding MAR to be displayed instead in summary field 2240 (see, e.g. FIG. 47 showing Humulin). Accordingly, the health care provider can advantageously quickly navigate through the drugs listed in the menu to obtain an immediate snapshot of the patient's MAR with respect to each medication.

In one embodiment, a scroll bar 2229a may be provided on the right or alternatively left side that allows a user to scroll up or down the list of drugs in medication menu 2210 which also vertically changes the corresponding display in the adherence chart 2220. Alternatively or in addition, a user may place the cursor of an input device such as a mouse within the GUI display of the medication menu 2210 and/or adherence chart 2220 and roll the center wheel of the mouse up or down as an alternative way of scrolling vertically through the list of drugs and chart.

In one embodiment, the list of active medications in the patient medication menu 2210 may be sorted by ascending MAR order with the lowest MAR percentage at the top of the list. The medications without an MAR may be located at the bottom of the list. Generic drug names may be displayed in lower case letters. Brand drug names may be displayed with the first letter capitalized with the generic name placed under it in parentheses (see, e.g. FIGS. 46 and 47).

Referring to FIG. 46, report card summary field 2240 may include an adherence graphic 2241 representing the MAR percentage rate in a graphical and/or numeric value form, the name 2242 of the pertinent drug, and an adherence data identifier 2243 confirming the type of adherence data being displayed in the summary field and Report Card tab 2010 at present (e.g. MAR as shown here). To get the MAR for each active medication in the patient medication menu 2210, the user clicks on the name of the drug of interest listed in the menu. The MAR will change for each drug when selected and display the corresponding MAR percentage. The name 2242 of the drug chosen will also change in the report card summary field 2240 to correspond to the drug that was selected from the active medication menu 2210.

In one embodiment, without limitation, the adherence graphic 2241 includes a bar graph which may be a circular bar graph (also referred to as a wheel or donut chart) including an arcuately-shaped bar, as shown in FIG. 46. Advantageously, the circular format of a circular bar graph permits a visually large display of adherence data or metric in a compact area which does consume an excessive amount of space in the patient advisor report card 2200. The circular bar graph may include a display of the numeric value of the adherence data or metric such as the MAR percentage value displayed and positioned in the center of the circular graph which further contributes to the compactness of the adherence graphic and patient advisor report card 2200 in general. The numeric MAR value, however, may be located elsewhere in the report card summary field 2240 in other embodiments. The circular bar graph may be in the form of a partial circle with a gap as shown or alternatively a complete circle without a gap (not shown). Preferably, in one embodiment, the adherence bar representing the MAR percentage value graphically displayed in the circular bar graph has a circumferential or arcuate length which is directly proportionate to the actual MAR numeric value (compare, e.g. FIG. 46 showing MAR of 30% and FIG. 47 showing MAR of 27% with bar having a shorter extent or length). Accordingly, the bar has an extent or length (based on MAR %) which is relative to the total available graph space. For example, a bar representing an MAR of 100% would completely fill the available circular bar graph space whereas a MAR of 50% will only fill half of the available graph space (e.g. to approximately the 12 o'clock position). The adherence bar for the MAR of 30% in FIG. 46 occupies only about 30% of the available graph space.

Preferably, the adherence wheel or bar in the circular bar graph of the adherence graphic 2241 may have a contrasting color and/or pattern in comparison to the unused available circumferential portion of the circular bar graph to be readily visibility noticeable to the health care provider for ease of reference. In some embodiments, the adherence bar may change color based on the MAR percentage corresponding to the selected drug from the patient medication menu 2210. In one non-limiting example, the adherence bar may change color as follows: Green—MAR is 71% or greater: Yellow—MAR is between 60% to 70%; Red—MAR is less than 60%. Other suitable colors and/or ranges may be used.

In instances there is insufficient data to calculate an MAR for a drug selected from patient medication menu 2210, “N/A” or something similar may be displayed for the adherence graphic 2241. A minimum of two “fills” for a single prescription drug are required in order to calculate the MAR.

It will be appreciated that in other embodiments, the adherence graphic 2241 may have other configuration and shapes other than a circular bar graph which are typically used to visually depict relative numeric data values, such as for example without limitation a linear bar graph, a line graph, a pie chart, and others. Accordingly, the type and configuration of the adherence graphic 2241 is not limited to circular bar graphs or donut charts alone. A preferred type of adherence graphic 2241 displayed, however, should not be complex so that the graphic representation of the MAR value is easily and quickly recognizable by the health care provider without undue examination to save time and expedite the patient visit.

With continuing reference to FIG. 46, the chart navigation control buttons 2230 are dynamic links which provide one-click access to one or more different types of patient medication adherence data to be displayed in patient advisor report card 2200. The non-limiting example shown includes four dynamic control buttons; however, more or less buttons may be provided. The button currently selected is preferably highlighted in some manner (e.g. change in appearance such as size, color, etc.) so as to be distinguishable from non-selected buttons. In this example shown in FIG. 46, the MAR button 2230 is highlighted indicating that it has been selected (whereas the remaining buttons may be grayed out) and the information displayed in the report card summary field 2240 and adherence chart 2220 is MAR information for the selected drug (hydrocodone-acetaminophen in this example). Preferably, when the user such as a health care provider initially selects (e.g. click on) and activates the Report Card tab 2010, a predetermined one of the default chart navigation control buttons 2230 is automatically activated/selected for display of the patient advisor report card 2200 to the user. The user may then switch to display another type of patient medication adherence data by selecting a different one of the available chart navigation control buttons 2230. Non-limiting examples of some other type adherence data that may be used for buttons 2230 include first fill compliance (FFC) data and patient Medication Adherence Rate (MAR)/Medication Persistency Rate (MPR) data as already described which also offer information in summary form with respect to patient compliance in following their medication regimen.

The patient medication adherence chart 2220 is a graphical display of the patient's medication fill history for all their active medications. Adherence chart 2220 is a graphical display of medication fill history. In one embodiment, the graphical display of every medication may be placed on a time graph as further described below. At a glance, the health care provider will be able to see if a patient has “filled” their medications or if there has been a gap in care because they have not filled it.

Referring to FIG. 46, patient medication adherence chart 2220 (also referred to as simply “adherence chart” for brevity herein) in the present embodiment may generally include a master timeline 2224 and a plurality of individual historical drug timelines 2222 each corresponding to one of the drugs listed in the patient medication menu 2210 located adjacent to the chart for ease of reference. In one non-limiting embodiment as shown, the master timeline may be displayed at the bottom of the chart 2220; however, in other embodiments the timeline 2224 may be displayed at the top of the chart or another suitable location. The master timeline 2224 includes past, present, and future dates.

When the patient advisor report card 2200) and patient medication adherence chart 2220 are initially rendered via selecting the Report Card tab 2010, the present date 2221 (i.e. today's date of patient visit and/or health care provider's access to the patient advisor system) is displayed as shown in FIG. 46. The present date 2221 may be displayed in a highlighted or otherwise visually emphasized manner that is readily discernible to the user. In one embodiment, a vertical dateline 2228 may be displayed in the adherence chart 2220 corresponding to the present date. Advantageously, the adherence chart 2220 projects and displays future information about each drug including expected refill dates and prescription end dates so that the health care provider gets a future look at the medications which may continue to be taken to consider when prescribing a new medication or additional refills for an existing medication.

In one embodiment, a slidable date marker 2223 (see, e.g. FIG. 46 and particularly FIG. 47) may be provided that allows the user to slide the dateline 2228 to the right or left over any the information in an individual drug timeline 2222 on the adherence chart 2220 (corresponding to the drug currently selected for display in medication menu 2210) to quickly get the adherence information for the date located at the present position of the dateline without having to click on the chart for details. The slidable date marker 2223 is moveable left or right (i.e. backwards or forward in time) along the master timeline 2224. The adherence information may be displayed in a pop-up window or box in a manner similar to that shown in FIGS. 47-52, as further described below. However, an input device cursor need not be placed directly over the individual drug timeline 2222 as in FIGS. 47-52 to access the pop-up box and information displayed therein. Instead, the cursor is used to lock on the slidable date marker 2223 via a click and hold action by the user followed by sliding the marker to the right or left in the adherence chart 2220.

In addition to the slidable date marker 2223, a stationary present date marker 2227 may also be provided (see, e.g. FIG. 47) which remains fixed in position on master timeline 2224 at the present date position. Present date marker 2227 displays the present date 2221 and allows the user to see the chart lined up against the current day. In one embodiment, when the patient advisor report card 2220 is first rendered in the user interface as shown in FIG. 46, the present date marker 2227 is positioned underneath the slidable date marker 2223 which is superimposed over top of the present date marker. When the user moves the slidable date marker 2223 right or left, the present date marker 2227 becomes visible and remains in the position fixed on master timeline 2224. In one embodiment, the present date marker 2227 may further have an associated vertical dateline 2225 displayed in the adherence chart 2220.

In one embodiment, a chart scroll bar 2229b may be provided such as at the bottom of the adherence chart 2220 or alternatively at the top of the chart. The scroll bar 2229b provides another or an alternate means to slidable date marker 2223 for a user to navigate forward or backward in time in the chart by moving the bar from left to right and vice-versa. Similarly to sliding date marker 2223 left or right, the date range displayed at a given time in the adherence chart timeline changes forward or backward in time.

Referring to FIGS. 46-52, the following icons or symbols and acronyms may be used in the adherence chart 2220 to represent various possible elements displayed in each historical drug timeline 2222: Rx=prescription date; F=Fill Date; R=Expected Refill Date (calculated from total quantity of prescription and prescribed dosage); X=prescription end date; solid colored bar=gap in fill date; and striped colored bar=prescription duration. It will be appreciated that more or less and/or different icons and/or may be used to represent the elements of the timelines. In addition, additional or other information may be displayed in the timelines. Furthermore, the solid and striped colored bars may also be displayed in a variety of alternative different colors and/or patterns or plain other than those foregoing non-limiting examples given herein. Accordingly, the display and information content of the drug timelines 2222 are described herein by way of the foregoing exemplary embodiments for convenient and are not intended to limit the invention.

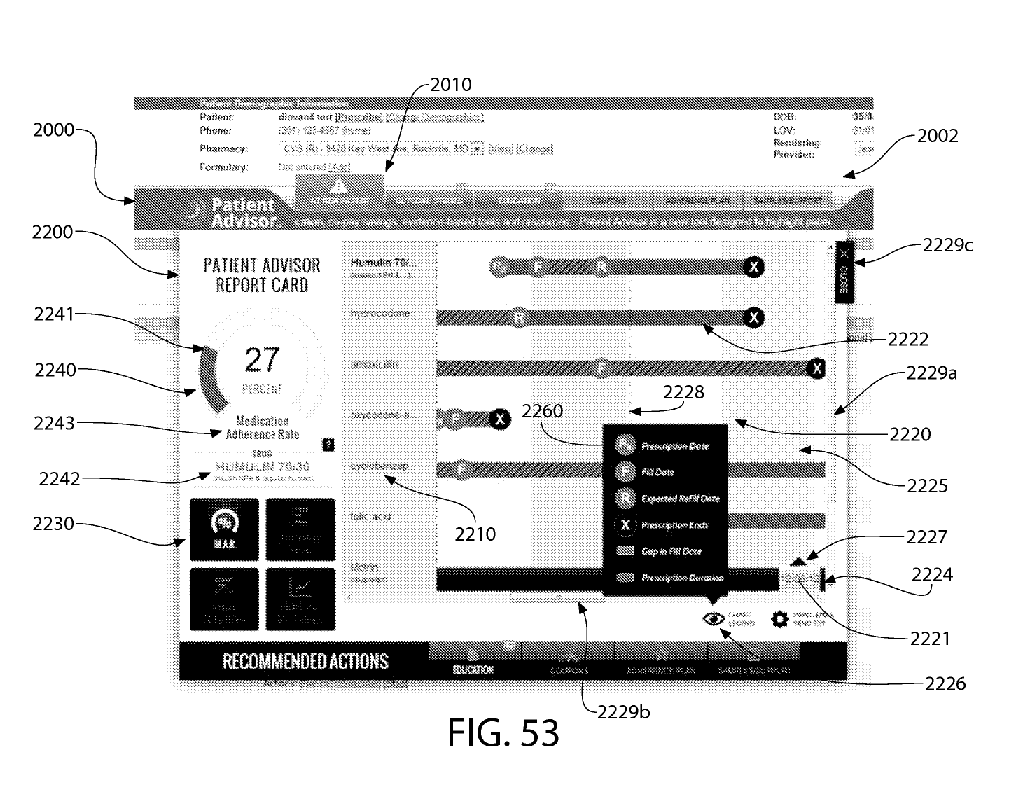

In one embodiment, a chart legend 2260 defining these foregoing timeline elements may be accessed via a chart legend icon 2226 which causes a pop-up window to be displayed with the legend information when selected or an input device cursor is hovered/rolled over the icon, as shown in FIG. 53.

In certain embodiments, each of the drug timelines 2222 may include one or more dynamic links to medication and adherence summary data and information for each drug. Each or some of the foregoing elements of a drug timeline 2222 displayed in the adherence chart 2220 (e.g. F. R. X, plain bar, striped bar, etc.) may themselves be an active dynamic link that causes a pop-up box with complementary information to be displayed as shown in FIGS. 47-52 by rolling or hovering the cursor of an input device over the element.

FIG. 47 shows an exemplary pop-up box 2250 that is displayed in adherence chart 2220 by placing an input device cursor over the Rx (prescription date) element. The pop-up box shows the name of the drug (e.g. “Humulin 70/30)”), prescription start date (e.g. “Oct. 20, 2012”), and MAR (e.g. “27%”). Dosage information may also be displayed.

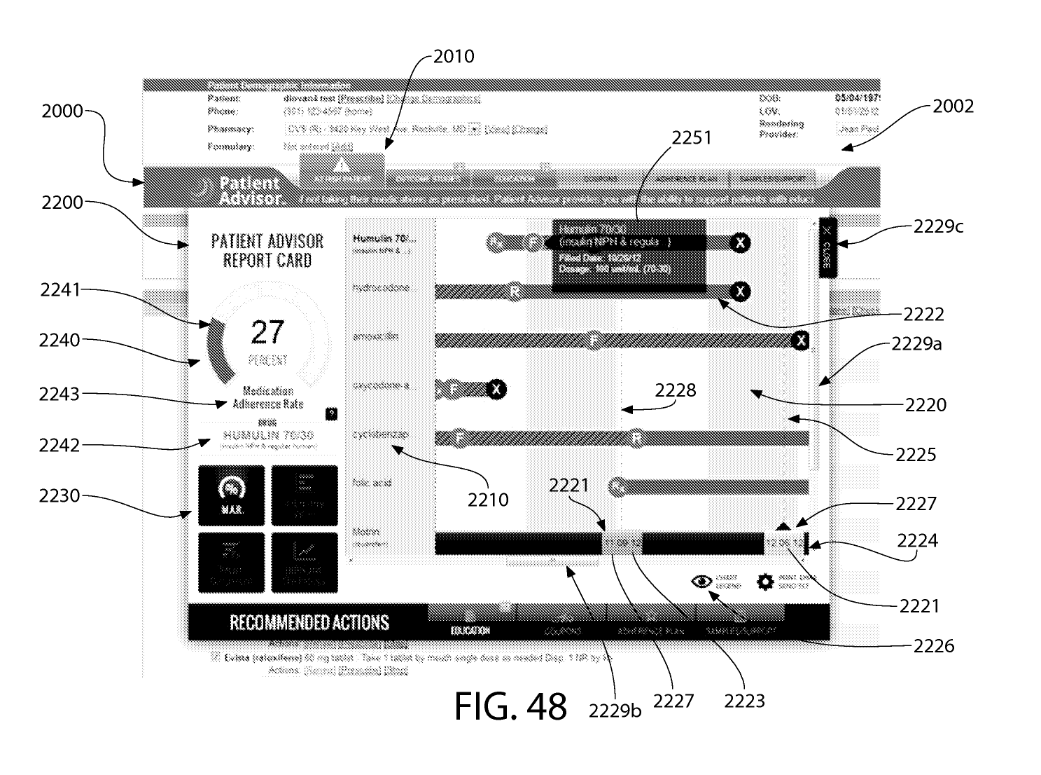

FIG. 48 shows an exemplary pop-up box 2251 that is displayed in adherence chart 2220 by placing an input device cursor over the F (fill date) element. The pop-up box shows the name of the drug (e.g. “Humulin 70/30”), prescription fill date (e.g. “Oct. 26, 2012”), and dosage (e.g. “100 units/mL (70-30)”). The Fill data indicates the date in which the medication was filled at a pharmacy.

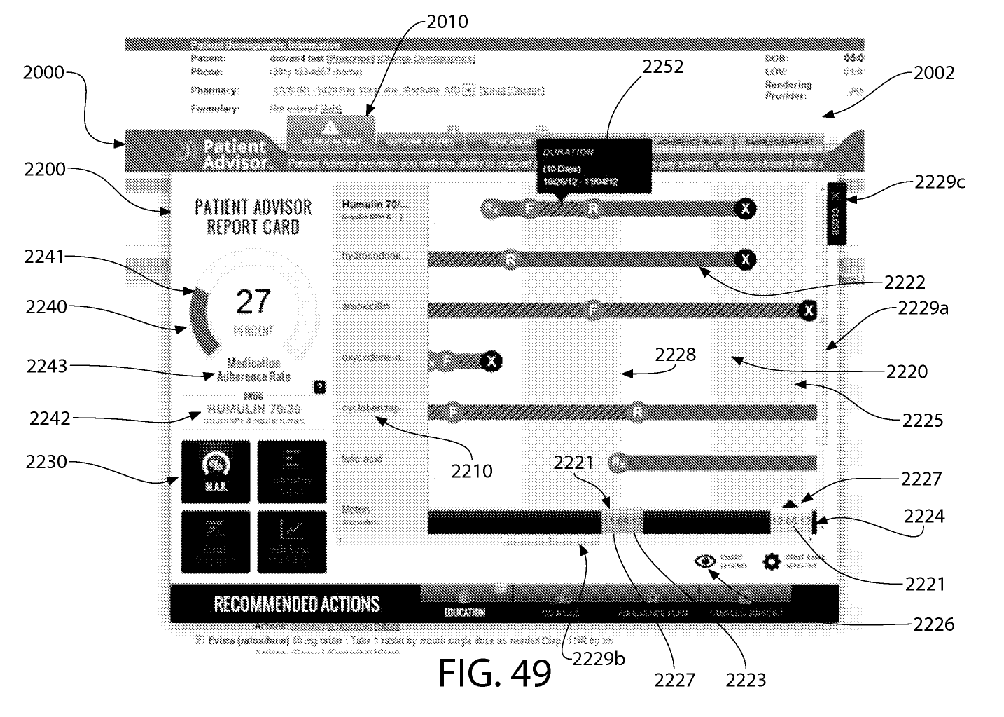

FIG. 49 shows an exemplary pop-up box 2252 that is displayed in adherence chart 2220 by placing an input device cursor over the striped colored bar (prescription duration) element. The pop-up box shows the identity of the selected element (e.g. “Duration”), the duration in days (e.g. “10 days”), and the calendar dates corresponding to the days duration (e.g. “Oct. 26, 2012-Nov. 4, 2012”). The duration bar or element indicates the duration of the fill for that medication before a refill is required or when it ends. The number of days plus the date range it covers may be displayed. For a drug fill that did not fall within a prescription's start and end date, there will be no duration bar that follows. The reason for this is because there is no clear indication for which prescription that prescription fill was associated with.

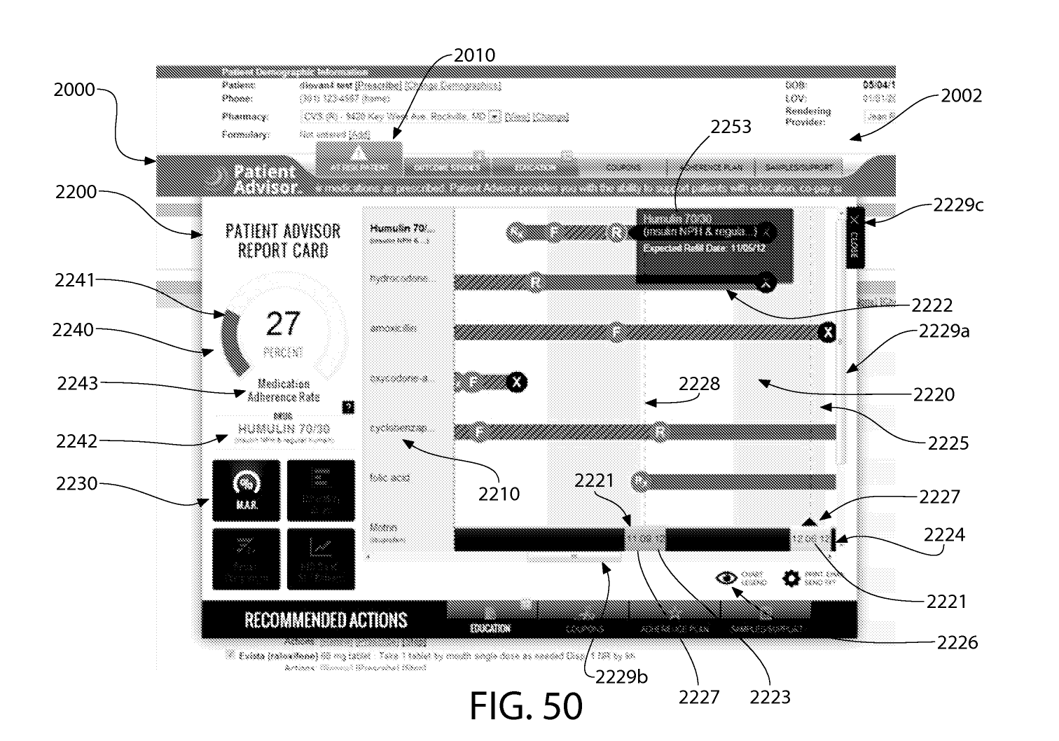

FIG. 50 shows an exemplary pop-up box 2253 that is displayed in adherence chart 2220 by placing an input device cursor over the R (expected refill date) element. The pop-up box shows the name of the drug (e.g. “Humulin 70/30”) and expected refill date (e.g. “Nov. 5, 2012”). The Refill (R) element indicates to the health care provider that there was a refill event that should have occurred but was missed. Accordingly, the pop-up box shows the name of the drug and date that it was expected to have been refilled based on the original prescription. The refill date R takes into account when the prior fill actually occurred. For example, if a prescription with 10 pills taken once a day was written on January 1 but was not filled until January 15, then the first refill is expected to occur on January 25. The “R” will thus appear in chart 2220 indicating to the provider that a refill date was missed according to the original prescription.

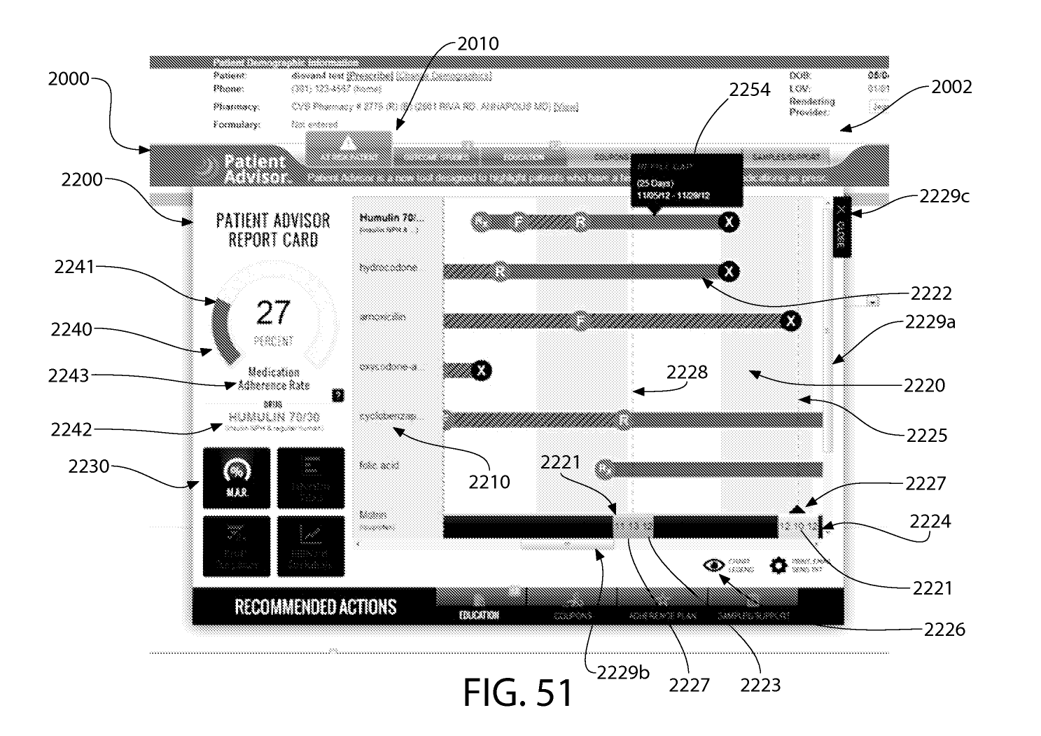

FIG. 51 shows an exemplary pop-up box 2254 that is displayed in adherence chart 2220 by placing an input device cursor over the solid colored bar (gap in fill date) element. The pop-up box shows the identity of the selected element (e.g. “Refill Gap”), the duration in days (e.g. “25 days”), and the calendar dates corresponding to the days duration (e.g. “Nov. 5, 2012-Nov. 29, 2012”). The refill gap bar shows the number of days and the dates between the time the patient should have had their medication filled and the next event. The refill gap bar can show up between an “Rx” and an “F” and between a “R” and an “F” or the end of a prescription.

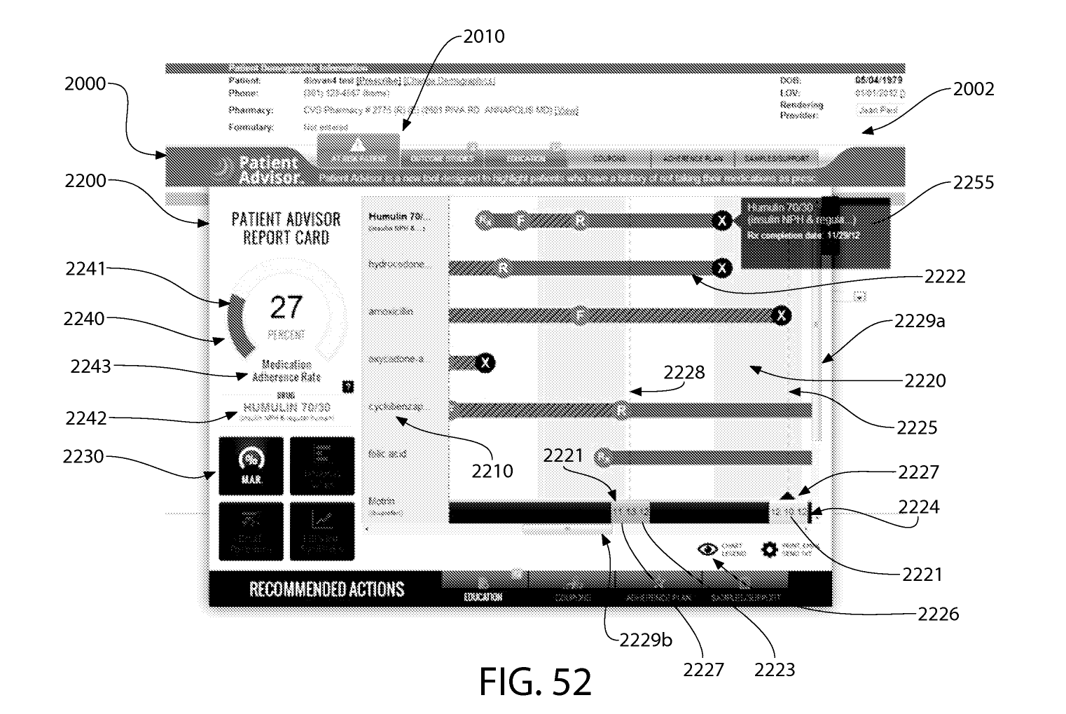

FIG. 52 shows an exemplary pop-up box 2255 that is displayed in adherence chart 2220 by placing an input device cursor over the X (prescription end data) element. The pop-up box shows the name of the drug (e.g. “Humulin 70/30”) and prescription end date (e.g. “Nov. 29, 2012”). The end of a prescription is calculated and readjusted based on the dates that the prescription was filled.

In one embodiment, as shown in FIG. 46, the adherence graphic 2241 representing the MAR percentage in graphical and/or numeric value form is displayed adjacent to the patient medication adherence chart 2220 in the graphical user interface in a manner that does not visually obscure the individual historical drug timelines 2222. The adherence graphic 2241 is visually enlarged having a vertical height which is higher than the vertical height of an individual drug timeline 2222, and preferably at least as vertically high as two individual historical drug timelines 2222 spaced vertically apart in the patient medication adherence chart 2220 so that the graphic readily stands out from the chart 2220 and timelines 2222 to the user. Furthermore, it should be noted that the patient medication adherence data (e.g. MAR in this embodiment) shown in adherence graphic 2241 which has a numeric value calculated from the patient medication history data graphically represented in the individual historical drug timelines 2222 cannot be obtained with a single glance by the health care provider from the timelines without more in-depth time consuming manual calculations by the health care provider from the adherence chart 2220. Accordingly, the report card summary field 2240 and particularly adherence graphic 2241 provides a different form of adherence data to the health care provider than adherence chart 2220 (e.g. numeric MAR value) albeit that numeric data is calculated from the same patient medication history data used by Patient Adherence Generation Module 306 to generate the individual historical drug timelines 2222.

Advantageously, the report card summary field 2240 including the adherence graphic 2241 provides a quantitative summary of patient adherence to their medication regimen for each drug identified in the medication menu 2210 and adherence chart 2220 based on an actual numeric value or measure of adherence (e.g. MAR/MPR, FFC, etc.) instead of on a statistically less meaningful qualitative basis to the health care provider which may be less informative as to the degree of the patient's non-compliance (e.g. star ratings, poor/average/good, etc.). In addition, by providing the ability for the health care provider to select an individual drug and display its associated patient adherence information in the visually enlarged report card summary field 2240 (in height relative to the height of each smaller individual historical drug timelines displayed in the adherence chart 2220), the degree of non-compliance is more easily discernible without requiring the health care provider to scan through the more detailed adherence chart 2220 timelines and data to obtain information about the patient's adherence data. Accordingly, the patient advisor report card 2200 advantageously offers an easier to navigate, use, and meaningful approach for graphically displaying medication adherence data on a GUI which saves time for both the health care provider and patient. Since the patient advisor report card 2200 is accessible directly from the summary screen of the main EP system GUI 2002 via the patient advisor toolbar 2004, no additional searching or accessing other program modules or system are required for the health care provider making the patient advisor system user friendly and improving efficiency for the user.

The patient advisor report card 2200 may be closed in one embodiment by a user selecting and clicking a “close” tab 2229c (see, e.g. FIG. 46) which returns the display to the summary screen of the main EP system GUI 2002 as shown in FIG. 42. Alternatively, a user may select one of the other tabs 2020-2060 in the toolbar 2004 which switches the display to the selected new tab. The contents of the additional tabs will now be described.

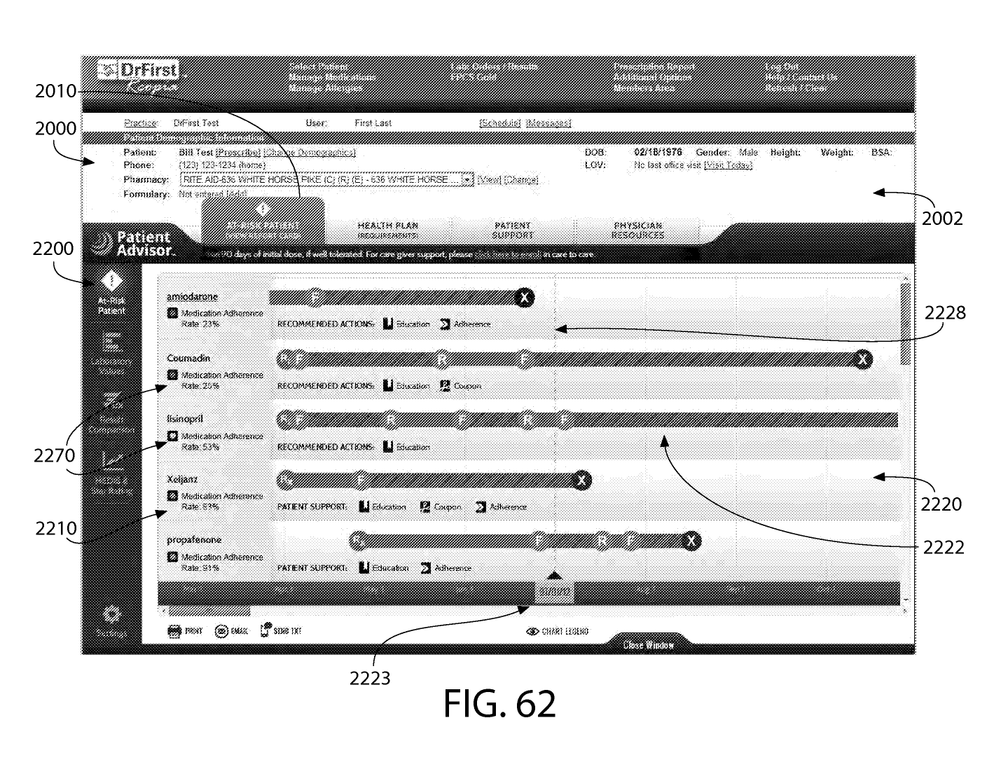

FIG. 62 shows an alternative embodiment of a report card summary field 2240 which displays the MAR % numeric value in a similar manner to that shown in FIG. 46 described herein, but with MAR % being simultaneously displayed for each drug listed in the medication menu 2210. Individual drug adherence graphics 2270 representing the MAR percentage rate are displayed for each drug with a numeric value MAR (e.g. 25%, 53%, etc.). In some illustrative embodiments, without limitation, an adherence graphic 2270 may be configured as a square as shown, recognizing that alternative shapes may be used such as rectangles, triangles, circles, etc. The adherence graphics 2270 may include a color indicia which changes color in dependent upon the MAR % for each drug in a similar manner to the color changing operation of adherence graphic 2241 as already described herein (e.g. Green—MAR is 71% or greater; Yellow . . . MAR is between 60% to 70%; Red—MAR is less than 60%). Other suitable colors and/or ranges may be used.

Outcome Studies Tab

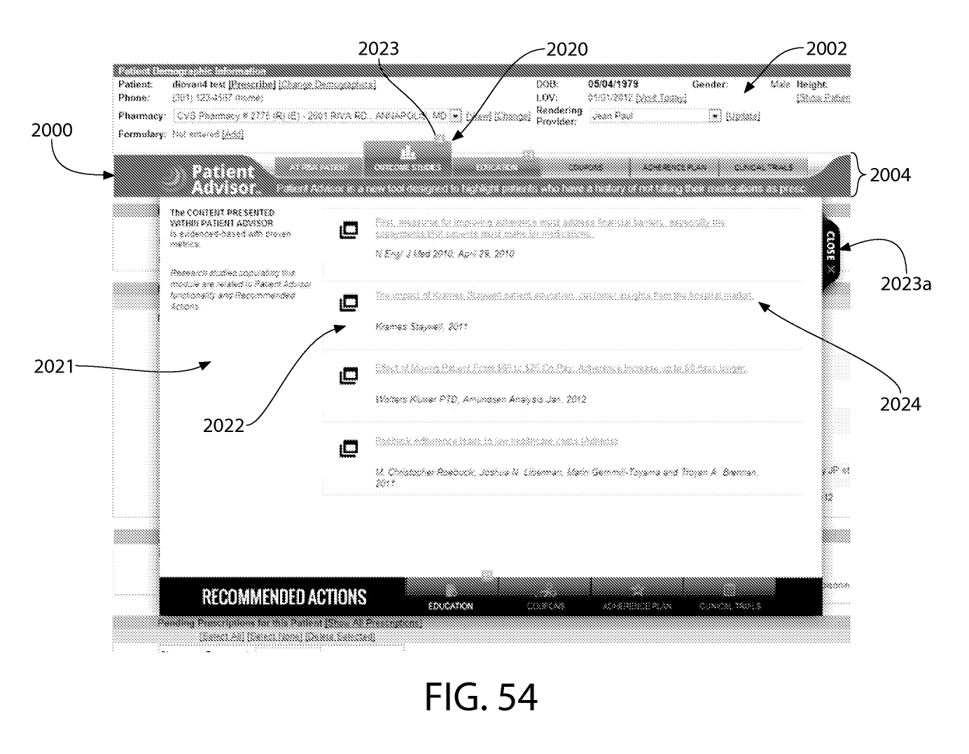

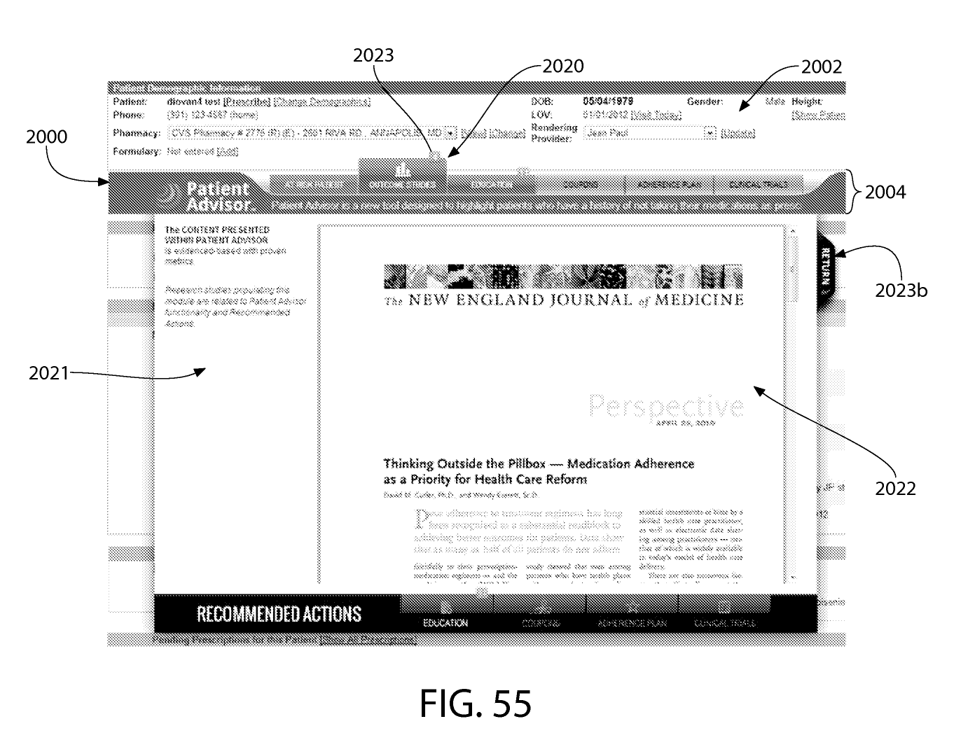

Referring to FIG. 54, the Outcome Studies tab 2020 may optionally be selected by a user (e.g. health care provider) from the toolbar 2004 in a manner similar to Report Card tab 2010 already described herein in detail. Upon selecting this tab, a pop-up window 2021 appears in the summary screen of the EP system GUI 2002, such as below the patient advisor compliance dashboard 2000 and toolbar 2004 as shown. In one embodiment, window 2021 may be enlarged and overlaid on top of GUI 2002. Outcome Studies is a list of studies (e.g. clinical studies) that have evidence-based data with proven metrics showing that medication adherence has a positive outcome on a patient's overall well-being. The user will be able to review the article within Patient Advisor, send it to the printer, or save it to their local storage drive. Window 2021 displays a list of one or more relevant study articles 2022 with bibliographic summary information such as title of article, source, author, date, etc. for each article. The article name 2024 is a user selectable dynamic link which allows the user to access and display a copy of the article selected, as shown in FIG. 55. In one embodiment, the Outcome Studies tab 2020 may include a studies counter icon 2023 which is displayed with tab 2020 and includes a numeric identifier showing the user at a glance the total number of articles available on topic. The studies counter icon 2023 may be displayed as being at least partially connected or part of the Outcome Studies tab 2020 and may have a different color than the tab to be visibly discernible by the user.

In the non-limiting example shown in FIGS. 54 and 55, the study articles 2022 pertain to the benefits realized by patient's adhering to their prescription medication regimen. It should be noted that the Outcome Studies listed in this section are not patient specific and general or generic in nature.

In other embodiments contemplated, the system 1000 may be programmed and configured to compile and provide user access (e.g. health care provider) to drug-specific study articles via the Outcome Studies tab 2020. Accordingly, the content of articles accessed by the Outcome Studies tab 2020 corresponds to studies which are drug-specific in nature based on the medications shown in the medication history field 2002d of the patient summary screen of the EP system GUI 2002 which displays a list of all active medications prescribed for the patient (see, e.g. FIG. 42). The total number of available articles which may be accessed via Outcome Studies tab 2020 (and shown in studies counter icon 2023) may correspond to all drugs listed in the medication history field 2002d, or alternatively only articles corresponding to one or a group of some drugs that has been selected (e.g. highlighted or marked) by the user from the list within the medication history field 2002d by selecting or de-selecting the drug in the list. The foregoing method of selecting study articles 2022 for retrieval and display by the system involve user actions which are taken in the medication history field 2002d of the patient summary screen of the EP system GUI 2002.

In other embodiments, selecting study articles 2022 for retrieval and display by the system may involve user actions which are taken in the medication menu 2210 displayed in the patient advisor report card 2200). For example, if a user (e.g. health care provider) selects Humulin in the medication menu 2210 of the patient advisor report card 2200 for viewing the MAR percentage (shown highlighted in FIG. 53), the content of the clinical study articles accessible by selecting the Outcome Studies tab 2020 directly correspond to the beneficial effects experienced by patients taking Humulin. The article content will change when the user selects a different drug in the medication menu 2210 to correspond to the new drug selected. The studies counter icon 2023 will change each time a different drug is selected by the user. If no articles 2022 are available related to the drug selected, the counter icon 2023 may not be displayed by the system or alternatively “0” may be indicated in the icon.

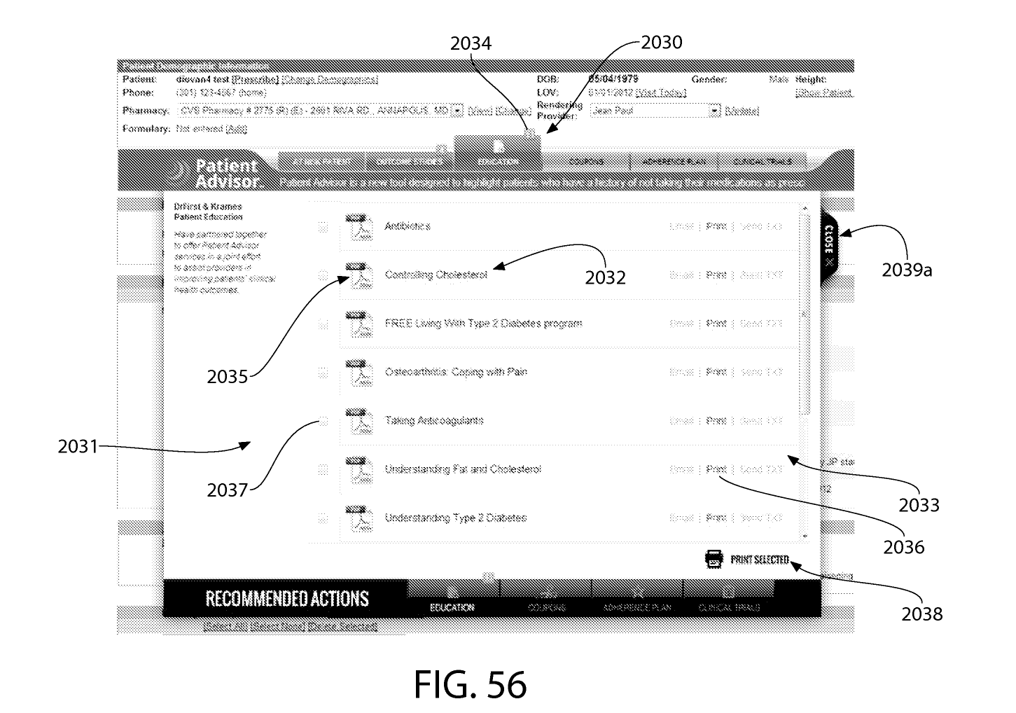

FIG. 55 shows an exemplary image of a clinical study article 2022 which is displayed by clicking on (i.e. selecting) the article name 2024 in the pop-up window 2021 shown in FIG. 56. A return tab 2023b allows the user to close the displayed article window and return to the previous screen shown in FIG. 546 with a list of all available articles.

To close the Outcome Studies tab 2020 and return to the patient summary screen of the EP system GUI 2002 (see, e.g. FIG. 42), a close tab 2023a may be provided as shown in FIG. 54.

Education Tab

Referring to FIG. 56, the Education tab 2030 may optionally be selected by a user (e.g. health care provider) from the toolbar 2004 in a manner similar to Report Card tab 2010 already described herein in detail. Upon selecting this tab, a pop-up window 2031 appears in the summary screen of the EP system GUI 2002 as shown displaying a list of educational sheets or articles 2032 which are drug-specific in nature. In one embodiment, window 2031 may be enlarged and overlaid on top of GUI 2002.

The content of the Education tab 2030 is mapped by the system 1000 to a patient's active medication list in one embodiment (see, e.g. medication menu 2210 of patient advisor report card 2200 in FIG. 46). If the patient has an active medication for which an educational type health sheet or article 2032 is available for a drug on the medication list, it will be accessible and listed in the Education tab. The education counter icon 2034, which functions similarly to studies counter icon 2023 discussed above, will be displayed with a numeric indication of the number of articles 2032 that are available for viewing by clicking on the Education tab 2030.

In other or additional embodiments, the health care provider may take one of the following actions in the EP system 200 with a prescription to be written and filled which will also display if educational articles 2032 are available for the prescribed medications in the Education tab 2030: (1) electronically sending/submitting the prescription to the pharmacy system (see, e.g. FIGS. 1 and 6); (2) electronically sending/submitting and printing prescription; (3) printing prescription without electronically sending/submitting; and (4) electronically signing the prescription without electronically sending/submitting.

To select an educational health sheet or article 2032 for immediate viewing on display 121 of the health care provider system within the main EP system GUI 2002, the user can click on the article icon 2035 shown in FIG. 56. In some embodiments, an action options field 2033 may be provided which includes a plurality of user selectable action buttons 2036 which gives the health care provider several options for providing a displayed article 2032 to the patient based on the format preferences of the patient for obtaining the health information.

To select an educational health sheet or article 2032 to print, the user can click on the “Print” button on the same line as the article. To select multiple documents to print at a time, the user can click on the check box 2037 next to each educational health sheet or article 2032 and then click on the “Print Selected” icon 2038. Other available user action buttons 2036 may include “E-mail” which triggers the system to send a copy of the article 2032 to the patient's email address of record in the EP system 200, and “Send Text” which sends a text message to the patient's cell phone number of record in the EP system of the article. Other action buttons may also be provided.

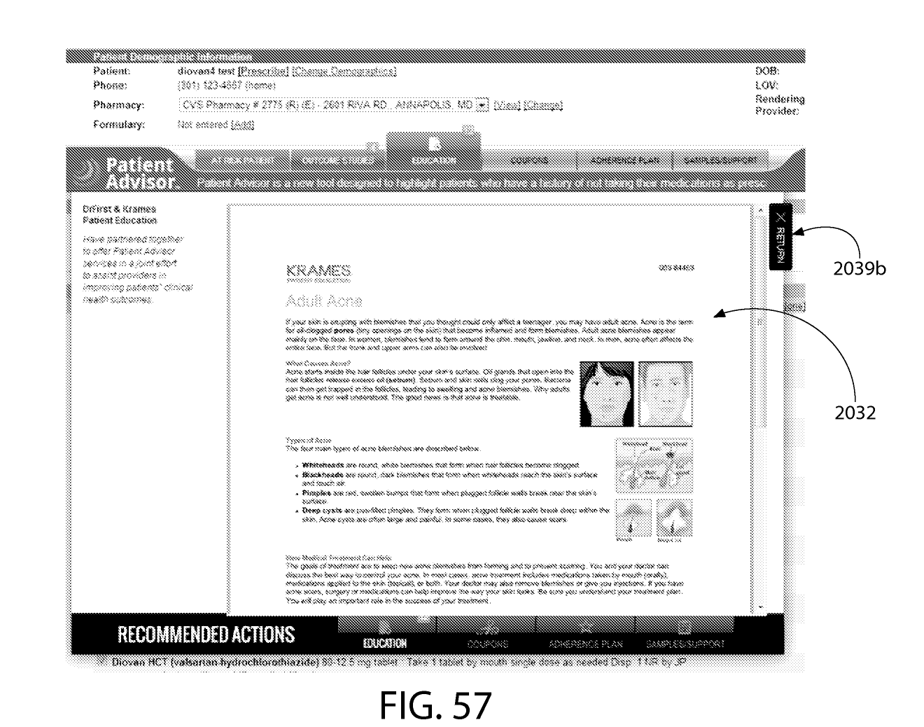

FIG. 57 shows an exemplary image of an educational health sheet or article 2032 which is displayed by clicking on (i.e. selecting) the article icon 2035 shown in FIG. 56. The article may be displayed in a pop-up window below patient advisor compliance dashboard 2000 and interactive toolbar 2004 in one embodiment as shown. A return tab 2039b allows the user to close the displayed article window and return to the previous screen shown in FIG. 56 with a list of all available articles on the topic.

To close the Education tab 2030 and return to the patient summary screen of the EP system GUI 2002 (see, e.g. FIG. 42), a close tab 2039a may be provided as shown in FIG. 56.

Coupons and Co-Pay

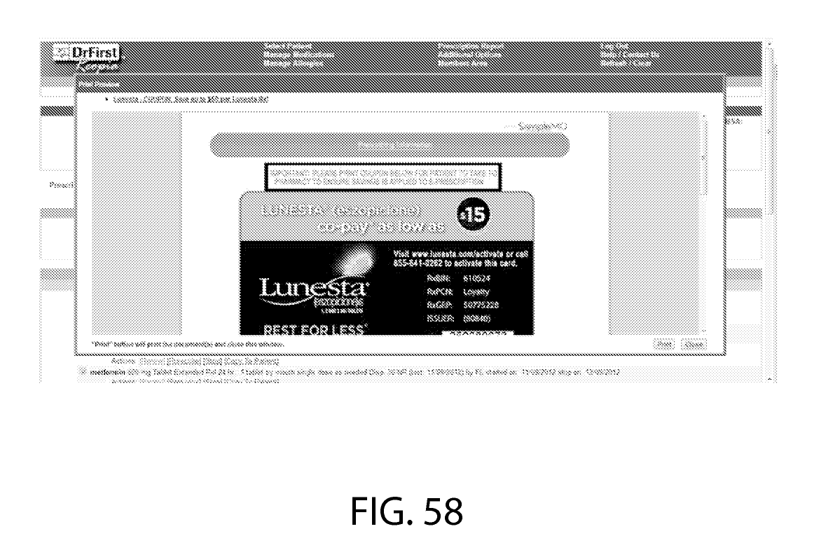

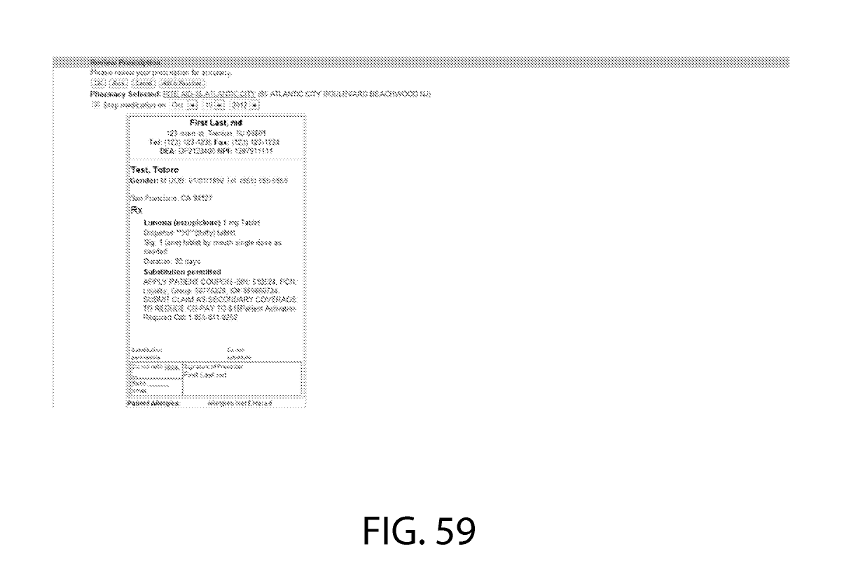

Selecting Coupon tab 2040 of the toolbar 2004 shown in FIG. 42 provides a health care provider with access to and displays available coupons and co-pay savings for the patient based on active medications currently prescribed for the patient or those new medications to be presently prescribed. In one embodiment, the patient adherence system 360 may be configured to automatically display a relevant coupon for a drug presently being electronically prescribed via the EP system 200 (e.g. new prescription) without the health care provider or other user manually selecting the Coupon tab 2040 simply by the action of the health care provider or other user electronically writing the prescription in the EP system. Coupons and co-pay savings for branded drugs which have been prescribed by the provider may be available for printing after the prescription is written in the EP system 200. If a coupon is available for a particular medication, the provider will see a preview window with the savings offer, as shown in FIG. 58. The relevant adjudication information of this offer will automatically be amended to the electronic prescription as part of the notes to pharmacist as shown in FIG. 59. In some embodiments, if the provider uses the notes to pharmacist field to write a message, the coupon information may not be amended in that field.

While the embodiment of the present invention has been described with reference to the accompanying drawings, it will be understood by those skilled in the art that the present invention can be embodied in other specific forms without departing from its spirit or essential characteristics. Therefore, the foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses if provided are intended to cover the structures described herein as performing the recited function and also equivalent structures.

1. A computer processor implemented method for navigating and displaying patient medication adherence information in a graphical user interface, the method comprising:
a processor displaying a toolbar in the graphical user interface, the toolbar comprising a plurality of user selectable content tabs;
the processor retrieving a patient medication adherence metric from a database for at least one drug, the patient medication adherence metric being indicative of the patient's compliance with following a medication treatment regimen and having a numeric value;
the processor displaying a patient advisor report card comprising an adherence chart comprising a plurality of drugs prescribed for the patient, each drug being displayed by name in the graphical user interface,
the processor further displaying an adherence metric graphic displaying the patient medication adherence metric in a graphical form;
wherein the patient medication adherence metric displayed in the adherence graphic corresponds to one of the drugs in the adherence chart.

2. The method of claim 1, wherein the graphical user interface in which the toolbar is displayed is a healthcare system entry screen.

3. The method of claim 2, wherein the processor generates the plurality of user selectable content tabs when a user selects a patient name in an electronic prescription system entry screen.

4. The method of claim 1, wherein the adherence graphic is visually enlarged in a vertical direction relative to its corresponding drug timeline in the adherence chart.

5. (canceled)

6. The method of claim 1, wherein the adherence graphic is a circular bar chart having an arcuately shaped adherence bar which changes length directly proportionate to the numeric value of the patient medication adherence metric for the at least one drug.

7. The method of claim 1, wherein the timeline is horizontally scrollable to move forward or backward in time to change the date range displayed in the adherence chart.

8. The method of claim 1, further comprising displaying a master timeline in the adherence chart which includes a slidable date marker, the slidably date marker being operable by sliding the date marker to the right or left to correspondingly change a range of dates displayed in the adherence chart.

9. The method of claim 8, wherein sliding the date marker to the left scrolls backward in time to allow a user to see past portions of the individual historical drug timelines, and wherein sliding the date marker to the right scrolls forward in time to allow the user to see predicted future portions of the individual historical drug timelines.

10. The method of claim 8, further comprising displaying a present date marker on the master timeline, wherein the present date marker remains fixed on the present date in the master timeline and the slidable date marker is moveable along the master timeline with respect to the present date marker.

11. The method of claim 8, further comprising displaying a vertical dateline in the adherence chart, the dateline being moveable forward or backward in time by moving the slidable date marker.

12-13. (canceled)

14. The method of claim 8, further comprising:
displaying a vertical dateline in the adherence chart, the dateline being moveable forward or backward in time by moving the slidable date marker;
moving the dateline over a portion of one of the individual drug timelines using the slidably date marker; and
correspondingly displaying information related to at least one of a prescription date, expected refill date, prescription end date, a gap in the fill date, or a prescription duration in a pop-up box in the graphical user interface depending on which portion of the one of the individual drug timelines is contacted by the dateline.

15-26. (canceled)

27. A computer processor implemented method for navigating and displaying patient medication adherence information in a graphical user interface, the method comprising:
a first processor receiving patient medication history data for a patient;
the first processor generating patient medication adherence data for at least one drug prescribed for the patient, the patient medication adherence data having a numeric value indicative of the patient's compliance with following a medication treatment regimen;
the first processor storing the patient medication adherence data in a first database;
a second processor automatically displaying a toolbar in a graphical user interface of a user terminal, the toolbar comprising a plurality of user selectable content tabs;
the second processor retrieving the patient medication adherence data from the first database for the at least one drug;
the second processor displaying a patient advisor report card comprising an adherence chart having a plurality of individual drug timelines and an adherence graphic displaying the patient medication adherence data in a graphical form;
wherein the patient medication adherence data displayed in the adherence graphic corresponds to one of the drug timelines in the adherence chart.

28. The method of claim 27, wherein the graphical user interface is a healthcare system entry screen.

29. The method of claim 27, wherein the processor automatically generates the plurality of user selectable content tabs when a user selects a patient name in electronic prescription system entry screen.

30. The method of claim 27, wherein the adherence graphic is visually enlarged in a vertical direction relative to its corresponding drug timeline in the adherence chart.

31. The method of claim 30, wherein the adherence graphic has a height that is as high as a distance between at least two individual drug timelines.

32-33. (canceled)

34. The method of claim 27, further comprising displaying a medication menu in the adherence chart comprising a plurality of drugs prescribed for the patient, each drug being displayed by name in the graphical user interface as a user selectable dynamic name link;
wherein selecting a dynamic name link for one of the drugs displayed in the menu automatically changes the patient medication adherence metric displayed in the adherence graphic to the selected drug.

35. The method of claim 27, further comprising hovering a pointer of an input device over a portion of an individual drug timeline, and correspondingly displaying information related to at least one of a prescription date, expected refill date, prescription end date, a gap in the fill date, or a prescription duration in a pop-up box in the graphical user interface.

36. The method of claim 27, wherein each of the plurality of individual drug timelines has an associated individual adherence graphic displayed simultaneously adjacent to each drug timeline, the adherence graphics displaying the numeric value of the patient medication adherence data corresponding to each of the drugs represented by a drug timeline.

37-40. (canceled)
